(19) United States
(12) Patent Application Publication
(10) Pub. No.: US 2008/0283702 A1
(43) Pub. Date: Nov. 20, 2008

(54) Structural forged steel angled L-shaped brackets and steel joining plates for effecting the bolted connecting between various main structural supports a horizontal beam, the horizontal joist members, the horizontal rim joist members and a column in a lumber frame structure

(76) Inventor: Timothy Dewayne Ikerd, Chicago Ridge, IL (US)

Correspondence Address: Timothy D. Ikerd, Apartment 3-West, 6011 S. Marshall Avenue, Chicago Ridge, IL, 60415-1666, US

(21) Appl. No.: 11/803,382

(22) Filed: May 14, 2007

(51) Int. Cl. F16B 1/00

(52) U.S. Cl. 248/228.1

(57) ABSTRACT

A series of various structural steel forged angled L shaped brackets and various steel joining plates for effecting a bolted connection between various new structural lumber members consisting of horizontal beam/vertical column/horizontal rim joists members/horizontal joist beam in various framed structure includes a latitudinal connecting portion and a longitudinal connecting portion. The various embodiments of the forged angled L shaped brackets and various steel joining plates are particularly useful in the context of upgrading or reinforcing existing structures connections at the horizontal beam/vertical column/horizontal rim joists members interfaces in various existing lumber framed structures. The structural steel forged angled L shaped brackets and steel joining plates can be used in various new lumber frame constructions. Also, the structural steel forged angled L shaped brackets and steel joining plates have various proviso features on the manufacturing process and specifications on the embodiments.

This invention relates to the construction of lumber structures with need of structural integrity. The present invention relates particularly to new construction method utilizing a series of forged steel angled L shaped brackets and joining plates usages in new construction of lumber structures and the reinforcing of existing structures of lumber structures needing ability.

### BACKGROUND OF THE INVENTION

The unlimited appropriate use of materials and methods of design or construction are not specifically prescribed by this building codes, provided the building official determines that the proposed alternate materials or methods of design or construction are at least equivalent of that prescribed in this building codes in strength, durability, dimensional stability, and safety. Do to the structural collapsing

In the early latent past porches and decks lumber framed structures such as porches and decks are typically constructed with lumber framed structure members stacked vertical column supporting horizontal members secured with nails and metal strips fastened with nail between the union of the vertical column supporting horizontal beam members. Allowing the joist to be supported by the horizontal beam members and the horizontal to be supported by the vertical column. Providing the building official to determine that the methods of design or construction are at least equivalent to the prescribed building codes of the times.

In latent past porches and decks lumber framed structures such as porches and decks are typically constructed with lumber framed structure members by notching the vertical column allowing the horizontal members to be positioned and supported by the notched cutout of the vertical secured with nails and typically metal strips fastened with nail between the union of the vertical column supporting horizontal members. Providing the building official to determine that the methods of design or construction are at least equivalent to the prescribed building codes dimensional stability of the times.

In past porches and decks lumber framed structures such as porches and decks are typical constructed with lumber framed structure members, metal construction connectors used in various locations including vertical column allowing the horizontal members to be positioned and supported by the formed metal construction connectors. Providing the building official to determine that the methods of design or construction are at least equivalent to the prescribed building codes dimensional stability and safety of the times.

At present the porches and decks lumber framed structures such as porches and decks are typically constructed with lumber framed structure members, metal construction connectors used in various locations including vertical column allowing the horizontal members to be positioned and supported by the formed metal construction connectors and steel braces being support elements without bolt connecting elements. The unlimited appropriate use of materials and methods of design or construction are not specifically prescribed by this building codes, provided the building official determines that the proposed alternate materials or methods of design or construction are at least equivalent of that prescribed in this building codes providing the building official to determine that the methods of design or construction are at least equivalent to the prescribed building codes strength, dimensional stability, durability and safety of the times.

In viewing the forging, a need exist for facilitating the reinforcing of existing lumber framed structures. While the present steel braces have not proven there durability, dimensional stability, durability, safety and strength with the present methods of construction and the configuration and construction of the steel braces does not lend itself to being placed on an existing horizontal beam/vertical column/horizontal rim joist interface. A need exist, therefore, for reinforcing existing various lumber framed structures between the horizontal beam/vertical column/horizontal rim joist members through the use of various bolted connection. It would also preferred if the solution was also adaptable for the use in connections with the construction of new lumber frame structures to thereby provide a rigid connection. Being adapted for the use in connections with the new methods construction herein and having wide range of uses.

### SUMMARY

First aspect of the present invention involves the first method of new construction providing the utilization of a series of angle L-shaped brackets, joining plate, fasteners, connectors whereby the affixed interlocks of wooden members or plastic composite lumber members form the main structural supports.

The first angle “L” shaped bracket being provided with apertures in the median of the connecting leg. The first angle “L” shaped bracket is provided with a longitudinal connecting element to connecting leg and a latitudinal supporting element supporting the short flange. The first angle “L” shaped bracket being provided with apertures in the medians of the connecting leg.

The positioning of the first angle L-shaped brackets connecting leg is positioned in an upside down “L” shape configuration to the longitudinal vertical column's front surface coinciding with the short flanges top surface height to the heights of the bottom surface of the horizontal rim joists members and bottom surface of the horizontal beam forming the main support structure intersection by height requirements of the structure.

The second angle “L” shaped bracket is provided with a longitudinal connecting element the connecting leg and a latitudinal supporting element supporting the long flange. The second angle “L” shaped bracket being provided with apertures in the medians of the connecting leg.

The second angle L-shaped brackets connecting leg is positioned in a reversed upside down L-shape configuration longitudinally to the vertical column back surface coinciding with the long flanges top surface height to the heights of the bottom surface of the horizontal beam and bottom surface of the horizontal rim joist members forming the main support structure intersection by height requirements of the structure.

The coinciding height intersections on the vertical column surfaces by the horizontal rim joists members supported by the first angled L-shaped bracket intersects the height of the horizontal beam supported by the second angled L-shaped bracket coincides with equal horizontal height planes of the main supports of the structure.

Utilizing a locking clasping clamp temporarily holds the first angled L-shaped bracket to the vertical columns outward front surface and the second angled L-shaped bracket to the same vertical columns inward back surface, allowing for parallel latitudinal alignment of the supporting flanges and parallels latitudinal alignment of the apertures in each of the connecting legs. Utilizing locking clasping clamps insure longitudinal plumb of the vertical column.

The latitudinal alignment of the apertures in each of the connecting legs being used as drill guides for the first latitudinal through hole drillings of the vertical column and the second latitudinal through hole drillings of the vertical column can be preformed by utilizing a two stage latitudinal drilling technique per each aperture in the connecting legs for each of the angled L-shaped brackets.

The two stage latitudinal drilling technique through the vertical column requires each of the apertures in connecting leg of the first angled L-shaped bracket to be used as drill guides for the first stage of the latitudinal drillings to the median of the vertical column from the front surface and the second angled L-shaped bracket connecting leg apertures are used as drill guides for the second stage of the latitudinal drillings to the median of the vertical column from the back surface aligning latitudinally with the first stage drillings to the median of the vertical column from the front surface allowing for an aligned latitudinal through holes passage of each of the apertures in the connecting legs for each of the angled L-shaped brackets.

The first angle L-shaped bracket apertures, the vertical column through holes and the second angle L-shaped bracket apertures allows for means of an affixed interlocking latitudinally.

The affixed interlocking latitudinally of the first angle L-shaped bracket to the front surface of the vertical column and the second angle L-shaped bracket to the back surface of the vertical column is comprised of through bolts passing through the first angle L-shaped brackets connecting leg apertures through the vertical column through holes to the second angle L-shaped brackets connecting leg apertures, where the threads of the through bolts are affixed with washers and secured with through bolt hex nuts.

Remove the temporarily locking clasping clamp after the completion of the affixed interlocking latitudinally of the first angle L-shaped bracket to the front surface of the vertical column and the second angle L-shaped bracket to the back surface of the vertical column.

The first angle L-shape brackets short flange with respect to second angle L-shape brackets long flange allowing for opposing flanges to the longitudinal surfaces of the vertical column are arranged that the first angle L-shape brackets short flange extends outwards from the front surface of the longitudinal vertical column and the second angle L-shape bracket long flange extends outwards from the back surface of the longitudinal vertical column, forming a “T” shape configuration do to equal latitudinal height planes of the flanges to the longitudinal surfaces of the vertical column.

The positioning of the second angle L-shape brackets long flange conforms to a supporting element for the horizontal support beam and the first angle L-shape brackets short flange conforms to a supporting element for the horizontal rim joists beam and the joining plate.

Positioning the horizontal rim joist members on the short flange of the first angle L-shape bracket and the positioning of the joining plate in front of the horizontal rim joist members on the short flange of the first angle L-shape bracket allows for the longitudinal alignment of the apertures in the joining plate to be used as drill guides for the single stage longitudinal drillings through the horizontal rim joist members through the vertical column to the horizontal support beam.

Utilizing a locking clasping clamp temporarily allows stability of the joining plate, the horizontal rim joist members to the vertical column for the single stage latitudinal drillings.

The single stage latitudinal drilling technique through the horizontal rim joist members through the vertical column to the horizontal support beam requires each of the apertures in the joining plate to be used as drill guides for the single stage latitudinal drillings through the front surface of the horizontal rim joist members to the opposing side the back surface through the front surface of the vertical column to the opposing side the back surface to the front surface of the horizontal support beam, allowing for each of the apertures in the joining plate to be aligned latitudinal with each of the through holes in the horizontal rim joist members, vertical column and to the holes in the horizontal support beam.

The joining plate apertures, the horizontal rim joist members through holes, the vertical columns through holes and the horizontal support beam holes allows for means of an affixed interlocking latitudinally.

The affixed interlocking latitudinally of the joining plate, the horizontal rim joist members, vertical columns and the horizontal support beam is comprised of lag bolts passing through The joining plate apertures through the horizontal rim joist members through holes through the vertical column through holes to the horizontal support beam holes, where the threads of the lag bolts are embedded into the horizontal support beam.

Remove the temporarily locking clasping clamp after the completion of the affixed interlocking latitudinally of the joining plate, the horizontal rim joist members, vertical columns and the horizontal support beam.

Second aspect of the present invention involves the second method of new construction providing the utilization of a series of angle L-shaped brackets, joining plate, fasteners, connectors whereby the affixed interlocks of wooden members or plastic composite lumber members form the main structural supports.

The first angle “L” shaped bracket being provided with apertures in the median of the connecting leg. The first angle “L” shaped bracket is provided with a longitudinal connecting element the connecting leg and a latitudinal supporting element supporting the short flange. The first angle “L” shaped bracket being provided with apertures in the medians of the connecting leg.

The positioning of the first angle L-shaped brackets connecting leg is positioned in an upside down “L” shape configuration to the longitudinal vertical column's front surface, coinciding with the short flanges top surface height to the heights of the bottom surface of the horizontal rim joists members and bottom surface of the horizontal beam forming the main support structure intersection by height requirements of the structure.

The second angle “L” shaped bracket is provided with a longitudinal connecting element the connecting leg and a combinational latitudinal supporting element supporting and connecting element the long flange. The second angle “L” shaped bracket being provided with apertures in the medians of the connecting leg and the long flange, thereby confirming the long flange to having the connecting elements.

The second angle L-shaped brackets connecting leg is positioned in a reversed upside down L-shape configuration longitudinally to the vertical column back surface coinciding with the long flanges top surface height to the heights of the bottom surface of the horizontal beam and bottom surface of the horizontal rim joist members forming the main support structure intersection by height requirements of the structure.

The coinciding height intersections on the vertical column surfaces by the horizontal rim joists members supported by the first angled L-shaped bracket intersects the height of the horizontal beam supported by the second angled L-shaped bracket coincides with equal horizontal height planes of the main supports of the structure.

Utilizing a locking clasping clamp temporarily holds the first angled L-shaped bracket to the vertical columns outward front surface and the second angled L-shaped bracket to the same vertical columns inward back surface, allowing for parallel latitudinal alignment of the supporting flanges and parallels latitudinal alignment of the apertures in each of the connecting legs. Utilizing locking clasping clamps insure longitudinal plumb of the vertical column.

The latitudinal alignment of the apertures in each of the connecting legs being used as drill guides for the first latitudinal through hole drillings of the vertical column and the second latitudinal through hole drillings of the vertical column can be preformed by utilizing a two stage latitudinal drilling technique per each aperture in the connecting legs for each of the angled L-shaped brackets.

The two stage latitudinal drilling technique through the vertical column requires each of the apertures in connecting leg of the first angled L-shaped bracket to be used as drill guides for the first stage of the latitudinal drillings to the median of the vertical column from the front surface and the second angled L-shaped bracket connecting leg apertures are used as drill guides for the second stage of the latitudinal drillings to the median of the vertical column from the back surface aligning latitudinally with the first stage drillings to the median of the vertical column from the front surface allowing for an aligned latitudinal through holes passage of each of the apertures in the connecting legs for each of the angled L-shaped brackets.

The first angle L-shaped bracket apertures, the vertical column through holes and the second angle L-shaped bracket apertures allows for means of an affixed interlocking latitudinally.

The affixed interlocking latitudinally of the first angle L-shaped bracket to the front surface of the vertical column and the second angle L-shaped bracket to the back surface of the vertical column is comprised of through bolts passing through the first angle L-shaped brackets connecting leg apertures through the vertical column through holes to the second angle L-shaped brackets connecting leg apertures, where the threads of the through bolts are affixed with washers and secured with through bolt hex nuts.

Remove the temporarily locking clasping clamp after the completion of the affixed interlocking latitudinally of the first angle L-shaped bracket to the front surface of the vertical column and the second angle L-shaped bracket to the back surface of the vertical column.

The first angle L-shape brackets short flange with respect to second angle L-shape brackets long flange allowing for opposing flanges to the longitudinal surfaces of the vertical column are arranged that the first angle L-shape brackets short flange extends outwards from the front surface of the longitudinal vertical column and the second angle L-shape bracket long flange extends outwards from the back surface of the longitudinal vertical column, forming a “T” shape configuration do to equal latitudinal height planes of the flanges to the longitudinal surfaces of the vertical column.

The positioning of the second angle L-shape brackets long flange conforms to a combinational supporting element and connecting element for the horizontal support beam and the first angle L-shape brackets short flange conforms to a supporting element for the horizontal rim joists beam and the joining plate.

Positioning the horizontal support beam on the long flange of the second angle L-shape bracket allows for the longitudinal apertures in the long flange to be drill guides for the single stage longitudinal drillings through the horizontal support beam.

The single stage longitudinal drilling technique through the horizontal support beam requires each of the apertures in the connecting flange of the second angled L-shaped bracket to be used as drill guides for the single stage longitudinal drillings through the bottom surface of the horizontal support beam to the opposing side the top surface allowing for each of the apertures in the connecting flange of the second angled L-shaped bracket to be aligned longitudinal with through holes in the horizontal support beam.

The second angle L-shaped bracket apertures in the long flange and the horizontal support beam through holes allows for means of an affixed interlocking longitudinally.

The affixed interlocking longitudinally of the second angle L-shaped brackets long flange to the horizontal support beam is comprised of through bolts passing through the second angle L-shaped bracket long flange apertures through the horizontal support beam through holes, where the threads of the through bolts are affixed with some washers and secured with through bolt hex nuts.

Positioning the horizontal rim joist members on the short flange of the first angle L-shape bracket and the positioning of the joining plate in front of the horizontal rim joist members on the short flange of the first angle L-shape bracket allows for the longitudinal alignment of the apertures in the joining plate to be used as drill guides for the single stage longitudinal drillings through the horizontal rim joist members to the vertical column.

Utilizing a locking clasping clamp temporarily allows stability of the joining plate, the horizontal rim joist members to the vertical column for the single stage latitudinal drillings.

The single stage latitudinal drilling technique through the horizontal rim joist members and vertical column requires each of the apertures in the joining plate to be used as drill guides for the single stage latitudinal drillings through the front surface of the horizontal rim joist members to the opposing side the back surface through the front surface of the vertical column, allowing for each of the apertures in the joining plate to be aligned latitudinal with each of the through holes in the horizontal rim joist members to the holes in the vertical column.

The joining plate apertures, the horizontal rim joist members through holes and the vertical columns holes allows for means of an affixed interlocking latitudinally.

The affixed interlocking latitudinally of the joining plate apertures, the horizontal rim joist members through holes and the vertical columns holes is comprised of lag bolts passing through the joining plate apertures through the horizontal rim joist members through holes to the vertical column holes, where the threads of the lag bolts are embedded into the vertical column.

Remove the temporarily locking clasping clamp after the completion of the affixed interlocking latitudinally of the joining plate apertures, the horizontal rim joist members through holes and the vertical columns holes.

Third aspect of the present invention involves the third method of new construction providing the utilization of a series of angle L-shaped brackets, joining plate, fasteners, connectors whereby the affixed interlocks of wooden members or plastic composite lumber members form the main structural supports.

The first angle “L” shaped bracket being provided with apertures in the median of the connecting leg. The first angle “L” shaped bracket is provided with a longitudinal connecting element connecting leg and a latitudinal supporting element supporting the short flange. The first angle “L” shaped bracket being provided with apertures in the medians of the connecting leg.

The positioning of the first angle L-shaped brackets connecting leg is positioned in an upside down “L” shape configuration to the longitudinal vertical column's front surface coinciding with the short flanges top surface height to the heights of the bottom surface of the horizontal rim joists members and bottom surface of the horizontal beam forming the main support structure intersection by height requirements of the structure.

The second angle “L” shaped bracket is provided with a longitudinal connecting element the connecting leg and a combinational latitudinal supporting element and connecting elements the long flange. The second angle “L” shaped bracket being provided with apertures in the medians of the connecting leg and the long flange, thereby confirming the long flange to having the connecting elements.

The second angle L-shaped brackets connecting leg is positioned in a reversed upside down L-shape configuration longitudinally to the vertical column back surface coinciding with the long flanges top surface height to the heights of the bottom surface of the horizontal beam and bottom surface of the horizontal rim joist members forming the main support structure intersection by height requirements of the structure.

The coinciding height intersections on the vertical column surfaces by the horizontal rim joists members supported by the first angled L-shaped bracket intersects the height of the horizontal beam supported by the second angled L-shaped bracket coincides with equal horizontal height planes of the main supports of the structure.

Utilizing a locking clasping clamp temporarily holds the first angled L-shaped bracket to the vertical columns outward front surface and the second angled L-shaped bracket to the same vertical columns inward back surface, allowing for parallel latitudinal alignment of the supporting flanges and parallels latitudinal alignment of the apertures in each of the connecting legs. Utilizing locking clasping clamps insure longitudinal plumb of the vertical column.

The latitudinal alignment of the apertures in each of the connecting legs being used as drill guides for the first latitudinal through hole drillings of the vertical column and the second latitudinal through hole drillings of the vertical column can be preformed by utilizing a two stage latitudinal drilling technique per each aperture in the connecting legs for each of the angled L-shaped brackets.

The two stage latitudinal drilling technique through the vertical column requires each of the apertures in connecting leg of the first angled L-shaped bracket to be used as drill guides for the first stage of the latitudinal drillings to the median of the vertical column from the front surface and the second angled L-shaped bracket connecting leg apertures are used as drill guides for the second stage of the latitudinal drillings to the median of the vertical column from the back surface aligning latitudinally with the first stage drillings to the median of the vertical column from the front surface allowing for an aligned latitudinal through holes passage of each of the apertures in the connecting legs for each of the angled L-shaped brackets.

The first angle L-shaped bracket apertures, the vertical column through holes and the second angle L-shaped bracket apertures allows for means of an affixed interlocking latitudinally.

The affixed interlocking latitudinally of the first angle L-shaped bracket to the front surface of the vertical column and the second angle L-shaped bracket to the back surface of the vertical column is comprised of through bolts passing through the first angle L-shaped brackets connecting leg apertures through the vertical column through holes to the second angle L-shaped brackets connecting leg apertures, where the threads of the through bolts are affixed with washers and secured with through bolt hex nuts.

Remove the temporarily locking clasping clamp after the completion of the affixed interlocking latitudinally of the first angle L-shaped bracket to the front surface of the vertical column and the second angle L-shaped bracket to the back surface of the vertical column.

The first angle L-shape brackets short flange with respect to second angle L-shape brackets long flange allowing for opposing flanges to the longitudinal surfaces of the vertical column are arranged that the first angle L-shape brackets short flange extends outwards from the front surface of the longitudinal vertical column and the second angle L-shape bracket long flange extends outwards from the back surface of the longitudinal vertical column, forming a “T” shape configuration do to equal latitudinal height planes of the flanges to the longitudinal surfaces of the vertical column.

The positioning of the second angle L-shape brackets long flange conforms to a combinational supporting element and connecting element for the horizontal support beam to the third angle L-shape brackets long flange and the first angle L-shape brackets short flange conforms to a supporting element for the horizontal rim joists beam and the joining plate.

The third angle “L” shaped bracket is provided with a longitudinal connecting element the connecting leg and a latitudinal supporting element and connecting elements the long flange. The third angle “L” shaped bracket being provided with apertures in the medians of the connecting leg and the long flange, conforming the long flange combinational supporting element and connecting element.

Positioning the horizontal support beam on the long flange of the second angle L-shape bracket allows the third angle L-shape bracket long flange to be positioned atop the horizontal support beam, whereby the longitudinal apertures in the long flange of the second angle L-shape bracket and third angle L-shape bracket long flange apertures can be used as drill guides for the two stage longitudinal drillings through the horizontal support beam. The third angle L-shaped brackets is positioned in a revered L-shape configuration the back surface of the vertical column, allowing the long flange is position atop the horizontal support beam and the connecting leg to be positioned to the back surface of the vertical column.

The two stage longitudinal drilling technique through the horizontal requires each of the apertures in support flange of the first angled L-shaped bracket to be used as drill guides for the first stage of the longitudinal drillings to the median of the horizontal support beam from the bottom surface and the third angled L-shaped bracket connecting flange apertures are used as drill guides for the second stage of the longitudinal drillings to the median of the horizontal support beam from the top surface aligning longitudinally with the first stage drillings to the median of the horizontal support beam from the bottom surface allowing for an aligned longitudinal through holes passage of each of the apertures in the flanges for each of the angled L-shaped brackets.

The second angle L-shaped bracket apertures in the long flange, the through holes in the horizontal support beam and the third angle L-shaped bracket apertures in the long flange allows for means of an affixed interlocking longitudinally.

The affixed interlocking longitudinally of the second angle L-shaped brackets long flange through the horizontal support beam through the third angle L-shaped brackets long flange is comprised of through bolts passing through the second angle L-shaped bracket long flange apertures through the horizontal support beam through holes through the apertures in the third angle L-shaped brackets long flange, where the threads of the through bolts are affixed with some washers and secured with through bolt hex nuts.

The third angle L-shaped brackets connecting leg apertures are to be used as drill guides for the single stage latitudinal drillings through the back surface of the vertical column to the opposing side the front surface, allowing for each of the apertures in the connecting leg of the third angle L-shaped brackets to be aligned latitudinal with each of the through holes in the vertical column.

The affixed interlocking latitudinally of the third angle L-shaped bracket to the back surface of the vertical column is comprised of through bolts passing through the third angle L-shaped brackets connecting leg apertures through the vertical column through holes, where the threads of the through bolts are affixed with washers and secured with through bolt hex nuts.

Positioning the horizontal rim joist members on the short flange of the first angle L-shape bracket and the positioning of the joining plate in front of the horizontal rim joist members on the short flange of the first angle L-shape bracket allows for the latitudinal alignment of the apertures in the joining plate to be used as drill guides for the single stage latitudinal drillings through the horizontal rim joist members to the vertical column.

Utilizing a locking clasping clamp temporarily allows stability of the joining plate, the horizontal rim joist members to the vertical column for the single stage latitudinal drillings.

The single stage latitudinal drilling technique through the horizontal rim joist members and vertical column requires each of the apertures in the joining plate to be used as drill guides for the single stage latitudinal drillings through the front surface of the horizontal rim joist members to the opposing side the back surface through the front surface of the vertical column, allowing for each of the apertures in the joining plate to be aligned latitudinal with each of the through holes in the horizontal rim joist members to the holes in the vertical column.

The joining plate apertures, the horizontal rim joist members through holes and the vertical columns holes allows for means of an affixed interlocking latitudinally.

The affixed interlocking latitudinally of the joining plate apertures, the horizontal rim joist members through holes and the vertical columns holes is comprised of lag bolts passing through The joining plate apertures through the horizontal rim joist members through holes to the vertical column holes, where the threads of the lag bolts are embedded into the vertical column.

Remove the temporarily locking clasping clamp after the completion of the affixed interlocking latitudinally of the joining plate apertures, the horizontal rim joist members through holes and the vertical columns holes.

Fourth aspect of the present invention involves the fourth method of new construction providing the utilization of a series of angle L-shaped brackets, joining plate, fasteners, connectors whereby the affixed interlocks of wooden members or plastic composite lumber members form the main structural supports.

The first angle “L” shaped bracket is provided with a longitudinal connecting element connecting leg and a latitudinal supporting element supporting the short flange. The first angle “L” shaped bracket being provided with apertures in the median of the connecting leg.

The positioning of the first angle L-shaped brackets connecting leg is positioned in an upside down “L” shape configuration to the longitudinal vertical column's front surface coinciding with the short flange top surface height to the heights of the bottom surface of the horizontal rim joists members and bottom surface of the horizontal beam forming the main support structure intersection by height requirements of the structure.

The second angle “L” shaped bracket is provided with a longitudinal connecting element the connecting leg, a latitudinal supporting element the long flange and two trapezoid plates secured to the outer edges of the connecting leg and the supporting flange forming a combinational channelized supporting element. The channelized supporting element is provided with a series of connecting elements the apertures that are aligned longitudinally along the median of the height of the channel and providing latitudinal alignment of the corresponding trapezoid plates apertures.

The second angle L-shaped brackets connecting leg is positioned in a reversed upside down L-shape configuration longitudinally to the vertical column back surface coinciding with long flange top surface height to the heights of the bottom surface of the horizontal beam and bottom surface of the horizontal rim joist members forming the main support structure intersection by height requirements of the structure.

The coinciding height intersections on the vertical column surfaces by the horizontal rim joists members supported by the first angled L-shaped bracket intersects the height of the horizontal beam supported by the second angled L-shaped bracket coincides with equal horizontal height planes of the main supports of the structure.

Utilizing a locking clasping clamp temporarily holds the first angled L-shaped bracket to the vertical columns outward front surface and the second angled L-shaped bracket to the same vertical columns inward back surface, allowing for parallel latitudinal alignment of the supporting flanges and parallel latitudinal alignment of the apertures in each of the connecting legs. Utilizing locking clasping clamps insure longitudinal plumb of the vertical column.

The latitudinal alignment of the apertures in each of the connecting legs being used as drill guides for the first latitudinal through hole drillings of the vertical column and the second latitudinal through hole drillings of the vertical column can be preformed by utilizing a two stage latitudinal drilling technique per each aperture in the connecting legs for each of the angled L-shaped brackets.

The two stage latitudinal drilling technique through the vertical column requires each of the apertures in connecting leg of the first angled L-shaped bracket to be used as drill guides for the first stage of the latitudinal drillings to the median of the vertical column from the front surface and the second angled L-shaped bracket connecting leg apertures are used as drill guides for the second stage of the latitudinal drillings to the median of the vertical column from the back surface aligning latitudinally with the first stage drillings to the median of the vertical column from the front surface allowing for an aligned latitudinal through holes passage of each of the apertures in the connecting legs for each of the angled L-shaped brackets.

The first angle L-shaped bracket apertures, the vertical column through holes and the second angle L-shaped bracket apertures allows for means of an affixed interlocking latitudinally.

The affixed interlocking latitudinally of the first angle L-shaped bracket to the front surface of the vertical column and the second angle L-shaped bracket to the back surface of the vertical column is comprised of through bolts passing through the first angle L-shaped brackets connecting leg apertures through the vertical column through holes to the second angle L-shaped brackets connecting leg apertures, where the threads of the through bolts are affixed with washers and secured with through bolt hex nuts.

Remove the temporarily locking clasping clamp after the completion of the affixed interlocking latitudinally of the first angle L-shaped bracket to the front surface of the vertical column and the second angle L-shaped bracket to the back surface of the vertical column.

The first angle L-shape brackets short flange with respect to second angle L-shape brackets long flange allowing for opposing flanges to the longitudinal surfaces of the vertical column are arranged that the first angle L-shape brackets short flange extends outwards from the front surface of the longitudinal vertical column and the second angle L-shape bracket long flange extends outwards from the back surface of the longitudinal vertical column, forming a “T” shape configuration do to equal latitudinal height planes of the flanges to the longitudinal surfaces of the vertical column.

The positioning of the second angle L-shape brackets long flange conforms to a combinational supporting element and connecting element for the horizontal joist member and companion spacer block and the first angle L-shape brackets short flange conforms to a supporting element for the horizontal rim joists beam and the joining plate.

Positioning the horizontal joist member and companion spacer block on the long flange of the second angle L-shape bracket allows for the latitudinal apertures in the trapezoid plates to be drill guides for the two stage latitudinal drillings through the horizontal joist member and companion spacer block.

The latitudinal alignment of the apertures in the first trapezoid plates being aligned latitudinally with the second trapezoid plates apertures allows for two stage latitudinal drilling technique of the through holes in the horizontal joist member and companion spacer block by utilizing the two stage latitudinal drilling technique per each aperture in the trapezoid plates through the horizontal joist member and companion spacer block.

The two stage latitudinal drilling technique through the horizontal joist member and companion spacer block requires each of the apertures in the first trapezoid plate to be used as drill guides for the first stage of the latitudinal drillings to the median of the horizontal joist member and companion spacer block from the outside surface and the second trapezoid plate apertures are used as drill guides for the second stage of the latitudinal drillings to the median of the horizontal joist member and companion spacer block from the inside surface aligning latitudinally with the first stage drillings of the horizontal joist member and companion spacer block from the outside surface allowing for an aligned latitudinal through holes passage through each of the apertures in each of the trapezoid plates.

The affixed interlocking latitudinally of the first trapezoid plate apertures to the horizontal joist member and companion spacer block to the second trapezoid plate apertures is comprised of through bolts passing through the first trapezoid plate apertures through the horizontal joist member and companion spacer block through holes through the second trapezoid plate, where the threads of the through bolts are affixed with some washers and secured with through bolt hex nuts.

The joining plate is provided with a main longitudinal connecting elements the bolt apertures in the median of the joining plate and a secondary longitudinal connecting element the two longitudinal rows of nail apertures positioned between the longitudinal median and the longitudinal outer edges of the joining plates perimeter, allowing for parallel longitudinal alignment of the two longitudinal rows of nail apertures consequently offsetting the main longitudinal connecting elements apertures.

Positioning the horizontal rim joist members on the short flange of the first angle L-shape bracket and the positioning of the joining plate in front of the horizontal rim joist members on the short flange of the first angle L-shape bracket, allowing for the secondary longitudinal alignment of the apertures in the joining plate to be utilized as permanent connections to the horizontal rim joist members and vertical column

The joining plates secondary longitudinal connecting element the two longitudinal rows of nail apertures are to be affixed latitudinal by the fastening of nails through each of the nail apertures through the horizontal rim joist members to the vertical column, allowing the stabilization of the horizontal rim joist members to the vertical column for the main longitudinal alignment of the apertures in the joining plate to be used as drill guides for the single stage longitudinal drillings through the horizontal rim joist members to the vertical column.

The single stage latitudinal drilling technique through the horizontal rim joist members and vertical column requires each of the apertures in the joining plate to be used as drill guides for the single stage latitudinal drillings through the front surface of the horizontal rim joist members to the opposing side the back surface through the front surface of the vertical column, allowing for each of the apertures in the joining plate to be aligned latitudinal with each of the through holes in the horizontal rim joist members to the holes in the vertical column.

The joining plate apertures, the horizontal rim joist members through holes and the vertical columns holes allows for means of an affixed interlocking latitudinally.

The affixed interlocking latitudinally of the joining plate apertures, the horizontal rim joist members through holes and the vertical columns holes is comprised of lag bolts passing through The joining plate apertures through the horizontal rim joist members through holes to the vertical column holes, where the threads of the lag bolts are embedded into the vertical column.

Fifth aspect of the present invention involves the fifth method of new construction providing the utilization of a series of angle L-shaped brackets, joining plate, fasteners, connectors whereby the affixed interlocks of wooden members or plastic composite lumber members form the main structural supports.

The first angle “L” shaped bracket is provided with a longitudinal connecting element the connecting leg and a combinational latitudinal supporting element supporting and connecting element the long flange. The first angle “L” shaped bracket being provided with apertures in the medians of the connecting leg and the long flange, thereby confirming the long flange to having the connecting elements.

The first angle L-shaped brackets connecting leg is positioned in a reversed upside down L-shape configuration longitudinally to the vertical column back surface, allowing the top surface of the flange to coinciding with the heights of the bottom surface of the horizontal beam and the height of the horizontal beam top surface intersects the height of the bottom surface of the horizontal rim joist members to the front surface of the vertical column.

The second angle “L” shaped bracket being provided with apertures in the median of the connecting leg. The second angle “L” shaped bracket is provided with a longitudinal connecting element connecting leg and a latitudinal supporting element supporting the short flange. The second angle “L” shaped bracket being provided with apertures in the medians of the connecting leg.

The second angle L-shaped brackets connecting leg is positioned in an upside down “L” shape configuration to the longitudinal vertical column's front surface, allowing the top surface of the flange to coinciding with the height of the bottom surface of the horizontal rim joists members and the height of the bottom surface of the horizontal rim joist members intersects the height of the top surface of the horizontal beam to the back surface of the vertical column.

The coinciding height intersections of the horizontal support beam bottom surface is supported by the long flange of the first angled L-shaped bracket positioned to the back surface of the vertical column, the horizontal rim joist members supported by the short flange of the second angled L-bracket positioned to the front surface of the vertical column, the horizontal support beams top surface is positioned to the back surface of the vertical column while aligning with the bottom surface of the horizontal rim joist members positioned to the front surface of the vertical column and thereby implying unequal latitudinal height planes converging on a single segmented latitudinal plane.

Utilizing a locking clasping clamp temporarily holds the first angled L-shaped bracket to the vertical columns inward back surface and the first angled L-shaped bracket to the same vertical columns outward front surface.

The first angle L-shaped brackets connecting legs is to be utilized as drill guides for the first latitudinal through hole drillings of the vertical column by preforming a single stage latitudinal drilling through back surface of the vertical to the opposing front surface. The first angle L-shaped bracket aperture(s) and the vertical column through hole(s) for means of an affixed interlocking latitudinally.

The affixed interlocking latitudinally of the first angle L-shaped bracket to the back surface of the vertical column is comprised of through bolts passing through the first angle L-shaped brackets connecting leg aperture(s) through the vertical column through hole(s), where the threads of the through bolt(s) are affixed with washer(s) and secured with through bolt hex nut(s).

The latitudinal alignment of the aperture(s) in the first angle L-brackets connecting legs and the second angle L-brackets connecting legs aperture(s) being used as drill guides for the second latitudinal through hole drilling(s) of the vertical column can be preformed by utilizing a two stage latitudinal drilling technique per each aperture(s) in the connecting legs for each of the angled L-shaped brackets.

The two stage latitudinal drilling technique through the vertical column requires each of the aperture(s) in connecting leg of the first angled L-shaped bracket to be used as drill guides for the first stage of the latitudinal drillings to the median of the vertical column from the back surface and the second angled L-shaped bracket connecting leg aperture(s) are used as drill guides for the second stage of the latitudinal drillings to the median of the vertical column from the front surface aligning latitudinally with the first stage drillings to the median of the vertical column from the back surface allowing for an aligned latitudinal through holes passage of each of the aperture(s) in the connecting legs for each of the angled L-shaped brackets.

The first angle L-shaped bracket aperture(s), the vertical column through hole(s) and the second angle L-shaped bracket aperture(s) allows for means of an affixed interlocking latitudinally.

The affixed interlocking latitudinally of the first angle L-shaped bracket to the back surface of the vertical column and the second angle L-shaped bracket to the front surface of the vertical column is comprised of through bolts passing through the second angle L-shaped brackets connecting leg aperture(s) through the vertical column through hole(s) to the first angle L-shaped brackets connecting leg aperture(s), where the threads of the through bolt(s) are affixed with (a) washer(s) and secured with through bolt hex nut(s).

Remove the temporarily locking clasping clamp after the completion of the affixed interlocking latitudinally of the first angle L-shaped bracket to the back surface of the vertical column and the second angle L-shaped bracket to the front surface of the vertical column.

The second angle L-shaped brackets connecting leg aperture(s) is to be utilized as drill guides for the third latitudinal through hole drilling(s) of the vertical column by preforming a single stage latitudinal drilling to the front surface of the vertical.

The single stage latitudinal drilling technique to the vertical column front surface requires each of the aperture(s) in the second angle L-shaped brackets connecting leg to be used as drill guide(s) for the single stage latitudinal drillings through the front surface of the vertical column, allowing for the aperture(s) in the second angle L-shaped brackets connecting leg to be aligned latitudinal with the through hole(s) in the vertical column.

The second angle L-shaped brackets connecting leg aperture(s) and the vertical columns hole(s) allows for means of an affixed interlocking latitudinally.

The affixed interlocking latitudinally of the second angle L-shaped brackets connecting leg aperture(s) and the vertical columns hole(s) is comprised of lag bolt(s) passing through the second angle L-shaped brackets connecting leg aperture(s) to the vertical column hole(s), where the lag bolts threads are embedded into the vertical column.

The positioning of the first angle L-shape brackets long flange conforms to a combinational supporting element and connecting element for the horizontal support beam and the second angle L-shape brackets short flange conforms to a supporting element for the horizontal rim joists beam and the joining plate.

Positioning the horizontal support beam on the long flange of the first angle L-shape bracket allows for the longitudinal apertures in the long flange to be drill guides for the single stage longitudinal drillings through the horizontal support beam.

The single stage longitudinal drilling technique through the horizontal support beam requires each of the apertures in the connecting flange of the first angled L-shaped bracket to be used as drill guides for the single stage longitudinal drillings through the bottom surface of the horizontal support beam to the opposing side the top surface allowing for each of the apertures in the connecting flange of the first angled L-shaped bracket to be aligned longitudinal with through holes in the horizontal support beam.

The first angle L-shaped bracket apertures in the long flange and the horizontal support beam through holes allows for means of an affixed interlocking longitudinally.

The affixed interlocking longitudinally of the first angle L-shaped brackets long flange to the horizontal support beam is comprised of through bolts passing through the first angle L-shaped bracket long flange apertures through the horizontal support beam through holes, where the threads of the through bolts are affixed with some washers and secured with through bolt hex nuts.

Positioning the horizontal rim joist members on the short flange of the second angle L-shape bracket and the positioning of the joining plate in front of the horizontal rim joist members on the short flange of the second angle L-shape bracket allows for the longitudinal alignment of the apertures in the joining plate to be used as drill guides for the single stage longitudinal drillings through the horizontal rim joist members through the vertical column.

Utilizing a locking clasping clamp temporarily allows stability of the joining plate, the horizontal rim joist members to the vertical column for the single stage latitudinal drillings.

The single stage latitudinal drilling technique through the horizontal rim joist members and vertical column requires each of the apertures in the joining plate to be used as drill guides for the single stage latitudinal drillings through the front surface of the horizontal rim joist members to the opposing side the back surface through the front surface of the vertical column to the opposing side the back surface, allowing for each of the apertures in the joining plate to be aligned latitudinal with each of the through holes in the horizontal rim joist members and the vertical column through holes.

The joining plate apertures, the horizontal rim joist members through holes and the vertical columns through holes allows for means of an affixed interlocking latitudinally.

The affixed interlocking latitudinally of the joining plate apertures, the horizontal rim joist members through holes and the vertical columns through holes is comprised of through bolts passing through the joining plate apertures through the horizontal rim joist members through holes and the vertical columns through holes, where the threads of the through bolts are affixed with washers and secured with through bolt hex nuts.

Remove the temporarily locking clasping clamp after the completion of the affixed interlocking latitudinally of the joining plate apertures, the horizontal rim joist members through holes and the vertical columns through holes.

Sixth aspect of the present invention involves the sixth method of new construction providing the utilization of a series of angle L-shaped brackets, joining plate, fasteners, connectors whereby the affixed interlocks of wooden members or plastic composite lumber members form the main structural supports.

The first angle “L” shaped bracket is provided with a longitudinal connecting element the connecting leg and a combinational latitudinal supporting element supporting and connecting element the long flange. The first angle “L” shaped bracket being provided with apertures in the medians of the connecting leg and the long flange, thereby confirming the long flange to having the connecting elements.

The first angle L-shaped brackets connecting leg is positioned in a reversed upside down L-shape configuration longitudinally to the vertical column back surface, allowing the top surface of the flange to coinciding with the height of the bottom surface of the horizontal beam and the height of the horizontal beam top surface intersects the height of the bottom surface of the horizontal rim joist members to the front surface of the vertical column.

The second angle “L” shaped bracket being provided with apertures in the median of the connecting leg. The second angle “L” shaped bracket is provided with a longitudinal connecting element connecting leg and a latitudinal supporting element supporting the short flange. The second angle “L” shaped bracket being provided with apertures in the medians of the connecting leg.

The second angle L-shaped brackets connecting leg is positioned in an upside down “L” shape configuration to the longitudinal vertical column's front surface, allowing the top surface of the flange to coinciding with the height of the bottom surface of the horizontal rim joists members and the height of the bottom surface of the horizontal rim joist members intersects the height of the top surface of the horizontal beam to the back surface of the vertical column.

The coinciding height intersections of the horizontal support beam bottom surface is supported by the long flange of the first angled L-shaped bracket positioned to the back surface of the vertical column, the horizontal rim joist members supported by the short flange of the second angled L-bracket positioned to the front surface of the vertical column, the horizontal support beams top surface is positioned to the back surface of the vertical column while aligning with the bottom surface of the horizontal rim joist members positioned to the front surface of the vertical column and thereby implying unequal latitudinal height planes converging on a single segmented latitudinal plane.

Utilizing a locking clasping clamp temporarily holds the first angled L-shaped bracket to the vertical columns inward back surface and the first angled L-shaped bracket to the same vertical columns outward front surface.

The first angle L-shaped brackets connecting legs lower aperture is to be utilized as drill guides for the first latitudinal through hole drillings of the vertical column by preforming a single stage latitudinal drilling through back surface of the vertical to the opposing front surface.

The first angle L-shaped bracket lower aperture and the vertical column through hole for means of an affixed interlocking latitudinally.

The affixed interlocking latitudinally of the first angle L-shaped bracket to the back surface of the vertical column is comprised of through bolts passing through the first angle L-shaped brackets connecting leg lower aperture through the vertical column through hole, where the threads of the through bolt are affixed with a washer and secured with through bolt hex nut.

The latitudinal alignment of the upper aperture in the first angle L-brackets connecting leg and the second angle L-brackets connecting legs lower aperture being used as drill guides for the second latitudinal through hole drillings of the back surface of the vertical column to the opposing front surface can be preformed by utilizing a two stage latitudinal drilling technique per each aperture in the connecting legs for each of the angled L-shaped brackets.

The two stage latitudinal drilling technique through the vertical column requires the upper aperture in connecting leg of the first angled L-shaped bracket to be used as drill guides for the first stage of the latitudinal drillings to the median of the vertical column from the back surface and the second angled L-shaped bracket connecting leg lower aperture to be used as drill guides for the second stage of the latitudinal drillings to the median of the vertical column from the front surface aligning latitudinally with the first stage drillings to the median of the vertical column from the back surface allowing for an latitudinal alignment of the second angled L-shaped bracket connecting leg lower aperture to the vertical column through holes to the upper aperture in connecting leg of the first angled L-shaped bracket.

The latitudinal alignment of the second angle L-shaped bracket lower aperture to the vertical column through hole and the first angle L-shaped bracket upper aperture allows for means of an affixed interlocking latitudinally.

The affixed interlocking latitudinally of the first angle L-shaped bracket to the back surface of the vertical column and the second angle L-shaped bracket to the front surface of the vertical column is comprised of through bolts passing through the second angle L-shaped brackets connecting leg lower aperture through the vertical column through hole to the first angle L-shaped brackets connecting leg upper aperture, where the threads of the through bolt are affixed with a washer and secured with through bolt hex nuts.

The second angle L-shaped brackets connecting leg upper aperture is to be utilized as drill guides for the third latitudinal through hole drilling of the vertical column by preforming a single stage latitudinal drilling to the front surface of the vertical.

The single stage latitudinal drilling technique to the vertical column front surface requires the upper aperture in the second angle L-shaped brackets connecting leg to be used as drill guide for the single stage latitudinal drillings through the front surface of the vertical column, allowing for the upper aperture in the second angle L-shaped brackets connecting leg to be aligned latitudinal with the through hole in the vertical column.

The second angle L-shaped brackets connecting leg upper aperture and the vertical columns hole allows for means of an affixed interlocking latitudinally.

The affixed interlocking latitudinally of the second angle L-shaped brackets connecting leg upper aperture and the vertical columns hole is comprised of a lag bolt passing through the second angle L-shaped brackets connecting leg upper aperture to the vertical column hole, where the lag bolts threads are embedded into the vertical column.

Remove the temporarily locking clasping clamp after the completion of the affixed interlocking latitudinally of the lower aperture of the first angle L-shaped bracket connection to the vertical column, upper aperture of the first angle L-shaped bracket connection to the vertical column to the lower aperture of the second angle L-shaped bracket and the connection of the upper aperture of the second angle L-shaped brackets connecting leg to the vertical column.

The positioning of the first angle L-shape brackets long flange conforms to a combinational supporting element and connecting element for the horizontal support beam to the third angle L-shape brackets long flange and the second angle L-shape brackets short flange conforms to a supporting element for the horizontal rim joists beam and the joining plate.

The third angle “L” shaped bracket is provided with a longitudinal connecting element the connecting leg and a latitudinal supporting element and connecting elements the long flange. The third angle “L” shaped bracket being provided with apertures in the medians of the connecting leg and the long flange, conforming the long flange combinational supporting element and connecting element.

Positioning the horizontal support beam on the long flange of the first angle L-shape bracket allows the third angle L-shape bracket long flange to be positioned atop the horizontal support beam, whereby the longitudinal apertures in the long flange of the first angle L-shape bracket and third angle L-shape bracket long flange apertures can be used as drill guides for the two stage longitudinal drillings through the horizontal support beam. The third angle L-shaped brackets is positioned in a revered L-shape configuration the back surface of the vertical column, allowing the long flange is position atop the horizontal support beam and the connecting leg to be positioned to the back surface of the vertical column.

The two stage longitudinal drilling technique through the horizontal requires each of the apertures in support flange of the first angled L-shaped bracket to be used as drill guides for the first stage of the longitudinal drillings to the median of the horizontal support beam from the bottom surface and the third angled L-shaped bracket connecting flange apertures are used as drill guides for the first stage of the longitudinal drillings to the median of the horizontal support beam from the top surface aligning longitudinally with the first stage drillings to the median of the horizontal support beam from the bottom surface allowing for an aligned longitudinal through holes passage of each of the apertures in the flanges for each of the angled L-shaped brackets.

The first angle L-shaped bracket apertures in the long flange, the through holes in the horizontal support beam and the third angle L-shaped bracket apertures in the long flange allows for means of an affixed interlocking longitudinally.

The affixed interlocking longitudinally of the first angle L-shaped brackets long flange through the horizontal support beam through the third angle L-shaped brackets long flange is comprised of through bolts passing through the first angle L-shaped bracket long flange apertures through the horizontal support beam through holes through the apertures in the third angle L-shaped brackets long flange, where the threads of the through bolts are affixed with some washers and secured with through bolt hex nuts.

Utilizing a locking clasping clamp temporarily allows stability of the joining plate, the horizontal rim joist members, the vertical column and the third angle L-shaped brackets connecting leg for the two stage latitudinal drillings.

The third angle L-shaped brackets connecting leg apertures are to be used as drill guides for first part of two stage latitudinal drillings through the back surface of the vertical column to the median and the joining plate apertures are to be used as drill guides for second part of two stage latitudinal drillings of the front surface of the horizontal rim joist member through the front surface of the vertical column to the medians first part drilling from the third angle L-shaped brackets, allowing for each of the apertures in the joining plate to be aligned latitudinal with each of the through holes in the horizontal rim joist members through the vertical column to the apertures in the connecting leg of the third angle L-shaped bracket.

The affixed interlocking latitudinally of the front surfaces of the joining plate, horizontal rim joist members, vertical column to the third angle L-shaped bracket to the front surface is comprised of through bolts passing through the joining plate apertures through the horizontal rim joist members and vertical column through holes to the third angle L-shaped brackets connecting leg apertures, where the threads of the through bolts are affixed with washers and secured with through bolt hex nuts.

Positioning the horizontal rim joist members on the short flange of the first angle L-shape bracket and the positioning of the joining plate in front of the horizontal rim joist members on the short flange of the first angle L-shape bracket allows for the latitudinal alignment of the apertures in the joining plate to be used as drill guides for the single stage latitudinal drillings through the horizontal rim joist members to the vertical column.

Remove the temporarily locking clasping clamp after the completion of the affixed interlocking latitudinally of the joining plate, horizontal rim joist members, vertical column to the third angle L-shaped bracket.

Seventh aspect of the present invention involves the seventh method of new construction providing the utilization of a series of angle L-shaped brackets, joining plate, fasteners, connectors whereby the affixed interlocks of wooden members or plastic composite lumber members form the main structural supports.

The first angle “L” shaped bracket is provided with a longitudinal connecting element the connecting leg and a latitudinal supporting element supporting the long flange. The first angle “L” shaped bracket being provided with apertures in the medians of the connecting leg and the long flange, thereby confirming the long flange to having the connecting elements.

The first angle “L” shaped bracket is provided with a longitudinal connecting element the connecting leg, a latitudinal supporting element the long flange and two trapezoid plates secured to the outer edges of the connecting leg and the supporting flange forming a combinational channelized supporting element. The channelized supporting element is provided with a series of connecting elements the apertures that are aligned longitudinally along the median of the height of the channel and providing latitudinal alignment of the corresponding trapezoid plates apertures.

The first angle L-shaped bracket connecting leg is positioned in a reversed upside down L-shape configuration longitudinally to the vertical column back surface, allowing the top surface of the flange to coinciding with the height of the bottom surface of the horizontal joist members and companion spacer block and the height of the horizontal joist members and companion spacer block top surface intersects the height of the bottom surface of the horizontal rim joist members to the front surface of the vertical column.

The second angle “L” shaped bracket being provided with apertures in the median of the connecting leg. The second angle “L” shaped bracket is provided with a longitudinal connecting element connecting leg and a latitudinal supporting element supporting the short flange. The second angle “L” shaped bracket being provided with apertures in the medians of the connecting leg.

The second angle L-shaped brackets connecting leg is positioned in an upside down “L” shape configuration to the longitudinal vertical column's front surface, allowing the top surface of the flange to coinciding with the height of the bottom surface of the horizontal rim joists members and the height of the bottom surface of the horizontal rim joist members intersects the height of the top surface of the horizontal joist members and companion spacer block to the back surface of the vertical column.

The coinciding height intersections of the horizontal support beam bottom surface is supported by the long flange of the first angled L-shaped bracket positioned to the back surface of the vertical column, the horizontal rim joist members supported by the short flange of the second angled L-bracket positioned to the front surface of the vertical column, the horizontal support beams top surface is positioned to the back surface of the vertical column while aligning with the bottom surface of the horizontal rim joist members positioned to the front surface of the vertical column and thereby implying unequal latitudinal height planes converging on a single segmented latitudinal plane.

Utilizing a locking clasping clamp temporarily holds the first angled L-shaped bracket to the vertical columns inward back surface and the first angled L-shaped bracket to the same vertical columns outward front surface.

The first angle L-shaped brackets connecting legs lower aperture is to be utilized as drill guides for the first latitudinal through hole drillings of the vertical column by preforming a single stage latitudinal drilling through back surface of the vertical to the opposing front surface.

The first angle L-shaped bracket lower aperture and the vertical column through hole for means of an affixed interlocking latitudinally.

The affixed interlocking latitudinally of the first angle L-shaped bracket to the back surface of the vertical column is comprised of through bolts passing through the first angle L-shaped brackets connecting leg lower aperture through the vertical column through hole, where the threads of the through bolt are affixed with a washer and secured with through bolt hex nut.

The latitudinal alignment of the upper aperture in the first angle L-brackets connecting leg and the second angle L-brackets connecting legs lower aperture being used as drill guides for the second latitudinal through hole drillings of the back surface of the vertical column to the opposing front surface can be preformed by utilizing a two stage latitudinal drilling technique per each aperture in the connecting legs for each of the angled L-shaped brackets.

The two stage latitudinal drilling technique through the vertical column requires the upper aperture in connecting leg of the first angled L-shaped bracket to be used as drill guides for the first stage of the latitudinal drillings to the median of the vertical column from the back surface and the second angled L-shaped bracket connecting leg lower aperture to be used as drill guides for the second stage of the latitudinal drillings to the median of the vertical column from the front surface aligning latitudinally with the first stage drillings to the median of the vertical column from the back surface allowing for an latitudinal alignment of the second angled L-shaped bracket connecting leg lower aperture to the vertical column through holes to the upper aperture in connecting leg of the first angled L-shaped bracket.

The latitudinal alignment of the first angle L-shaped bracket lower aperture to the vertical column through hole and the first angle L-shaped bracket upper aperture allows for means of an affixed interlocking latitudinally.

The affixed interlocking latitudinally of the first angle L-shaped bracket to the back surface of the vertical column and the second angle L-shaped bracket to the front surface of the vertical column is comprised of through bolts passing through the second angle L-shaped brackets connecting leg lower aperture through the vertical column through hole to the first angle L-shaped brackets connecting leg upper aperture, where the threads of the through bolt are affixed with a washer and secured with through bolt hex nuts.

The second angle L-shaped brackets connecting leg upper aperture is to be utilized as drill guides for the third latitudinal through hole drilling of the vertical column by preforming a single stage latitudinal drilling to the front surface of the vertical.

The single stage latitudinal drilling technique to the vertical column front surface requires the upper aperture in the second angle L-shaped brackets connecting leg to be used as drill guide for the single stage latitudinal drillings through the front surface of the vertical column, allowing for the upper aperture in the second angle L-shaped brackets connecting leg to be aligned latitudinal with the through hole in the vertical column.

The second angle L-shaped brackets connecting leg upper aperture and the vertical columns hole allows for means of an affixed interlocking latitudinally.

The affixed interlocking latitudinally of the second angle L-shaped brackets connecting leg upper aperture and the vertical columns hole is comprised of a lag bolt passing through the second angle L-shaped brackets connecting leg upper aperture to the vertical column hole, where the lag bolts threads are embedded into the vertical column.

Remove the temporarily locking clasping clamp after the completion of the affixed interlocking latitudinally of the lower aperture of the first angle L-shaped bracket connection to the vertical column, upper aperture of the first angle L-shaped bracket connection to the vertical column to the lower aperture of the second angle L-shaped bracket and the connection of the upper aperture of the second angle L-shaped brackets connecting leg to the vertical column.

The positioning of the second angle L-shape brackets long flange conforms to a combinational supporting element and connecting element for the horizontal joist member and companion spacer block and the first angle L-shape brackets short flange conforms to a supporting element for the horizontal rim joists beam and the joining plate.

Positioning the horizontal joist member and companion spacer block on the long flange of the first angle L-shape bracket allows for the latitudinal apertures in the trapezoid plates to be drill guides for the two stage latitudinal drillings through the horizontal joist member and companion spacer block.

The latitudinal alignment of the apertures in the first trapezoid plates being aligned latitudinally with the second trapezoid plates apertures allows for two stage latitudinal drilling technique of the through holes in the horizontal joist member and companion spacer block by utilizing the two stage latitudinal drilling technique per each aperture in the trapezoid plates through the horizontal joist member and companion spacer block.

The two stage latitudinal drilling technique through the horizontal joist member and companion spacer block requires each of the apertures in the first trapezoid plate to be used as drill guides for the first stage of the latitudinal drillings to the median of the horizontal joist member and companion spacer block from the outside surface and the second trapezoid plate apertures are used as drill guides for the second stage of the latitudinal drillings to the median of the horizontal joist member and companion spacer block from the inside surface aligning latitudinally with the first stage drillings of the horizontal joist member and companion spacer block from the outside surface allowing for an aligned latitudinal through holes passage through each of the apertures in each of the trapezoid plates.

The affixed interlocking latitudinally of the first trapezoid plate apertures to the horizontal joist member and companion spacer block to the second trapezoid plate apertures is comprised of through bolts passing through the first trapezoid plate apertures through the horizontal joist member and companion spacer block through holes through the second trapezoid plate, where the threads of the through bolts are affixed with some washers and secured with through bolt hex nuts.

Positioning the horizontal rim joist members on the short flange of the second angle L-shape bracket and the positioning of the joining plate in front of the horizontal rim joist members on the short flange of the second angle L-shape bracket allows for the longitudinal alignment of the apertures in the joining plate to be used as drill guides for the single stage longitudinal drillings through the horizontal rim joist members to the vertical column.

Utilizing a locking clasping clamp temporarily allows stability of the joining plate, the horizontal rim joist members to the vertical column for the single stage latitudinal drillings.

The single stage latitudinal drilling technique through the horizontal rim joist members to the vertical column requires each of the apertures in the joining plate to be used as drill guides for the single stage latitudinal drillings through the front surface of the horizontal rim joist members to the opposing side the back surface through the front surface of the vertical column, allowing for each of the apertures in the joining plate to be aligned latitudinal with each of the through holes in the horizontal rim joist members and the vertical column through holes.

The joining plate apertures, the horizontal rim joist members through holes and the vertical columns holes allows for means of an affixed interlocking latitudinally.

The affixed interlocking latitudinally of the joining plate apertures, the horizontal rim joist members through holes and to the vertical columns holes is comprised of lag bolts passing through the joining plate apertures through the horizontal rim joist members through holes to the vertical columns holes, where the threads of the lag bolts are embedded into the vertical column.

Remove the temporarily locking clasping clamp after the completion of the affixed interlocking latitudinally of the joining plate apertures, through the horizontal rim joist members through holes to the vertical columns holes.

Eight aspect of the present invention involves the eight method of new construction providing the utilization of a series of angle L-shaped brackets, a series of joining plate, fasteners, connectors whereby the affixed interlocks of wooden members or plastic composite lumber members form the main structural supports.

The first angle “L” shaped bracket being provided with apertures in the median of the connecting leg. The first angle “L” shaped bracket is provided with a longitudinal connecting element the connecting leg and a latitudinal supporting element supporting the short flange. The first angle “L” shaped bracket being provided with apertures in the medians of the connecting leg.

The positioning of the first angle L-shaped brackets connecting leg is positioned in an upside down “L” shape configuration to the longitudinal vertical column's front surface, coinciding with the short flanges top surface height to the heights of the bottom surface of the horizontal rim joists members and bottom surface of the horizontal joist members forming the main support structure intersection by height requirements of the structure.

The second angle “L” shaped bracket being provided with apertures in the median of the connecting leg. The second angle “L” shaped bracket is provided with a longitudinal connecting element the connecting leg and a latitudinal supporting element supporting the short flange. The second angle “L” shaped bracket being provided with apertures in the medians of the connecting leg.

The second angle L-shaped brackets connecting leg is positioned in an upside down “L” shape configuration to the longitudinal vertical column's side surface coinciding with the short flanges top surface height to the heights of the bottom surface of the horizontal joists members and bottom surface of the horizontal rim joist members forming the main support structure intersection by height requirements of the structure.

The coinciding height intersections on the vertical column surfaces by the horizontal rim joists members supported by the first angled L-shaped bracket intersects the height of the horizontal beam supported by the second angled L-shaped bracket coincides with equal horizontal height planes of the main supports of the structure.

Utilizing one locking clasping clamp temporarily holds the first angled L-shaped bracket to the vertical columns outwards front surface and utilizing second locking clasping clamp temporarily holds the second angled L-shaped bracket to the same vertical columns outwards side surface, allowing for parallel latitudinal alignment of the supporting flanges.

The latitudinal alignment of the apertures in each of the connecting legs being used as drill guides for the several single stage latitudinal through hole drillings of the vertical column surfaces, utilizing the single stage latitudinal drillings technique through the vertical column surface, per each aperture in each of the connecting legs for each of the angled L-shaped brackets equals a through hole in the vertical column surface.

The single stage latitudinal drilling technique through the vertical column surfaces requires each of the apertures in the connecting legs to be used as drill guides for the single stage latitudinal drillings. The first angle “L” shaped bracket being provided with apertures allows the single stage latitudinal drillings through the outwards front surface of the vertical column to the opposing inwards back surface. The second angle “L” shaped bracket being provided with apertures allows the single stage latitudinal drillings through the outwards side surface of the vertical column to the opposing inwards side surface. Thereby, allowing for each of the apertures in the in each of the angle “L” shaped brackets to be aligned latitudinal with each of the through holes in the vertical column.

The first angle L-shaped bracket apertures and the vertical columns through holes through the outwards front surface thorough the opposing inwards back surface allows for means of an affixed interlocking latitudinally. The second angle L-shaped bracket apertures and the vertical columns through holes through the outwards side surface thorough the opposing inwards side surface allows for means of an affixed interlocking latitudinally.

The affixed interlocking latitudinally of the first angle L-shaped bracket to the front surface of the vertical column is comprised of through bolts passing through the first angle L-shaped brackets connecting leg apertures through the vertical column through holes, where the threads of the through bolts are affixed with washers and secured with through bolt hex nuts.

The affixed interlocking latitudinally of the second angle L-shaped bracket to the side surface of the vertical column is comprised of through bolts passing through the second angle L-shaped brackets connecting leg apertures through the vertical column through holes, where the threads of the through bolts are affixed with washers and secured with through bolt hex nuts.

Remove the temporarily locking clasping clamps after the completion of the affixed interlocking latitudinally of the first angle L-shaped bracket to the outwards front surface of the vertical column and the second angle L-shaped bracket to the outwards side surface of the vertical column.

The positioning of the first angle L-shape brackets short flange conforms to a supporting element for the horizontal rim joists beam and the first joining plate. The positioning of the second angle L-shape brackets short flange conforms to a supporting element for the horizontal joists members and the second joining plate.

Positioning the horizontal rim joist members on the short flange of the first angle L-shape bracket and the positioning of the first joining plate in front of the horizontal rim joist members on the short flange of the first angle L-shape bracket allows for the longitudinal alignment of the apertures in the first joining plate to be used as drill guides for the single stage longitudinal drillings through the horizontal rim joist members through the outwards front surface of the vertical column to the opposing inwards back surface.

Utilizing a locking clasping clamp temporarily allows stability of the first joining plate, the horizontal rim joist members to the vertical column for the single stage latitudinal drillings.

Positioning the horizontal joist members on the short flange of the second angle L-shape bracket and the positioning of the second joining plate in front of the horizontal joist members on the short flange of the second angle L-shape bracket allows for the longitudinal alignment of the apertures in the second joining plate to be used as drill guides for the single stage longitudinal drillings through the horizontal joist members through the outwards side surface of the vertical column to the opposing inwards side surface.

Utilizing a locking clasping clamp temporarily allows stability of the second joining plate, the horizontal joist members to the vertical column for the single stage latitudinal drillings. The utilization of locking clasping clamps insure longitudinal plumb of the vertical column.

The single stage latitudinal drilling technique through the horizontal rim joist members and vertical column requires each of the apertures in the first joining plate to be used as drill guides for the single stage latitudinal drillings through the front surface of the horizontal rim joist members to the opposing side the back surface through the outwards front surface of the vertical column to the opposing side the inwards back surface, allowing for each of the apertures in the first joining plate to be aligned latitudinal with each of the through holes in the horizontal rim joist members to the through holes in the outwards front surface of the vertical column to the opposing side the inwards back surface.

The single stage latitudinal drilling technique through the horizontal joist members and vertical column requires each of the apertures in the second joining plate to be used as drill guides for the single stage latitudinal drillings through the front surface of the horizontal joist members to the opposing side the back surface through the outwards side surface of the vertical column to the opposing side the inwards side surface, allowing for each of the apertures in the second joining plate to be aligned latitudinal with each of the through holes in the horizontal joist members to the through holes in the outwards side surface of the vertical column to the opposing side the inwards side surface.

The first joining plate apertures, the horizontal rim joist members through holes and the vertical columns through holes through the outwards front surface to the opposing inwards back surface allows for means of an affixed interlocking latitudinally.

The second joining plate apertures, the horizontal joist members through holes and the vertical columns through holes through the outwards side surface to the opposing inwards side surface allows for means of an affixed interlocking latitudinally.

The affixed interlocking latitudinally of the first joining plate apertures, the horizontal rim joist members through holes and the vertical columns front through holes is comprised of through bolts passing through the first joining plate apertures through the horizontal rim joist members through holes through the outwards front surface through holes in the vertical column to the opposing inwards back surface, where the threads of the through bolts are affixed with washers and secured with through bolt hex nuts.

The affixed interlocking latitudinally of the second joining plate apertures, the horizontal joist members through holes and the vertical columns side through holes is comprised of through bolts passing through the second joining plate apertures through the horizontal joist members through holes through the outwards side surface through holes in the vertical column to the opposing inwards side surface, where the threads of the through bolts are affixed with washers and secured with through bolt hex nuts.

Remove the temporarily locking clasping clamps after the completion of the affixed interlocking latitudinally of the first joining plate apertures to the horizontal rim joist members through holes to the vertical columns through holes in the outwards front surface and second joining plate apertures to the horizontal joist members through holes to the vertical columns through holes in the outwards side surface.

Ninth aspect of the present invention involves the first method of reinforcing existing stacked structures providing the utilization of a series of angle L-shaped brackets, joining plate, fasteners, connectors whereby the affixed interlocks of wooden members or plastic composite lumber members form the main structural supports.

The first angle “L” shaped bracket is provided with a longitudinal connecting element the connecting leg and a combinational latitudinal supporting element supporting and connecting element the long flange. The first angle “L” shaped bracket being provided with apertures in the medians of the connecting leg and the long flange, thereby confirming the long flange to having the connecting elements.

The first angle L-shaped brackets connecting leg is positioned in a reversed upside down L-shape configuration longitudinally to the first vertical column back surface, allowing the top surface of the flange to coinciding with the height of the bottom surface of the horizontal beam and the height of the horizontal beam top surface intersects the height of the bottom surface of the horizontal rim joist members to the front surface of the first vertical column.

The second angle “L” shaped bracket being provided with apertures in the median of the connecting leg. The second angle “L” shaped bracket is provided with a longitudinal connecting element connecting leg and a latitudinal supporting element supporting the short flange. The second angle “L” shaped bracket being provided with apertures in the medians of the connecting leg.

The second angle L-shaped brackets connecting leg is positioned in an upside down “L” shape configuration to the longitudinal vertical column's front surface, allowing the top surface of the flange to coinciding with the height of the bottom surface of the horizontal rim joists members and the height of the bottom surface of the horizontal rim joist members intersects the height of the top surface of the horizontal beam to the front surface stacked on the first vertical column.

The coinciding height intersections of the horizontal support beam bottom surface is supported by the long flange of the first angled L-shaped bracket positioned to the back surface of the first vertical column, the horizontal rim joist members supported by the short flange of the second angled L-bracket positioned to the front surface of the first vertical column, the horizontal support beams top surface is positioned to the back surface of the first vertical column while aligning with the bottom surface of the horizontal rim joist members positioned to the front surface of the horizontal support beam and thereby implying unequal latitudinal height planes converging on a single segmented latitudinal plane.

Utilizing a locking clasping clamp temporarily holds the first angled L-shaped bracket to the first vertical columns inward back surface and the first angled L-shaped bracket to the same first vertical columns outward front surface.

The first angle L-shaped brackets connecting legs lower aperture is to be utilized as drill guides for the first latitudinal through hole drillings of the first vertical column by preforming a single stage latitudinal drilling through back surface of the first vertical to the opposing front surface.

The first angle L-shaped bracket lower aperture and the first vertical column through hole for means of an affixed interlocking latitudinally.

The affixed interlocking latitudinally of the first angle L-shaped bracket to the back surface of the first vertical column is comprised of through bolts passing through the first angle L-shaped brackets connecting leg lower aperture through the first vertical column through hole, where the threads of the through bolt are affixed with a washer and secured with through bolt hex nut.

The latitudinal alignment of the upper aperture in the first angle L-brackets connecting leg and the second angle L-brackets connecting legs lower aperture being used as drill guides for the second latitudinal through hole drillings of the back surface of the first vertical column to the opposing front surface can be preformed by utilizing a two stage latitudinal drilling technique per each aperture in the connecting legs for each of the angled L-shaped brackets.

The two stage latitudinal drilling technique through the first vertical column requires the upper aperture in connecting leg of the first angled L-shaped bracket to be used as drill guides for the first stage of the latitudinal drillings to the median of the first vertical column from the back surface and the second angled L-shaped bracket connecting leg lower aperture to be used as drill guides for the second stage of the latitudinal drillings to the median of the first vertical column from the front surface aligning latitudinally with the first stage drillings to the median of the first vertical column from the back surface allowing for an latitudinal alignment of the second angled L-shaped bracket connecting leg lower aperture to the first vertical column through holes to the upper aperture in connecting leg of the first angled L-shaped bracket.

The latitudinal alignment of the second angle L-shaped bracket lower aperture to the first vertical column through hole and the first angle L-shaped bracket upper aperture allows for means of an affixed interlocking latitudinally.

The affixed interlocking latitudinally of the first angle L-shaped bracket to the back surface of the first vertical column and the second angle L-shaped bracket to the front surface of the first vertical column is comprised of through bolts passing through the second angle L-shaped brackets connecting leg lower aperture through the first vertical column through hole to the first angle L-shaped brackets connecting leg upper aperture, where the threads of the through bolt are affixed with a washer and secured with through bolt hex nuts.

The second angle L-shaped brackets connecting leg upper aperture is to be utilized as drill guides for the third latitudinal through hole drilling of the horizontal support beam by preforming a single stage latitudinal drilling to the front surface of the horizontal support beam.

The single stage latitudinal drilling technique to the horizontal support beam front surface requires the upper aperture in the second angle L-shaped brackets connecting leg to be used as drill guide for the single stage latitudinal drillings through the front surface of the horizontal support beam, allowing for the upper aperture in the second angle L-shaped brackets connecting leg to be aligned latitudinal with the through hole in the horizontal support beam.

The second angle L-shaped brackets connecting leg upper aperture and the horizontal support beam hole allows for means of an affixed interlocking latitudinally.

The affixed interlocking latitudinally of the second angle L-shaped brackets connecting leg upper aperture and the horizontal support beam hole is comprised of a lag bolt passing through the second angle L-shaped brackets connecting leg upper aperture to the horizontal support beam hole, where the lag bolts threads are embedded into the horizontal support beam.

Remove the temporarily locking clasping clamp after the completion of the affixed interlocking latitudinally of the lower aperture of the first angle L-shaped bracket connection to the first vertical column, upper aperture of the first angle L-shaped bracket connection to the first vertical column to the lower aperture of the second angle L-shaped bracket and the connection of the upper aperture of the second angle L-shaped brackets connecting leg to the horizontal support beam.

The positioning of the first angle L-shape brackets long flange conforms to a combinational supporting element and connecting element for the horizontal support beam to the third angle L-shape brackets long flange and the second angle L-shape brackets short flange conforms to a supporting element for the horizontal rim joists beam and the joining plate.

The third angle “L” shaped bracket is provided with a longitudinal connecting element the connecting leg and a latitudinal supporting element and connecting elements the long flange. The third angle “L” shaped bracket being provided with apertures in the medians of the connecting leg and the long flange, conforming the long flange combinational supporting element and connecting element.

Positioning the horizontal support beam on the long flange of the first angle L-shape bracket allows the third angle L-shape bracket long flange to be positioned atop the horizontal support beam, whereby the longitudinal apertures in the long flange of the first angle L-shape bracket and third angle L-shape bracket long flange apertures can be used as drill guides for the two stage longitudinal drillings through the horizontal support beam. The third angle L-shaped brackets is positioned in a revered L-shape configuration the back surface of the second vertical column, allowing the long flange is position atop the horizontal support beam and the connecting leg to be positioned to the back surface of the second vertical column.

The two stage longitudinal drilling technique through the horizontal requires each of the apertures in support flange of the first angled L-shaped bracket to be used as drill guides for the first stage of the longitudinal drillings to the median of the horizontal support beam from the bottom surface and the third angled L-shaped bracket connecting flange apertures are used as drill guides for the first stage of the longitudinal drillings to the median of the horizontal support beam from the top surface aligning longitudinally with the first stage drillings to the median of the horizontal support beam from the bottom surface allowing for an aligned longitudinal through holes passage of each of the apertures in the flanges for each of the angled L-shaped brackets.

The first angle L-shaped bracket apertures in the long flange, the through holes in the horizontal support beam and the third angle L-shaped bracket apertures in the long flange allows for means of an affixed interlocking longitudinally.

The affixed interlocking longitudinally of the first angle L-shaped brackets long flange through the horizontal support beam through the third angle L-shaped brackets long flange is comprised of through bolts passing through the first angle L-shaped bracket long flange apertures through the horizontal support beam through holes through the apertures in the third angle L-shaped brackets long flange, where the threads of the through bolts are affixed with some washers and secured with through bolt hex nuts.

Utilizing a locking clasping clamp temporarily allows stability of the joining plate, the horizontal rim joist members, the second vertical column and the third angle L-shaped brackets connecting leg for the two stage latitudinal drillings.

The third angle L-shaped brackets connecting leg apertures are to be used as drill guides for first part of two stage latitudinal drillings through the back surface of the second vertical column to the median and the joining plate apertures are to be used as drill guides for second part of two stage latitudinal drillings of the front surface of the horizontal rim joist member through the front surface of the second vertical column to the medians first part drilling from the third angle L-shaped brackets, allowing for each of the apertures in the joining plate to be aligned latitudinal with each of the through holes in the horizontal rim joist members through the second vertical column to the apertures in the connecting leg of the third angle L-shaped bracket.

The affixed interlocking latitudinally of the front surfaces of the joining plate, horizontal rim joist members to the second vertical column to the third angle L-shaped bracket to the front surface is comprised of through bolts passing through the joining plate apertures through the horizontal rim joist members extending through the second vertical column through holes to the third angle L-shaped brackets connecting leg apertures, where the threads of the through bolts are affixed with washers and secured with through bolt hex nuts.

Positioning the horizontal rim joist members on the short flange of the first angle L-shape bracket and the positioning of the joining plate in front of the horizontal rim joist members on the short flange of the first angle L-shape bracket allows for the latitudinal alignment of the apertures in the joining plate to be used as drill guides for the single stage latitudinal drillings through the horizontal rim joist members to the second vertical column.

Remove the temporarily locking clasping clamp after the completion of the affixed interlocking latitudinally of the joining plate, horizontal rim joist members, second vertical column to the third angle L-shaped bracket.

Tenth aspect of the present invention involves the second method of reinforcing existing notched structures providing the utilization of a series of angle L-shaped brackets, joining plate, fasteners, connectors whereby the affixed interlocks of wooden members or plastic composite lumber members form the main structural supports.

The first angle “L” shaped bracket is provided with a longitudinal connecting element the connecting leg and a combinational latitudinal supporting element supporting and connecting element the long flange. The first angle “L” shaped bracket being provided with apertures in the medians of the connecting leg and the long flange, thereby confirming the long flange to having the connecting elements.

The first angle L-shaped brackets connecting leg is positioned in a reversed upside down L-shape configuration longitudinally to the notched vertical column back surface, allowing the top surface of the flange to coinciding with the height of the bottom surface of the horizontal beam and the height of the horizontal beam top surface intersects the height of the bottom surface of the horizontal rim joist members to the front surface of the notched vertical column.

The second angle “L” shaped bracket being provided with apertures in the median of the connecting leg. The second angle “L” shaped bracket is provided with a longitudinal connecting element connecting leg and a latitudinal supporting element supporting the short flange. The second angle “L” shaped bracket being provided with apertures in the medians of the connecting leg.

The second angle L-shaped brackets connecting leg is positioned in an upside down “L” shape configuration to the longitudinal vertical column's front surface, allowing the top surface of the flange to coinciding with the height of the bottom surface of the horizontal rim joists members and the height of the bottom surface of the horizontal rim joist members intersects the height of the top surface of the horizontal beam to the front surface on the notched vertical column.

The coinciding height intersections of the horizontal support beam bottom surface is supported by the long flange of the first angled L-shaped bracket positioned to the back surface of the notched vertical column, the horizontal rim joist members supported by the short flange of the second angled L-bracket positioned to the front surface of the notched vertical column, the horizontal support beams top surface is positioned to the back surface of the notched vertical column while aligning with the bottom surface of the horizontal rim joist members positioned to the front surface of the horizontal support beam and thereby implying unequal latitudinal height planes converging on a single segmented latitudinal plane.

Utilizing a locking clasping clamp temporarily holds the first angled L-shaped bracket to the notched vertical columns inward back surface and the first angled L-shaped bracket to the same notched vertical columns outward front surface.

The first angle L-shaped brackets connecting legs lower aperture is to be utilized as drill guides for the first latitudinal through hole drillings of the notched vertical column by preforming a single stage latitudinal drilling through back surface of the notched vertical to the opposing front surface.

The first angle L-shaped bracket lower aperture and the notched vertical column through hole for means of an affixed interlocking latitudinally.

The affixed interlocking latitudinally of the first angle L-shaped bracket to the back surface of the notched vertical column is comprised of through bolts passing through the first angle L-shaped brackets connecting leg lower aperture through the notched vertical column through hole, where the threads of the through bolt are affixed with a washer and secured with through bolt hex nut.

The latitudinal alignment of the upper aperture in the first angle L-brackets connecting leg and the second angle L-brackets connecting legs lower aperture being used as drill guides for the second latitudinal through hole drillings of the back surface of the notched vertical column to the opposing front surface can be preformed by utilizing a two stage latitudinal drilling technique per each aperture in the connecting legs for each of the angled L-shaped brackets.

The two stage latitudinal drilling technique through the notched vertical column requires the upper aperture in connecting leg of the first angled L-shaped bracket to be used as drill guides for the first stage of the latitudinal drillings to the median of the notched vertical column from the back surface and the second angled L-shaped bracket connecting leg lower aperture to be used as drill guides for the second stage of the latitudinal drillings to the median of the notched vertical column from the front surface aligning latitudinally with the first stage drillings to the median of the notched vertical column from the back surface allowing for an latitudinal alignment of the second angled L-shaped bracket connecting leg lower aperture to the notched vertical column through holes to the upper aperture in connecting leg of the first angled L-shaped bracket.

The latitudinal alignment of the second angle L-shaped bracket lower aperture to the notched vertical column through hole and the first angle L-shaped bracket upper aperture allows for means of an affixed interlocking latitudinally.

The affixed interlocking latitudinally of the first angle L-shaped bracket to the back surface of the notched vertical column and the second angle L-shaped bracket to the front surface of the notched vertical column is comprised of through bolts passing through the second angle L-shaped brackets connecting leg lower aperture through the notched vertical column through hole to the first angle L-shaped brackets connecting leg upper aperture, where the threads of the through bolt are affixed with a washer and secured with through bolt hex nuts.

The second angle L-shaped brackets connecting leg upper aperture is to be utilized as drill guides for the third latitudinal through hole drilling of the horizontal support beam by preforming a single stage latitudinal drilling to the front surface of the notched vertical column.

The single stage latitudinal drilling technique to the notched vertical column front surface requires the upper aperture in the second angle L-shaped brackets connecting leg to be used as drill guide for the single stage latitudinal drillings through the front surface of the notched vertical column, allowing for the upper aperture in the second angle L-shaped brackets connecting leg to be aligned latitudinal with the through hole in the notched vertical column.

The second angle L-shaped brackets connecting leg upper aperture and the notched vertical column hole allows for means of an affixed interlocking latitudinally.

The affixed interlocking latitudinally of the second angle L-shaped brackets connecting leg upper aperture and the notched vertical column hole is comprised of a lag bolt passing through the second angle L-shaped brackets connecting leg upper aperture to the notched vertical column hole, where the lag bolts threads are embedded into the notched vertical column.

Remove the temporarily locking clasping clamp after the completion of the affixed interlocking latitudinally of the lower aperture of the first angle L-shaped bracket connection to the notched vertical column, upper aperture of the first angle L-shaped bracket connection to the notched vertical column to the lower aperture of the second angle L-shaped bracket and the connection of the upper aperture of the second angle L-shaped brackets connecting leg to the notched vertical column.

The positioning of the first angle L-shape brackets long flange conforms to a combinational supporting element and connecting element for the horizontal support beam to the third angle L-shape brackets long flange and the second angle L-shape brackets short flange conforms to a supporting element for the horizontal rim joists beam and the joining plate.

The third angle “L” shaped bracket is provided with a longitudinal connecting element the connecting leg and a latitudinal supporting element and connecting elements the long flange. The third angle “L” shaped bracket being provided with apertures in the medians of the connecting leg and the long flange, conforming the long flange combinational supporting element and connecting element.

Positioning the horizontal support beam on the long flange of the first angle L-shape bracket allows the third angle L-shape bracket long flange to be positioned atop the horizontal support beam, whereby the longitudinal apertures in the long flange of the first angle L-shape bracket and third angle L-shape bracket long flange apertures can be used as drill guides for the two stage longitudinal drillings through the horizontal support beam. The third angle L-shaped brackets is positioned in a revered L-shape configuration the back surface of the notched vertical column, allowing the long flange is position atop the horizontal support beam and the connecting leg to be positioned to the back surface of the second vertical column.

The two stage longitudinal drilling technique through the horizontal requires each of the apertures in support flange of the first angled L-shaped bracket to be used as drill guides for the first stage of the longitudinal drillings to the median of the horizontal support beam from the bottom surface and the third angled L-shaped bracket connecting flange apertures are used as drill guides for the first stage of the longitudinal drillings to the median of the horizontal support beam from the top surface aligning longitudinally with the first stage drillings to the median of the horizontal support beam from the bottom surface allowing for an aligned longitudinal through holes passage of each of the apertures in the flanges for each of the angled L-shaped brackets.

The first angle L-shaped bracket apertures in the long flange, the through holes in the horizontal support beam and the third angle L-shaped bracket apertures in the long flange allows for means of an affixed interlocking longitudinally.

The affixed interlocking longitudinally of the first angle L-shaped brackets long flange through the horizontal support beam through the third angle L-shaped brackets long flange is comprised of through bolts passing through the first angle L-shaped bracket long flange apertures through the horizontal support beam through holes through the apertures in the third angle L-shaped brackets long flange, where the threads of the through bolts are affixed with some washers and secured with through bolt hex nuts.

Utilizing a locking clasping clamp temporarily allows stability of the joining plate, the horizontal rim joist members, the notched vertical column and the third angle L-shaped brackets connecting leg for the two stage latitudinal drillings.

The third angle L-shaped brackets connecting leg apertures are to be used as drill guides for first part of two stage latitudinal drillings through the back surface of the notched vertical column to the median and the joining plate apertures are to be used as drill guides for second part of two stage latitudinal drillings of the front surface of the horizontal rim joist member through the front surface of the notched vertical column to the medians first part drilling from the third angle L-shaped brackets, allowing for each of the apertures in the joining plate to be aligned latitudinal with each of the through holes in the horizontal rim joist members through the notched vertical column to the apertures in the connecting leg of the third angle L-shaped bracket.

The affixed interlocking latitudinally of the front surfaces of the joining plate, horizontal rim joist members to the notched vertical column to the third angle L-shaped bracket to the front surface is comprised of through bolts passing through the joining plate apertures through the horizontal rim joist members extending through notched vertical column through holes to the third angle L-shaped brackets connecting leg apertures, where the threads of the through bolts are affixed with washers and secured with through bolt hex nuts.

Positioning the horizontal rim joist members on the short flange of the first angle L-shape bracket and the positioning of the joining plate in front of the horizontal rim joist members on the short flange of the first angle L-shape bracket allows for the latitudinal alignment of the apertures in the joining plate to be used as drill guides for the single stage latitudinal drillings through the horizontal rim joist members to the notched vertical column.

Remove the temporarily locking clasping clamp after the completion of the affixed interlocking latitudinally of the joining plate, horizontal rim joist members, notched vertical column to the third angle L-shaped bracket.

### BRIEF DESCRIPTION OF THE DRAWINGS FIGURES

The foregoing and other features of the present invention will become more apparent from the detailed description set forth below considered in conjunction with the accompanying drawing figures in which like elements designed by reference numbers and alphabets and wherein:

FIG. 1: is an exploded illustration depicting two brackets with the joining plate in accordance with the first construction method part of the embodiment of the invention;

FIG. 2: is an exploded illustration depicting two brackets with the joining plate in accordance with the second construction method part of the embodiment of the invention;

FIG. 3: is an exploded illustration depicting three brackets with the joining plate in accordance with the third construction method part of the embodiment of the invention;

FIG. 4: is an exploded illustration depicting two brackets with the joining plate in accordance with the fourth construction method part of the embodiment of the invention;

FIG. 5: is an exploded illustration depicting two brackets with the joining plate in accordance with the fifth construction method part of the embodiment of the invention;

FIG. 6: is an exploded illustration depicting three brackets with the joining plate in accordance with the sixth construction method part of the embodiment of the invention;

FIG. 7: is an exploded illustration depicting two brackets with the joining plate in accordance with the seventh construction method part of the embodiment of the invention;

FIG. 8: is an exploded illustration depicting two brackets with the two joining plates in accordance with the eighth construction method part of the embodiment of the invention;

FIG. 9 is a perspective front angled viewing of a portion of a column/beam/rim joists connection illustrating the two brackets with the joining plate shown in FIG. 1 bolted to the column, beam and a series of rim joists, in accordance with the first construction method;

FIG. 10 is a perspective rear angled viewing of a portion of a column/beam/rim joists connection illustrating the two brackets with the joining plate shown in FIG. 1 bolted to the column, beam and a series of rim joists, in accordance with the first construction method;

FIG. 11 is a perspective front angled viewing of a portion of a column/beam/rim joists connection illustrating the two brackets with the joining plate shown in FIG. 2 bolted to the column, beam and a series of rim joists, in accordance with the second construction method;

FIG. 12 is a perspective rear angled viewing of a portion of a column/beam/rim joists connection illustrating the two brackets with the joining plate shown in FIG. 2 bolted to the column, beam and a series of rim joists, in accordance with the second construction method;

FIG. 13 is a perspective front angled viewing of a portion of a column/beam/rim joists connection illustrating the three brackets with the joining plate shown in FIG. 3 bolted to the column, beam and a series of rim joists, in accordance with the third construction method;

FIG. 14 is a perspective rear angled viewing of a portion of a column/beam/rim joists connection illustrating the three brackets with the joining plate shown in FIG. 3 bolted to the column, beam and a series of rim joists, in accordance with the third construction method;

FIG. 15 is a perspective front angled viewing of a portion of a column/series of rim joists/series of joist beams/spacer block connection illustrating the two brackets with the joining plate shown in FIG. 4 bolted to the column, series of joist beams with companion spacer block and a series of rim joists, in accordance with the fourth construction method;

FIG. 16 is a perspective rear angled viewing of a portion of a column/series of rim joists/series of joist beams/spacer block connection illustrating the two brackets with the joining plate shown in FIG. 4 bolted to the column, series of joist beams with companion spacer block and a series of rim joists, in accordance with the fourth construction method;

FIG. 17 is a perspective front angled viewing of a portion of a column/beam/rim joists connection illustrating the two brackets with the joining plate shown in FIG. 5 bolted to the column, beam and a series of rim joists, in accordance with the fifth construction method;

FIG. 18 is a perspective rear angled viewing of a portion of a column/beam/rim joists connection illustrating the two brackets with the joining plate shown in FIG. 5 bolted to the column, beam and a series of rim joists, in accordance with the fifth construction method;

FIG. 19 is a perspective front angled viewing of a portion of a column/beam/rim joists connection illustrating the three brackets with the joining plate shown in FIG. 6 bolted to the column, beam and a series of rim joists, in accordance with the sixth construction method;

FIG. 20 is a perspective rear angled viewing of a portion of a column/beam/rim joists connection illustrating the three brackets with the joining plate shown in FIG. 6 bolted to the column, beam and a series of rim joists, in accordance with the sixth construction method;

FIG. 21 is a perspective front angled viewing of a portion of a column/series of rim joists/series of joist beam/spacer block connection illustrating the two brackets with the joining plate shown in FIG. 7 bolted to the column, series of joist beams with companion spacer block and a series of rim joists, in accordance with the seventh construction method;

FIG. 22 is a perspective rear angled viewing of a portion of a column/series of rim joists/series of joist beams/spacer block connection illustrating the two brackets with the joining plate shown in FIG. 7 bolted to the column, series of joist beams with companion spacer block and a series of rim joists, in accordance with the seventh construction method;

FIG. 23 is a perspective side angled viewing of a portion of a column/series of rim joists/series of joist beam connection illustrating the two brackets with two joining plate shown in FIG. 8 bolted to the column, series of joist beams and a series of rim joists, in accordance with the eighth construction method;

FIG. 24 is prior art is a perspective side angled viewing of a portion of a series of columns/rim joist/beam connections of past construction techniques using stacked structural member process.

FIG. 25 is a perspective rear angled viewing of a portion of a columns/series of rim joists/beam connection illustrating the three brackets with a joining plate shown in FIG. 6 bolted to the series of columns, beam and a series of rim joists, in accordance with the first reinforcing construction method;

FIG. 26 is prior art is a perspective side angled viewing of a portion of a series of column/rim joist/beam connections of past construction techniques using structural member with cutout notch process;

FIG. 27 is a perspective rear angled viewing of a portion of a column/series of rim joists/beam connection illustrating the three brackets with a joining plate shown in FIG. 6 bolted to the column, beam and a series of rim joists, in accordance with the second reenforcing construction method;

FIG. 28 is a perspective view of the first embodiment of the angled L bracket according to the present invention for attaching to the outwardly front face surface of a column and the downwards bottom face surface of the rim joist members;

FIG. 29 is a perspective view of the second embodiment of the angled L bracket according to the present invention for attaching to the inwardly back face surface of a column and the downwards bottom face surface of the beam;

FIG. 30 is a perspective view of the fourth embodiment according to the present invention for attaching to the inwardly back face surface of a column and the downwards bottom face surface of the beam;

FIG. 31 is a perspective view of the sixth embodiment according to the present invention for attaching to the upwardly top face surface of the beam and the inwardly back face surface of a column;

FIG. 32 is a perspective view of the seventh embodiment according to the present invention for attaching to the inwardly back face surface of a column and the outwards side face surface of the series of joist beams and companion spacer block;

FIG. 33 is an exploded illustration depicting two trapezoid plates and the angle L bracket construction method part of the embodiment of the invention;

FIG. 34 is a perspective view of the eighth embodiment of the angled L bracket according to the present invention for attaching to the outwardly front face surface of a column and the downwards bottom face surface of the rim joist members; In addition, according to the present invention for attaching to the outwardly side face surface of a column and the downwards bottom face surface of the joist beam members shown in FIG. 25;

FIG. 35 is a perspective view of the third embodiment according to the present invention for attaching to the outwardly back face surface of rim joist members and column while being positioned a top the upwards top face surface of a angled L bracket;

FIG. 36 is a perspective view of the fifth embodiment according to the present invention for attaching to the outwardly back face surface of rim joist members and column while being positioned a top the upwards top face surface of a angled L bracket; In addition, according to the present invention for attaching to the outwardly side face surface of a column while being positioned a top the upwards top face surface of a angled L bracket shown in FIG. 23; In addition, according to the present invention for attaching to the outwardly back face surface of rim joist members, column and angled L bracket while being positioned a top the upwards top face surface of a angled L bracket shown in FIG. 25;

FIG. 37 is a perspective view of the ninth embodiment according to the present invention for attaching to the outwardly back face surfaces of several conjunctions of rim joist members, column and an angled L bracket while being positioned a top the upwards top face surface of a angled L bracket;

FIG. 38 is a perspective view of the tenth embodiment according to the present invention for attaching to the outwardly back face surfaces of several conjunctions of rim joist members and column while being positioned a top the upwards top face surface of a angled L bracket;

### DETAIL DESCRIPTION OF THE PREFERRED EMBODIMENT

There are several proviso features that must be addressed on the embodiments, the usage of the brackets, the manufacturing process of the bracing invention's embodiment, the rust preventive coating, the components' fasteners and connection hardware used in assembly of the structural main support, the component's structural wooden lumber members and/or composite and/or plastic lumber members, and the forming or manufacturing process of steel products which all steel angled L-shaped brackets derive from each have been detailed and outlined below with specifics to the types angled L-shaped brackets, materials' requirements for the angled L-shaped brackets, angled L-shaped brackets proviso specification for this bracing invention's embodiment herein and hereafter part of the invention and the embodiments.

The first proviso feature of all components of the embodiments of the angle L brackets, plates and trapezoid plates must be manufactured of forged hot rolled carbon steel or cold rolled carbon steel shaping and processing per the specification outlined by the American Iron and Steel Institute Specification, forged fabrication of structural steel members.

The American Iron and Steel Institute Specifications outlining A-36 Carbon Structural Steel minimum yield of 36,000 Pounds Per Square inch with tensile strength of 58,000 to 80,000 Pounds Per Square Inch.

The American Iron and Steel Institute Specifications outlining A-242 high-strength Low-Alloy Structural Steel minimum yield of 50,000 Pounds Per Square Inch with superior atmospheric corrosion resistance properties and tensile strength of 70,000 Pounds Per Square Inch.

The American Iron and Steel Institute Specifications outlining A-572 High-Strength Low-Alloy Columbium-Vanadium Steels of structural Quality minimum yield of 42,000 to 70,000 Pounds Per Square Inch with atmospheric corrosion resistance properties.

The American Iron and Steel Institute Specifications outlining A-992 Steel for Structural Shapes for Using in Building Framing minimum yield of 50,000 to 65,000 Pounds Per Square inch with tensile strength of 65,000 Pounds Per Square Inch.

The American Iron and Steel Institute Specifications outlining A-588 high-strength Low-Alloy Structural Steel (Weathering Steel) minimum yield of 50,000 Pounds Per Square Inch with superior atmospheric corrosion resistance properties and tensile strength of 70,000 Pounds Per Square Inch.

The angle L brackets all derive from the American Iron and Steel Institute Specifications outlining forging of common structural steel products consisting of forming of the fillet in Angles (equal or unequal), Wide Flange Beams (W-section), American Standard Beam (S-section), American Standard Beam (H-section), American Standard Beam (HP-section) and American Standard (I-section) formed from steel forging of the hot rolled carbon steel or cold rolled carbon steel manufacturing processes.

The joining plates and trapezoid plates derive from the American Iron and Steel Institute Specifications on forging hot rolled carbon steel or cold rolled carbon steel manufacturing process outlining forging of common structural steel products consisting of forming of hot rolled steel flats, universal mill plate and plate steel.

The embodiments of the angle L brackets, joining plates and trapezoid plates are derive from the American Iron and Steel Institute Specifications outlined on forging herein before and cut to dimensions requirements herein below outlined.

The second proviso feature that all the American Iron and Steel Institute Specifications on forging of common structural steel products deriving to form the metal L-shaped angle forming all the different dimensions of angled L-shaped bracket's connecting legs and flanges have minimum thickness of 0.25 but not to exceed the 1. inch maximum thickness, the height of the connecting leg is 4 inches minimum to 12 inches maximum, the flange length is 4 inches minimum to 12 inches maximum.

The trapezoid plates are comprised of rolled steel plates with a thickness of 0.125 inches minimum to 1.0 inches maximum, a parallel sides the short base and the long base the single angled hypotenuse and single perimeter. The joining plates are comprised of rolled steel plates with a thickness of 0.125 inches minimum to 1.0 inches maximum, two longitudinal parallel sides and two latitudinal parallel sides.

The third proviso feature is required do to the subjection of inclement elements a rust preventive coating be embodied to all the embodiments angled “L” brackets, trapezoid plates and securing plates to prevent rusting.

There are several rust preventive coating processes that will be accepted in the embodiment rust proof coating process, rigorous hot dipping of the disclosed in embodiment of the invention's in either a zinc coating or galvanized coating to 1.85 ounces per square foot per the American Society for Testing and Material [ASTM], specification on structural steel coating process A123, A153 or A653, the bracing inventions rust proof coating process can be substituted with a rust preventive primer three mills in thickness when dried.

The usage of manufactured metal products already containing the rust protection in the making of the produces under the American Iron and Steel Institute Specifications A-242 high-strength Low-Alloy Structural Steel minimum yield of 50,000 Pounds Per Square Inch with superior atmospheric corrosion resistance properties and tensile strength of 70,000 Pounds Per Square Inch, A-572 High-Strength Low-Alloy Columbium-Vanadium Steels of structural Quality minimum yield of 42,000 to 70,000 Pounds Per Square Inch with atmospheric corrosion resistance properties is part of the angled L-shaped brackets and plates embodiments of the invention.

The fourth proviso feature that all fasteners and connecting elements will consist of the American Society for Testing and Material, in accordance with specification in structural steel connectors, galvanized connectors and timber connections; through bolts, threaded rod, lag bolts, hex nuts and washers: shall be galvanized in accordance with ASTM A325, ASTM A153 and ASTM A307 specification and standards per the American Society for Testing and Material.

The fifth proviso feature that all components wooden lumber members are to comply, per the American Nation Standards Institute [ANSI] Committee 05 and the Committee's activities in maintaining the standards and dimensions. The composite and/or plastic lumber members are to comply, per American Society for Testing and Material, [ASTM] Committee D-20 and the Committee's activities in maintaining the standards and dimensions.

The sixth proviso feature that no part of the embodiment of the angled L-shaped brackets may be factory fabricated by the means of bending to form the L-shape forming of the angled L-shaped brackets embodiment.

No part of the embodiment of the angled L-shaped brackets may be factory fabricated by the means of or welding to form the juncture of the L-shape forming of the angled L-shaped brackets embodiment.

The first proviso feature stipulates that the embodiment of the angled L-shaped brackets derive from manufactured steel products overseen by the American Iron and Steel Institute Specifications and herein before outlined in the steel products that the brackets derive from in the first proviso feature proviso.

There are eight new construction method embodiments, two new reinforcing method of existing structures embodiments, six invention embodiments of the angled L-shaped brackets after refer to as brackets, four invention embodiments of the steel plates after refer to as joining plates, the six proviso features comprising the brackets and securing plates embodiments of the invention, working in conjunction with the treated wooden lumber members and/or composite lumber and/or plastic lumber members used to form the structures framing and the fasteners.

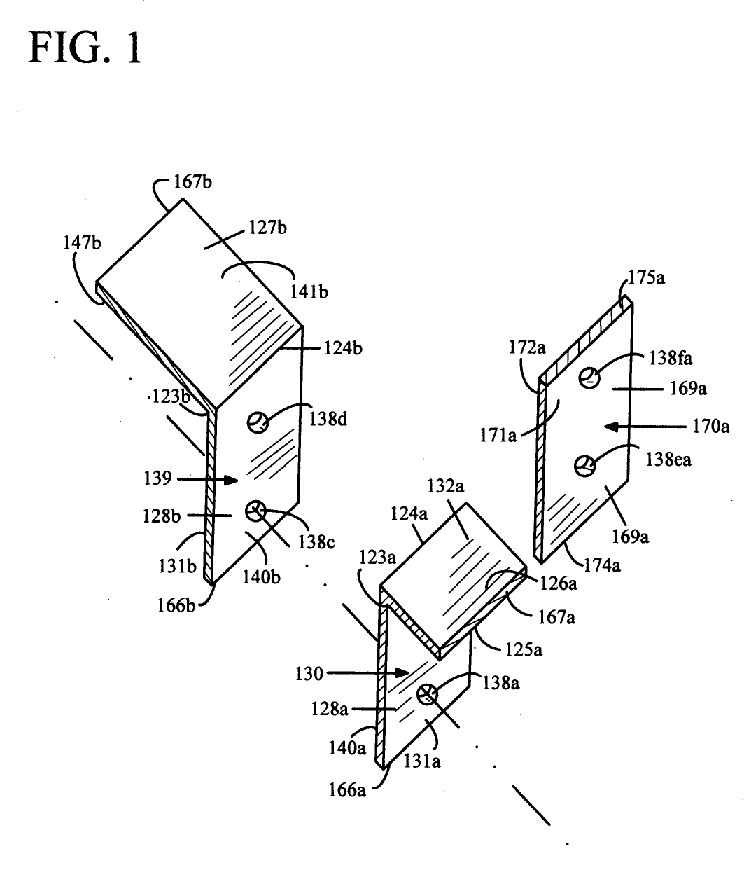

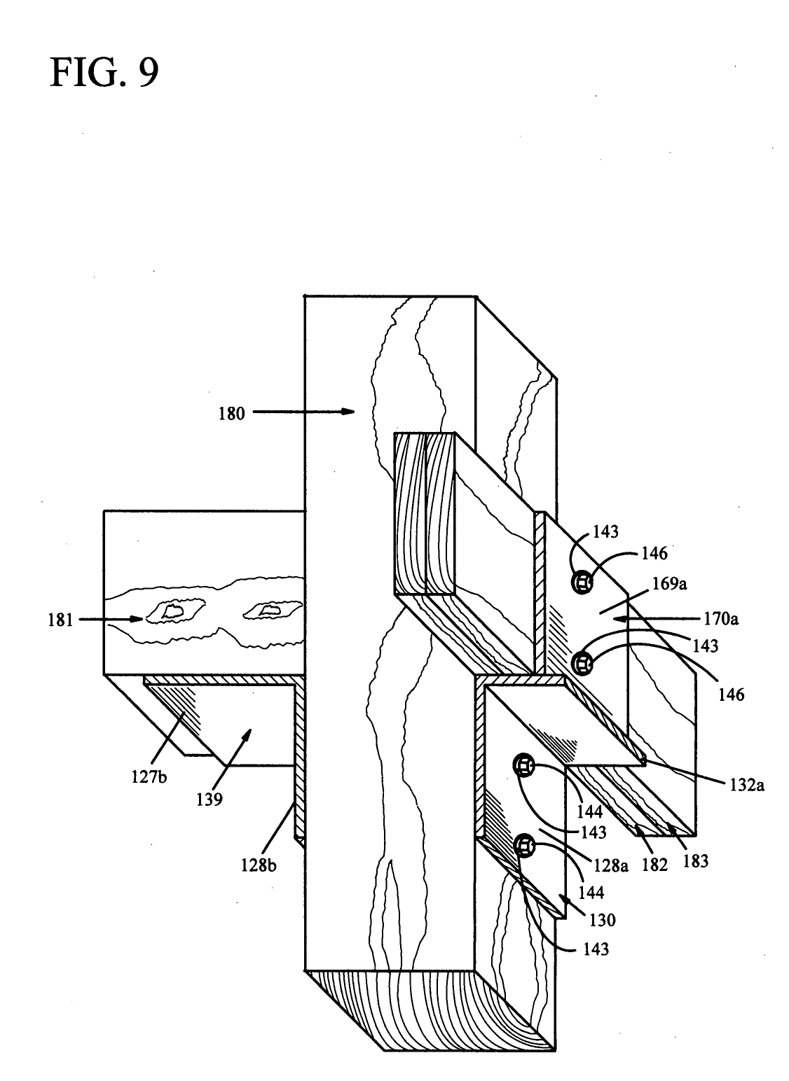

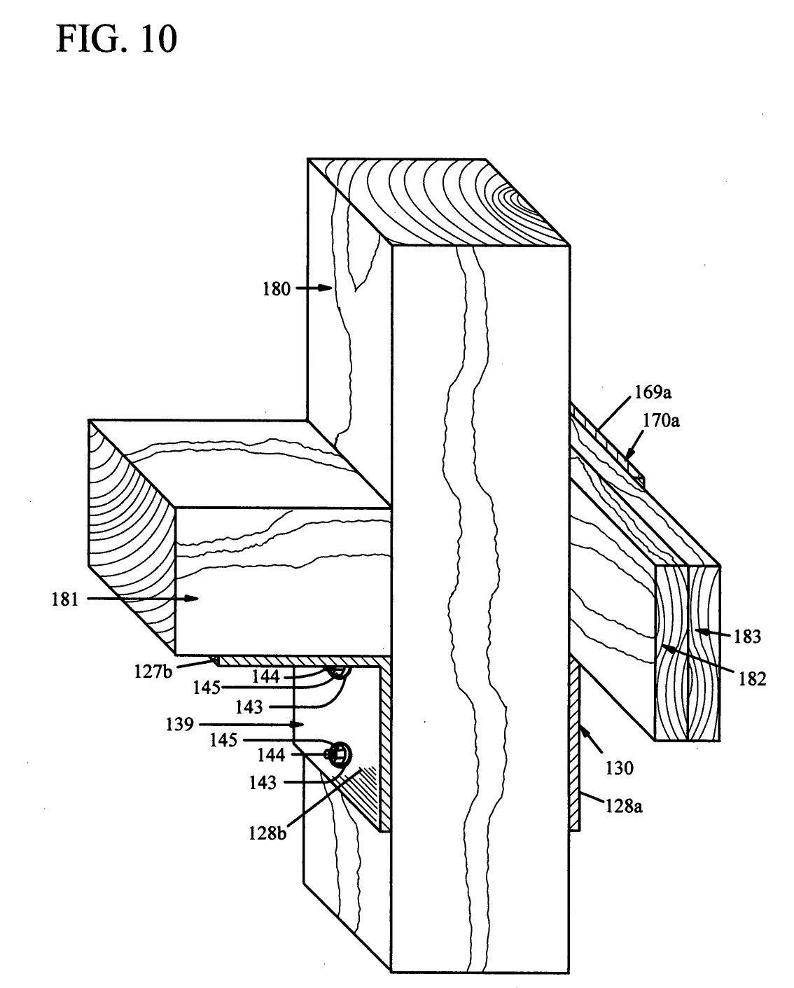

The first method of new construction embodiment provides a series of L-shaped brackets and joining plate, according to the present invention is illustrated and delineated in FIG. 1 allowing for several equally horizontal planes. As described below in more detail, the first embodiment is bracket 130 which is adapted to be positioned in an upside down L-shaped configuration, the second embodiment is bracket 139 which is adapted to be positioned in an upside down reversed L-shaped configuration and the third embodiment is joining plate 170a which is utilized as a securing element. As described below in more detailed specifications and illustrated depictions in FIGS. 9 and 10, whereby the bolting connecting techniques and installation practices of the bracket 130, bracket 139, and joining plate 170a are explained in detail on the assembly of the first method of new construction.

The bracket 130 is comprised of a vertical connecting element or connecting leg 128a and a horizontal supporting element or short supporting flange 132a. The bracket 130 is positioned in an upside down L-shaped configuration. The connecting leg 128a consists of a flat planar plate member having a inwards facing back surface 140a and an oppositely positioned outwards facing front surface 131a. The vertical connecting leg 128a is provided with a series of through holes the lower through bolt hole 138a and the upper through bolt hole 138b that are through the connecting leg 128a outwards front facing surface 131a through the oppositely positioned inwards back facing surface 140a.

The horizontal supporting flange 132a of bracket 130 is also comprised of a generally planar plate having an upwards facing top surface 132a and an oppositely positioned downwards facing bottom surface 125a.

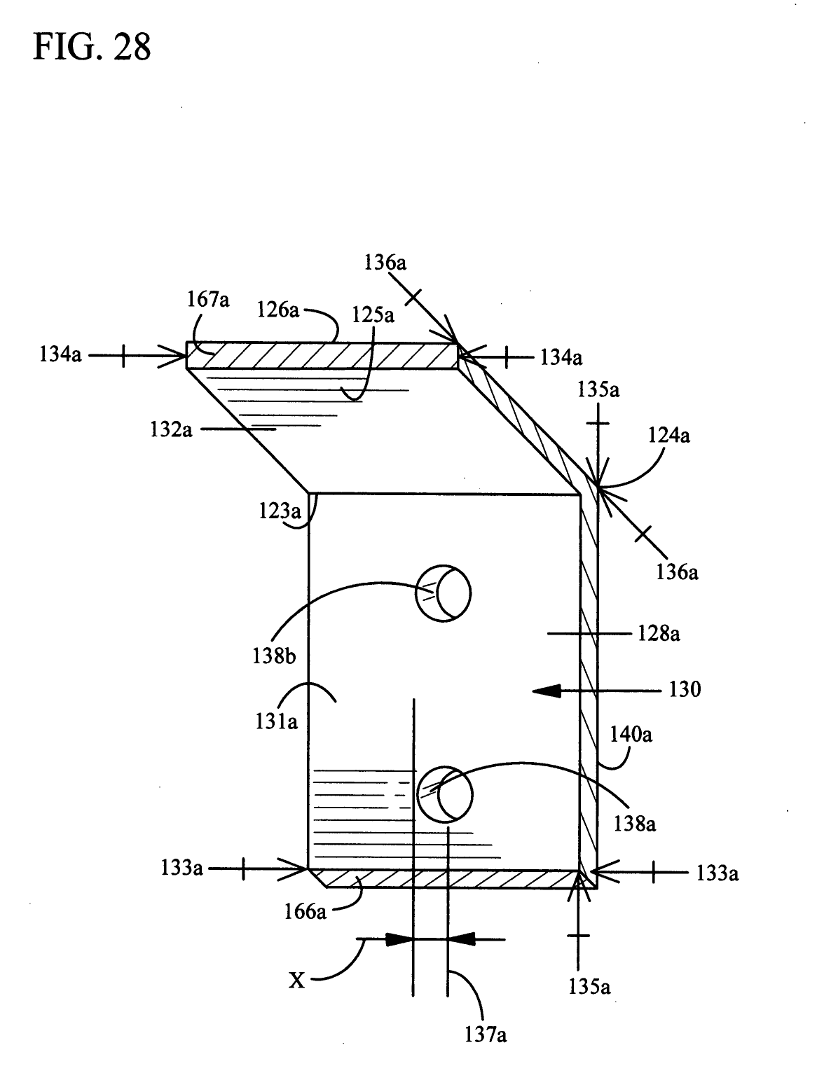

The bracket 130 vertical connecting leg 128a and horizontal supporting flange 132a together define an L-shaped bracket. The L-shaped bracket is provided with an outer corner edge 124a, the upwards facing top surface 126a of the horizontal supporting flange 032a is in abutting relation with the inwards facing back surface 140a of the vertical connecting leg 128a and the inner corner 123a is in direct abutting relation to the downwards facing surface 125a of the horizontal supporting flange 132a supported by the vertical connecting leg 128a outwards facing front surface 131a. As described below in more detail in FIG. 28 bracket 130 specifications.

The bracket 139 is comprised of a vertical connecting element or vertical connecting leg 128b and a horizontal supporting element or horizontal supporting flange 127b. The bracket 139 is positioned in an upside down reversed L-shaped configuration. The vertical connecting leg 128b consists of a flat planar plate having a inwards facing back surface 140b and an oppositely positioned outwards facing front surface 131b. The vertical connecting leg 128b of bracket 139 is provided with a series of through holes 138 the lower through bolt hole 138c and the upper through bolt hole 138d that are through the vertical connecting leg 128b outwards front facing surface 131b through to the oppositely positioned inwards back facing surface 140b.

The horizontal supporting flange 127b of bracket 139 is also comprised of a generally planar plate having an upwards facing top surface 141b and an oppositely positioned downwards facing bottom surface 147b.

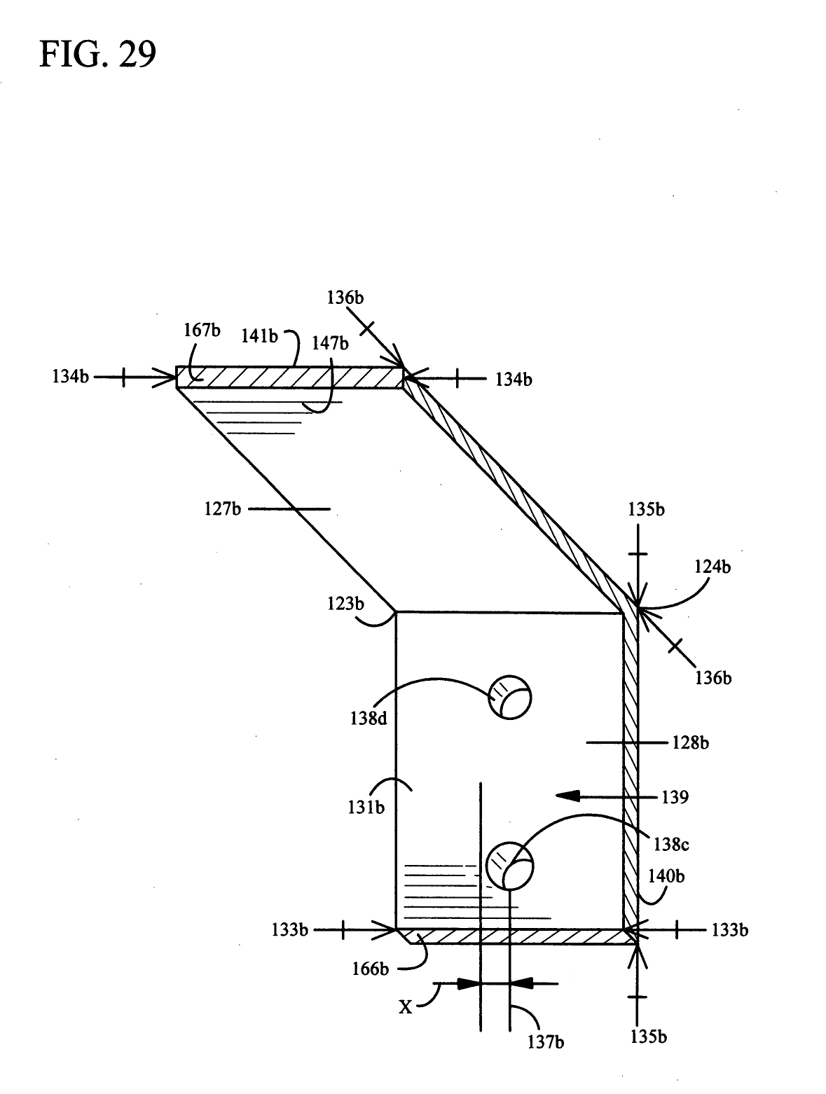

The bracket 139 connecting leg 128b and horizontal supporting flange 127b together define an L-shaped bracket. The L-shaped bracket is provided with an outer corner edge 124b, the upwards facing top surface 141b of the horizontal supporting flange 127b is in abutting relation with the inwards facing back surface 140b of the vertical connecting leg 128b and the inner corner 123b is in direct abutting relation to the downwards facing surface 147b of the horizontal supporting flange 127b supported by the vertical connecting leg 128b outwards facing front surface 131b. As described below in more detail in FIG. 29 bracket 139 specifications.

The joining plate 170a is comprised of a connecting element or planer plate 169a. The joining plate 170a is positioned atop the bracket 130 supporting flange 132a upwards facing top surface 126a.

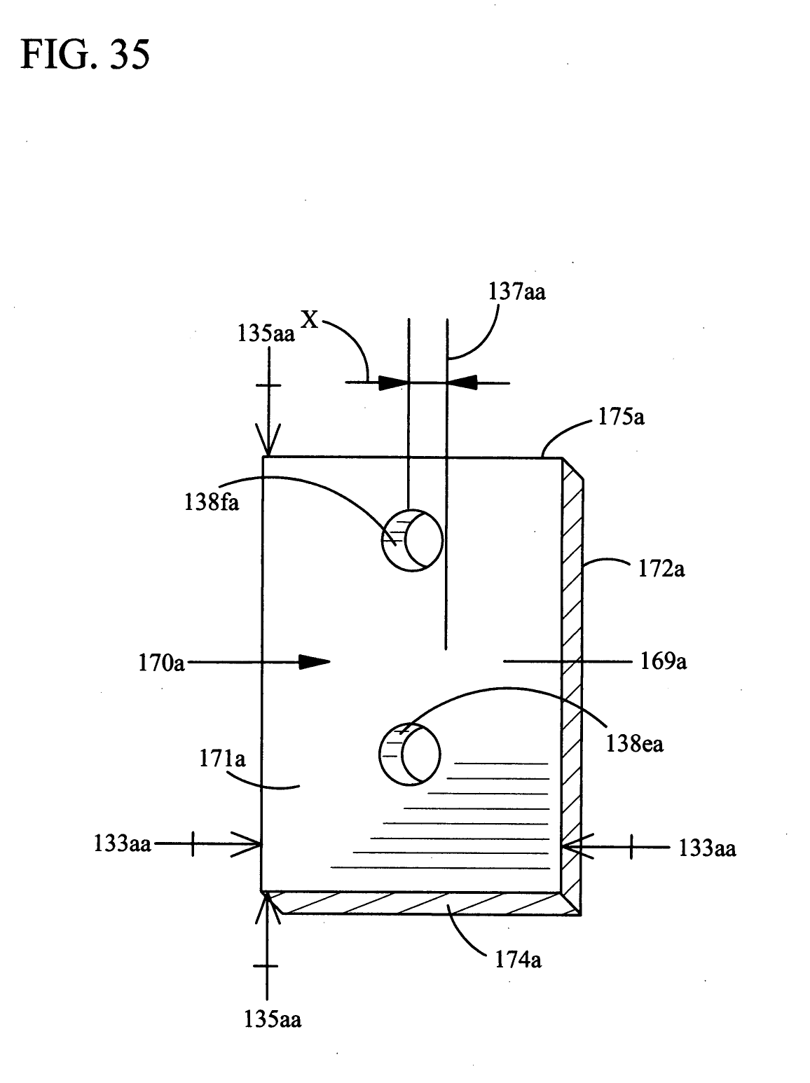

The joining plate 170a planer plate 169a consists of a flat planar plate having a rear inwards facing back surface 172a and an oppositely positioned outwards facing front surface 171b. The planer plate 169a is provided with a series of through holes 138 the lower through bolt hole 138ea and the upper through bolt hole 138fa that are arranged in a single row that all of the holes in the row that is linearly arranged longitudinally. As described below in more detail in FIG. 35 joining plate 170a specifications.

The outwards facing front surface 131a of bracket 130 connecting leg 128a lower through bolt hole 138a aligns through to the inwards facing back surface 140a to the inwards facing back surface 140b of bracket 139 connecting leg 128b lower through bolt hole 138c and out to the inwards facing front surface 131b. The outwards facing front surface 131a of bracket 130 connecting leg 128a upper through bolt hole 138b aligns through to the inwards facing back surface 140a to the inwards facing back surface 140b of bracket 139 connecting leg 128b upper through bolt hole 138d and out to the inwards facing front surface 131b. As described below in more detailed specifications and illustrated depictions in FIGS. 9 and 10, whereby the bolting connecting techniques and installation practices of the bracket 130, bracket 139, and joining plate 170a are explained in detail on the assembly of the first method of new construction.

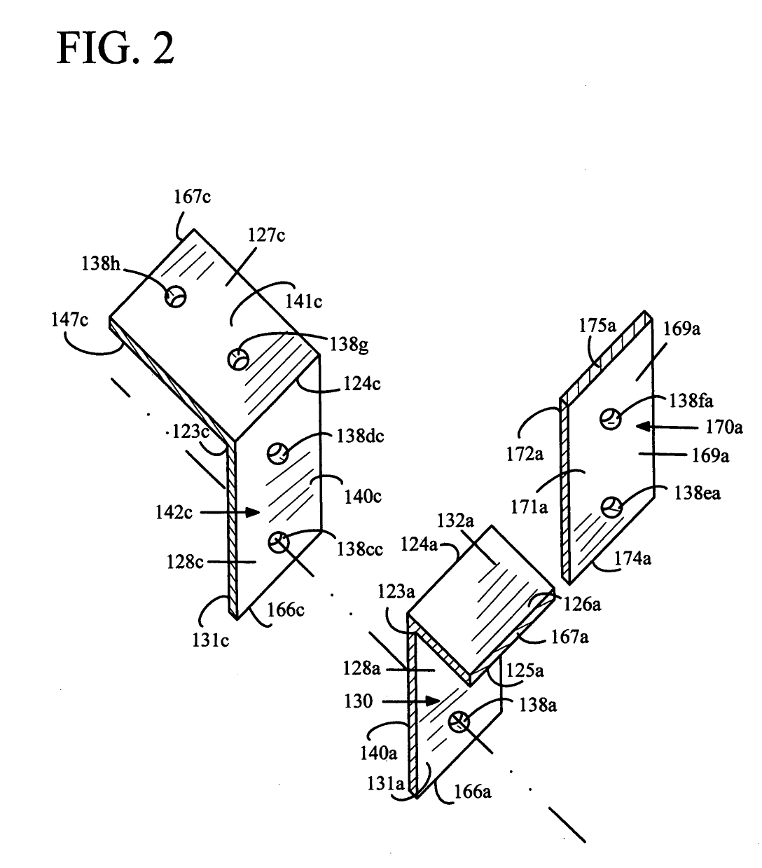

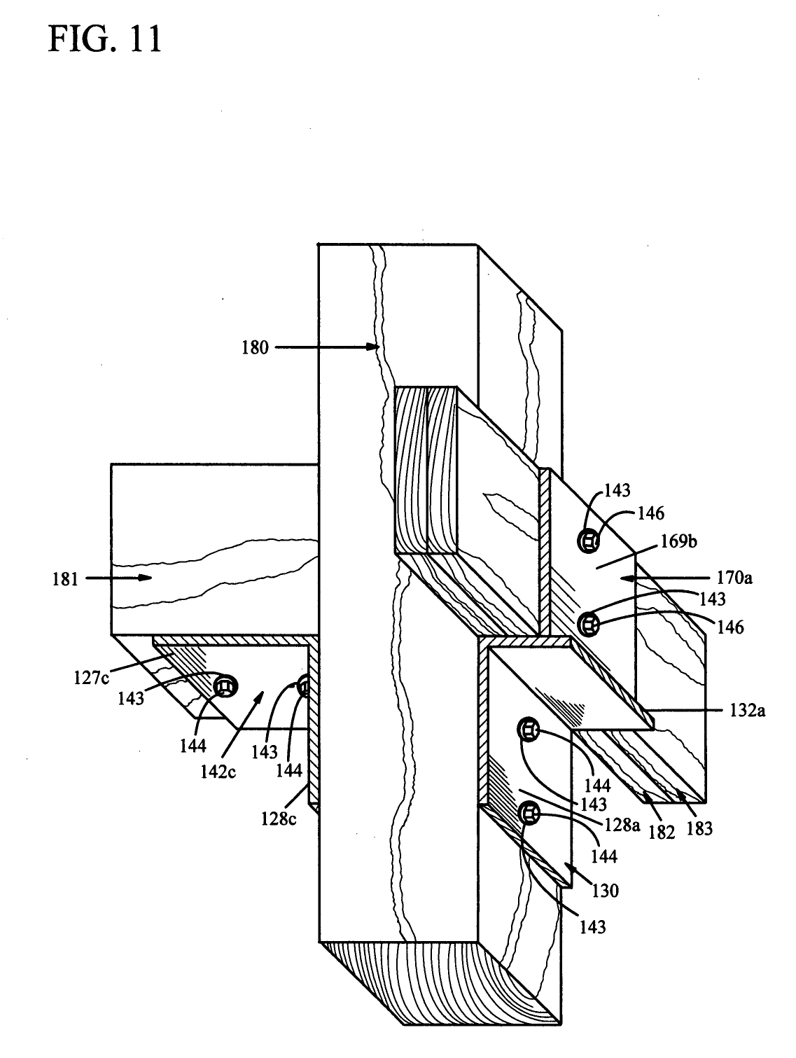

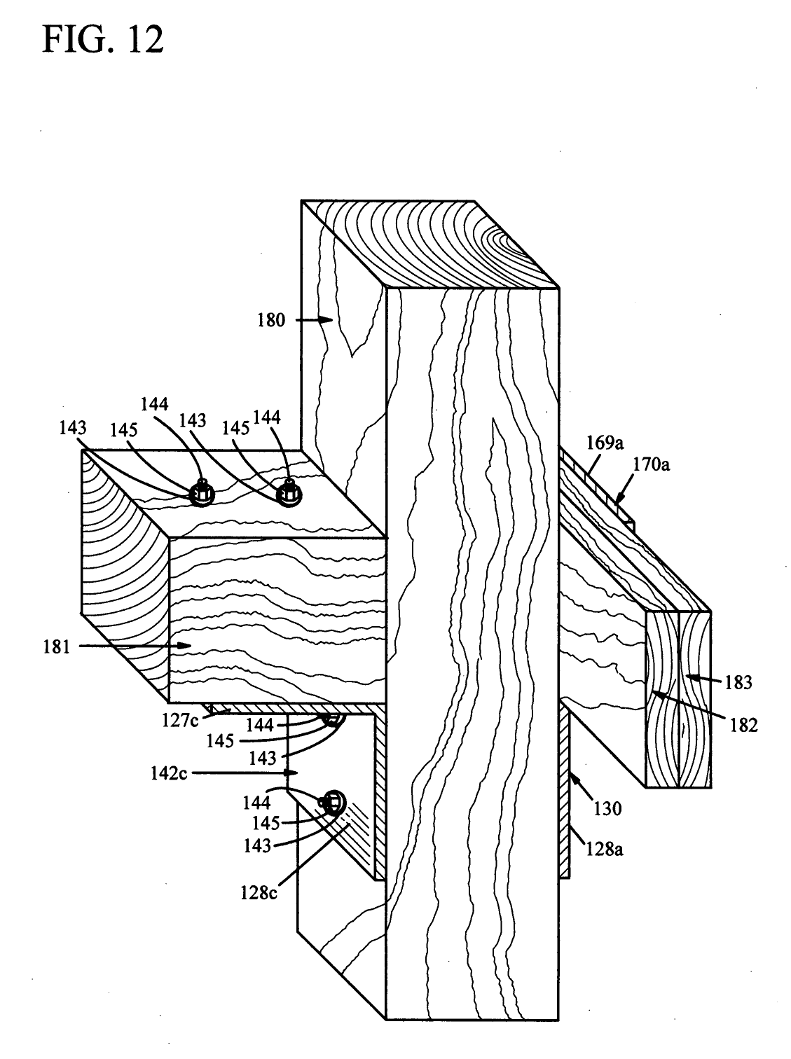

The second method of new construction embodiment provides a series of L-shaped bracket and plate fitting, according to the present invention is illustrated in FIG. 2 allowing for several equally horizontal planes. As described below in more detail, the first fabricated embodiment is bracket 130 which is adapted to be positioned in an upside down L-shaped configuration, the fourth fabricated embodiment is bracket 142c which is adapted to be positioned upside down reversed L-shaped configuration and the third fabricated embodiment is joining plate 170a which is utilized as a securing element. As described below in more detailed specifications and illustrated depictions in FIGS. 11 and 12, whereby the bolting connecting techniques and installation practices of the bracket 130, bracket 142c and joining plate 170a are explained in detail on the second method of new construction.

As outlined in FIG. 1 the bracket 130 is comprised of a vertical connecting element or connecting leg 128a and a horizontal supporting element or short supporting flange 132a. The bracket 130 is positioned in an upside down L-shaped configuration. The vertical connecting leg 128a consists of a flat planar plate member having a inwards facing back surface 140a and an oppositely positioned outwards facing front surface 131a. The vertical connecting leg 128a is provided with a series of through holes the lower through bolt hole 138a and the upper through bolt hole 138b that are through the connecting leg 128a outwards front facing surface 131a through the oppositely positioned inwards back facing surface 140a. The through holes the lower through bolt hole 138a and the upper through bolt hole 138b are arranged in a single row linearly arranged longitudinally and latitudinally aligned through the connecting leg 128a.

The horizontal supporting flange 132a of bracket 130 is also comprised of a generally planar plate having an upwards facing top surface 132a and an oppositely positioned downwards facing bottom surface 125a.

The bracket 130 vertical connecting leg 128a and horizontal supporting flange 132a together define an L-shaped bracket. The L-shaped bracket is provided with an outer corner edge 124a, the upwards facing top surface 126a of the horizontal supporting flange 132a is in abutting relation with the inwards facing back surface 140a of the vertical connecting leg 128a and the inner corner 123a is in direct abutting relation to the downwards facing surface 125a of the horizontal supporting flange 132a supported by the vertical connecting leg 128a outwards facing front surface 131a. As described below in more detail in FIG. 28 bracket 130 specifications.

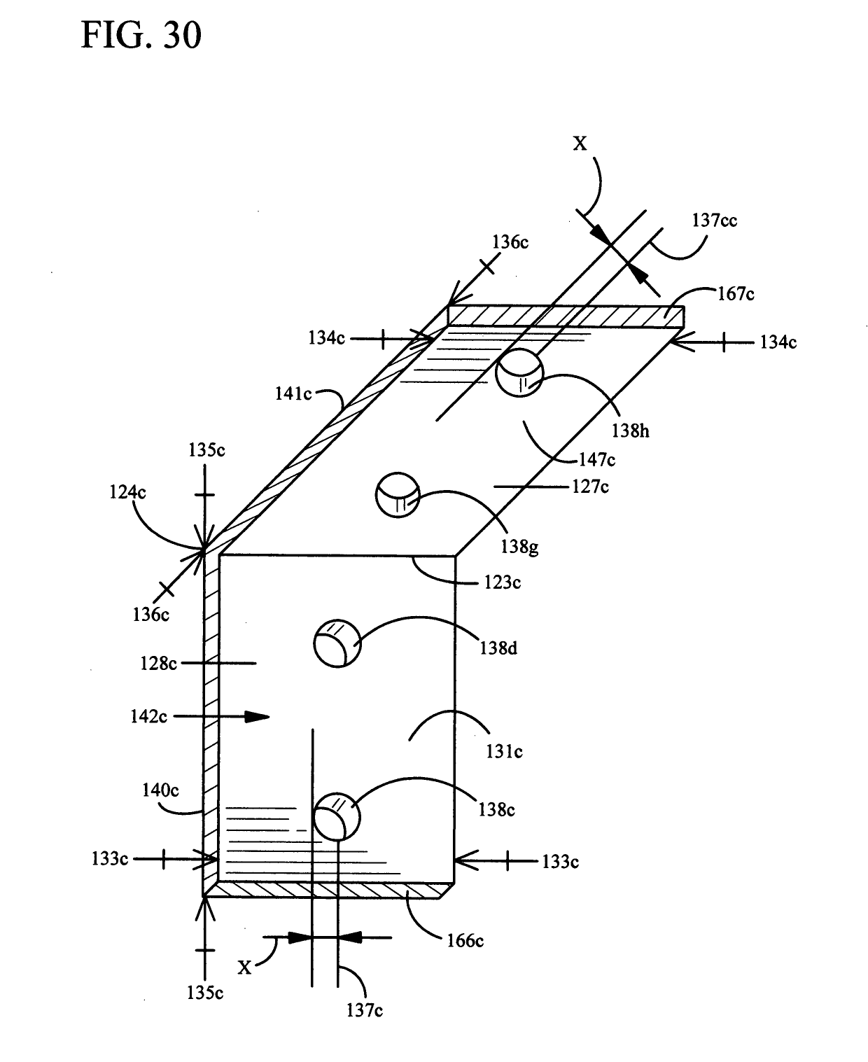

The bracket 142c is comprised of a vertical connecting element or connecting leg 128c and a horizontal supporting and connecting element or supporting flange 127c. The bracket 142c is positioned in an upside down reversed L-shaped configuration. The bracket 142c vertical connecting leg 128c consists of a flat planar plate member having a inwards facing back surface 140c and an oppositely positioned outwards front surface 131c. The bracket 142c connecting flange 127c consists of a flat planar plate member having a upwards facing top surface 141c and an oppositely positioned downwards facing bottom surface 147c. The vertical connecting leg 128c height is equal to the horizontal supporting flange 127c length. As described below in more detail in FIG. 30 bracket 142c specifications.

The vertical connecting leg 128c of bracket 142c is provided with a series of through holes the lower through bolt hole 138cc and the upper through bolt hole 138dc that are through the connecting leg 128c outwards front facing surface 131c through the oppositely positioned inwards back facing surface 140c. The through holes the lower through bolt hole 138cc and the upper through bolt hole 138dc are arranged in a single row linearly arranged longitudinally and latitudinally aligned through the connecting leg 128c.

The connecting elements of the horizontal supporting flange 127c of bracket 142c is provided with a downward facing bottom surface 147c is provided with a series of through holes the front through bolt hole 138h and the rear through bolt hole 138g through the oppositely positioned upwards facing top surface 141c the supporting element. The through holes the front through bolt hole 138h and the rear through bolt hole 138g are arranged in a single row linearly arranged latitudinally and aligned longitudinally through the horizontal supporting flange 127c. As described below in more detailed specifications and illustrated depictions in FIGS. 11 and 12, whereby the bolting connecting techniques and installation practices of the bracket 130, bracket 142c and joining plate 170a are explained in detail on the second method of new construction.

The joining plate 170a is comprised of a vertical connecting element or flat planar plate 169a comprised of a outwards front facing surface 171a and an oppositely positioned inwards facing back surface 172a. The planer plate 169a is provided with a series of through holes 138 the lower through bolt hole 138ea and the upper through bolt hole 138fa that are arranged in a single row linearly arranged longitudinally and latitudinally aligned through the joining plate 170a the securing element. As described below in more detail in FIG. 35 joining plate 170a specifications and described below in more detailed specifications and illustrated depictions in FIGS. 11 and 12, whereby the bolting connecting techniques and installation practices of the bracket 130, bracket 142c and joining plate 170a are explained in detail on the second method of new construction.

The outwards facing front surface 131a of bracket 130 vertical connecting leg 128a lower through bolt hole 138a aligns through to the inwards facing back surface 140a to the inwards facing back surface 140c of bracket 142c vertical connecting leg 128c lower through bolt hole 138cc and out the inwards facing front surface 131c.

The outwards facing front surface 131a of bracket 130 vertical connecting leg 128a upper through bolt hole 138b aligns through to the inwards facing back surface 140a to the inwards facing back surface 140c of bracket 142c vertical connecting leg 128c through the inwards facing back surface 140b of bracket 142c connecting leg 128c upper through bolt hole 138dc and out the inwards facing front surface 131c. As described below in more detailed specifications and illustrated depictions in FIGS. 11 and 12, whereby the bolting connecting techniques and installation practices of the bracket 130, bracket 142c and joining plate 170a are explained in detail on the second method of new construction.

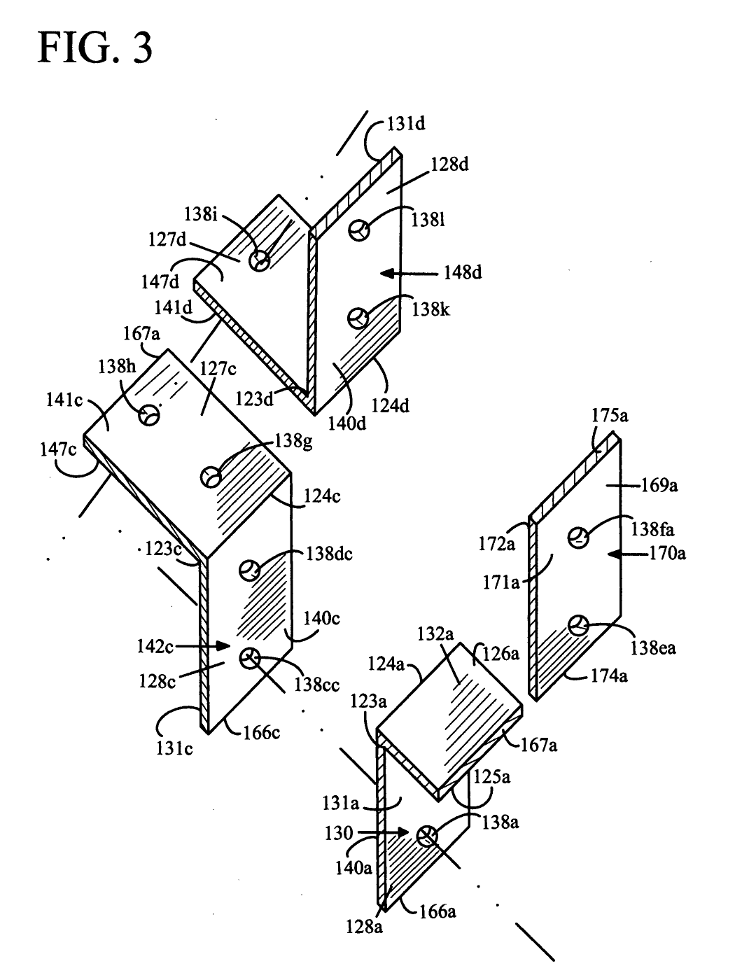

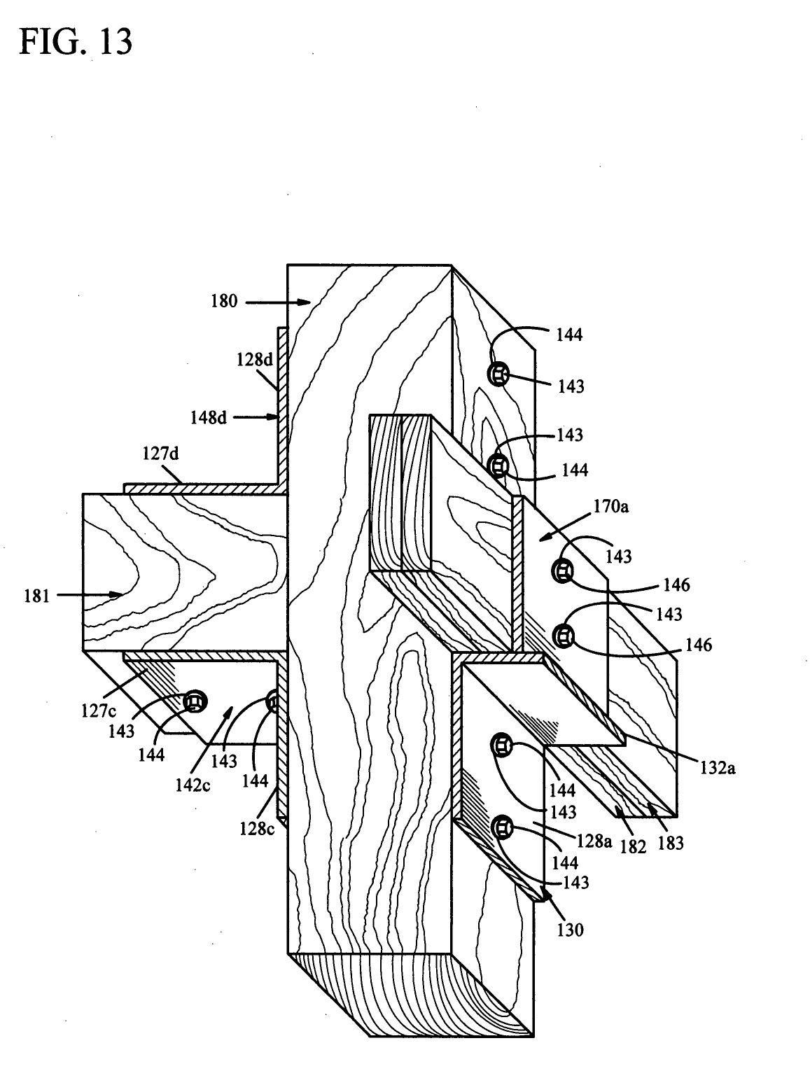

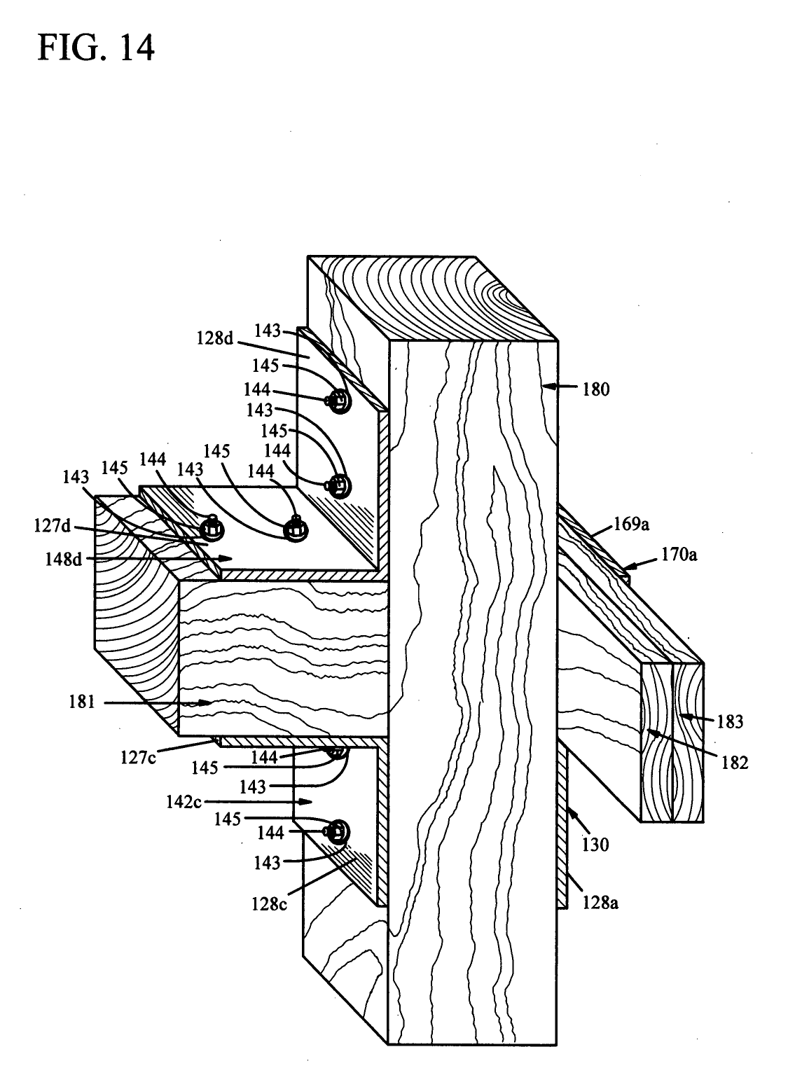

The third method of new construction embodiment provides a series of L-shaped bracket and plate fitting, according to the present invention is illustrated in FIG. 3 allowing for several equally horizontal planes. As described below in more detail, the first fabricated embodiment is bracket 130 which is adapted to be positioned in an upside down L-shaped configuration, the fourth fabricated embodiment is bracket 142c which is adapted to be positioned upside down reversed L-shaped configuration and the third fabricated embodiment is joining plate 170a which is utilized as a securing element and the sixth fabricated embodiment is bracket 148d which is adapted to be positioned reversed L-shaped configuration. As described below in more detailed specifications and illustrated depictions in FIGS. 13 and 14, whereby the bolting connecting techniques and installation practices of the third method of new construction embodiment using bracket 130, bracket 142c, bracket 148d and joining plate 170a are explained in detail on the third method of new construction.

As outlined in FIG. 1 the bracket 130 is comprised of a vertical column 180 connecting element or connecting leg 128a and a horizontal single rim joist 182 or the horizontal double rim joist 183 supporting element or short supporting flange 132a. The bracket 130 is positioned in an upside down L-shaped configuration. The connecting leg 128a consists of a flat planar plate member having a inwards facing back surface 140a and an oppositely positioned outwards facing front surface 131a. The connecting leg 128a is provided with a series of through holes the lower through bolt hole 138a and the upper through bolt hole 138b that are through the connecting leg 128a outwards front facing surface 131a through the oppositely positioned inwards back facing surface 140a.

The supporting flange 132a of bracket 130 is also comprised of a generally planar plate having an upwards facing top surface 132a and an oppositely positioned downwards facing bottom surface 125a.

The bracket 130 connecting leg 128a and supporting flange 132a together define an L-shaped bracket. The L-shaped bracket is provided with an outer corner edge 124a, the upwards facing top surface 126a of the supporting flange 132a is in abutting relation with the inwards facing back surface 140a of the connecting leg 128a and the inner corner 123a is in direct abutting relation to the downwards facing surface 125a of the supporting flange 132a supported by the connecting leg 128a outwards facing front surface 131a. As described below in more detail in FIG. 28 bracket 130 specifications.

As outlined in FIG. 2 the bracket 142c is comprised of a vertical connecting element or connecting leg 128c and a horizontal supporting and connecting element or supporting flange 127c. The bracket 142c is positioned in an upside down reversed L-shaped configuration. The bracket 142c vertical connecting leg 128c consists of a flat planar plate member having a inwards facing back surface 140c and an oppositely positioned outwards front surface 131c. The bracket 142c connecting flange 127c consists of a flat planar plate 128c member having a upwards facing top surface 141c and an oppositely positioned downwards facing bottom surface 147c. The vertical connecting leg 128c height is equal to the horizontal supporting flange 127c length. As described below in more detail in FIG. 30 bracket 142c specifications.

The vertical connecting leg 128c of bracket 142c is provided with a series of through holes the lower through bolt hole 138cc and the upper through bolt hole 138dc that are through the connecting leg 128c outwards front facing surface 131c through the oppositely positioned inwards back facing surface 140c. The through holes the lower through bolt hole 138c and the upper through bolt hole 138d are arranged in a single row linearly arranged longitudinally and latitudinally aligned through the connecting leg 128c.

The connecting elements of the horizontal supporting flange 127c of bracket 142c is provided with a downward facing bottom surface 147c is provided with a series of through holes the front through bolt hole 138h and the rear through bolt hole 138g through the oppositely positioned upwards facing top surface 141c the supporting element. The through holes the front through bolt hole 138h and the rear through bolt hole 138g are arranged in a single row linearly arranged latitudinally and aligned longitudinally through the horizontal supporting flange 127c. As described below in more detailed specifications and illustrated depictions in FIGS. 13 and 14, whereby the bolting connecting techniques and installation practices of the third method of new construction embodiment using bracket 130, bracket 142c, bracket 148d and joining plate 170a are explained in detail on the third method of new construction.

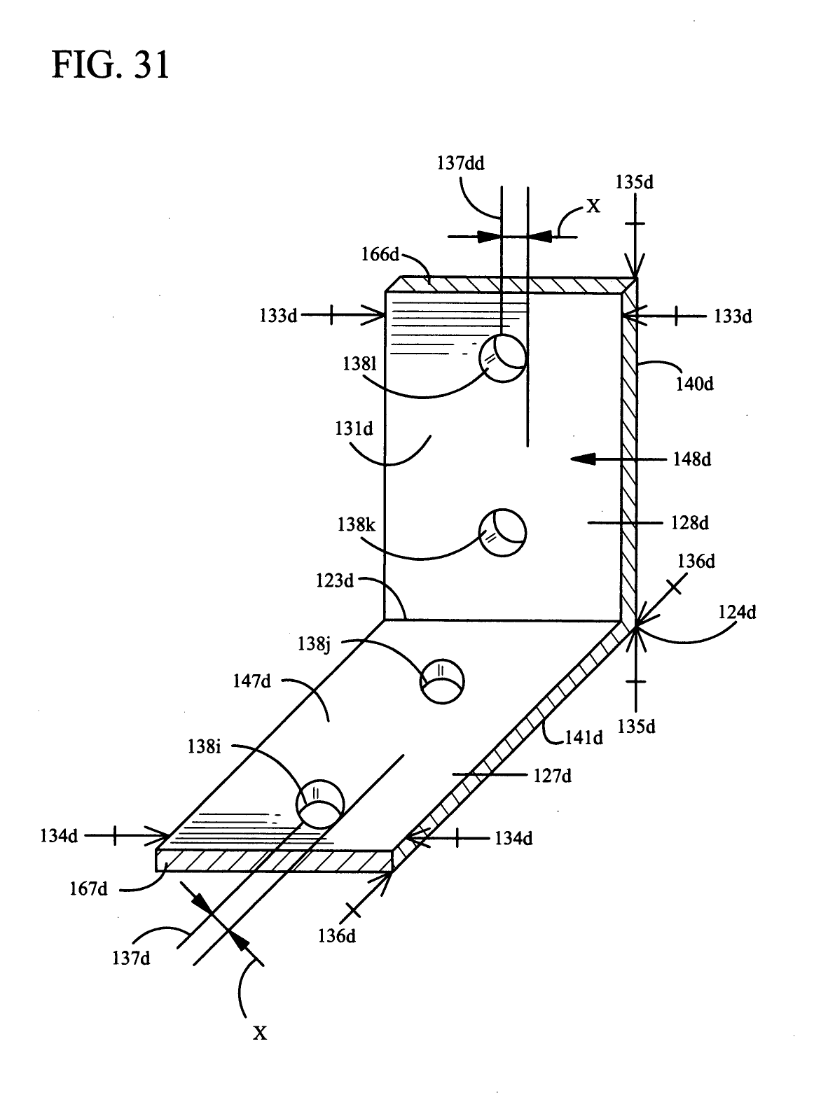

The bracket 148d is comprised of a vertical connecting element or connecting leg 128d and a horizontal connecting element or securing flange 127d. The bracket 148d is positioned in an reversed L-shaped configuration. The bracket 148d connecting leg 128d consists of a flat planar plate member having a inwards facing back surface 140d and an oppositely positioned outwards front surface 131d. The bracket 148d securing flange 127d consists of a flat planar plate member having a upwards facing top surface 147d and an oppositely positioned downwards facing bottom surface 141d. The connecting leg 128d height is equal to the connecting flange 127d length. As described below in more detail in FIG. 31 bracket 148d specifications.

The connecting leg 128d of bracket 148d is provided with a series of through holes the lower through bolt hole 138k and the upper through bolt hole 138l that are through the connecting leg 128d outwards front facing surface 131d through the oppositely positioned inwards back facing surface 140d. The through holes the lower through bolt hole 138k and the upper through bolt hole 138l are arranged in a single row linearly arranged longitudinally and latitudinally aligned through the connecting leg 128d.

The connecting flange 127d of bracket 148d is provided with a downward facing bottom surface 141d is provided with a series of through holes the front through bolt hole 138i and the rear through bolt hole 138j through the oppositely positioned upwards facing top surface 147d detailing the supporting and securing element. As described below in more detailed specifications and illustrated depictions in FIGS. 13 and 14, whereby the bolts connecting techniques and installation practices of the bracket 130, bracket 142c, bracket 148d and joining plate 170a are explained in detail. The through holes the front through bolt hole 138i and the rear through bolt hole 138j are arranged in a single row linearly arranged latitudinally and aligned longitudinally through the horizontal supporting flange 127d.

The bracket 148d connecting leg 128d and supporting flange 127d together define an L-shaped bracket. The L-shaped bracket is provided with an inner corner 123d when the upwards facing top surface 147d of the supporting flange 127d is in abutting relation with the outwards facing front surface 131d of the connecting leg 128d and an outer corner edge 124d is in direct abutting relation to the downwards facing surface 141c of the supporting flange 127d supporting the connecting leg 128d inwards facing back surface 140d. As described below in more detail in FIG. 31 bracket 148d specifications.

The joining plate 170a is comprised of a column connecting element or flat planar plate 169a comprised of a outwards front facing surface 171a and an oppositely positioned inwards facing back surface 172a. The planer plate 169a is provided with a series of through holes 138 the lower through bolt hole 138ea and the upper through bolt hole 138fa that are arranged in a single row linearly arranged longitudinally and latitudinally aligned through the joining plate 170a the securing element. As described below in more detail in FIG. 35 joining plate 170a specifications and described below in more detailed specifications and illustrated depictions in FIGS. 13 and 14, whereby the bolting connecting techniques and installation practices of the bracket 130, bracket 142c, bracket 148d and joining plate 170a are explained in detail on the third method of new construction.

The outwards facing front surface 131a of bracket 130 connecting leg 128a lower through bolt hole 138a aligns through to the inwards facing back surface 140a to the inwards facing back surface 140c of bracket 142c connecting leg 128c lower through bolt hole 138cc and out the inwards facing front surface 131b. The outwards facing front surface 131a of bracket 130 connecting leg 128a upper through bolt hole 138b aligns through to the inwards facing back surface 140a to the inwards facing back surface 140c of bracket 142c connecting leg 128c through the inwards facing back surface 140b of bracket 142c connecting leg 128c upper through bolt hole 138dc and out the inwards facing front surface 131c. As described below in more detailed specifications and illustrated depictions in FIGS. 13 and 14, whereby the bolting connecting techniques and installation practices of the bracket 130, bracket 142c, bracket 148d and joining plate 170a are explained in detail on the third method of new construction.

The downwards facing bottom surface 147c of bracket 142c horizontal support beam connecting element or supporting flange 127c rear through bolt hole 138g aligns through to the upwards facing top surface 141c to the downwards facing bottom surface 141d of bracket 148d horizontal connecting element or flange 127c rear through bolt hole 138j and out the upwards facing top surface 147d. The downwards facing bottom surface 147c of bracket 142c horizontal support beam connecting element or supporting flange 127c front through bolt hole 138h aligns through to the upwards facing top surface 141c to the downwards facing bottom surface 141d of bracket 148d horizontal connecting element or flange 127d front through bolt hole 138i and out the upwards facing top surface 147d. As described below in more detailed specifications and illustrated depictions in FIGS. 13 and 14, whereby the bolting connecting techniques and installation practices of the bracket 130, bracket 142c, bracket 148d and joining plate 170a are explained in detail on the third method of new construction.

The outwards facing front surface 171a of joining plate 170a flat planar plate 169a lower through hole 138ea and upper through bolt hole 138fb. As described below in more detailed specifications and illustrated depictions in FIGS. 13 and 14, whereby the bolting connecting techniques and installation practices of the bracket 130, bracket 142c, bracket 148d and joining plate 170a are explained in detail on the third method of new construction.

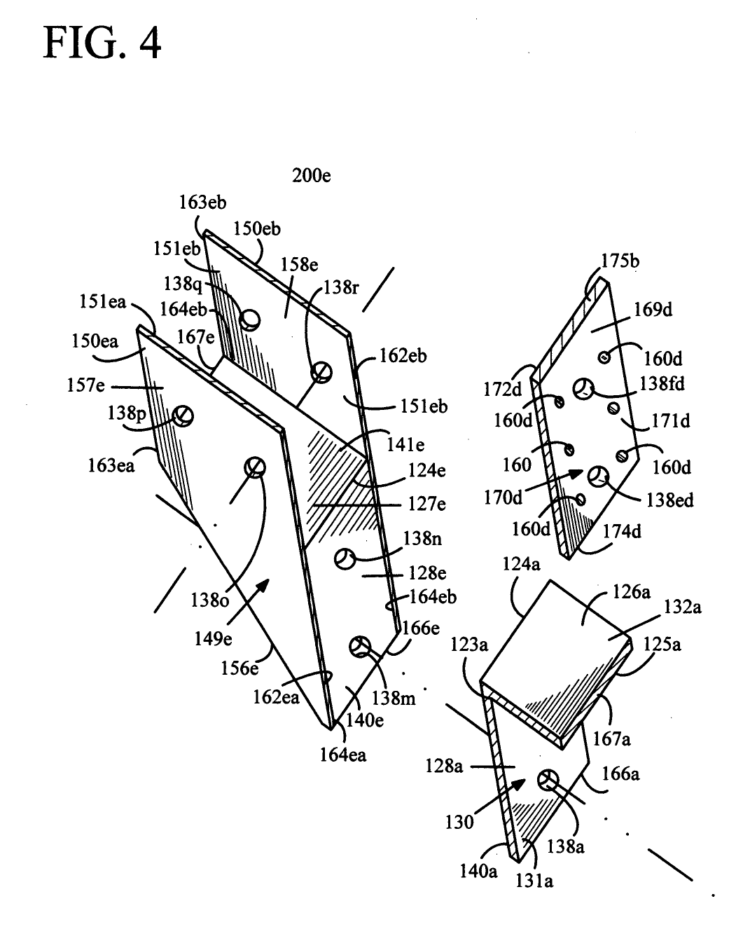

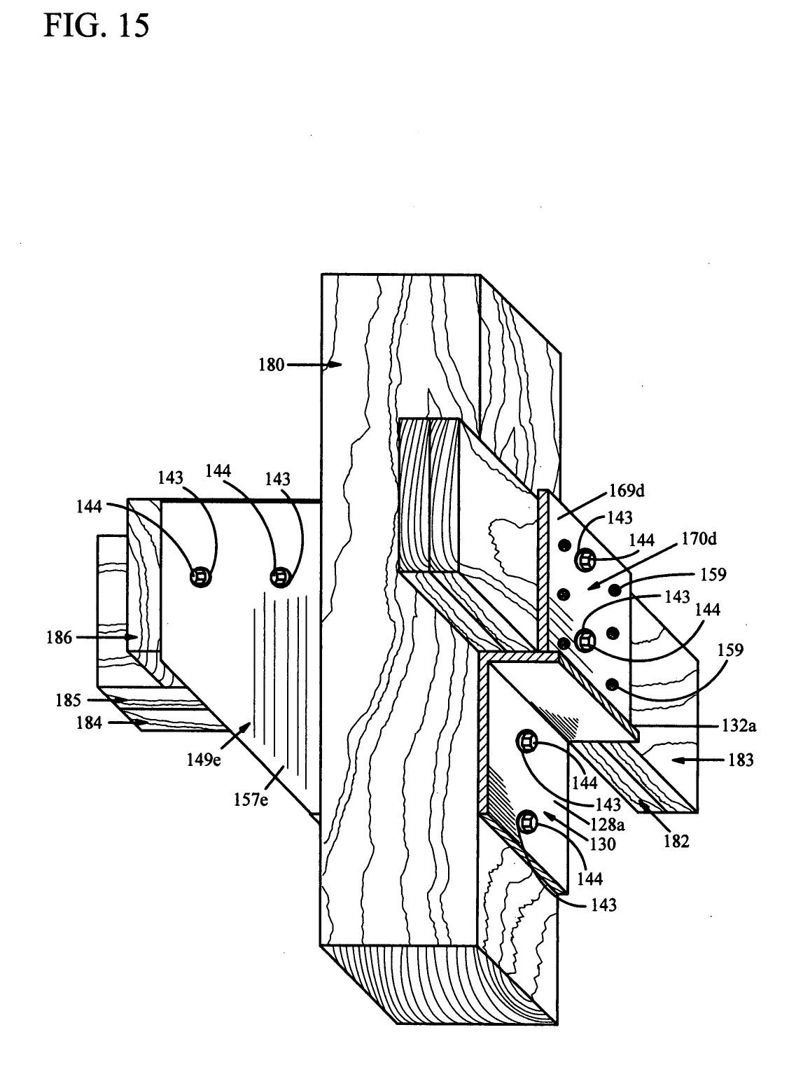

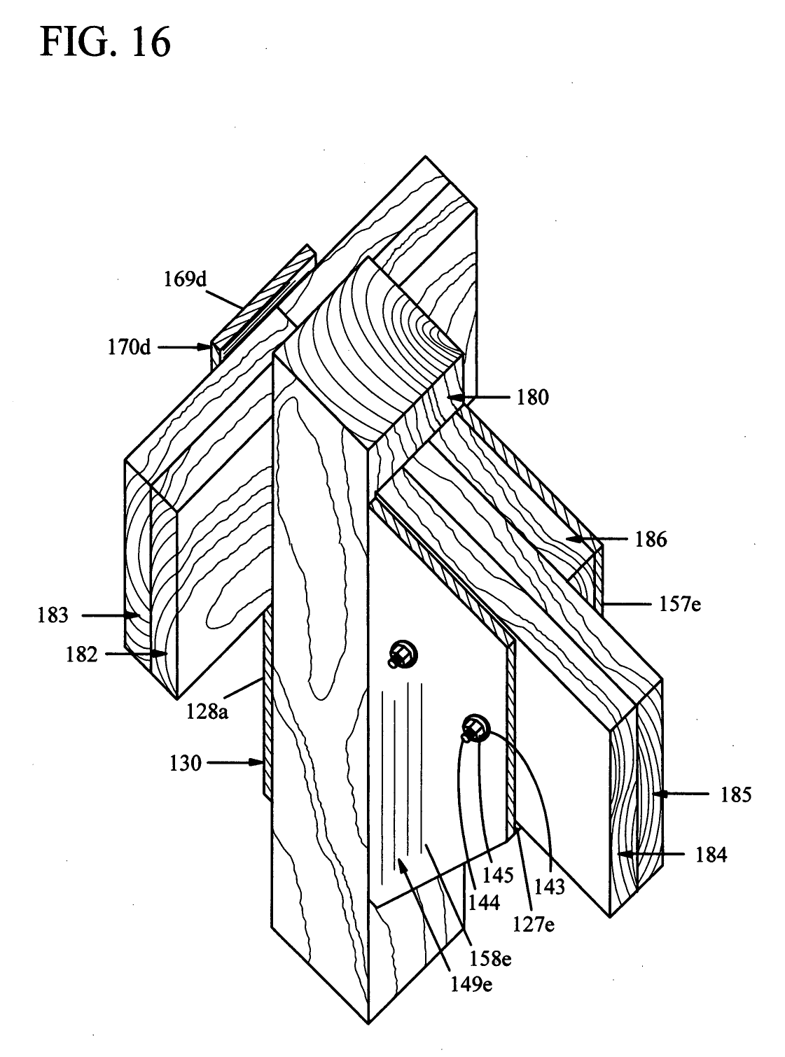

The fourth third method of new construction embodiment provides a series of L-shaped bracket and plate fitting, according to the present invention is illustrated in FIG. 4 allowing for several equally horizontal planes. As described below in more detail, the first fabricated embodiment is bracket 130 which is adapted to be positioned in an upside down L-shaped configuration, the seventh fabricated embodiment is bracket 149e and welded components are adapted to be positioned upside down reversed L-shaped configuration and the tenth fabricated embodiment is joining plate 170d which is utilized as a securing element. As described below in more detailed specifications and illustrated depictions in FIGS. 15 and 16, whereby the bolting connecting techniques and installation practices of the fourth method of new construction embodiment using bracket 130, bracket 149e and joining plate 170d are explained in detail on the fourth method of new construction.

As outlined in FIG. 1 the bracket 130 is comprised of a vertical column 180 connecting element or connecting leg 128a and a horizontal single rim joist 182 or the horizontal double rim joist 183 supporting element or short supporting flange 132a. The bracket 130 is positioned in an upside down L-shaped configuration. The connecting leg 128a consists of a flat planar plate member having a inwards facing back surface 140a and an oppositely positioned outwards facing front surface 131a. The connecting leg 128a is provided with a series of through holes the lower through bolt hole 138a and the upper through bolt hole 138b that are through the connecting leg 128a outwards front facing surface 131a through the oppositely positioned inwards back facing surface 140a.

The supporting flange 132a of bracket 130 is also comprised of a generally planar plate having an upwards facing top surface 132a and an oppositely positioned downwards facing bottom surface 125a.

The bracket 130 connecting leg 128a and supporting flange 132a together define an L-shaped bracket. The L-shaped bracket is provided with an outer corner edge 124a, the upwards facing top surface 126a of the supporting flange 132a is in abutting relation with the inwards facing back surface 140a of the connecting leg 128a and the inner corner 123a is in direct abutting relation to the downwards facing surface 125a of the supporting flange 132a supported by the connecting leg 128a outwards facing front surface 131a. As described below in more detail in FIG. 28 bracket 130 specifications.

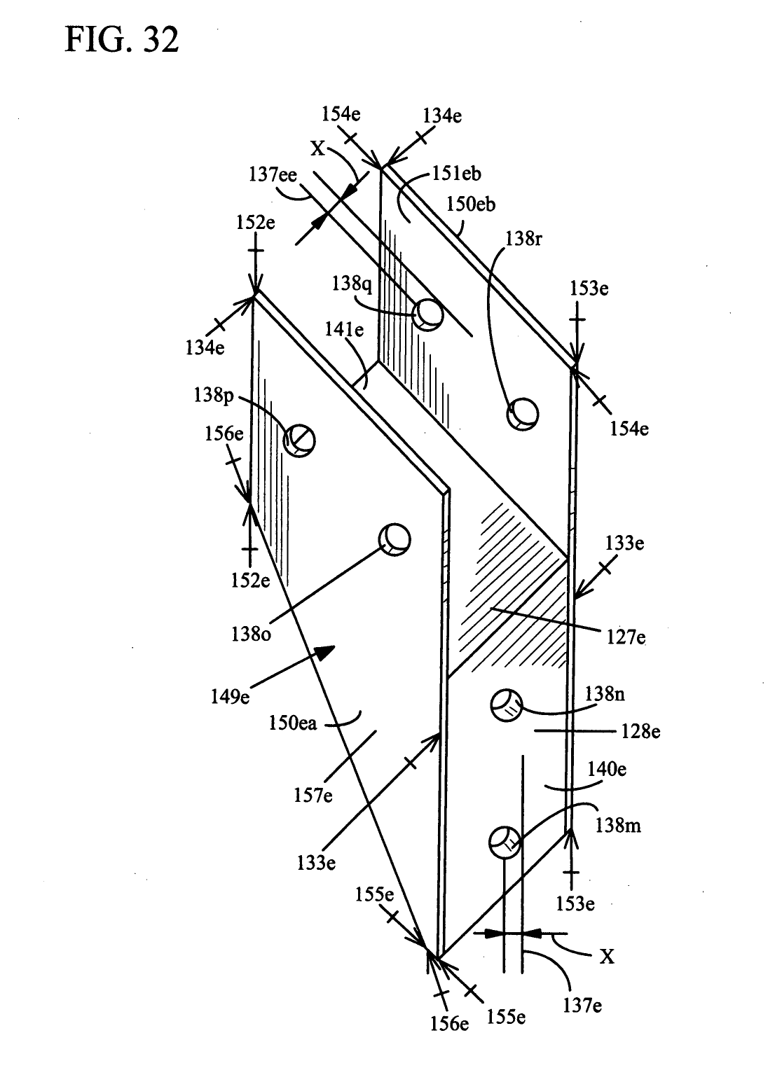

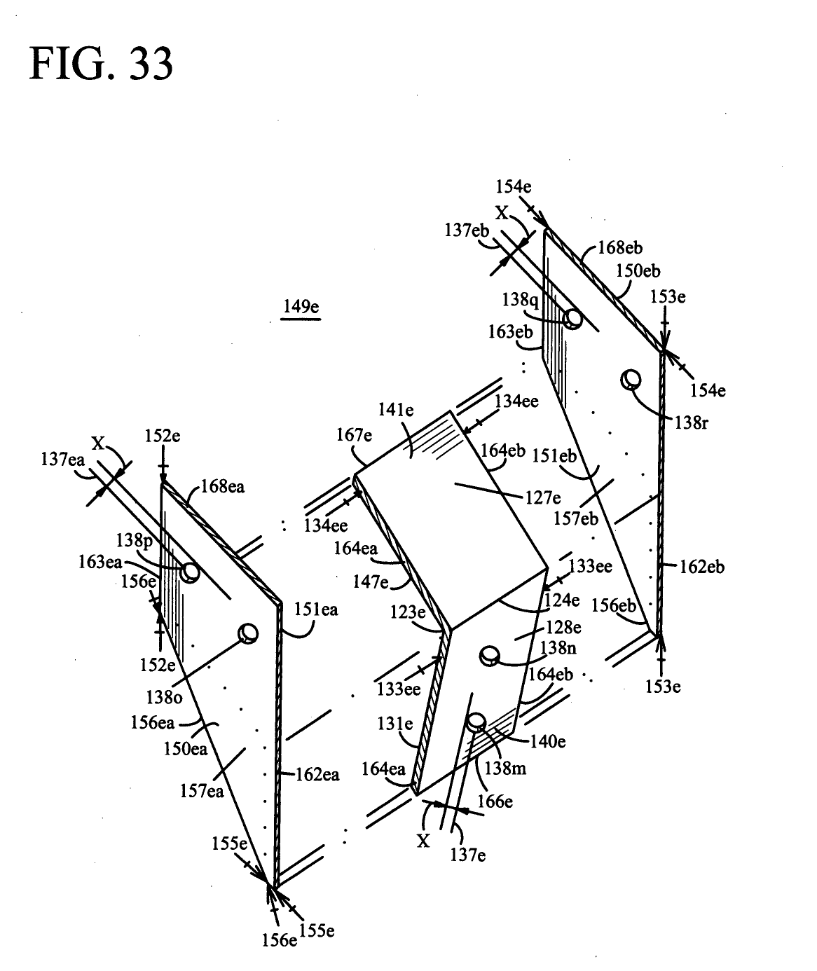

The bracket 149e is comprised of a connecting element or connecting leg 128e, a horizontal supporting element or flange 127e and two interconnecting elements or two connecting trapezoid shaped planer plates 157e and 158e. As described below in more detail in FIGS. 32 and 33 bracket 149e specifications.

The bracket 149e is positioned in an upside down reversed L-shaped configuration. The vertical connecting leg 128e consists of a flat planar plate having a inwards facing back surface 140e and an oppositely positioned outwards facing front surface 131e. The vertical connecting leg 128e of bracket 149e is provided with a series of through holes 138 the lower through bolt hole 138m and the upper through bolt hole 138n that are through the vertical connecting leg 128e outwards front facing surface 140e through to the oppositely positioned inwards back facing surface 131e. The through holes the lower through bolt hole 138m and the upper through bolt hole 138n are arranged in a single row linearly arranged longitudinally and latitudinally aligned through the connecting leg 128e.

The horizontal supporting flange 127e of bracket 149e is also comprised of a generally planar plate having an upwards facing top surface 141e and an oppositely positioned downwards facing bottom surface 147e.

The upwards facing top surface 141e of the flange 127e is in abutting relation with the inwards facing back surface 140e of the connecting leg 128e constitutes the outer corner 124e. The vertical connecting leg 128e and the single horizontal supporting flange 127e together define an L-shaped bracket fitted with two connecting trapezoid shaped planer plates 157e and 158e. As described below in more detail in FIGS. 32 and 33 bracket 149e specifications.

The vertical connecting leg 128e left outer edge 164ea is welded to the long bases 162ea of the trapezoid shaped planer plate 157e inward facing surface 151ea and oppositely positioned right outer edge 164eb of the connecting leg 128e is welded long bases 162eb of the trapezoid shaped planer plate 158e inward facing surfaces 151eb. The horizontal support flange 127e left outer edge 164ea is welded to the short bases 163ea of the trapezoid shaped planer plates 157e inward facing surface 151ea and oppositely positioned right outer edge 164eb of the support flange 127e is welded to the short bases 163eb of the trapezoid shaped planer plate 158e inward facing surface 151eb. The two trapezoid shaped planer plates 157e and 158e are welded to the vertical connecting leg 128e and the horizontal supporting flange 127e form a supported channelized connecting element 200e supported by the flange 127e upwards facing top surface 141e and channeled by the trapezoid shaped planer plate 157e and trapezoid shaped planer plate 158e.

The outwards facing surface 150ea and the oppositely positioned inwards facing surface 151ea of the trapezoid shaped planer plate 157e is provided with a series of through holes the front through hole 138p and the rear through hole 138o. The outwards facing surface 150eb and the oppositely positioned inwards facing surface 151eb of the connecting trapezoid planer plate 158e provided with a series of through holes the front through hole 138q and the rear through hole 138r. As described below in more detail in FIGS. 32 and 33 bracket 149e specifications.

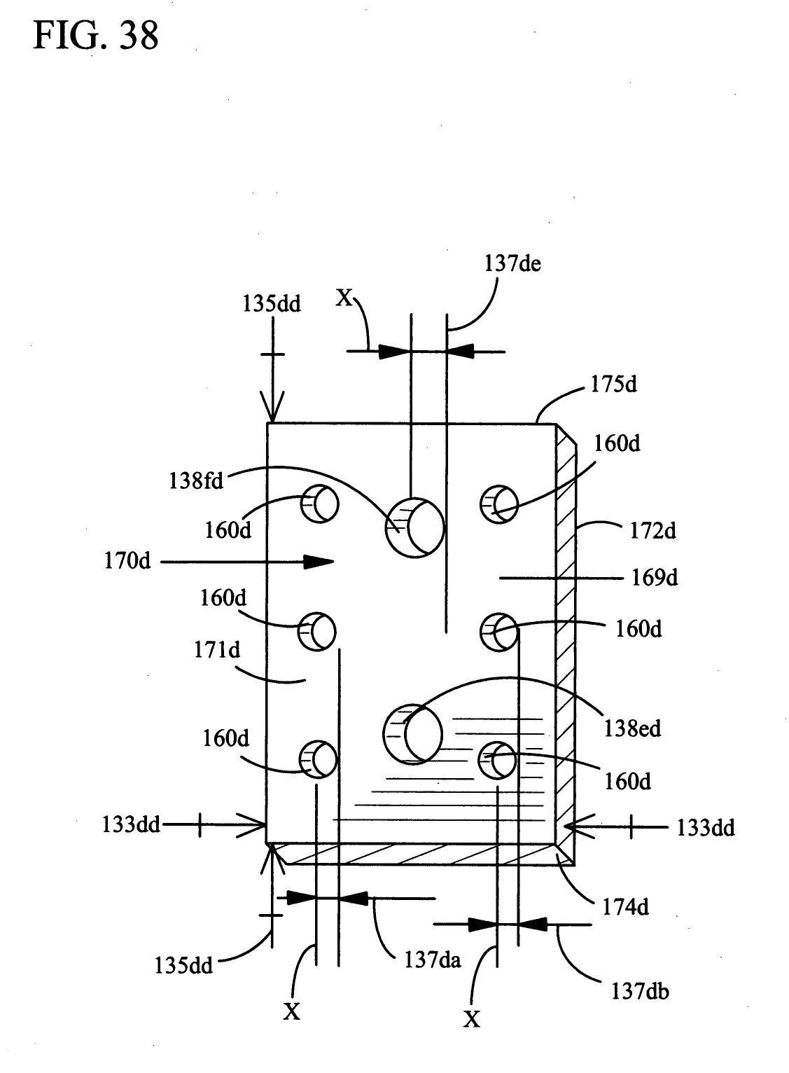

The joining plate 170d is comprised of a column connecting element or flat planar plate 169b comprised of a outwards front facing surface 171d and an oppositely positioned inwards facing back surface 172d. The planer plate 128d is provided with a series of through holes 138 the lower through bolt hole 138ed, upper through bolt hole 138fd and two rows of smaller nail through holes 160d that are arranged in a single rows linearly arranged longitudinally and latitudinally aligned through the joining plate 170d the securing element. The lower through bolt hole 138ed and upper through bolt hole 138fd are arranged in median in a single rows linearly arranged longitudinally and latitudinally aligned and the smaller nail through holes 160d are arranged in two rows that are longitudinally arranged between the median of the planner plate 169d of the joining plate 170d outer edges 133 and latitudinal aligned through the planner plate 169d. As described below in more detail in FIG. 38 joining plate 170d specifications and described below in more detailed specifications and illustrated depictions in FIGS. 15 and 16, whereby the bolting connecting techniques and installation practices of the fourth method of new construction embodiment using bracket 130, bracket 149e and joining plate 170d are explained in detail on the fourth method of new construction.

The outwards facing front surface 131a of bracket 130 connecting leg 128a lower through bolt hole 138a aligns through to the inwards facing back surface 140a to the inwards facing back surface 140e of bracket 149e connecting leg 128e lower through bolt hole 138m and out the inwards facing front surface 131e. The outwards facing front surface 131a of bracket 130 connecting leg 128a upper through bolt hole 138b aligns through to the inwards facing back surface 140a to the inwards facing back surface 140e of bracket 149e connecting leg 128e through the inwards facing back surface 140e of bracket 149e connecting leg 128e upper through bolt hole 138n and out the inwards facing front surface 131e. As described below in more detailed specifications and illustrated depictions in FIGS. 15 and 16, whereby the bolting connecting techniques and installation practices of the fourth method of new construction embodiment using bracket 130, bracket 149e and joining plate 170d are explained in detail on the fourth method of new construction.

The left outward facing surface 150ea of bracket 149e trapezoid shaped planer plate 157e front through hole 138p aligns through to the inward facing surface 151ea to the inward facing surface 151eb trapezoid shaped planer plate 158e front through hole 138q and out to the right outward facing surface 150eb. The left outward facing surface 150ea of bracket 149e trapezoid shaped planer plate 157e rear through hole 138o aligns through to the inward facing surface 15 lea to the inward facing surface 151eb trapezoid shaped planer plate 158e rear through hole 138r and out to the right outward facing surface 150eb. The through holes the front through bolt hole 138p and the front through bolt hole 138q are arranged in a single row linearly arranged latitudinally and latitudinally aligned through both trapezoid shaped planer plate 157e and trapezoid shaped planer plate 158e. As described below in more detailed specifications and illustrated depictions in FIGS. 15 and 16, whereby the bolting connecting techniques and installation practices of the fourth method of new construction embodiment using bracket 130, bracket 149e and joining plate 170d are explained in detail on the fourth method of new construction.

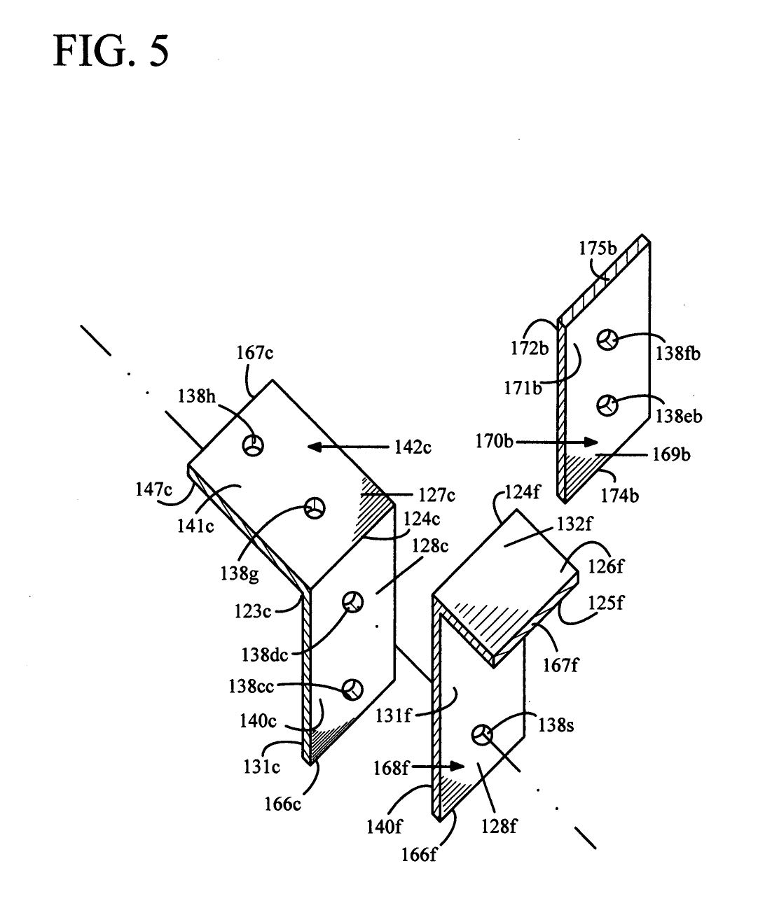

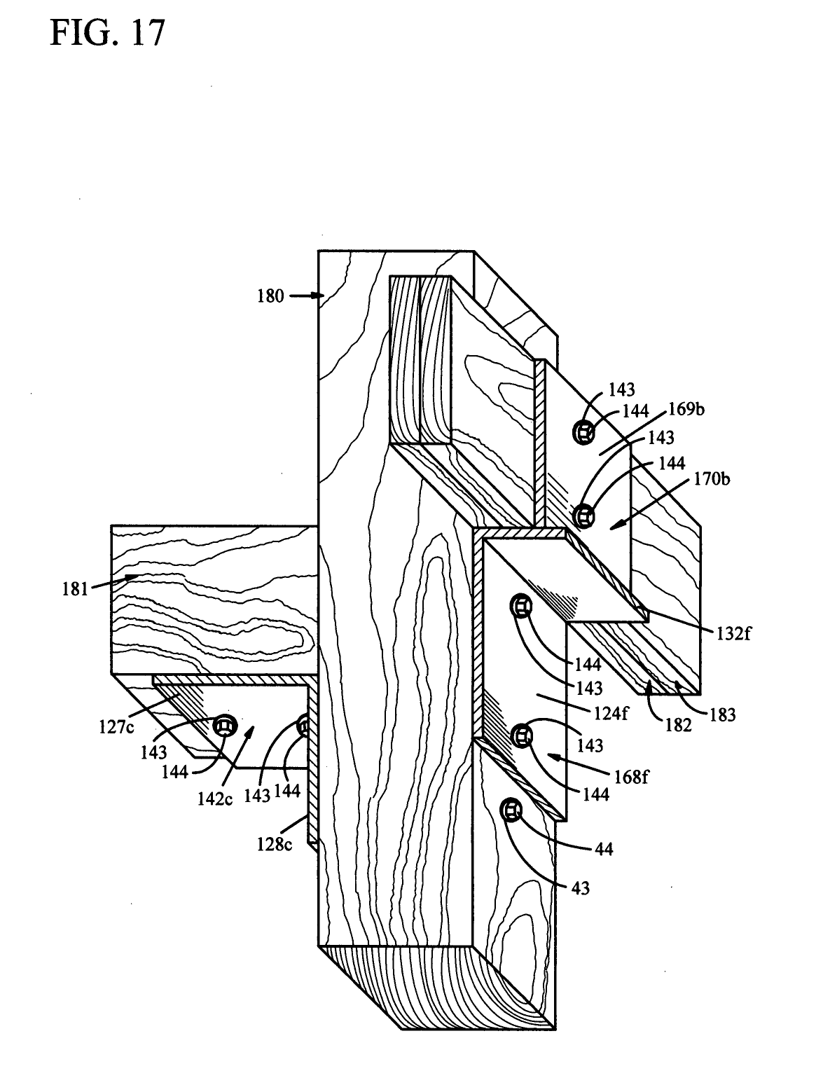

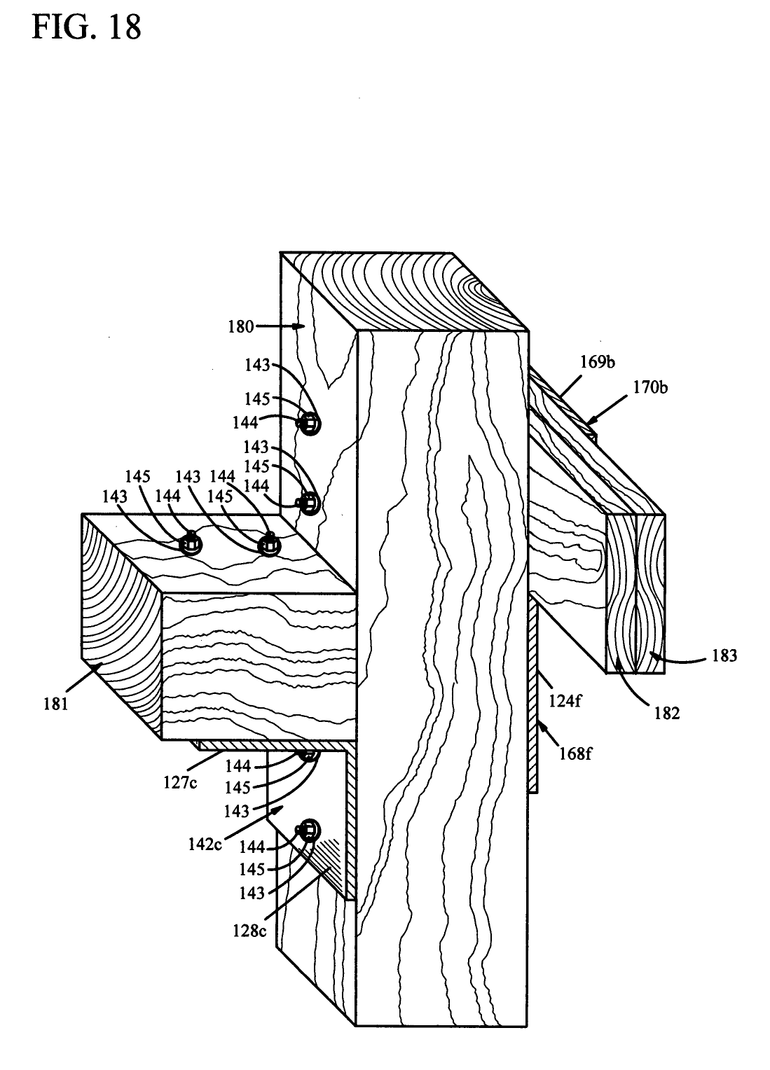

The fifth method of new construction embodiment provides a series of L-shaped bracket and plate fitting, according to the present invention is illustrated in FIG. 5 allowing for two unequally horizontal segmented planes converging on a single horizontal segmented plane. As described below in more detail, the first fabricated embodiment is bracket 168f which is adapted to be positioned in an upside down L-shaped configuration, the fourth fabricated embodiment is bracket 142c which is adapted to be positioned upside down reversed L-shaped configuration and the fifth fabricated embodiment is joining plate 170b which is utilized as a securing element. As described below in more detailed specifications and illustrated depictions in FIGS. 17 and 18, whereby the bolting connecting techniques and installation practices of the fifth method of new construction embodiment using bracket 168f, bracket 142c and joining plate 170b are explained in detail on the fifth method of new construction.

The bracket 168f is comprised of a long vertical connecting element or long connecting leg 128f and a short horizontal supporting element or short supporting flange 132f. The bracket 168f is positioned in an upside down L-shaped configuration. The vertical long connecting leg 128f consists of a long flat planar plate member having a inwards facing back surface 140f and an oppositely positioned outwards facing front surface 131f. The vertical long connecting leg 128f is provided with a series of through holes the lower through bolt hole 138s and the upper through bolt hole 138t that are through the long connecting leg 128f outwards front facing surface 131f through the oppositely positioned inwards back facing surface 140f. The through holes the lower through bolt hole 138s and the upper through bolt hole 138t are arranged in a single row linearly arranged longitudinally and latitudinally aligned through the long connecting leg 128f.

The horizontal supporting flange 132f of bracket 168f is also comprised of a short generally planar plate having an upwards facing top surface 132f and an oppositely positioned downwards facing bottom surface 125f.

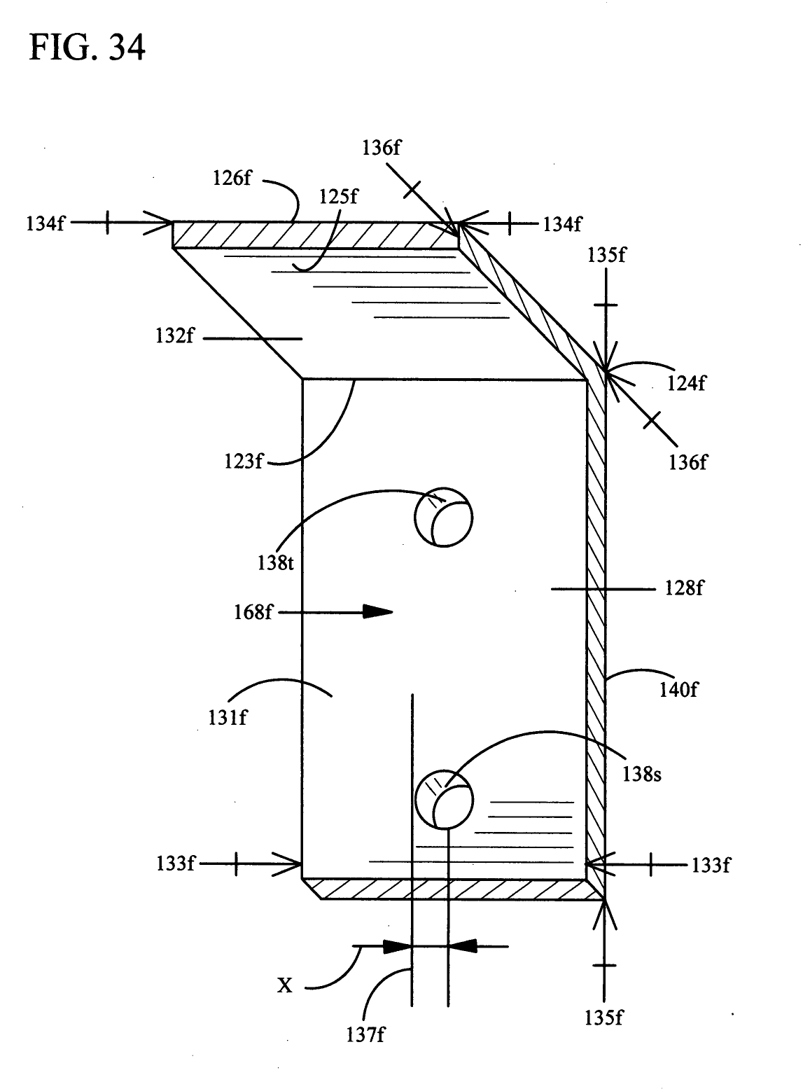

The bracket 168f vertical long connecting leg 128f and horizontal supporting flange 132f together define an L-shaped bracket. The L-shaped bracket is provided with an outer corner edge 124f when the upwards facing top surface 126f of the horizontal supporting flange 132f is in abutting relation with the inwards facing back surface 140f of the vertical connecting leg 128f and the inner corner 123f is in direct abutting relation to the downwards facing surface 125f of the horizontal supporting flange 132f supported by the vertical long connecting leg 128f outwards facing front surface 131f. As described below in more detail in FIG. 34 bracket 168f specifications.

As outlined in FIG. 2 the bracket 142c is comprised of a vertical connecting element or connecting leg 128c and a horizontal supporting and connecting element or supporting flange 127c. The bracket 142c is positioned in an upside down reversed L-shaped configuration. The bracket 142c vertical connecting leg 128c consists of a flat planar plate member having a inwards facing back surface 140c and an oppositely positioned outwards front surface 131c. The bracket 142c connecting flange 127c consists of a flat planar plate member having a upwards facing top surface 141c and an oppositely positioned downwards facing bottom surface 147c. The vertical connecting leg 128c height is equal to the horizontal supporting flange 127c length. As described below in more detail in FIG. 30 bracket 142c specifications.

The vertical connecting leg 128c of bracket 142c is provided with a series of through holes the lower through bolt hole 138cc and the upper through bolt hole 138dc that are through the connecting leg 128c outwards front facing surface 131c through the oppositely positioned inwards back facing surface 140b. The through holes the lower through bolt hole 138cc and the upper through bolt hole 138dc are arranged in a single row linearly arranged longitudinally and latitudinally aligned through the connecting leg 128c.

The connecting elements of the horizontal supporting flange 127c of bracket 142c is provided with a downward facing bottom surface 147c is provided with a series of through holes the front through bolt hole 138h and the rear through bolt hole 138g through the oppositely positioned upwards facing top surface 141c the supporting element. The through holes the front through bolt hole 138h and the rear through bolt hole 138g are arranged in a single row linearly arranged latitudinally and aligned longitudinally through the horizontal supporting flange 127c. As described below in more detailed specifications and illustrated depictions in FIGS. 17 and 18, whereby the bolting connecting techniques and installation practices of the fifth method of new construction embodiment using bracket 168f, bracket 142c and joining plate 170b are explained in detail on the fifth method of new construction.

The bracket 142c vertical connecting leg 128c and horizontal supporting flange 127c together define an L-shaped bracket. The L-shaped bracket is provided with an outer corner edge 124c when the upwards facing top surface 141c of the horizontal supporting flange 127c is in abutting relation with the inwards facing back surface 140c of the vertical connecting leg 128c and the inner corner 123c is in direct abutting relation to the downwards facing surface 147c of the horizontal supporting flange 127c supported by the vertical connecting leg 128c outwards facing front surface 131c. As described below in more detail in FIG. 30 bracket 142c specifications.

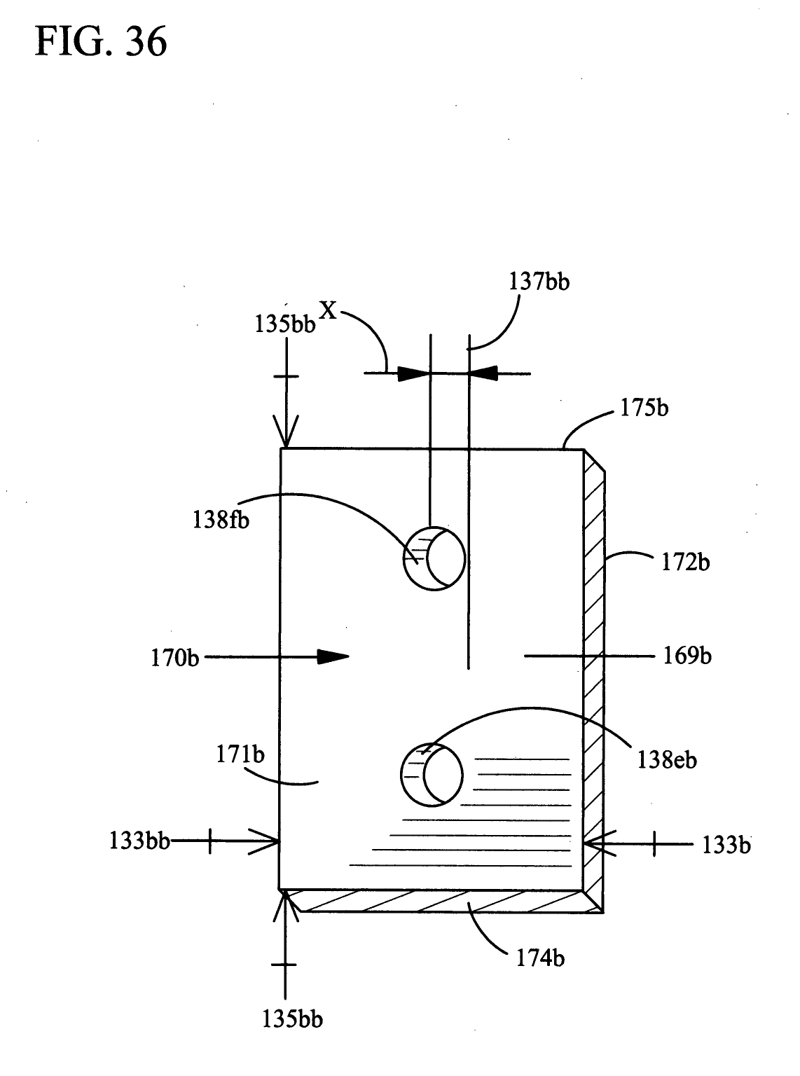

The joining plate 170b is comprised of a vertical connecting element or flat planar plate 169b comprised of a outwards front facing surface 171b and an oppositely positioned inwards facing back surface 172b. The planer plate 128b is provided with a series of through holes 138 the lower through bolt hole 138eb and the upper through bolt hole 138fb that are arranged in a single row linearly arranged longitudinally and latitudinally aligned through the joining plate 170b the securing element. As described below in more detail in FIG. 36 joining plate 170b specifications and described below in more detailed specifications and illustrated depictions in FIGS. 17 and 18, whereby the bolting connecting techniques and installation practices of the fifth method of new construction embodiment using bracket 168f, bracket 142c and joining plate 170b are explained in detail on the fifth method of new construction.

The outwards facing front surface 131f of bracket 168f long vertical connecting leg 128f lower through bolt hole 138s aligns through to the inwards facing back surface 140a to the inwards facing back surface 140c of bracket 142c vertical connecting leg 128c upper through bolt hole 138dc and out the inwards facing front surface 131b. As described below in more detailed specifications and illustrated depictions in FIGS. 17 and 18, whereby the bolting connecting techniques and installation practices of the fifth method of new construction embodiment using bracket 168f, bracket 142c and joining plate 170b are explained in detail on the fifth method of new construction.

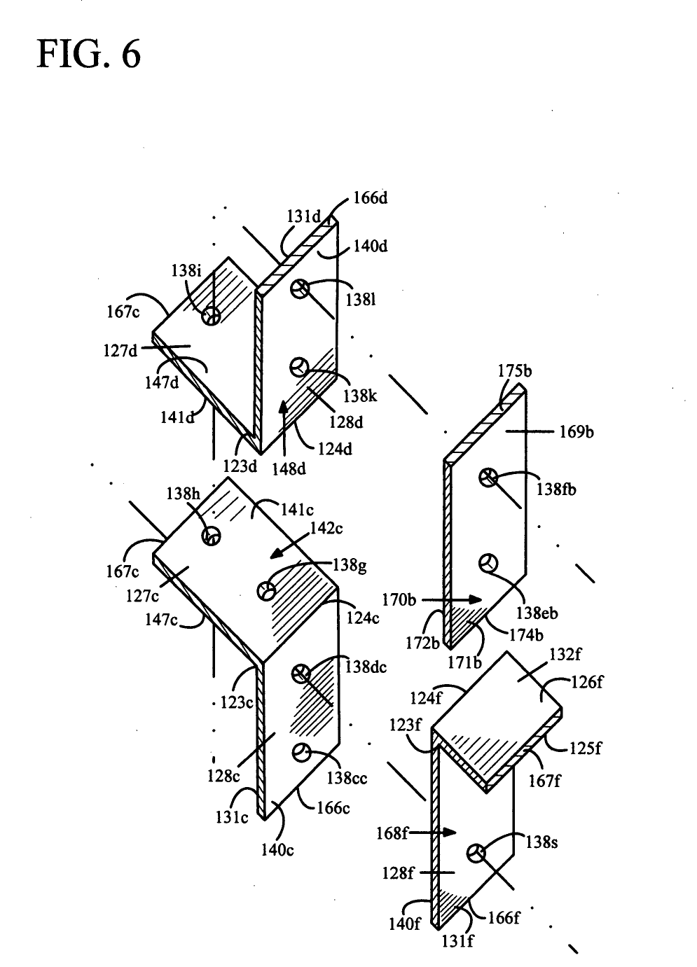

The sixth method of new construction embodiment provides L-shaped brackets and plate fitting, brackets, according to the present invention is illustrated in FIG. 6 allowing for two unequally horizontal planes converging on a single horizontal segmented line plane. As described below in more detail, the eighth fabricated embodiment bracket 168f is adapted to be positioned upside down L-shaped configuration, the fourth fabricated embodiment bracket 142c is adapted to be positioned in an upside down reversed L-shaped configuration, the sixth fabricated embodiment bracket 148d is adapted to be positioned reversed L-shaped configuration and the fifth fabricated embodiment joining plate 170b is utilized as a securing element.

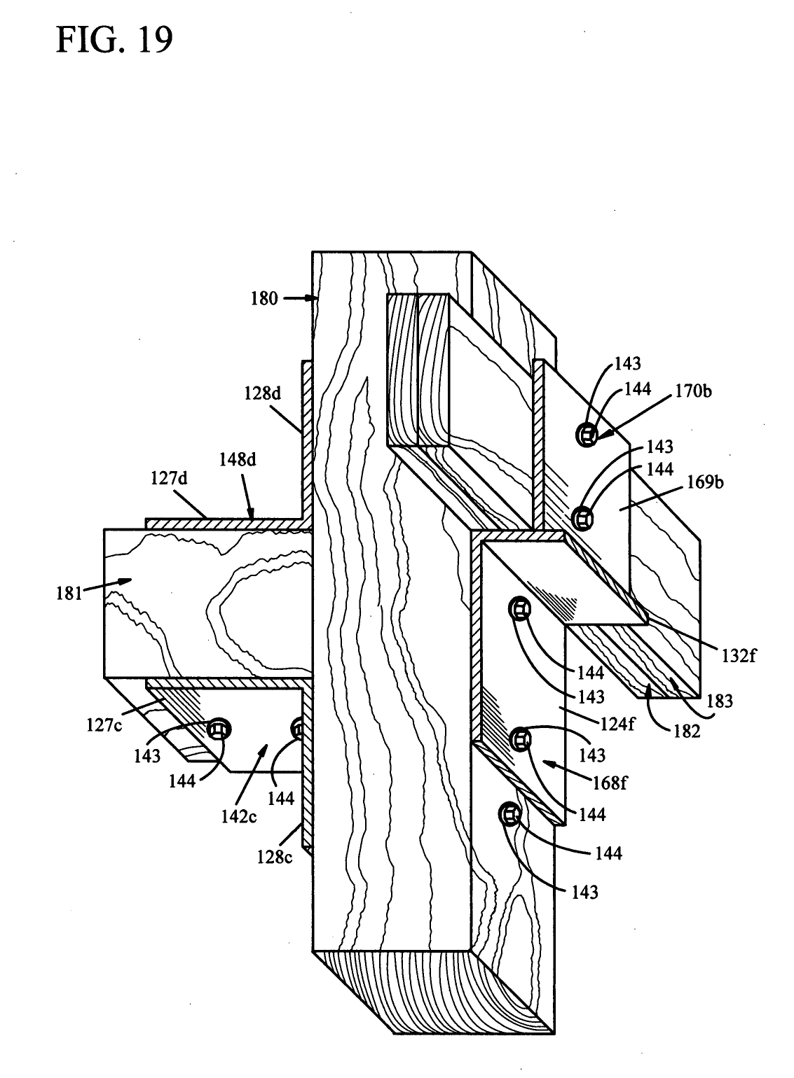

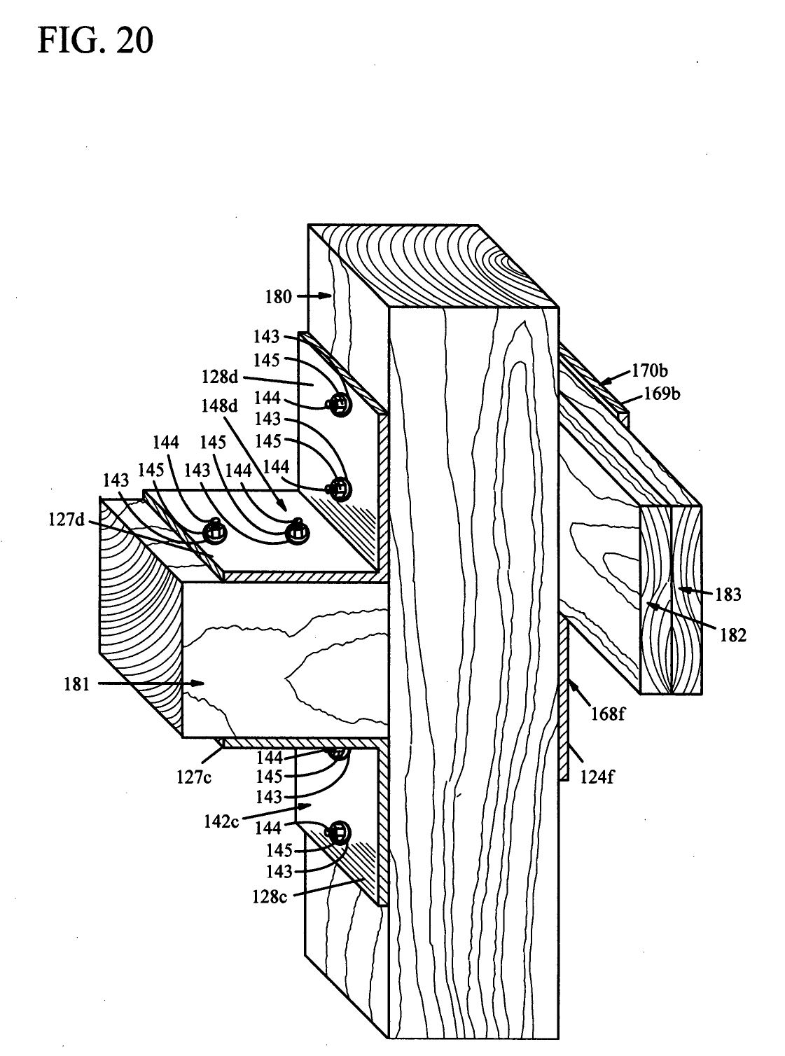

As described below in more detailed specifications and illustrated depictions in FIGS. 19 and 20, whereby the bolting connecting techniques and installation practices of the sixth method of new construction embodiment using bracket 168f, bracket 142c, bracket 148d and joining plate 170b are explained in detail on the sixth method of new construction.

The bracket 168f is comprised of a long vertical connecting element or connecting leg 128f and a short horizontal supporting element or short supporting flange 132f. The bracket 168f is positioned in an upside down L-shaped configuration. The vertical connecting leg 128f consists of a long flat planar plate member having a inwards facing back surface 140f and an oppositely positioned outwards facing front surface 131f. The vertical connecting leg 128f is provided with a series of through holes the lower through bolt hole 138s and the upper through bolt hole 138t that are through the connecting leg 128f outwards front facing surface 131f through the oppositely positioned inwards back facing surface 140f. The through holes the lower through bolt hole 138s and the upper through bolt hole 138t are arranged in a single row linearly arranged longitudinally and latitudinally aligned through the long connecting leg 128f.

The horizontal supporting flange 132f of bracket 168f is also comprised of a short generally planar plate having an upwards facing top surface 132f and an oppositely positioned downwards facing bottom surface 125f.

The bracket 168f vertical connecting leg 128f and horizontal supporting flange 132f together define an L-shaped bracket. The L-shaped bracket is provided with an outer corner edge 124f, the upwards facing top surface 126f of the horizontal supporting flange 132f is in abutting relation with the inwards facing back surface 140f of the vertical connecting leg 128f and the inner corner 123f is in direct abutting relation to the downwards facing surface 125f of the horizontal supporting flange 132f supported by the vertical connecting leg 128f outwards facing front surface 131f. As described below in more detail in FIG. 34 bracket 168f specifications and illustrated depictions in FIGS. 19 and 20, whereby the bolting connecting techniques and installation practices of the sixth method of new construction embodiment using the bracket 168f, bracket 142c, bracket 148d and joining plate 170b are explained in detail on the sixth method of new construction.

As outlined in FIG. 2 the bracket 142c is comprised of a vertical connecting element or connecting leg 128c and a horizontal supporting and connecting element or supporting flange 127c. The bracket 142c is positioned in an upside down reversed L-shaped configuration. The bracket 142c vertical connecting leg 128c consists of a flat planar plate member having a inwards facing back surface 140c and an oppositely positioned outwards front surface 131c. The bracket 142c connecting flange 127c consists of a flat planar plate member having a upwards facing top surface 141c and an oppositely positioned downwards facing bottom surface 147c. The vertical connecting leg 128c height is equal to the horizontal supporting flange 127c length. As described below in more detail in FIG. 30 bracket 142c specifications.

The vertical connecting leg 128c of bracket 142c is provided with a series of through holes the lower through bolt hole 138cc and the upper through bolt hole 138dc that are through the connecting leg 128c outwards front facing surface 131c through the oppositely positioned inwards back facing surface 140c. The through holes the lower through bolt hole 138cc and the upper through bolt hole 138dc are arranged in a single row linearly arranged longitudinally and latitudinally aligned through the connecting leg 128c.

The connecting elements of the horizontal supporting flange 127c of bracket 142c is provided with a downward facing bottom surface 147c is provided with a series of through holes the front through bolt hole 138h and the rear through bolt hole 138g through the oppositely positioned upwards facing top surface 141c the supporting element. The through holes the front through bolt hole 138h and the rear through bolt hole 138g are arranged in a single row linearly arranged latitudinally and aligned longitudinally through the horizontal supporting flange 127c. As described below in more detailed specifications and illustrated depictions in FIGS. 19 and 20, whereby the bolting connecting techniques and installation practices of the sixth method of new construction embodiment using the bracket 168f, bracket 142c, bracket 148d and joining plate 170b are explained in detail.

The bracket 142c vertical connecting leg 128c and horizontal supporting flange 127c together define an L-shaped bracket. The L-shaped bracket is provided with an outer corner edge 124c, the upwards facing top surface 141c of the horizontal supporting flange 127c is in abutting relation with the inwards facing back surface 140c of the vertical connecting leg 128c and the inner corner 123c is in direct abutting relation to the downwards facing surface 147c of the horizontal supporting flange 127c supported by the vertical connecting leg 128c outwards facing front surface 131c. As described below in more detail in FIG. 30 bracket 142c specifications.

The bracket 148d is comprised of a vertical connecting element or connecting leg 128d and a horizontal connecting element or securing flange 127d. The bracket 148d is positioned in an reversed L-shaped configuration. The bracket 148d connecting leg 128d consists of a flat planar plate member having a inwards facing back surface 140d and an oppositely positioned outwards front surface 131d. The bracket 148d securing flange 127d consists of a flat planar plate member having a upwards facing top surface 147d and an oppositely positioned downwards facing bottom surface 141d. The connecting leg 128d height is equal to the connecting flange 127d length. As described below in more detail in FIG. 31 bracket 148d specifications.

The connecting leg 128d of bracket 148d is provided with a series of through holes the lower through bolt hole 138k and the upper through bolt hole 138l that are through the connecting leg 128d outwards front facing surface 131d through the oppositely positioned inwards back facing surface 140d. The through holes the lower through bolt hole 138k and the upper through bolt hole 138l are arranged in a single row linearly arranged longitudinally and latitudinally aligned through the connecting leg 128d.

The connecting flange 127d of bracket 148d is provided with a downward facing bottom surface 141d is provided with a series of through holes the front through bolt hole 138i and the rear through bolt hole 138j through the oppositely positioned upwards facing top surface 147d detailing the supporting and securing element. As described below in more detailed specifications and illustrated depictions in FIGS. 19 and 20, whereby the bolting connecting techniques and installation practices of the sixth method of new construction embodiment using bracket 130, bracket 142c, bracket 148d and joining plate 170b are explained in detail on the sixth method of new construction. The through holes the front through bolt hole 138i and the rear through bolt hole 138j are arranged in a single row linearly arranged latitudinally and aligned longitudinally through the horizontal supporting flange 127d.

The bracket 148d connecting leg 128d and supporting flange 127d together define an L-shaped bracket. The L-shaped bracket is provided with an inner corner 123d, the upwards facing top surface 147d of the supporting flange 127d is in abutting relation with the outwards facing front surface 131d of the connecting leg 128d and the outer corner edge 124d is in direct abutting relation to the downwards facing surface 141d of the supporting flange 127d supporting the connecting leg 128d inwards facing back surface 140d. As described below in more detail in FIG. 31 bracket 148d specifications.

The joining plate 170b is comprised of a vertical connecting element or flat planar plate 169b comprised of a outwards front facing surface 171b and an oppositely positioned inwards facing back surface 172b. The planer plate 169b is provided with a series of through holes 138 the lower through bolt hole 138eb and the upper through bolt hole 138fb that are arranged in a single row linearly arranged longitudinally and latitudinally aligned through the joining plate 170b. As described below in more detail in FIG. 36 joining plate 170b specifications and described below in more detailed specifications and illustrated depictions in FIGS. 19 and 20, whereby the bolting connecting techniques and installation practices of the sixth method of new construction embodiment using bracket 130, bracket 142c, bracket 148d and joining plate 170b are explained in detail on the sixth method of new construction.

The outwards facing front surface 131f of bracket 168f long vertical connecting leg 128f lower through bolt hole 138s aligns through to the inwards facing back surface 140a to the inwards facing back surface 140c of bracket 142c vertical connecting leg 128c upper through bolt hole 138dc and out the inwards facing front surface 131c. As described below in more detailed specifications and illustrated depictions in FIGS. 19 and 20, whereby the bolting connecting techniques and installation practices of the sixth method of new construction embodiment using bracket 168f, bracket 142c, bracket 148d and joining plate 170b are explained in detail on the sixth method of new construction.

The downwards facing bottom surface 147c of bracket 142c horizontal support beam connecting element or supporting flange 127c rear through bolt hole 138g aligns through to the upwards facing top surface 141c to the downwards facing bottom surface 141d of bracket 148d horizontal connecting element or flange 127c rear through bolt hole 138j and out the upwards facing top surface 147d. As described below in more detailed specifications and illustrated depictions in FIGS. 19 and 20, whereby the bolting connecting techniques and installation practices of the sixth method of new construction embodiment using bracket 168f, bracket 142c, bracket 148d and joining plate 170b are explained in detail on the sixth method of new construction.

The downwards facing bottom surface 147c of bracket 142c horizontal support beam connecting element or supporting flange 127c front through bolt hole 138h aligns through to the upwards facing top surface 141c to the downwards facing bottom surface 141d of bracket 148d horizontal connecting element or flange 127d front through bolt hole 138i and out the upwards facing top surface 147d. As described below in more detailed specifications and illustrated depictions in FIGS. 19 and 20, whereby the bolting connecting techniques and installation practices of the sixth method of new construction embodiment using bracket 168f, bracket 142c, bracket 148d and joining plate 170b are explained in detail on the sixth method of new construction.

The outwards facing front surface 171b of joining plate 170b flat planar plate 169b lower through bolt hole 138eb aligns through to the inwards facing back surface 172b through the inwards facing back surface 140d of bracket 148d connecting leg 128d lower through bolt hole 138k and out the inwards facing front surface 131d allowing for latitudinal alignment. The outwards facing front surface 171b of joining plate 170b flat planar plate 169b upper through bolt hole 138fb aligns through to the inwards facing back surface 172b through the inwards facing back surface 140d of bracket 148d connecting leg 128d upper through bolt hole 138l and out the inwards facing front surface 131d allowing for latitudinal alignment. As described below in more detailed specifications and illustrated depictions in FIGS. 19 and 20, whereby the bolting connecting techniques and installation practices of the sixth method of new construction embodiment using bracket 168f, bracket 142c, bracket 148d and joining plate 170b are explained in detail on the sixth method of new construction.

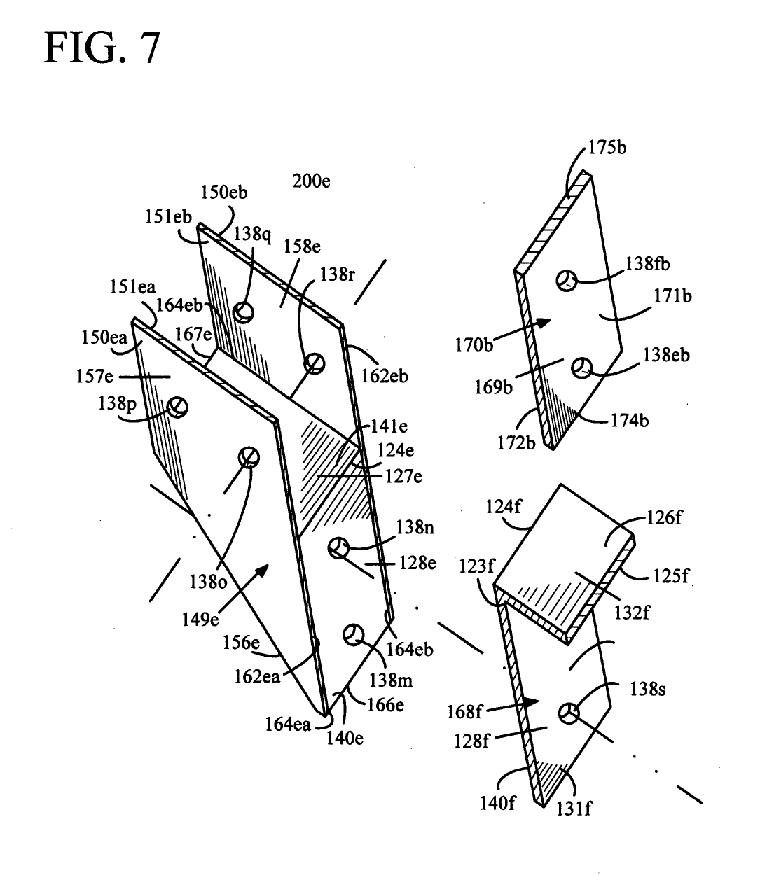

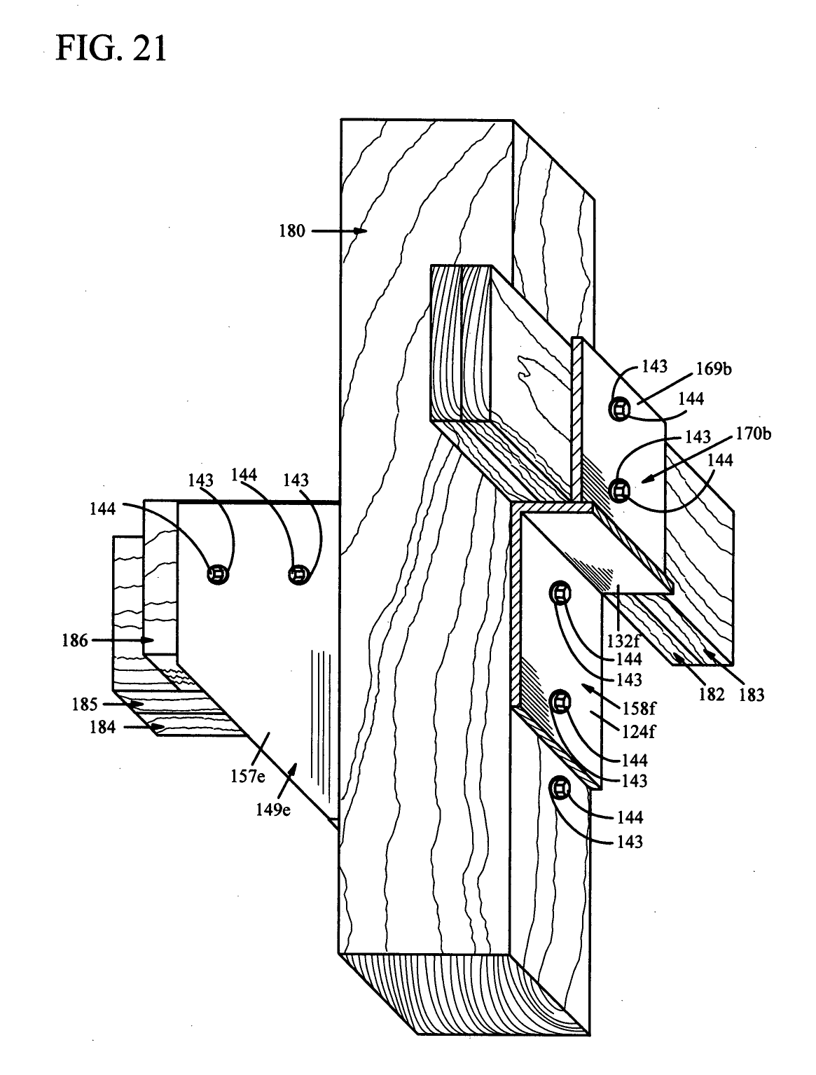

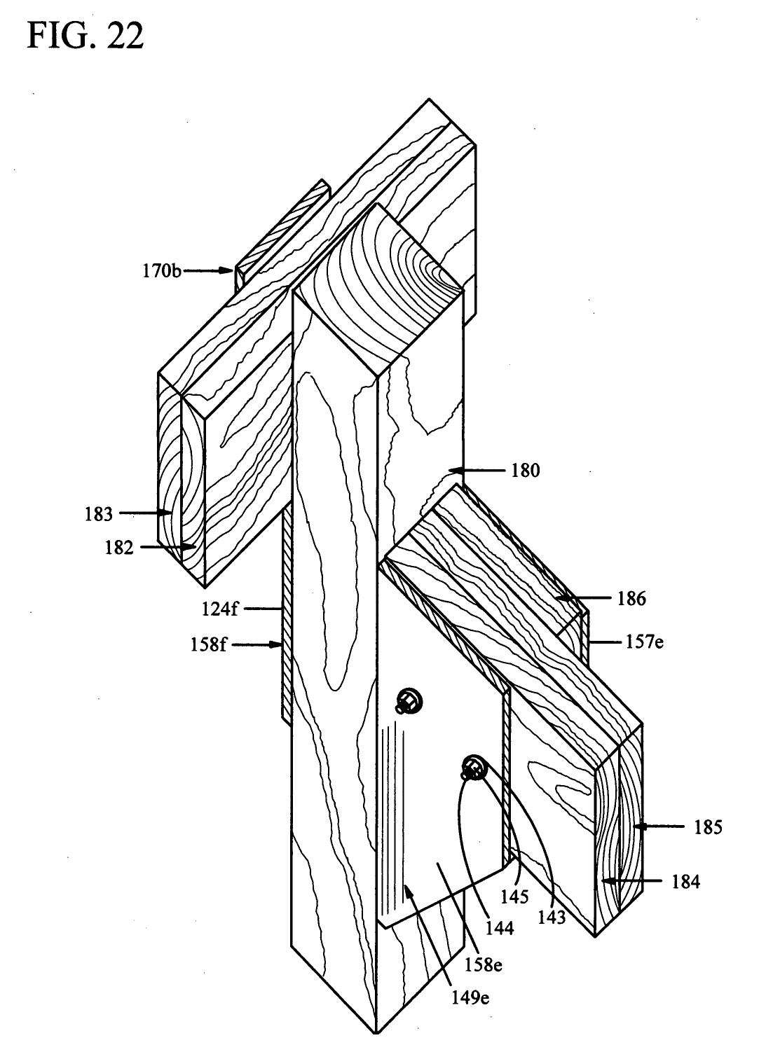

The seventh method of new construction embodiment provides L-shaped brackets and plate fitting, brackets, according to the present invention is illustrated in FIG. 7 allowing for two unequally horizontal planes converging on a single horizontal segmented line plane. As described below in more detail, bracket 168f, bracket 149e, joining plate 170b, bolts connecting technique and practices in FIGS. 21 and 22. As described below in more detail, the eighth fabricated embodiment bracket 168f is adapted to be positioned upside down L-shaped configuration, the seventh fabricated embodiment is bracket 149e which is adapted to be positioned upside down reversed L-shaped configuration and the fifth fabricated embodiment is the joining plate 170b is utilized as a connecting element. As described below in more detailed specifications and illustrated depictions in FIGS. 21 and 22, whereby the bolting connecting techniques and installation practices of the seventh method of new construction embodiment using bracket 168f, bracket 149e and joining plate 170b are explained in detail on the seventh method of new construction.

As outlined in FIG. 5 the bracket 168f is comprised of a long vertical connecting element or connecting leg 128f and a short horizontal supporting element or short supporting flange 132f. The bracket 168f is positioned in an upside down L-shaped configuration. The vertical connecting leg 128f consists of a long flat planar plate member having a inwards facing back surface 140f and an oppositely positioned outwards facing front surface 131f. The vertical connecting leg 128f is provided with a series of through holes the lower through bolt hole 138s and the upper through bolt hole 138t that are through the connecting leg 128f outwards front facing surface 131f through the oppositely positioned inwards back facing surface 140f. The through holes the lower through bolt hole 138s and the upper through bolt hole 138t are arranged in a single row linearly arranged longitudinally and latitudinally aligned through the long connecting leg 128f.

The horizontal supporting flange 132f of bracket 168f is also comprised of a short generally planar plate having an upwards facing top surface 132f and an oppositely positioned downwards facing bottom surface 125f.

The bracket 168f vertical connecting leg 128f and horizontal supporting flange 132f together define an L-shaped bracket. The L-shaped bracket is provided with an outer corner edge 124f, the upwards facing top surface 126f of the horizontal supporting flange 132f is in abutting relation with the inwards facing back surface 140f of the vertical connecting leg 128f and the inner corner 123f is in direct abutting relation to the downwards facing surface 125f of the horizontal supporting flange 132f supported by the vertical connecting leg 128f outwards facing front surface 131f. As described below in more detail in FIG. 34 bracket 168f specifications.

As outlined in FIG. 4 the bracket 149e is comprised of a connecting element or connecting leg 128e, a horizontal supporting element or flange 127e and two interconnecting elements or two connecting trapezoid shaped planer plates 157e and 158e. As described below in more detail in FIGS. 32 and 33 bracket 149e specifications.

The bracket 149e is positioned in an upside down reversed L-shaped configuration. The vertical connecting leg 128e consists of a flat planar plate having a inwards facing back surface 140e and an oppositely positioned outwards facing front surface 131e. The vertical connecting leg 128e of bracket 149e is provided with a series of through holes 138 the lower through bolt hole 138m and the upper through bolt hole 138n that are through the vertical connecting leg 128e outwards front facing surface 140e through to the oppositely positioned inwards back facing surface 131e. The through holes the lower through bolt hole 138m and the upper through bolt hole 138n are arranged in a single row linearly arranged longitudinally and latitudinally aligned through the connecting leg 128e.

The horizontal supporting flange 127e of bracket 149e is also comprised of a generally planar plate having an upwards facing top surface 141e and an oppositely positioned downwards facing bottom surface 147e.

The upwards facing top surface 141e of the flange 127e is in abutting relation with the inwards facing back surface 140e of the connecting leg 128e constitutes the outer corner 124e. The vertical connecting leg 128e and the single horizontal supporting flange 127e together define an L-shaped bracket fitted with two connecting trapezoid shaped planer plates 157e and 158e. As described below in more detail in FIGS. 32 and 33 bracket 149e specifications.

The vertical connecting leg 128e left outer edge 164ea is welded to the long bases 162ea of the trapezoid shaped planer plate 157e inward facing surface 151ea and oppositely positioned right outer edge 164eb of the connecting leg 128e is welded long bases 162eb of the trapezoid shaped planer plate 158e inward facing surfaces 151eb. The horizontal support flange 127e left outer edge 164ea is welded to the short bases 163ea of the trapezoid shaped planer plates 157e inward facing surface 151ea and oppositely positioned right outer edge 164eb of the support flange 127e is welded to the short bases 163eb of the trapezoid shaped planer plate 158e inward facing surface 151eb. The two trapezoid shaped planer plates 157e and 158e are welded to the vertical connecting leg 128e and the horizontal supporting flange 127e form a supported channelized connecting element 200e supported by the flange 127e upwards facing top surface 141e and channeled by the trapezoid shaped planer plate 157e and trapezoid shaped planer plate 158e.

The outwards facing surface 150ea and the oppositely positioned inwards facing surface 151ea of the trapezoid shaped planer plate 158e is provided with a series of through holes the front through hole 138p and the rear through hole 138o. The outwards facing surface 150eb and the oppositely positioned inwards facing surface 151 eb of the connecting trapezoid planer plate 158e provided with a series of through holes the front through hole 138q and the rear through hole 138r. As described below in more detail in FIGS. 32 and 33 bracket 149e specifications.

As outlined in FIG. 2 the joining plate 170b is comprised of a column connecting element or flat planar plate 169b comprised of a outwards front facing surface 171b and an oppositely positioned inwards facing back surface 172b. The planer plate 128b is provided with a series of through holes 138 the lower through bolt hole 138eb and the upper through bolt hole 138fb that are arranged in a single row linearly arranged longitudinally and latitudinally aligned through the joining plate 170b the securing element. As described below in more detail in FIG. 36 joining plate 170b specifications and described below in more detailed specifications and illustrated depictions in FIGS. 21 and 22, whereby the bolting connecting techniques and installation practices of the seventh method of new construction embodiment using bracket 168f, bracket 149e and joining plate 170b are explained in detail on the seventh method of new construction.

As outlined in FIG. 4 the outwards facing front surface 131f of bracket 168f connecting leg 128c lower through bolt hole 138s aligns through to the inwards facing back surface 140f to the inwards facing back surface 140e of bracket 149e connecting leg 128e upper through bolt hole 138n and out the inwards facing front surface 131e. As described below in more detailed specifications and illustrated depictions in FIGS. 21 and 22, whereby the bolting connecting techniques and installation practices of the seventh method of new construction embodiment using bracket 168f, bracket 149e and joining plate 170b are explained in detail on the seventh method of new construction.

As outlined in FIG. 4 the left outward facing surface 150ea of bracket 149e trapezoid shaped planer plate 157e front through hole 138p aligns through to the inward facing surface 15 lea to the inward facing surface 151eb trapezoid shaped planer plate 158e front through hole 138q and out to the right outward facing surface 150eb. The left outward facing surface 150ea of bracket 149e trapezoid shaped planer plate 157e rear through hole 138o aligns through to the inward facing surface 151ea to the inward facing surface 151eb trapezoid shaped planer plate 158e rear through hole 138r and out to the right outward facing surface 150eb. The through holes the front through bolt hole 138p and the front through bolt hole 138q are arranged in a single row linearly arranged latitudinally and latitudinally aligned through both trapezoid shaped planer plate 157e and trapezoid shaped planer plate 158e. As described below in more detailed specifications and illustrated depictions in FIGS. 21 and 22, whereby the bolting connecting techniques and installation practices of the seventh method of new construction embodiment using bracket 168f, bracket 149e and joining plate 170b are explained in detail on the seventh method of new construction.

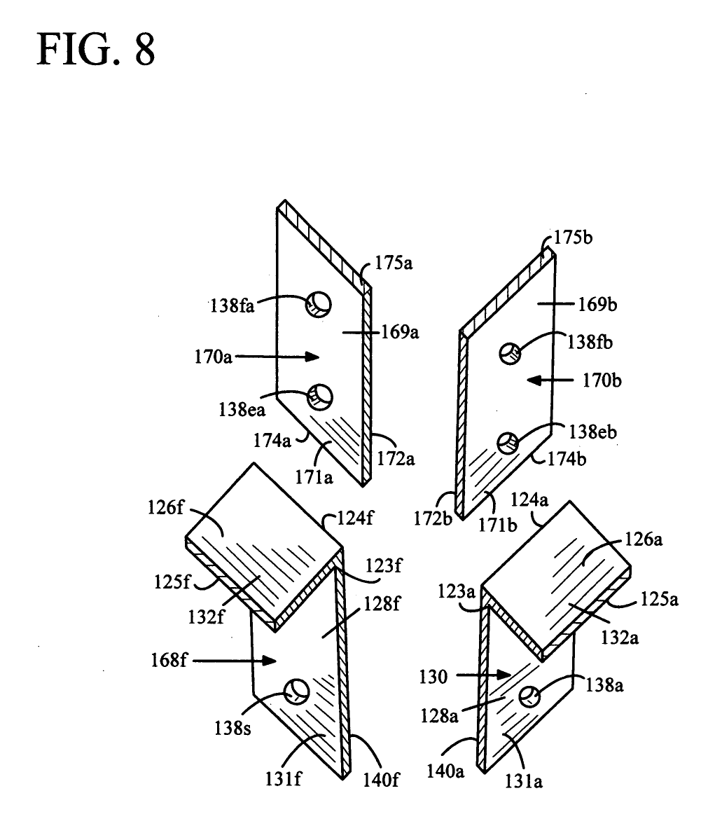

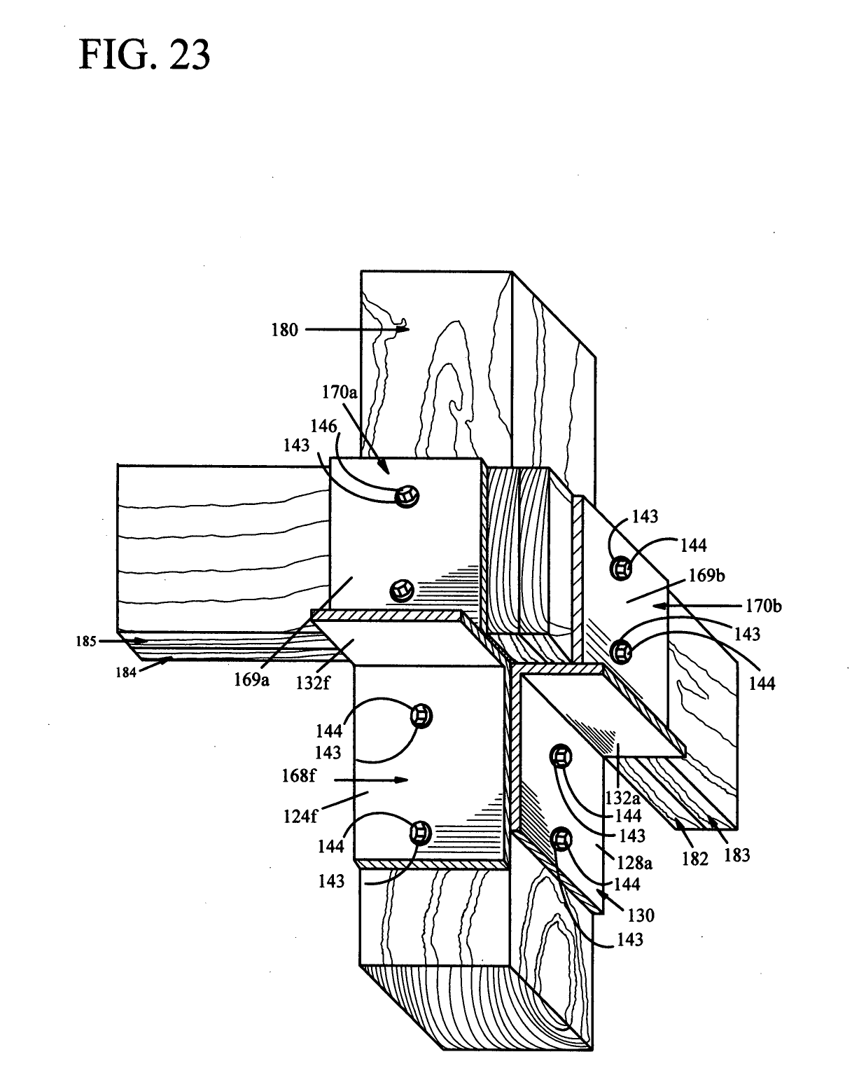

The eight method of new construction embodiment provides a series of L-shaped bracket and plate fittings, according to the present invention is illustrated in FIG. 8 allowing for several equally horizontal planes. As described below in more detail, the first fabricated embodiment is bracket 130 which is adapted to be positioned in an upside down L-shaped configuration to the outwards front face surface of the vertical column 180, the eighth fabricated embodiment is bracket 168f which is adapted to be positioned upside down L-shaped configuration to the outwards side face surface of the vertical column 180, and the third fabricated embodiment is joining plate 170a which is utilized as a securing element of the single horizontal joist 184 or double horizontal joist beam 185 atop the short supporting flange 132f of bracket 168f and the fifth fabricated embodiment is joining plate 170b which is utilized as a securing element of the horizontal single rim joists 182 or the horizontal double rim joist beam 183 atop the short supporting flange 132a of bracket 130. As described below in more detailed specifications and illustrated depictions in FIG. 23, whereby the bolting connecting techniques and installation practices of the eight method of new construction embodiment using bracket 130, bracket 168f, joining plate 170a and joining plate 170b are explained in detail on the eight method of new construction.

As outlined in FIG. 1 the bracket 130 is comprised of a vertical connecting element or connecting leg 128a and a horizontal supporting element or short supporting flange 132a. The bracket 130 is positioned in an upside down L-shaped configuration. The vertical connecting leg 128a consists of a flat planar plate member having a inwards facing back surface 140a and an oppositely positioned outwards facing front surface 131a. The vertical connecting leg 128a is provided with a series of through holes the lower through bolt hole 138a and the upper through bolt hole 138b that are through the connecting leg 128a outwards front facing surface 131a through the oppositely positioned inwards back facing surface 140a. The through holes the lower through bolt hole 138a and the upper through bolt hole 138b are arranged in a single row linearly arranged longitudinally and latitudinally aligned through the connecting leg 128a.

The horizontal supporting flange 132a of bracket 130 is also comprised of a generally planar plate having an upwards facing top surface 132a and an oppositely positioned downwards facing bottom surface 125a.

The bracket 130 vertical connecting leg 128a and horizontal supporting flange 132a together define an L-shaped bracket. The L-shaped bracket is provided with an outer corner edge 124a, the upwards facing top surface 126a of the horizontal supporting flange 132a is in abutting relation with the inwards facing back surface 140a of the vertical connecting leg 128a and the inner corner 123a is in direct abutting relation to the downwards facing surface 125a of the horizontal supporting flange 132a supported by the vertical connecting leg 128a outwards facing front surface 131a. As described below in more detail in FIG. 28 bracket 130 specifications and described below in more detailed specifications and illustrated depictions in FIG. 23 whereby the bolting connecting techniques and installation practices of the eight method of new construction embodiment using bracket 130, bracket 168f, joining plate 170a and joining plate 170b are explained in detail on the eight method of new construction.

As outlined in FIG. 5 the bracket 168f is comprised of a long vertical connecting element or connecting leg 128f and a short horizontal supporting element or short supporting flange 132f. The bracket 168f is positioned in an upside down L-shaped configuration. The vertical connecting leg 128f consists of a long flat planar plate member having a inwards facing back surface 140f and an oppositely positioned outwards facing front surface 131f. The vertical connecting leg 128f is provided with a series of through holes the lower through bolt hole 138s and the upper through bolt hole 138t that are through the connecting leg 128f outwards front facing surface 131f through the oppositely positioned inwards back facing surface 140f. The through holes the lower through bolt hole 138s and the upper through bolt hole 138t are arranged in a single row linearly arranged longitudinally and latitudinally aligned through the long connecting leg 128f.

The horizontal supporting flange 132f of bracket 168f is also comprised of a short generally planar plate having an upwards facing top surface 132f and an oppositely positioned downwards facing bottom surface 125f.

The bracket 168f vertical connecting leg 128f and horizontal supporting flange 132f together define an L-shaped bracket. The L-shaped bracket is provided with an outer corner edge 124f, the upwards facing top surface 126f of the horizontal supporting flange 132f is in abutting relation with the inwards facing back surface 140f of the vertical connecting leg 128f and the inner corner 123f is in direct abutting relation to the downwards facing surface 125f of the horizontal supporting flange 132f supported by the vertical connecting leg 128f outwards facing front surface 131f. As described below in more detail in FIG. 34 bracket 168f specifications and described below in more detailed specifications and illustrated depictions in FIG. 23 whereby the bolting connecting techniques and installation practices of the eight method of new construction embodiment using bracket 130, bracket 168f, joining plate 170a and joining plate 170b are explained in detail on the eight method of new construction.

As outlined in FIG. 1 the joining plate 170a is comprised of a vertical connecting element or flat planar plate 169a comprised of a outwards front facing surface 171a and an oppositely positioned inwards facing back surface 172a. The planer plate 128a is provided with a series of through holes 138 the lower through bolt hole 138ea and the upper through bolt hole 138fa that are arranged in a single row linearly arranged longitudinally and latitudinally aligned through the joining plate 170b the securing element. As described below in more detail in FIG. 35 joining plate 170a specifications and described below in more detailed specifications and illustrated depictions in FIG. 23 whereby the bolting connecting techniques and installation practices of the eight method of new construction embodiment using bracket 130, bracket 168f, joining plate 170a and joining plate 170b are explained in detail on the eight method of new construction.

The joining plate 170b is comprised of a vertical connecting element or flat planar plate 169b comprised of a outwards front facing surface 171b and an oppositely positioned inwards facing back surface 172b. The planer plate 128b is provided with a series of through holes 138 the lower through bolt hole 138eb and the upper through bolt hole 138fb that are arranged in a single row linearly arranged longitudinally and latitudinally aligned through the joining plate 170b the securing element. As described below in more detail in FIG. 36 joining plate 170b specifications and described below in more detailed specifications and illustrated depictions in FIG. 23 whereby the bolting connecting techniques and installation practices of the eight method of new construction embodiment using bracket 130, bracket 168f, joining plate 170a and joining plate 170b are explained in detail.

FIG. 9 and FIG. 10 depicts the first fabricated embodiment bracket 130, second fabricated embodiment bracket 139 and third fabricated embodiment joining plate 170a, the installation practices and bolting connecting techniques of the four affixed interlocking connections comprising of: the four latitudinal locking connections to the structural components such as the vertical column 180, horizontal single rim joists 182 or the horizontal double rim joist beam 183 and horizontal support beam 181 forming the main structural supports of the structure and forming several equally horizontal planes.

As detailed below the bracket 130, bracket 139 and joining plate 170a are particularly advantageous for usage in new construction structures and allowing existing construction practices to be reevaluated on the merit or character of durability to time and especially severe inclement elements forming the first new construction techniques and practices incorporating the bracket 130, bracket 139 and joining plate 170a.

As described hereinbefore in the delineated assembly is in a more detailed illustration in FIG. 1 where the designated components are explained and illustrated on the design principles on the first method of new construction and each of the fabricated embodiments: first fabricated embodiment bracket 130, second fabricated embodiment bracket 139 and third fabricated embodiment joining plate 170a.

The bracket 130 is to be arranged in an upside down “L” shape configuration longitudinally to the vertical column 180, the position of the short supporting flanges 132a upwards top face surface 126a is latitudinally positioned to the downwards bottom face surface of the horizontal single rim joists 182 or the horizontal double rim joists 183 and the connecting legs 128a inwards back face surface 140a is longitudinally positioned to the outwards front face surface of the vertical column 180, together define a L-shaped bracket. The connecting leg 128a of bracket 130 is provided with a longitudinal row of through holes the lower through hole 138a and the upper through hole 138b. The bracket 130 connecting leg 128a height is longer then the supporting flange length.

The bracket 139 is to be arranged in an upside down reversed “L” shape configuration longitudinally to the vertical column 180, the position of the long supporting flanges 127b upwards top face surface 141b is latitudinally positioned to the downwards bottom face surface of the horizontal support beam 181 and the connecting leg 128b inwards back face surface 140b is longitudinally positioned to the inwards back face surface of the vertical column 180, together define a L-shaped bracket. The connecting leg 128b of bracket 139 is provided with a longitudinal row of through holes the lower through hole 138c and the upper through hole 138d. The bracket 139 connecting leg's 128d height is equal to the supporting flange's 127b length.

Once the positioning has been determined on the height's of the horizontal single rim joists 182 or the horizontal double rim joists beam 183 to the vertical columns' 180 outward front face surface and coinciding with the horizontal support beam 181 to the vertical columns' 180 inward back face surface allowing for equally horizontal planes of height of the structure.

The corner edge 124a of brackets 130 inwards back face surface 140a intersects the longitudinal outwards front face surface of the vertical column 180 and the upwards top face surface 126a of the short supporting flange 132a intersects the latitudinal bottom face surface of the horizontal single rim joists 182 or the horizontal double rim joists beam 183.

The inwards back face surface 140a of the connecting leg 128a of bracket 130 is to be positioned to the outwards front face surface of the vertical column 180 coinciding with the heights of the downward bottom face surface of the horizontal single rim joists 182 or the horizontal double rim joists beam 183. The horizontal single rim joists 182 or the horizontal double rim joists beam 183 is to be positioned to the upwards top face surface 126a of the short supporting flange 132a of bracket 130.

The corner edge 124b of bracket 139 coinciding height intersects the inwards back face surface of the vertical column 180 and the upwards top face surface 141b of the long supporting flange 127b intersects the bottom face surface of the horizontal support beam 181.

The inwards back face surface 140b of the connecting leg 128b of bracket 139 is to be positioned to height dimension requirements to the inwards back face surface of the vertical column 180 coinciding with the height of the bottom face surface of the horizontal support beam 181 supported by the long supporting flange 127b upwards top face surface 141b.

The coinciding height's of the horizontal single rim joists 182 or the horizontal double rim joists beam 183 to the horizontal support beam 181 allows for equally horizontal planes' height to the vertical column 180.

The coinciding height's of the short supporting flange 132a upwards top face surface 126a of bracket 130 to the long supporting flange 127b upwards top face surface 141b of bracket 139 insures equally horizontal planes of height.

The coinciding height's of the connecting leg 128a of bracket 130 to the connecting leg 128b of bracket 139 insures equally horizontal planes of alignment of the positioning of the first and second latitudinal aligned through holes drillings through the median of the vertical column 180 to the height dimension requirements.

The first latitudinal aligned through hole consists of a systematic two phase drilling technique to accomplish the first latitudinal aligned drilling through the vertical column 180. The first phase of the drilling technique consists of the lower through bolt hole 138a of the connecting leg 128a of bracket 130 being used as template guides to insure positioning and the alignment of the outward front face surface drilling to the median of the vertical column 180. The second phase of the drilling technique consists of the lower through bolt hole 138c of the connecting leg 128b of bracket 139 being used as template guides to insure positioning and the alignment of the inwards back face surface drilling through the vertical column 180 coinciding with the first phase of the drilling technique establishes first latitudinal aligned through hole in the vertical column 180.

The second latitudinal aligned through hole consists of a systematic two phase drilling technique to accomplish the second latitudinal aligned drilling through the vertical column 180. The first phase of the drilling technique consists of the upper through bolt hole 138b of the connecting leg 128a of bracket 130 being used as template guides to insure positioning and the alignment of the outward front face surface drilling to the median of the vertical column 180. The second phase of the drilling technique consists of the upper through bolt hole 138d of the connecting leg 128b of bracket 139 being used as template guides to insure positioning and the alignment of the inwards back face surface drilling through the vertical column 180 coinciding with the second phase of the drilling technique establishes second latitudinal aligned through hole in the vertical column 180.

The first affixed interlocking is latitudinally consisting of a galvanized washer 143 being affixed to a galvanized through bolts' 144 threads. The threads of the galvanized through bolt 144 are passed through the brackets' 130 connecting leg 128a lower through bolt hole 138a through the pre drilled first latitudinal through hole in the vertical column 180 through the brackets' 139 connecting leg 128b lower through bolt hole 138c where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the first latitudinal affixed connection of the bracket 130 lower through bolt hole 138a through the first latitudinal through hole in the vertical column 180 through the bracket 139 lower through bolt hole 138c.

The second affixed interlocking is latitudinally consisting of a galvanized washer 143 being affixed to a galvanized through bolts' 144 threads. The threads of the galvanized through bolt 144 are passed through the brackets' 130 connecting leg 128a upper through bolt hole 138b through the pre drilled second latitudinal through hole in the vertical column 180 through the brackets' 139 connecting leg 128b upper through bolt hole 138d where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the second latitudinal affixed connection of the bracket 130 upper through bolt hole 138b through the second latitudinal through hole in the vertical column 180 through the bracket 139 upper through bolt hole 138d.

The bracket 130 short supporting flange 132a extends latitudinally outwards of the longitudinal outwards front face surface of the vertical column 180 and the bracket 139 long supporting flange 127b extends latitudinally outwards of the longitudinal inwards back face surface of the vertical column 180. A “T” shape configuration is formed from the horizontal supporting plane of the bracket 130 short supporting flange 132a to the vertical column to the horizontal supporting plane of the 139 long supporting flange 127b allowing for equally latitudinal heights planes to the single longitudinal plane vertically.

Positioned atop the upwards top face surface 126a of the short supporting flange 132a of the bracket 130 latitudinally the downwards bottom face surface of the horizontal single rim joists 182 or the horizontal double rim joists 183 accompanied by the downwards bottom face surface 174a of joining plate 170a having an opposing side the upwards top surface 175a. The joining plate 170a inwards back face surface 172a is to be positioned in front of the outwards front face surface of the horizontal single rim joists 182 or the horizontal double rim joists 183. The joining plate 170a consists of latitudinal connecting elements the lower through bolt hole 138ea and an upper through bolt hole 138fa longitudinally aligned in a row along the median of the planner plate 169a. The width specifications of the joining plate 170a outer edges are to be to the longitudinal width specifications of the vertical column 180 forming the main vertical structural support and the height specification of the joining plate 170a planner plate 169a surface is to be longitudinal height of the horizontal single rim joists 182 or the horizontal double rim joists 183 forming the main horizontal structural supports.

Positioned latitudinally atop the upwards top face surface 141c of the long supporting flange 127c of the bracket 142c is the downwards bottom face surface of the horizontal support beam 181 forming a horizontal structural support member.

The third latitudinal aligned through hole consists of a systematic single phase drilling technique to accomplish the third latitudinal aligned drilling through the horizontal single rim joists 182 or the horizontal double rim joists 183 and vertical column 180. The single phase of the drilling technique consists of the lower through bolt hole 138ea of the planner plate 169a of joining plate 170a being used as a drilling template guide for drilling through the outwards front face surface of the horizontal single rim joists 182 or the horizontal double rim joists 183 through to the opposing side the inwards back face surface through the outwards front face surface median of the vertical column 180 through to the opposing side the inwards back face surface to outwards front face surface of the horizontal support beam 181 establishes third latitudinal aligned through hole in the horizontal single rim joists 182 or the horizontal double rim joists 183 through the vertical column 180 to the horizontal support beam 181.

The fourth latitudinal aligned through hole consists of a systematic single phase drilling technique to accomplish the fourth latitudinal aligned drilling through the horizontal single rim joists 182 or the horizontal double rim joists 183. The single phase of the drilling technique consists of the upper through bolt hole 138fa of the planner plate 169a of joining plate 170a being used as a drilling template guide for drilling through the outwards front face surface of the horizontal single rim joists 182 or the horizontal double rim joists 183 to outwards front face surface of the vertical column 180 establishes fourth latitudinal aligned through hole in the horizontal single rim joists 182 or the horizontal double rim joists 183 to the vertical column 180.

The third affixed interlocking is latitudinally consisting of a galvanized washer 143 being affixed to a galvanized lag bolt 146 threads. The threads of the galvanized lag bolt 146 are allowed passage through the lower through bolt hole 138ea joining plate 170a through the pre drilled third latitudinal through hole in the horizontal single rim joists 182 or horizontal single rim joists beam 183 through the pre drilled third latitudinal through hole in the vertical column's 180 to the horizontal support beams 181 outwards front face surface where the galvanized lag bolt 146 threads are rigidly embedded. Rigidly embedding the galvanized lag bolt's 146 threads forms the third latitudinal affixed connection of the securing the lower through bolt hole 138ea of the joining plate 170a through the third latitudinal through holes horizontal single rim joists 182 or horizontal single rim joists beam 183 and vertical column 180 to the horizontal support beam 181.

The fourth affixed interlocking is latitudinally consisting of a galvanized washer 143 being affixed to a galvanized lag bolt 146 threads. The threads of the galvanized lag bolt 146 are allowed passage through the upper through bolt hole 138fa joining plate 170a through the pre drilled fourth latitudinal through hole in the horizontal single rim joists 182 or horizontal single rim joists beam 183 to the vertical column's 180 outwards front face surface where the galvanized lag bolt 146 threads are rigidly embedded in the vertical column's 180. Rigidly embedding the galvanized lag bolt's 146 threads forms the fourth latitudinal affixed connection of the securing the upper through bolt hole 138fa of the joining plate 170a through the fourth latitudinal through holes in the horizontal single rim joists 182 or horizontal single rim joists beam 183 to the vertical column 180.

The primordial method of using the bracket's 130, 139 and joining plate 170a as templates is advantageous to positioning and drilling the through holes ensuring that the through holes align in the structural components such as the vertical column 180, horizontal single rim joists 182 or the horizontal double rim joist beam 183, and horizontal support beam 181 forming the main structural supports. The interlocking conjugational union of the through holes 144, washer's 143, through bolt hex nuts 145 with the alignment with through holes in bracket 130 and alignment with through holes in bracket 139 to the drilled through holes in the vertical column 180 allows for structural integrity in the supporting of the horizontal single rim joists 182 or the horizontal double rim joist beam 183 and horizontal support beam 181 forming the structure.

The interlocking conjugational union of the lag bolts 146, washers 143 with the alignment with through holes in joining plate 170a to the drilled through holes in the horizontal single rim joists 182 or the horizontal double rim joist beam 183, and vertical column 180 allows for structural integrity in forming the structure.

The primordial method of bracket 130 lower through bolt hole 138a in the connecting leg 128a aligns with bracket 139 lower through bolt hole 138c in the connecting leg 128c and bracket 130 upper through bolt hole 138b in the connecting leg 128a aligns with bracket 139 upper through bolt hole 138d in the connecting leg 128d. Allowing the upwards top face surface of the short supporting flange 132a of bracket 130 to aligned parallel the upwards top face surface of the supporting flange 127b of bracket 139 forming a T shape configuration by the aligning of the flange of 132a of bracket 130 with the flange of 127b of the bracket 139.

The supporting elements the flange 127b supports the horizontal support beam 181 and the supporting elements the flange 132a supports the horizontal single rim joists 182 or the horizontal double rim joist beam 183 allowing the upwards top face surface of the horizontal support beam 181 to align with the upwards top face surface of the horizontal single rim joists 182 or the horizontal double rim joist beam 183 forming the main structural supports would ensure a primary locking connection whereby the horizontal double rim joist beam 183 would support all joist members of the structure.

The primordial method of using bracket 130, bracket 139 and joining plate 170a in FIGS. 9 and 10 is to illustrate the four affixed interlocking consisting of four latitudinal connections in a structure formed of proportional aligned horizontal planes using horizontal support beam 181 as the first horizontal plane and horizontal single rim joists 182 or the horizontal double rim joist beam 183 as second horizontal plane intersecting into a single supporting equally horizontal plane. Thereby, forming the horizontal support beam 181 into an main structural element the horizontal main girder support beam for the floor joist to be supported by the inwards side facing surface of the horizontal support beam 181 or forming the horizontal double rim joist beam 183 into an main structural element the horizontal main girder support beam for the floor joist to be supported by the inwards back facing surface of the horizontal double rim joist beam 183.

The primordial method of joining plate 170a is ensuring an interlocking connection between the horizontal single rim joist 182 or horizontal double rim joist beam 183, the vertical column 180 and the horizontal support beam 181.

The three primary main structural support members the horizontal single rim joist 182 or horizontal double rim joist beam 183, the vertical column 180 and the horizontal support beam 181 with the three primary series of brackets and single plate: the bracket 130, bracket 139 and joining plate 170a are aligned and affixed by means of the through bolts 144, lag bolts 146, washers 143, through bolt hex nuts 145 forming the main structural conjoining elements or interlocking elements of the structure and the first method of new construction practices, bolting techniques, systematic two phase drilling technique, systematic single phase drilling technique and the fabricated embodiments of the invention of bracket 130, bracket 139 and joining plate 170a are disclosed hereinbefore in FIGS. 1, 9 and 10.

FIG. 11 and FIG. 12 depicts the first fabricated embodiment bracket 130, fourth fabricated embodiment bracket 142c and third fabricated embodiment joining plate 170a, the installation practices and bolting connecting techniques of the six affixed interlocking connections comprising of: the four latitudinal locking connections and two longitudinal locking connections to the structural components such as the vertical column 180, horizontal single rim joists 182 or the horizontal double rim joist beam 183 and horizontal support beam 181 forming the main structural supports of the structure and forming several equally horizontal planes.

As detailed below the bracket 130, bracket 142c and joining plate 170a are particularly advantageous for usage in new construction structures and allowing existing construction practices to be reevaluated on the merit or character of durability to time and especially severe inclement elements forming the second new construction techniques and practices incorporating the bracket 130, bracket 142c and joining plate 170a.

As described hereinbefore in the delineated assembly is in a more detailed illustration in FIG. 2 where the designated components are explained and illustrated on the design principles on the second method of new construction and each of the fabricated embodiments: first fabricated embodiment bracket 130, fourth fabricated embodiment bracket 142c and third fabricated embodiment joining plate 170a.

The bracket 130 is to be arranged in an upside down “L” shape configuration longitudinally to the vertical column 180, the position of the short supporting flanges 132a upwards top face surface 126a is latitudinally positioned to the downwards bottom face surface of the horizontal single rim joists 182 or the horizontal double rim joists 183 and the connecting legs 128a inwards back face surface 140a is longitudinally positioned to the outwards front face surface of the vertical column 180, together define a L-shaped bracket. The connecting leg 128a of bracket 130 is provided with a longitudinal row of through holes the lower through hole 138a and the upper through hole 138b. The bracket 130 connecting leg 128a height is longer then the supporting flange length.

The bracket 142c is to be arranged in an upside down reversed “L” shape configuration longitudinally to the vertical column 180, the position of the long supporting flanges 141c upwards top face surface 141c is latitudinally positioned to the downwards bottom face surface of the horizontal support beam 181 and the connecting leg 128c inwards back face surface 140c is longitudinally positioned to the inwards back face surface of the vertical column 180, together define a L-shaped bracket. The connecting leg 128c of bracket 142c is provided with a longitudinal row of through holes the lower through hole 138cc and the upper through hole 138dc. The long supporting flange 127c of bracket 142c is provided with a latitudinal row of through holes the rear through hole 138g and the front through hole 138h. The bracket 142c connecting leg's 128c height is equal to the supporting flange's 127c length.

Once the positioning has been determined on the height's of the horizontal single rim joists 182 or the horizontal double rim joists beam 183 to the vertical columns' 180 outward front face surface and coinciding with the horizontal support beam 181 to the vertical columns' 180 inward back face surface allowing for equally horizontal planes of height of the structure.

The corner edge 124a of brackets 130 inwards back face surface 140a intersects the longitudinal outwards front face surface of the vertical column 180 and the upwards top face surface 126f of the short supporting flange 132a intersects the latitudinal bottom face surface of the horizontal single rim joists 182 or the horizontal double rim joists beam 183. The inwards back face surface 140a of the connecting leg 128a of bracket 130 is to be positioned to the outwards front face surface of the vertical column 180 coinciding with the heights of the downward bottom face surface of the horizontal single rim joists 182 or the horizontal double rim joists beam 183. The horizontal single rim joists 182 or the horizontal double rim joists beam 183 is to be positioned to the upwards top face surface 126a of the short supporting flange 132a of bracket 130.

The corner edge 124c of bracket 142c coinciding height intersects the inwards back face surface of the vertical column 180 and the upwards top face surface 141c of the long supporting flange 127c intersects the bottom face surface of the horizontal support beam 181. The inwards back face surface 140c of the connecting leg 128c of bracket 142c is to be positioned to height dimension requirements to the inwards back face surface of the vertical column 180 coinciding with the height of the bottom face surface of the horizontal support beam 181 supported by the long supporting flange 127c upwards top face surface 141c.

The coinciding height's of the horizontal single rim joists 182 or the horizontal double rim joists beam 183 to the horizontal support beam 181 allows for equally horizontal planes' height to the vertical column 180. The coinciding height's of the short supporting flange 132a upwards top face surface 126a of bracket 130 to the long supporting flange 127c upwards top face surface 141c of bracket 142c insures equally horizontal planes of height. The coinciding height's of the connecting leg 128a of bracket 130 to the connecting leg 128c of bracket 142c insures equally horizontal planes of alignment of the positioning of the first and second latitudinal aligned through holes drillings through the median of the vertical column 180 to the height dimension requirements.

The first latitudinal aligned through hole consists of a systematic two phase drilling technique to accomplish the first latitudinal aligned drilling through the vertical column 180. The first phase of the drilling technique consists of the lower through bolt hole 138a of the connecting leg 128a of bracket 130 being used as template guides to insure positioning and the alignment of the outward front face surface drilling to the median of the vertical column 180. The second phase of the drilling technique consists of the lower through bolt hole 138cc of the connecting leg 128c of bracket 142c being used as template guides to insure positioning and the alignment of the drilling through the inwards back face surface drilling through the vertical column 180 coinciding with the first phase of the drilling technique establishes first latitudinal aligned through hole in the vertical column 180.

The second latitudinal aligned through hole consists of a systematic two phase drilling technique to accomplish the second latitudinal aligned drilling through the vertical column 180. The first phase of the drilling technique consists of the upper through bolt hole 138b of the connecting leg 128a of bracket 130 being used as template guides to insure positioning and the alignment of the outward front face surface drilling to the median of the vertical column 180. The second phase of the drilling technique consists of the upper through bolt hole 138dc of the connecting leg 128c of bracket 142c being used as template guides to insure positioning and the alignment of the drilling through the inwards back face surface drilling through the vertical column 180 coinciding with the second phase of the drilling technique establishes second latitudinal aligned through hole in the vertical column 180.

The first affixed interlocking is latitudinally consisting of a galvanized washer 143 being affixed to a galvanized through bolts' 144 threads. The threads of the galvanized through bolt 144 are passed through the brackets' 130 connecting leg 128a lower through bolt hole 138a through the pre drilled first latitudinal through hole in the vertical column 180 through the brackets' 142c connecting leg 128c lower through bolt hole 138cc where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the first affixed latitudinal connection of the bracket 130 lower through bolt hole 138a through the first latitudinal through hole in the vertical column 180 through the bracket 142c lower through bolt hole 138cc.

The second affixed interlocking is latitudinally consisting of a galvanized washer 143 being affixed to a galvanized through bolts' 144 threads. The threads of the galvanized through bolt 144 are passed through the brackets' 130 connecting leg 128a upper through bolt hole 138b through the pre drilled second latitudinal through hole in the vertical column 180 through the brackets' 142c connecting leg 128c upper through bolt hole 138dc where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the second affixed latitudinal connection of the bracket 130 upper through bolt hole 138b through the second latitudinal through hole in the vertical column 180 through the bracket 142c upper through bolt hole 138dc.

The bracket 130 short supporting flange 132a extends latitudinally outwards of the longitudinal outwards front face surface of the vertical column 180 and the bracket 142c long supporting flange 127c extends latitudinally outwards of the longitudinal inwards back face surface of the vertical column 180. A “T” shape configuration is formed from the horizontal supporting plane of the bracket 130 short supporting flange 132a to the vertical column to the horizontal supporting plane of the 142c long supporting flange 127c allowing for equally latitudinal heights planes to the single longitudinal plane vertically.

Positioned latitudinally atop the upwards top face surface 141c of the long supporting flange 127c of the bracket 142c is the downwards bottom face surface of the horizontal support beam 181 forming a horizontal structural support member.

The first longitudinal aligned through hole consists of a systematic single phase drilling technique to accomplish the first longitudinal aligned drilling through the horizontal support beam 181. The single phase of the drilling technique consists of the rear through bolt hole 138g of the brackets 142c long supporting flange 127c as a drilling template guide for drilling through the downwards bottom face surface of the horizontal support beam 181 through to the opposing side the upwards top establishes first longitudinal aligned through hole in the horizontal support beam 181.

The second longitudinal aligned through hole consists of a systematic single phase drilling technique to accomplish the second longitudinal aligned drilling through the horizontal support beam 181. The single phase of the drilling technique consists of the front through bolt hole 138h of the brackets 142c long supporting flange 127c as a drilling template guide for drilling through the downwards bottom face surface of the horizontal support beam 181 through to the opposing side the upwards top establishes second longitudinal aligned through hole in the horizontal support beam 181.

The third affixed interlocking is longitudinally consisting of a galvanized washer 143 being affixed to a galvanized through bolts' 144 threads. The threads of the galvanized through bolt 144 are passed through the brackets' 142c long supporting flange 127c rear through bolt hole 138g through the pre drilled first longitudinal through hole in the horizontal support beam 181 where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the first affixed longitudinal connection of the bracket 142c rear through bolt hole 138g through the first longitudinal through hole in the horizontal support beam 181.

The fourth affixed interlocking is longitudinally consisting of a galvanized washer 143 being affixed to a galvanized through bolts' 144 threads. The threads of the galvanized through bolt 144 are passed through the brackets' 142c long supporting flange 127c front through bolt hole 138h through the pre drilled second longitudinal through hole in the horizontal support beam 181 where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the second affixed longitudinal connection of the bracket 142c front through bolt hole 138h through the second longitudinal through hole in the horizontal support beam 181.

Positioned atop the upwards top face surface 126a of the short supporting flange 132a of the bracket 130 latitudinally the downwards bottom face surface of the horizontal single rim joists 182 or the horizontal double rim joists 183 accompanied by the downwards bottom face surface 174a of joining plate 170a having an opposing side the upwards top surface 175a. The joining plate 170a inwards back face surface 172a is to be positioned in front of the outwards front face surface of the horizontal single rim joists 182 or the horizontal double rim joists 183. The joining plate 170a consists of latitudinal connecting elements the lower through bolt hole 138ea and an upper through bolt hole 138fa longitudinally aligned in a row along the median of the planner plate 169a. The width specifications of the joining plate 170a outer edges are to be to the longitudinal width specifications of the vertical column 180 forming the main vertical structural support and the height specification of the joining plate 170a planner plate 169a surface is to be longitudinal height of the horizontal single rim joists 182 or the horizontal double rim joists 183 forming the main horizontal structural supports.

The fifth latitudinal aligned through hole consists of a systematic single phase drilling technique to accomplish the third latitudinal aligned drilling through the horizontal single rim joists 182 or the horizontal double rim joists 183 and vertical column 180. The single phase of the drilling technique consists of the lower through bolt hole 138ea of the planner plate 169a of joining plate 170a being used as a drilling template guide for drilling through the outwards front face surface of the horizontal single rim joists 182 or the horizontal double rim joists 183 through to the opposing side the inwards back face surface through the outwards front face surface median of the vertical column 180 establishes third latitudinal aligned through hole in the horizontal single rim joists 182 or the horizontal double rim joists 183 to the vertical column 180.

The sixth latitudinal aligned through hole consists of a systematic single phase drilling technique to accomplish the fourth latitudinal aligned drilling through the horizontal single rim joists 182 or the horizontal double rim joists 183. The single phase of the drilling technique consists of the upper through bolt hole 138fa of the planner plate 169a of joining plate 170a being used as a drilling template guide for drilling through the outwards front face surface of the horizontal single rim joists 182 or the horizontal double rim joists 183 to the outwards front face surface of the vertical column 180 establishes fourth latitudinal aligned through hole in the horizontal single rim joists 182 or the horizontal double rim joists 183 to the vertical column 180.

The fifth affixed interlocking is latitudinally consisting of a galvanized washer 143 being affixed to a galvanized lag bolt 146 threads. The threads of the galvanized lag bolt 146 are allowed passage through the lower through bolt hole 138ea joining plate 170a through the pre drilled third latitudinal through hole in the horizontal single rim joists 182 or horizontal single rim joists beam 183 to the vertical column's 180 outwards front face surface where the galvanized lag bolt 146 threads are rigidly embedded. Rigidly embedding the galvanized lag bolt's 146 threads forms the third latitudinal affixed connection of the securing the lower through bolt hole 138ea of the joining plate 170a through the third latitudinal through holes horizontal single rim joists 182 or horizontal single rim joists beam 183 to the vertical column 180.

The sixth affixed interlocking is latitudinally consisting of a galvanized washer 143 being affixed to a galvanized lag bolt 146 threads. The threads of the galvanized lag bolt 146 are allowed passage through the upper through bolt hole 138fa joining plate 170a through the pre drilled fourth latitudinal through hole in the horizontal single rim joists 182 or horizontal single rim joists beam 183 to the vertical column's 180 outwards front face surface where the galvanized lag bolt 146 threads are rigidly embedded. Rigidly embedding the galvanized lag bolt's 146 threads forms the fourth latitudinal affixed connection of the securing the upper through bolt hole 138fa of the joining plate 170a through the fourth latitudinal through holes horizontal single rim joists 182 or horizontal single rim joists beam 183 to the vertical column 180.

The primordial method of using the bracket's 130, 142c and joining plate 170a as templates is advantageous to positioning and drilling the through holes ensuring that the through holes align in the structural components such as the vertical column 180, horizontal single rim joists 182 or the horizontal double rim joist beam 183, and horizontal support beam 181 forming the main structural supports.

The interlocking conjugational union of the through holes 144, washer's 143, through bolt hex nuts 145 with the alignment with through holes in bracket 130 and alignment with through holes in bracket 142c to the drilled through holes in the vertical column 180 allows for structural integrity in the supporting of the horizontal single rim joists 182 or the horizontal double rim joist beam 183 and horizontal support beam 181 forming the structure.

The interlocking conjugational union of the lag bolts 146, washers 143 with the alignment with through holes in joining plate 170a to the drilled through holes in the horizontal single rim joists 182 or the horizontal double rim joist beam 183, and vertical column 180 allows for structural integrity in forming the structure.

The primordial method of bracket 130 lower through bolt hole 138a in the connecting leg 128a aligns with bracket 142c lower through bolt hole 138cc in the connecting leg 128c and bracket 130 upper through bolt hole 138b in the connecting leg 128a aligns with bracket 142c upper through bolt hole 138dc in the connecting leg 128c. Allowing the upwards top face surface of the short supporting flange 132a of bracket 130 too aligned parallel the upwards top face surface of the supporting flange 127c of bracket 142c forming a T shape configuration by the aligning of the flange of 132a of bracket 130 with the flange of 127c of the bracket 142c.

The supporting elements the flange 127c of bracket 142c supports the horizontal support beam 181 and the supporting elements the flange 132a of bracket 130 supports the horizontal single rim joists 182 or the horizontal double rim joist beam 183 allowing the upwards top face surface of the horizontal support beam 181 to align with the upwards top face surface of the horizontal single rim joists 182 or the horizontal double rim joist beam 183 forming the main structural supports would ensure a primary locking connection whereby the horizontal double rim joist beam 183 would support all joist members of the structure.

The primordial method of using bracket 130, bracket 142c and joining plate 170a in FIGS. 11 and 12 is to illustrate the six affixed interlocking consisting of four latitudinal connections and two longitudinal connections in a structure formed of proportional aligned horizontal planes using horizontal support beam 181 as the first horizontal plane and horizontal single rim joists 182 or the horizontal double rim joist beam 183 as second horizontal plane intersecting into a single supporting equally horizontal plane. Thereby, forming the horizontal support beam 181 into an main structural element the horizontal main girder support beam for the floor joist to be supported by the inwards side facing surface of the horizontal support beam 181 or forming the horizontal double rim joist beam 183 into an main structural element the horizontal main girder support beam for the floor joist to be supported by the inwards back facing surface of the horizontal double rim joist beam 183.

The primordial method of joining plate 170a is ensuring an interlocking connection between the horizontal single rim joist 182 or horizontal double rim joist beam 183, the vertical column 180 and the horizontal support beam 181.

The three primary main structural support members the horizontal single rim joist 182 or horizontal double rim joist beam 183, the vertical column 180 and the horizontal support beam 181 with the three primary series of brackets and single plate: the bracket 130, bracket 142c and joining plate 170a are aligned and affixed by means of the through bolts 144, lag bolts 146, washers 143, through bolt hex nuts 145 forming the main structural conjoining elements or interlocking elements of the structure and the first method of new construction practices, bolting techniques, systematic two phase drilling technique, systematic single phase drilling technique and the fabricated embodiments of the invention of bracket 130, bracket 142c and joining plate 170a are disclosed hereinbefore in FIGS. 2, 11 and 12.

FIG. 13 and FIG. 14 depicts the first fabricated embodiment bracket 130, fourth fabricated embodiment bracket 142c, sixth fabricated embodiment bracket 148d and the third fabricated embodiment joining plate 170a, the installation practices and bolting connecting techniques of the eight affixed interlocking connections comprising of: the six latitudinal locking connections and two longitudinal locking connections to the structural components such as the vertical column 180, horizontal single rim joists 182 or the horizontal double rim joist beam 183 and horizontal support beam 181 forming the main structural supports of the structure and forming several equally horizontal planes.

As detailed below the bracket 130, bracket 142c, bracket 148d and joining plate 170a are particularly advantageous for usage in new construction structures and allowing existing construction practices to be reevaluated on the merit or character of durability to time and especially severe inclement elements forming the third new construction techniques and practices incorporating the bracket 130, bracket 142c, bracket 148d and joining plate 170a.

As described hereinbefore in the delineated assembly is in a more detailed illustration in FIG. 3 where the designated components are explained and illustrated on the design principles on the third method of new construction and each of the fabricated embodiments: first fabricated embodiment bracket 130, fourth fabricated embodiment bracket 142c, sixth fabricated embodiment bracket 148d and the third fabricated embodiment joining plate 170a.

The bracket 130 is to be arranged in an upside down “L” shape configuration longitudinally to the vertical column 180, the position of the short supporting flanges 132a upwards top face surface 126a is latitudinally positioned to the downwards bottom face surface of the horizontal single rim joists 182 or the horizontal double rim joists 183 and the connecting legs 128a inwards back face surface 140a is longitudinally positioned to the outwards front face surface of the vertical column 180, together define a L-shaped bracket. The connecting leg 128a of bracket 130 is provided with a longitudinal row of through holes the lower through hole 138a and the upper through hole 138b. The bracket 130 connecting leg 128a height is longer then the supporting flange length.

The bracket 142c is to be arranged in an upside down reversed “L” shape configuration longitudinally to the vertical column 180, the position of the long supporting flanges 141c upwards top face surface 141c is latitudinally positioned to the downwards bottom face surface of the horizontal support beam 181 and the connecting leg 128c inwards back face surface 140c is longitudinally positioned to the inwards back face surface of the vertical column 180, together define a L-shaped bracket. The connecting leg 128c of bracket 142c is provided with a longitudinal row of through holes the lower through hole 138cc and the upper through hole 138dc. The long supporting flange 127c of bracket 142c is provided with a latitudinal row of through holes the rear through hole 138g and the front through hole 138h. The bracket 142c connecting leg's 128c height is equal to the supporting flange's 127c length.

Once the positioning has been determined on the height's of the horizontal single rim joists 182 or the horizontal double rim joists beam 183 to the vertical columns' 180 outward front face surface and coinciding with the horizontal support beam 181 to the vertical columns' 180 inward back face surface allowing for equally horizontal planes of height of the structure.

The corner edge 124a of brackets 130 inwards back face surface 140a intersects the longitudinal outwards front face surface of the vertical column 180 and the upwards top face surface 126f of the short supporting flange 132a intersects the latitudinal bottom face surface of the horizontal single rim joists 182 or the horizontal double rim joists beam 183. The inwards back face surface 140a of the connecting leg 128a of bracket 130 is to be positioned to the outwards front face surface of the vertical column 180 coinciding with the heights of the downward bottom face surface of the horizontal single rim joists 182 or the horizontal double rim joists beam 183. The horizontal single rim joists 182 or the horizontal double rim joists beam 183 is to be positioned to the upwards top face surface 126a of the short supporting flange 132a of bracket 130.

The corner edge 124c of bracket 142c coinciding height intersects the inwards back face surface of the vertical column 180 and the upwards top face surface 141c of the long supporting flange 127c intersects the bottom face surface of the horizontal support beam 181.

The inwards back face surface 140c of the connecting leg 128c of bracket 142c is to be positioned to height dimension requirements to the inwards back face surface of the vertical column 180 coinciding with the height of the bottom face surface of the horizontal support beam 181 supported by the long supporting flange 127c upwards top face surface 141c. The coinciding height's of the horizontal single rim joists 182 or the horizontal double rim joists beam 183 to the horizontal support beam 181 allows for equally horizontal planes' height to the vertical column 180. The coinciding height's of the short supporting flange 132a upwards top face surface 126a of bracket 130 to the long supporting flange 127c upwards top face surface 141c of bracket 142c insures equally horizontal planes of height. The coinciding height's of the connecting leg 128a of bracket 130 to the connecting leg 128c of bracket 142c insures equally horizontal planes of alignment of the positioning of the first and second latitudinal aligned through holes drillings through the median of the vertical column 180 to the height dimension requirements.

The first latitudinal aligned through hole consists of a systematic two phase drilling technique to accomplish the first latitudinal aligned drilling through the vertical column 180. The first phase of the drilling technique consists of the lower through bolt hole 138a of the connecting leg 128a of bracket 130 being used as template guides to insure positioning and the alignment of the outward front face surface drilling to the median of the vertical column 180. The second phase of the drilling technique consists of the lower through bolt hole 138cc of the connecting leg 128c of bracket 142c being used as template guides to insure positioning and the alignment of the drilling through the inwards back face surface drilling through the vertical column 180 coinciding with the first phase of the drilling technique establishes first latitudinal aligned through hole in the vertical column 180.

The second latitudinal aligned through hole consists of a systematic two phase drilling technique to accomplish the second latitudinal aligned drilling through the vertical column 180. The first phase of the drilling technique consists of the upper through bolt hole 138b of the connecting leg 128a of bracket 130 being used as template guides to insure positioning and the alignment of the outward front face surface drilling to the median of the vertical column 180. The second phase of the drilling technique consists of the upper through bolt hole 138dc of the connecting leg 128c of bracket 142c being used as template guides to insure positioning and the alignment of the drilling through the inwards back face surface drilling through the vertical column 180 coinciding with the second phase of the drilling technique establishes second latitudinal aligned through hole in the vertical column 180.

The first affixed interlocking is latitudinally consisting of a galvanized washer 143 being affixed to a galvanized through bolts' 144 threads. The threads of the galvanized through bolt 144 are passed through the brackets' 130 connecting leg 128a lower through bolt hole 138a through the pre drilled first latitudinal through hole in the vertical column 180 through the brackets' 142c connecting leg 128c lower through bolt hole 138cc where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the first latitudinal affixed connection of the bracket 130 lower through bolt hole 138a through the first latitudinal through hole in the vertical column 180 through the bracket 142c lower through bolt hole 138cc.

The second affixed interlocking is latitudinally consisting of a galvanized washer 143 being affixed to a galvanized through bolts' 144 threads. The threads of the galvanized through bolt 144 are passed through the brackets' 130 connecting leg 128a upper through bolt hole 138b through the pre drilled second latitudinal through hole in the vertical column 180 through the brackets' 142c connecting leg 128c upper through bolt hole 138dc where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the second latitudinal affixed connection of the bracket 130 upper through bolt hole 138b through the second latitudinal through hole in the vertical column 180 through the bracket 142c upper through bolt hole 138dc.

The bracket 130 short supporting flange 132a extends latitudinally outwards of the longitudinal outwards front face surface of the vertical column 180 and the bracket 142c long supporting flange 127c extends latitudinally outwards of the longitudinal inwards back face surface of the vertical column 180. A “T” shape configuration is formed from the horizontal supporting plane of the bracket 130 short supporting flange 132a to the vertical column to the horizontal supporting plane of the 142c long supporting flange 127c allowing for equally latitudinal heights planes to the single longitudinal plane vertically.

Positioned latitudinally atop the upwards top face surface 141c of the long supporting flange 127c of the bracket 142c is the downwards bottom face surface of the horizontal support beam 181 forming a horizontal structural support member.

Bracket 148d is to be arranged in a reversed “L” shape, positioning the connecting leg 128d inwards back face surface 140d longitudinally to the inwards back face surface vertical column 180 and the long flange 127d downwards bottom face surface 141d is positioned to the upward top face surface of the horizontal support beam 181 forming a main structural support. The position of the long flange 127d upwards top face surface 141c of bracket 142c conforms to a connecting element connecting the upwards top face surface median of the horizontal support beam 181 through to the opposing side the downwards bottom face surface. The bracket 148d long supporting flange 127d connecting elements consist of a row of latitudinal through holes the front through bolt hole 138i and the rear through bolt hole 138j arranged in the median in the long flange 127d through upwards top face surface 141d through to downwards bottom face surface 147d the allowing for an affixed interlocking longitudinally of the upwards top face surface of the horizontal support beam 181 is positioned atop the upwards top face surface 141c of the long supporting flange 127c of bracket 142c. The connecting leg 128d of bracket 148d is provided with a longitudinal row of through holes the lower through hole 138k and the upper through hole 138l. The connecting leg 128d of bracket 148d is provided with a longitudinal row of through holes the lower through hole 138k and the upper through hole 138l and the long flange 127d is provided with a latitudinal row of through holes the front through hole 138i and the rear through hole 138j. The connecting leg 128d and long flange 127d of bracket 148d have aligned through holes and the connecting leg 128d height is equal to the long flange 127d length.

The corner edge 124d of bracket 148d coinciding height intersects the inwards back face surface of the vertical column 180 forming the main vertical structural support and the bottom face surface of the horizontal support beam 181. The inwards back face surface 140d of the connecting leg 128d of bracket 148d is to be positioned atop the upwards top face surface of the horizontal support beam 181 coinciding with the inwards back face surface of the vertical column 180.

The first longitudinal aligned through hole consists of a systematic two phase drilling technique to accomplish the first longitudinal aligned drilling through the horizontal support beam 181. The first phase of the drilling technique consists of the rear through bolt hole 138g of the brackets 142c long supporting flange 127c as a drilling template guide for drilling through the downwards bottom face surface to the median of the horizontal support beam 181. The second phase of the drilling technique consists of the rear through bolt hole 138j of the brackets 148d long supporting flange 127d being used as template guides to insure positioning and the alignment of the drilling through the upwards top face surface of the horizontal support beam 181 coinciding with the first phase of the drilling technique establishes first longitudinal aligned through hole in the horizontal support beam 181.

The second longitudinal aligned through hole consists of a systematic two phase drilling technique to accomplish the second longitudinal aligned drilling through the horizontal support beam 181. The first phase of the drilling technique consists of the front through bolt hole 138h of the brackets 142c long supporting flange 127c as a drilling template guide for drilling through the downwards bottom face surface to the median of the horizontal support beam 181. The second phase of the drilling technique consists of the front through bolt hole 138i of the brackets 148d long supporting flange 127d being used as template guides to insure positioning and the alignment of the drilling through the upwards top face surface of the horizontal support beam 181 coinciding with the first phase of the drilling technique establishes second longitudinal aligned through hole in the horizontal support beam 181.

The third affixed interlocking is longitudinally consisting of a galvanized washer 143 being affixed to a galvanized through bolts' 144 threads. The threads of the galvanized through bolt 144 are passed through the brackets' 142c long supporting flange 127c rear through bolt hole 138g through the pre drilled first longitudinal through hole in the horizontal support beam 181 passing through brackets' 148d long supporting flange 127d rear through bolt hole 138j where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the first longitudinal affixed connection of the bracket 142c rear through bolt hole 138g through the first longitudinal through hole in the horizontal support beam 181 through the bracket 148d rear through bolt hole 138j.

The fourth affixed interlocking is longitudinally consisting of a galvanized washer 143 being affixed to a galvanized through bolts' 144 threads. The threads of the galvanized through bolt 144 are passed through the brackets' 142c long supporting flange 127c front through bolt hole 138h through the pre drilled second longitudinal through hole in the horizontal support beam 181 passing through brackets' 148d long supporting flange 127d front through bolt hole 138i where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the second longitudinal affixed connection of the bracket 142c front through bolt hole 138h through the second longitudinal through hole in the horizontal support beam through 181 bracket 148d front through bolt hole 138i.

The third latitudinal aligned through hole consists of a systematic single phase drilling technique to accomplish the third latitudinal aligned drilling through the vertical column 180. The single phase of the drilling technique consists of the lower through bolt hole 138k of the connecting leg 128d of bracket 148d being used as template guides to insure positioning and the alignment of the drilling through the inwards back face surface drilling through the vertical column 180 through to the opposing side the outwards front face surface establishes third latitudinal aligned through hole in the vertical column 180.

The fourth latitudinal aligned through hole consists of a systematic single phase drilling technique to accomplish the fourth latitudinal aligned drilling through the vertical column 180. The first phase of the drilling technique consists of the upper through bolt hole 138l of the connecting leg 128d of bracket 148d being used as template guides to insure positioning and the alignment of the drilling through the inwards back face surface drilling through the vertical column 180 through to the opposing side the outwards front face surface establishes fourth latitudinal aligned through hole in the vertical column 180.

The fifth affixed interlocking is latitudinally consisting of a galvanized washer 143 being affixed to a galvanized through bolts' 144 threads. The threads of the galvanized through bolt 144 are passed through the brackets' 148d connecting leg 128d lower through bolt hole 138k through the pre drilled third latitudinal through hole in the vertical column 180 where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the fifth latitudinal affixed connection of the bracket 148d lower through bolt hole 138k through the third latitudinal through hole in the vertical column 180.

The sixth affixed interlocking is latitudinally consisting of a galvanized washer 143 being affixed to a galvanized through bolts' 144 threads. The threads of the galvanized through bolt 144 are passed through the brackets' 148d connecting leg 128d upper through bolt hole 138l through the pre drilled fourth latitudinal through hole in the vertical column 180 where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the sixth latitudinal affixed connection of the bracket 148d upper through bolt hole 138l through the fourth latitudinal through hole in the vertical column 180.

Positioned atop the upwards top face surface 126a of the short supporting flange 132a of the bracket 130 latitudinally the downwards bottom face surface of the horizontal single rim joists 182 or the horizontal double rim joists 183 accompanied by the downwards bottom face surface 174a of joining plate 170a having an opposing side the upwards top surface 175a. The joining plate 170a inwards back face surface 172a is to be positioned in front of the outwards front face surface of the horizontal single rim joists 182 or the horizontal double rim joists 183.

The joining plate 170a consists of latitudinal connecting elements the lower through bolt hole 138ea and an upper through bolt hole 138fa longitudinally aligned in a row along the median of the planner plate 169a. The width specifications of the joining plate 170a outer edges are to be to the longitudinal width specifications of the vertical column 180 forming the main vertical structural support and the height specification of the joining plate 170a planner plate 169a surface is to be longitudinal height of the horizontal single rim joists 182 or the horizontal double rim joists 183 forming the main horizontal structural supports.

The fifth latitudinal aligned through hole consists of a systematic single phase drilling technique to accomplish the third latitudinal aligned drilling through the horizontal single rim joists 182 or the horizontal double rim joists 183 and vertical column 180. The single phase of the drilling technique consists of the lower through bolt hole 138ea of the planner plate 169a of joining plate 170a being used as a drilling template guide for drilling through the outwards front face surface of the horizontal single rim joists 182 or the horizontal double rim joists 183 through to the opposing side the inwards back face surface through the outwards front face surface of the vertical column 180 establishes fifth latitudinal aligned through hole in the horizontal single rim joists 182 or the horizontal double rim joists 183 to the vertical column 180.

The sixth latitudinal aligned through hole consists of a systematic single phase drilling technique to accomplish the sixth latitudinal aligned drilling through the horizontal single rim joists 182 or the horizontal double rim joists 183. The single phase of the drilling technique consists of the upper through bolt hole 138fa of the planner plate 169a of joining plate 170a being used as a drilling template guide for drilling through the outwards front face surface of the horizontal single rim joists 182 or the horizontal double rim joists 183 to the outwards front face surface of the vertical column 180 establishes sixth latitudinal aligned through hole in the horizontal single rim joists 182 or the horizontal double rim joists 183 to the vertical column 180.

The seventh affixed interlocking is latitudinally consisting of a galvanized washer 143 being affixed to a galvanized lag bolt 146 threads. The threads of the galvanized lag bolt 146 are allowed passage through the lower through bolt hole 138ea joining plate 170a through the pre drilled fifth latitudinal through hole in the horizontal single rim joists 182 or horizontal single rim joists beam 183 to the vertical column's 180 outwards front face surface where the galvanized lag bolt 146 threads are rigidly embedded. Rigidly embedding the galvanized lag bolt's 146 threads forms the seventh latitudinal affixed connection of the securing the lower through bolt hole 138ea of the joining plate 170a through the fifth latitudinal through holes horizontal single rim joists 182 or horizontal single rim joists beam 183 to the vertical column 180.

The eight affixed interlocking is latitudinally consisting of a galvanized washer 143 being affixed to a galvanized lag bolt 146 threads. The threads of the galvanized lag bolt 146 are allowed passage through the upper through bolt hole 138fa joining plate 170a through the pre drilled sixth latitudinal through hole in the horizontal single rim joists 182 or horizontal single rim joists beam 183 to the vertical column's 180 outwards front face surface where the galvanized lag bolt 146 threads are rigidly embedded. Rigidly embedding the galvanized lag bolt's 146 threads forms the eight latitudinal affixed connection of the securing the upper through bolt hole 138fa of the joining plate 170a through the sixth latitudinal through holes horizontal single rim joists 182 or horizontal single rim joists beam 183 to the vertical column 180.

The primordial method of bracket 130 lower through bolt hole 138a in the connecting leg 128a aligns with bracket 142c lower through bolt hole 138cc in the connecting leg 128c and bracket 130 upper through bolt hole 138b in the connecting leg 128a aligns with bracket 142c upper through bolt hole 138dc in the connecting leg 128c. Allowing the upwards top face surface of the short supporting flange 132a of bracket 130 too aligned parallel the upwards top face surface of the supporting flange 127c of bracket 142c forming a T shape configuration by the aligning of the flange of 132a of bracket 130 with the flange of 127c of the bracket 142c. The supporting elements the flange's 132a of bracket 130 and 127c of bracket 142c support the horizontal support beam 181, horizontal single rim joists 182 or the horizontal double rim joist beam 183 allowing the upwards top face surface of the horizontal support beam 181 to align with the upwards top face surface of the horizontal single rim joists 182 or the horizontal double rim joist beam 183 forming the main structural supports would ensure a primary locking connection whereby the horizontal double rim joist beam 183 would support all joist members of the structure.

The primordial method of using bracket 130, bracket 142c, bracket 148d and joining plate 170a in FIGS. 13 and 14 is to illustrate the eight affixed interlocking consisting of six latitudinal connections and two longitudinal connections in a structure formed of proportional aligned horizontal planes using horizontal support beam 181 as the first horizontal plane and horizontal single rim joists 182 or the horizontal double rim joist beam 183 as second horizontal plane intersecting into a single supporting equally horizontal plane. Thereby, forming the horizontal support beam 181 into an main structural element the horizontal main girder support beam for the floor joist to be supported by the inwards side facing surface of the horizontal support beam 181 or forming the horizontal double rim joist beam 183 into an main structural element the horizontal main girder support beam for the floor joist to be supported by the inwards back facing surface of the horizontal double rim joist beam 183.

The primordial method of joining plate 170a is ensuring an interlocking connection between the horizontal single rim joist 182 or horizontal double rim joist beam 183 and the vertical column 180.

The primordial method of bracket 148d long flange 127d is to ensure an interlocking connection between the horizontal support beam 181 and bracket 142c long supporting flange 127c. The primordial method of bracket 148d connecting leg 128d is to ensure an interlocking connection between the vertical column 180.

The three primary main structural support members the horizontal single rim joist 182 or horizontal double rim joist beam 183, the vertical column 180 and the horizontal support beam 181 with the three primary series of brackets and single plate: the bracket 130, bracket 142c, bracket 148d and joining plate 170a are aligned and affixed by means of the through bolts 144, lag bolts 146, washers 143, through bolt hex nuts 145 forming the main structural conjoining elements or interlocking elements of the structure and the third method of new construction practices, bolting techniques, systematic two phase drilling technique, systematic single phase drilling technique and the fabricated embodiments of the invention of bracket 130, bracket 142c, bracket 148d and joining plate 170a are disclosed hereinbefore in FIGS. 3, 13 and 14.

FIG. 15 and FIG. 16 depicts the first fabricated embodiment bracket 130, seventh fabricated embodiment is bracket 149e is positioned upside down reversed L-shaped configuration with the welded trapezoid shaped planer plate components and the tenth fabricated embodiment is joining plate 170d, the installation practices and bolting connecting techniques of the eight affixed interlocking connections comprising of: the six main latitudinal locking connections and six secondary latitudinal locking connections to the structural components such as the vertical column 180, horizontal single rim joists 182 or the horizontal double rim joist beam 183, single horizontal joist 184 or double horizontal joist beam 185 and companion spacer blocks 186 forming the main structural supports of the structure and forming several equally horizontal planes.

As detailed below the bracket 130, bracket 149e and joining plate 170d are particularly advantageous for usage in new construction structures and allowing existing construction practices to be reevaluated on the merit or character of durability to time and especially severe inclement elements forming the third new construction techniques and practices incorporating the bracket 130, bracket 149e and joining plate 170d.

As described hereinbefore in the delineated assembly is in a more detailed illustration in FIG. 3 where the designated components are explained and illustrated on the design principles on the fourth method of new construction and each of the fabricated embodiments: first fabricated embodiment bracket 130, seventh fabricated embodiment bracket 149e and the tenth fabricated embodiment joining plate 170d.

The bracket 130 is to be arranged in an upside down “L” shape configuration longitudinally to the vertical column 180, the position of the short supporting flanges 132a upwards top face surface 126a is latitudinally positioned to the downwards bottom face surface of the horizontal single rim joists 182 or the horizontal double rim joists 183 and the connecting legs 128a inwards back face surface 140a is longitudinally positioned to the outwards front face surface of the vertical column 180, together define a L-shaped bracket. The connecting leg 128a of bracket 130 is provided with a longitudinal row of through holes the lower through hole 138a and the upper through hole 138b. The bracket 130 connecting leg 128a height is longer then the supporting flange length.

The bracket 149e is to be arranged in an upside down reversed “L” shape configuration longitudinally to the vertical column 180, the position of the long supporting flanges 127e upwards top face surface 141b is latitudinally positioned to the downwards bottom face surface of the and horizontal support beam 181 and the connecting leg 128e inwards back face surface 140e is longitudinally positioned to the inwards back face surface of the vertical column 180, together define a L-shaped bracket. The connecting leg 128e of bracket 149e is provided with a longitudinal row of through holes the lower through hole 138m and the upper through hole 138n. The bracket 149e connecting leg's 128e height is equal to the supporting flange's 127e length which are welded to two interconnecting elements or two connecting trapezoid shaped planer plates 157e and 158e forming the channel 200e. As described below in more detail in FIGS. 32 and 33 bracket 149e specifications.

The inwards back face surface 140e of the connecting leg 128e of bracket 149e is to be positioned to height dimension requirements to the inwards back face surface of the vertical column 180 coinciding with the height of the bottom face surface of the horizontal support beam 181 supported by the long supporting flange 127e upwards top face surface 141c. The coinciding height's of the horizontal single rim joists 182 or the horizontal double rim joists beam 183 to the horizontal support beam 181 allows for equally horizontal planes' height to the vertical column 180. The coinciding height's of the short supporting flange 132a upwards top face surface 126a of bracket 130 to the long supporting flange 127e upwards top face surface 141e of bracket 149e insures equally horizontal planes of height. The coinciding height's of the connecting leg 128a of bracket 130 to the connecting leg 128e of bracket 149e insures equally horizontal planes of alignment of the positioning of the first and second latitudinal aligned through holes drillings through the median of the vertical column 180 to the height dimension requirements.

The first latitudinal aligned through hole consists of a systematic two phase drilling technique to accomplish the first latitudinal aligned drilling through the vertical column 180. The first phase of the drilling technique consists of the lower through bolt hole 138a of the connecting leg 128a of bracket 130 being used as template guides to insure positioning and the alignment of the outward front face surface drilling to the median of the vertical column 180. The second phase of the drilling technique consists of the lower through bolt hole 138m of the connecting leg 128e of bracket 149e being used as template guides to insure positioning and the alignment of the drilling through the inwards back face surface drilling through the vertical column 180 coinciding with the first phase of the drilling technique establishes first latitudinal aligned through hole in the vertical column 180.

The second latitudinal aligned through hole consists of a systematic two phase drilling technique to accomplish the second latitudinal aligned drilling through the vertical column 180. The first phase of the drilling technique consists of the upper through bolt hole 138b of the connecting leg 128a of bracket 130 being used as template guides to insure positioning and the alignment of the outward front face surface drilling to the median of the vertical column 180. The second phase of the drilling technique consists of the upper through bolt hole 138n of the connecting leg 128e of bracket 149e being used as template guides to insure positioning and the alignment of the drilling through the inwards back face surface drilling through the vertical column 180 coinciding with the second phase of the drilling technique establishes second latitudinal aligned through hole in the vertical column 180.

The first main affixed interlocking is latitudinally consisting of a galvanized washer 143 being affixed to a galvanized through bolts' 144 threads. The threads of the galvanized through bolt 144 are passed through the brackets' 130 connecting leg 128a lower through bolt hole 138a through the pre drilled first latitudinal through hole in the vertical column 180 through the brackets' 149e connecting leg 128e lower through bolt hole 138m where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the first main latitudinal affixed connection of the bracket 130 lower through bolt hole 138a through the first latitudinal through hole in the vertical column 180 through the bracket 149e lower through bolt hole 138m.

The second main affixed interlocking is latitudinally consisting of a galvanized washer 143 being affixed to a galvanized through bolts' 144 threads. The threads of the galvanized through bolt 144 are passed through the brackets' 130 connecting leg 128a upper through bolt hole 138b through the pre drilled second latitudinal through hole in the vertical column 180 through the brackets' 149e connecting leg 128e upper through bolt hole 138n where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the second main latitudinal affixed connection of the bracket 130 upper through bolt hole 138b through the second latitudinal through hole in the vertical column 180 through the bracket 140e upper through bolt hole 138n.

The bracket 130 short supporting flange 132a extends latitudinally outwards of the longitudinal outwards front face surface of the vertical column 180 and the bracket 149e long supporting flange 127e extends latitudinally outwards of the longitudinal inwards back face surface of the vertical column 180. A “T” shape configuration is formed from the horizontal supporting plane of the bracket 130 short supporting flange 132a to the vertical column to the horizontal supporting plane of the 149e long supporting flange 127e allowing for equally latitudinal heights planes to the single longitudinal plane vertically.

The bracket 149e connecting leg 128e left outer edge 164ea is welded to the long bases 162ea of the trapezoid configured planner plate 157e inward facing surfaces 151ea and oppositely positioned right outer edge 164eb of the connecting leg 128e is welded long bases 162eb of the trapezoid configured planner plate 158e inward facing surfaces 151eb. The support flange 127e left outer edge 164ea is welded to the short bases 163ea of the trapezoid configured planner plates 157e inward facing surfaces 151ea and oppositely positioned right outer edge 164eb of the support flange 127e is welded to the short bases 163eb of the trapezoid configured planner plate 158e inward facing surfaces 151eb. The trapezoid configured planner plates 157e and 158e are welded to the connecting leg 128e and the supporting flange 127e form a channel 200e providing a combinational supporting element and connecting element for the single horizontal joist 184 or double horizontal joist beam 185 and companion spacer blocks 186.

The bracket 149e planner plates 157e and 158e are provided with a series of latitudinal through holes through the outwards facing surface 150ea of connecting planner plate 157e forming the rear through hole 138o and the front through hole 138p through to the oppositely positioned inwards facing surface 151ea and latitudinal through holes through the inwards facing surface 151eb of connecting planner plate 157e forming the rear through hole 138r and the front through hole 138q through to the oppositely positioned the outwards facing surface 150eb.

In the channel 200e of the bracket 149e atop the supporting flange 127e upwards facing top surface 141e latitudinally positioned with the downwards bottom facing surface of the single horizontal joist 184 or double horizontal joist beam 185 and companion spacer blocks 186 forming the main structural supports are positioned awaiting the third latitudinal though hole and fourth latitudinal though hole drilling.

Positioned latitudinally atop the upwards top face surface 141e of the long supporting flange 127e of the bracket 149e is the downwards bottom face surface of the single horizontal joist 184 or double horizontal joist beam 185 and companion spacer blocks 186 forming a horizontal structural supports member. The bracket 149e is comprised of two identical planner plates planner plate 157e and planner plate 158e shaped in trapezoid configurations. The proportional dimensions of the trapezoid planner plate 157e and planner plate 158e height's are the combined height's of the connecting leg 128e and the single horizontal joist 184 or double horizontal joist beam 185 and companion spacer blocks 186 forming the main structural supports. The proportional dimensions of the trapezoid planner plate 157e and planner plate 158e lengths are the length of the long supporting flange 127e. The proportional dimensions of the trapezoid planner plate 157e and planner plate 158e angled hypotenuse length 156e cutout is equal to the connecting leg 128e outwards facing front surface 131e height to the supporting flange 127e length downwards facing bottom surface 147e, as detail and illustrated in FIGS. 33 and 34.

The third latitudinal aligned through hole consists of a systematic two phase drilling technique to accomplish the third latitudinal aligned drilling through the companion spacer blocks 186 and the single horizontal joist 184 or double horizontal joist beam 185. The first phase of the drilling technique consists of the rear through bolt hole 138o of the trapezoid planner plate 157e of bracket 149e being used as template guides to insure positioning and the alignment of the outwards side face surface drilling to the median of the companion spacer blocks 186 and the single horizontal joist 184 or double horizontal joist beam 185. The second phase of the drilling technique consists of the rear through bolt hole 138r of the trapezoid planner plate 158e of bracket 149e of bracket 149e being used as template guides to insure positioning and the alignment of the drilling through the inwards side face surface drilling through the single horizontal joist 184 or double horizontal joist beam 185 and companion spacer blocks 186 coinciding with the first phase of the drilling technique establishes the connection through the trapezoid planner plate 157e through the third latitudinal aligned through hole in the companion spacer blocks 186 and the single horizontal joist 184 or double horizontal joist beam 185 through the trapezoid planner plate 158e.

The fourth latitudinal aligned through hole consists of a systematic two phase drilling technique to accomplish the fourth latitudinal aligned drilling through the companion spacer blocks 186 and the single horizontal joist 184 or double horizontal joist beam 185. The first phase of the drilling technique consists of the front through bolt hole 138p of the trapezoid planner plate 157e of bracket 149e being used as template guides to insure positioning and the alignment of the outwards side face surface drilling to the median of the companion spacer blocks 186 and the single horizontal joist 184 or double horizontal joist beam 185. The second phase of the drilling technique consists of the front through bolt hole 138q of the trapezoid planner plate 158e of bracket 149e being used as template guides to insure positioning and the alignment of the drilling through the inwards side face surface drilling through the single horizontal joist 184 or double horizontal joist beam 185 and companion spacer blocks 186 coinciding with the first phase of the drilling technique establishes the connection through the trapezoid planner plate 157e through the fourth latitudinal aligned through hole in the companion spacer blocks 186 and the single horizontal joist 184 or double horizontal joist beam 185 through the trapezoid planner plate 158e.

The third main affixed interlocking is latitudinally consisting of a galvanized washer 143 being affixed to a galvanized through bolts' 144 threads. The threads of the galvanized through bolt 144 are passed through the rear through bolt hole 138o of the trapezoid planner plate 157e the pre drilled third latitudinal through hole in the companion spacer blocks 186 and the single horizontal joist 184 or double horizontal joist beam 185 through the bracket 149e rear through bolt hole 138r in the trapezoid planner plate 158e where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the third main latitudinal affixed connection of the bracket 149e rear through bolt hole 138o in the trapezoid planner plate 157e through the third latitudinal through hole in the companion spacer blocks 186 and the single horizontal joist 184 or double horizontal joist beam 185 through the bracket 149e rear through bolt hole 138r in the trapezoid planner plate 158e.

The fourth main affixed interlocking is latitudinally consisting of a galvanized washer 143 being affixed to a galvanized through bolts' 144 threads. The threads of the galvanized through bolt 144 are passed through the brackets' 149e front through bolt hole 138p in the trapezoid planner plate 157e through the pre drilled fourth latitudinal through hole in the companion spacer blocks 186 and the single horizontal joist 184 or double horizontal joist beam 185 through the brackets' 149e front through bolt hole 138q in the trapezoid planner plate 158e where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the fourth main latitudinal affixed connection of the bracket 149e front through bolt hole 138p in the trapezoid planner plate 157e through the third latitudinal through hole in the companion spacer blocks 186 and the single horizontal joist 184 or double horizontal joist beam 185 through the bracket 149e front through bolt hole 138q in the trapezoid planner plate 158e.

Positioned atop the upwards top face surface 126a of the short supporting flange 132a of the bracket 130 latitudinally the downwards bottom face surface of the horizontal single rim joists 182 or the horizontal double rim joists 183 accompanied by the downwards bottom face surface 174d of joining plate 170d having an opposing side the upwards top surface 175d. The joining plate 170d inwards back face surface 172d is to be positioned in front of the outwards front face surface of the horizontal single rim joists 182 or the horizontal double rim joists 183.

The joining plate 170d consists of latitudinal connecting elements the lower through bolt hole 138ed and an upper through bolt hole 138fd longitudinally aligned in a row along the median of the planner plate 169d. The width specifications of the joining plate 170d outer edges are to be to the longitudinal width specifications of the vertical column 180 forming the main vertical structural support and the height specification of the joining plate 170d planner plate 169d surface is to be longitudinal height of the horizontal single rim joists 182 or the horizontal double rim joists 183 forming the main horizontal structural supports. The joining plate 170d has series of two rolls of longitudinally aligning smaller diameter through holes 160d offsetting of the median of the planner plate 169d and the outer edges 133d through the outwards facing front surface 171d through the front of the plate 171d through to the inwards facing back surface 172d allowing for nails 159 to be secure one horizontal single rim joist 182 conjoined to another horizontal single rim joist 182 in a union or one horizontal double rim joist 183 conjoined to another horizontal double rim joist 183 ends conjoin together to form a continues horizontal double rim joist 183 in a conjoined union and before the drilling for the fifth and sixth connection through holes. Refer to detailed illustration and specifications in FIG. 38.

The establishing of the six secondary latitudinal locking connections consist of the hammering six nails through the joining plate 170d six through holes 160d through the outwards facing front surface 171d through the front of the plate 171d through to the inwards facing back surface 172d allowing for nails 159 to be secure the two horizontal single rim joist 183 outwards front face surfaces through to the inward back face surfaces through the outwards front face surface the horizontal double rim joist 182 through to the inward back face surfaces through the outwards front face surface of the vertical column 180. Where the establishing of the six secondary latitudinal locking connections nailed through the horizontal single rim joists 182 or the horizontal double rim joists 183 to the vertical column 180.

The fifth latitudinal aligned through hole consists of a systematic single phase drilling technique to accomplish the fifth latitudinal aligned drilling through the horizontal single rim joists 182 or the horizontal double rim joists 183 to the vertical column 180. The single phase of the drilling technique consists of the lower through bolt hole 138ed of the planner plate 169d of joining plate 170d being used as a drilling template guide for drilling through the outwards front face surface of the horizontal single rim joists 182 or the horizontal double rim joists 183 through to the opposing side the inwards back face surface through the outwards front face surface of the vertical column 180 establishes fifth latitudinal aligned through hole in the horizontal single rim joists 182 or the horizontal double rim joists 183 to the vertical column 180.

The sixth latitudinal aligned through hole consists of a systematic single phase drilling technique to accomplish the sixth latitudinal aligned drilling through the horizontal single rim joists 182 or the horizontal double rim joists 183. The single phase of the drilling technique consists of the upper through bolt hole 138fd of the planner plate 169d of joining plate 170d being used as a drilling template guide for drilling through the outwards front face surface of the horizontal single rim joists 182 or the horizontal double rim joists 183 to the outwards front face surface of the vertical column 180 establishes sixth latitudinal aligned through hole in the horizontal single rim joists 182 or the horizontal double rim joists 183 to the vertical column 180.

The fifth main affixed interlocking is latitudinally consisting of a galvanized washer 143 being affixed to a galvanized lag bolt 146 threads. The threads of the galvanized lag bolt 146 are allowed passage through the lower through bolt hole 138ed joining plate 170d through the pre drilled fifth latitudinal through hole in the horizontal single rim joists 182 or horizontal single rim joists beam 183 to the vertical column's 180 outwards front face surface where the galvanized lag bolt 146 threads are rigidly embedded. Rigidly embedding the galvanized lag bolt's 146 threads forms the fifth latitudinal affixed connection of the securing the lower through bolt hole 138ed of the joining plate 170d through the fifth main latitudinal through holes horizontal single rim joists 182 or horizontal single rim joists beam 183 to the vertical column 180.

The sixth main affixed interlocking is latitudinally consisting of a galvanized washer 143 being affixed to a galvanized lag bolt 146 threads. The threads of the galvanized lag bolt 146 are allowed passage through the upper through bolt hole 138fd joining plate 170d through the pre drilled sixth latitudinal through hole in the horizontal single rim joists 182 or horizontal single rim joists beam 183 to the vertical column's 180 outwards front face surface where the galvanized lag bolt 146 threads are rigidly embedded. Rigidly embedding the galvanized lag bolt's 146 threads forms the sixth main latitudinal affixed connection of the securing the upper through bolt hole 138fd of the joining plate 170d through the sixth latitudinal through holes horizontal single rim joists 182 or horizontal single rim joists beam 183 to the vertical column 180.

The primordial method of using the bracket 130, bracket 149e and joining plate 170d as templates is advantageous to positioning and drilling the through holes in the structural components such as the vertical column 180, horizontal single rim joists 182 or the horizontal double rim joist beam 183, and single horizontal joist 184 or double horizontal joist beam 185 and companion spacer blocks 186 forming the main structural supports ensuring that the through holes align and interlocking element such as through bolts 144, lag bolts 146, washers 143, through bolt hex nuts 145 align with bracket 130, bracket 149e and joining plate 170d through holes allowing for structural integrity in the conjugational union.

The primordial method of using bracket 130, bracket 149e and joining plate 170d in FIGS. 15 and 16 is to illustrates the six main affixed latitudinal interlocking connections and the six secondary affixed latitudinal interlocking connections in a structure formed of proportional horizontal plane using horizontal joist 184 or double horizontal joist beam 185 and companion spacer blocks 186 as first horizontal plane and horizontal single rim joists 182 or the horizontal double rim joist beam 183 as second horizontal plane intersecting into a single supporting equally horizontal plane.

The primordial method of bracket 130 lower through bolt hole 138a and upper through bolt hole 138b in the connecting leg 128a being aligned bracket 142c lower through bolt hole 138c and upper through bolt hole 138d in the connecting leg 128c allows the upwards top facing surface of the short supporting flange 132a of bracket 130 to aligned parallel with the downwards bottom facing surface of the single horizontal joist 184 or double horizontal joist beam 185 and companion spacer blocks 186 forming the main structural supports ensuring that all joist supported by the single horizontal joist 184 or double horizontal joist beam 185 and companion spacer blocks 186 forming the main structural support would be in alignment with the horizontal single rim joists 182 or double horizontal joist beam 185 forming the main structural supports. Thereby, forming the horizontal double joist beam 185 into an main structural element the horizontal main girder support beam for the floor joist to be attached to and supported by the inwards side facing surface.

The three primary main structural support members the horizontal single rim joist 182 or horizontal double rim joist beam 183, the vertical column 180, single horizontal joist 184 or double horizontal joist beam 185 and companion spacer blocks 186 with the series of brackets: the bracket 130, bracket 149e and joining plate 170d are affixed and interlocked forming the main structural supports of the structure and the fourth method of new construction practices, bolting techniques and the embodiments of the invention of bracket 130, bracket 149e and joining plate 170d in FIG. 4.

FIG. 17 and FIG. 18 depicts the eighth fabricated embodiment bracket 168f, fourth fabricated embodiment bracket 142c and the fifth fabricated embodiment joining plate 170b, the installation practices and bolting connecting techniques of the seven affixed interlocking connections comprising of: the five latitudinal locking connections and two longitudinal locking connections to the structural components such as the vertical column 180, horizontal single rim joists 182 or the horizontal double rim joist beam 183 and horizontal support beam 181 forming the main structural supports of the structure and forming a single horizontal segmented plane.

As detailed below the bracket 168f, bracket 142c and joining plate 170b are particularly advantageous for usage in new construction structures and allowing existing construction practices to be reevaluated on the merit or character of durability to time and especially severe inclement elements forming the fifth new construction techniques and practices incorporating the bracket 168f, bracket 142c and joining plate 170b.

As described hereinbefore in the delineated assembly is in a more detailed illustration in FIG. 5 where the designated components are explained and illustrated on the design principles on the fifth method of new construction and each of the fabricated embodiments: eighth fabricated embodiment bracket 168f, fourth fabricated embodiment bracket 142c and the fifth fabricated embodiment joining plate 170b.

The bracket 168f is to be arranged in an upside down “L” shape configuration longitudinally to the vertical column 180, the position of the short supporting flanges 132f upwards top face surface 126f is latitudinally positioned to the downwards bottom face surface of the horizontal single rim joists 182 or the horizontal double rim joists 183 and the connecting legs 128f inwards back face surface 140f is longitudinally positioned to the outwards front face surface of the vertical column 180, together define a L-shaped bracket. The connecting leg 128f of bracket 168f is provided with a longitudinal row of through holes the lower through hole 138s and the upper through hole 138t. The bracket 168f connecting leg 128f height is longer then the supporting flanges 132f length.

The corner edge 124f of brackets 168f inwards back face surface 140f intersects the longitudinal outwards front face surface of the vertical column 180 and the upwards top face surface 126f of the short supporting flange 132f intersects the latitudinal bottom face surface of the horizontal single rim joists 182 or the horizontal double rim joists beam 183.

The bracket 142c is to be arranged in an upside down reversed “L” shape configuration longitudinally to the vertical column 180, the position of the long supporting flanges 127c upwards top face surface 141c is latitudinally positioned to the downwards bottom face surface of the horizontal support beam 181 and the connecting leg 128c inwards back face surface 140c is longitudinally positioned to the inwards back face surface of the vertical column 180, together define a L-shaped bracket. The connecting leg 128c of bracket 142c is provided with a longitudinal row of through holes the lower through hole 138cc and the upper through hole 138dc. The bracket 142c connecting leg's 128c height is equal to the supporting flange's 127c length.

The corner edge 124c of bracket 142c coinciding height intersects the inwards back face surface of the vertical column 180 and the upwards top face surface 141c of the long supporting flange 127c intersects the bottom face surface of the horizontal support beam 181.

The coinciding heights of the upwards top facing surface of the horizontal support beam 181 opposing side the downwards bottom facing surface is supported by the upwards facing top surface 141c of the supporting flange 127c and the horizontal single rim joists 182 or the horizontal double rim joists 183 downwards bottom facing surface is supported by the upwards facing top surface 126f of the supporting flange 132f of bracket 168f allowing for an disproportional horizontal planes or two unequal horizontal planes converging on a single horizontal segmented plane.

Once the positioning has been determined on the height of the main structural supports of the structure, the through holes first lower hole and second upper hole in the median of the vertical column 180 forming the main structural support can be drilled and completed to height dimension requirements: the coinciding height intersections of the vertical column forming the main structural support to the bracket 142c flange 127c supporting the downwards bottom facing surface of the horizontal support beam 181 and the height of the horizontal single rim joist 182 or horizontal double joist rim beam 184 downwardly bottom facing surface is level to the upward top facing surface of the horizontal support beam 181 forming the main structural support and the horizontal single rim joist 182 or horizontal double joist rim beam 184 are supported by the bracket 168f supporting flange 132f upwards facing top surface 141c.

The first latitudinal aligned through hole consists of a systematic single phase drilling technique to accomplish the first latitudinal aligned drilling through the vertical column 180. The first phase of the drilling technique consists of the lower through bolt hole 138cc of the connecting leg 128c of bracket 142c being used as template guides to insure positioning and the alignment of the inwards back face surface drilling through the median of the vertical column 180 to the outward front face surface establishes first latitudinal aligned through hole in the vertical column 180.

The second latitudinal aligned through hole consists of a systematic two phase drilling technique to accomplish the second latitudinal aligned drilling through the vertical column 180. The first phase of the drilling technique consists of the lower through bolt hole 138s of the connecting leg 128f of bracket 168f being used as template guides to insure positioning and the alignment of the outward front face surface drilling to the median of the vertical column 180. The second phase of the drilling technique consists of the upper through bolt hole 138dc of the connecting leg 128c of bracket 142c being used as template guides to insure positioning and the alignment of the inwards back face surface drilling through the vertical column 180 coinciding with the second phase of the drilling technique establishes second latitudinal aligned through hole in the vertical column 180.

The third latitudinal aligned through hole consists of a systematic single phase drilling technique to accomplish the third latitudinal aligned drilling to the median core of the vertical column 180. The single phase of the drilling technique consists of the upper through bolt hole 138t of the bracket 168f being used a drilling template guide for drilling through the bracket 168f to the outwards front face surface of the median core of the vertical column 180 establishes third latitudinal aligned through hole into the median core of the vertical column 180.

The first affixed interlocking is latitudinally consisting of a galvanized washer 143 being affixed to a galvanized through bolts' 144 threads. The threads of the galvanized through bolt 144 are passed through the pre drilled first latitudinal through hole in the vertical column 180 through the brackets' 142c connecting leg 128c lower through bolt hole 138cc where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the first latitudinal affixed connection of the first latitudinal through hole in the vertical column 180 through the bracket 142c lower through bolt hole 138cc.

The second affixed interlocking is latitudinally consisting of a galvanized washer 143 being affixed to a galvanized through bolts' 144 threads. The threads of the galvanized through bolt 144 are passed through the brackets' 168f connecting leg 128f lower through bolt hole 138s through the pre drilled second latitudinal through hole in the vertical column 180 through the brackets' 142c connecting leg 128c upper through bolt hole 138dc where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the second latitudinal affixed connection of the bracket 168f lower through bolt hole 138s through the second latitudinal through hole in the vertical column 180 through the bracket 142c upper through bolt hole 138dc.

The third affixed interlocking is latitudinally consisting of a galvanized washer 143 being affixed to a galvanized lag bolt 146 threads. The threads of the galvanized lag bolt 146 are allowed passage through the upper through bolt hole 138t of the bracket 168f through the pre drilled third latitudinal through hole in the vertical column outwards front face surface in the median core where the galvanized lag bolt 146 threads are rigidly embedded. Rigidly embedding the galvanized lag bolt's 146 threads forms the third latitudinal affixed connection of the securing the upper through bolt hole 138t of the bracket 168f to the vertical column 180.

The bracket 168f short supporting flange 132f extends latitudinally outwards of the longitudinal outwards front face surface of the vertical column 180 being respectively offset by height to the bracket 142c long supporting flange 127c extends latitudinally outwards of the longitudinal inwards back face surface of the vertical column 180. A “Z” shape configuration is formed from the converging of the segmental horizontal planes of the bracket 168f short supporting flange 132f being offset by longitudinal height to the bracket 142c long supporting flange 127c allowing for a single horizontal segmented plane to the single longitudinal plane vertically.

Positioned latitudinally atop the upwards top face surface 141c of the long supporting flange 127c of the bracket 142c is the downwards bottom face surface of the horizontal support beam 181 forming a horizontal structural support member.

The first longitudinal aligned through hole consists of a systematic single phase drilling technique to accomplish the first longitudinal aligned drilling through the horizontal support beam 181. The single phase of the drilling technique consists of the rear through bolt hole 138g of the brackets 142c long supporting flange 127c as a drilling template guide for drilling through the downwards bottom face surface of the horizontal support beam 181 through to the opposing side the upwards top establishes first longitudinal aligned through hole in the horizontal support beam 181.

The second longitudinal aligned through hole consists of a systematic single phase drilling technique to accomplish the second longitudinal aligned drilling through the horizontal support beam 181. The single phase of the drilling technique consists of the front through bolt hole 138h of the brackets 142c long supporting flange 127c as a drilling template guide for drilling through the downwards bottom face surface of the horizontal support beam 181 through to the opposing side the upwards top establishes second longitudinal aligned through hole in the horizontal support beam 181.

The fourth affixed interlocking is longitudinally consisting of a galvanized washer 143 being affixed to a galvanized through bolts' 144 threads. The threads of the galvanized through bolt 144 are passed through the brackets' 142c long supporting flange 127c rear through bolt hole 138g through the pre drilled first longitudinal through hole in the horizontal support beam 181 where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the first longitudinal affixed connection of the bracket 142c rear through bolt hole 138g through the first longitudinal through hole in the horizontal support beam 181.

The fifth affixed interlocking is longitudinally consisting of a galvanized washer 143 being affixed to a galvanized through bolts' 144 threads. The threads of the galvanized through bolt 144 are passed through the brackets' 142c long supporting flange 127c front through bolt hole 138h through the pre drilled second longitudinal through hole in the horizontal support beam 181 where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the second longitudinal affixed connection of the bracket 142c front through bolt hole 138h through the second longitudinal through hole in the horizontal support beam 181.

Positioned atop the upwards top face surface 126f of the short supporting flange 132f of the bracket 168f latitudinally the downwards bottom face surface of the horizontal single rim joists 182 or the horizontal double rim joists 183 accompanied by the downwards bottom face surface 174b of joining plate 170b having an opposing side the upwards top surface 175b. The joining plate 170b inwards back face surface 172b is to be positioned in front of the outwards front face surface of the horizontal single rim joists 182 or the horizontal double rim joists 183.

The joining plate 170b consists of latitudinal connecting elements the lower through bolt hole 138eb and an upper through bolt hole 138fb longitudinally aligned in a row along the median of the lower planner plate 169b. The width specifications of the joining plate 170b outer edges are to be to the longitudinal width specifications of the vertical column 180 forming the main vertical structural support and the height specification of the joining plate 170b planner plate 169b surface is to be longitudinal height of the horizontal single rim joists 182 or the horizontal double rim joists 183 forming the main horizontal structural support member.

The fourth latitudinal aligned through hole consists of a systematic single phase drilling technique to accomplish the fourth latitudinal aligned drilling through the horizontal single rim joists 182 or the horizontal double rim joists 183 and vertical column 180. The single phase of the drilling technique consists of the lower through bolt hole 138eb of the planner plate 169b of joining plate 170b being used as a drilling template guide for drilling through the outwards front face surface of the horizontal single rim joists 182 or the horizontal double rim joists 183 through to the opposing side the inwards back face surface through the outwards front face surface of the vertical column 180 through to the opposing side the inwards back face surface to the outwards front face surface of the vertical column 180 establishes fourth latitudinal aligned through hole in the horizontal single rim joists 182 or the horizontal double rim joists 183 to the vertical column 180.

The fifth latitudinal aligned through hole consists of a systematic single phase drilling technique to accomplish the fifth latitudinal aligned drilling through the horizontal single rim joists 182 or the horizontal double rim joists 183 and vertical column 180. The single phase of the drilling technique consists of the upper through bolt hole 138fb of the planner plate 169b of joining plate 170b being used as a drilling template guide for drilling through the outwards front face surface of the horizontal single rim joists 182 or the horizontal double rim joists 183 through to the opposing side the inwards back face surface through the outwards front face surface of the vertical column 180 through to the opposing side the inwards back face surface to the outwards front face surface of the vertical column 180 establishes fifth latitudinal aligned through hole in the horizontal single rim joists 182 or the horizontal double rim joists 183 to the vertical column 180.

The sixth affixed interlocking is latitudinally consisting of a galvanized washer 143 being affixed to a galvanized through bolt 144 threads. The threads of the galvanized through bolt 144 are allowed passage through the lower through bolt hole 138eb joining plate 170b through the pre drilled fourth latitudinal through hole in the horizontal single rim joists 182 or horizontal single rim joists beam 183 through vertical column's 180 inwards back face surface where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the fourth affixed latitudinal connection of the joining plate 170b lower through bolt hole 138eb through the fourth latitudinal through hole in the horizontal single rim joists 182 or horizontal single rim joists beam 183 through vertical column's 180.

The seventh affixed interlocking is latitudinally consisting of a galvanized washer 143 being affixed to a galvanized through bolt 144 threads. The threads of the galvanized through bolt 144 are allowed passage through the upper through bolt hole 138fb joining plate 170b through the pre drilled fifth latitudinal through hole in the horizontal single rim joists 182 or horizontal single rim joists beam 183 through vertical column's 180 inwards back face surface where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the fifth affixed latitudinal connection of the joining plate 170b lower through bolt hole 138eb through the fifth latitudinal through hole in the horizontal single rim joists 182 or horizontal single rim joists beam 183 through vertical column's 180.

The primordial method of using the bracket 142c, bracket 168f and joining plate 170b as template guides are advantageous to positioning and drilling the through holes in the structural components such as the vertical column 180, horizontal single rim joists 182 or the horizontal double rim joist beam 183, and horizontal support beam 181 forming the main structural support members. The template guides ensures that the through holes allow aligning passage for the interlocking connectors such as through bolts 144, lag bolts 146 and allows fastener components washers 143 and through bolt hex nuts 145 to be affixed by the alignment of the through holes with bracket 142c, bracket 168f, and joining plate 170b allowing for structural integrity in the conjugational union of the affixed interlocking connections between the main structural support members.

The primordial method of using bracket 168f, bracket 142c and joining plate 170c in FIGS. 17 and 18 is to illustrate the affixed five latitudinal interlocking connections and the affixed two longitudinal interlocking connections in a structure formed of disproportional horizontal plane or two unequal horizontal planes converging on a single horizontal segmented plane using a horizontal support beam 181 as first horizontal single plane and horizontal single rim joists 182 or the horizontal double rim joist beam 183 as second horizontal second plane converging on a single horizontal segmented plane. Thereby, forming the horizontal support beam 181 into a main structural element the horizontal main girder support beam for the floor joist to be supported atop the upwards top facing surface.

The primordial method of bracket 168f lower through bolt hole 138s in the connecting leg 124 being offset to the bracket 142c upper through bolt hole 138dc in the connecting leg 128c allows the upwards facing top surface 126f of the short supporting flange 132f of bracket 168f to aligned parallel with the upwards top facing surface of the horizontal support beam 181 ensures that all joists supported by the horizontal support beam 181 lay-in a parallel alignment parallel with the horizontal single rim joists 182 or the horizontal double rim joist beam 183.

The three primary main structural support members the horizontal single rim joist 182 or horizontal double rim joist beam 183, the vertical column 180 and the horizontal support beam 181 in affixed conjunction with the bracket 168f, bracket 142c and joining plate 170b by the fifth method of new construction practices, bolting techniques form the main structural supports of the structure and the fifth method of new construction practices, bolting techniques using the fabricated embodiments of the invention of bracket 168f, bracket 142 and joining plate 170b in FIG. 5.

FIG. 19 and FIG. 20 depicts the eighth fabricated embodiment bracket 168f, fourth fabricated embodiment bracket 142c, sixth fabricated embodiment bracket 148d and the fifth fabricated embodiment joining plate 170b, the installation practices and bolting connecting techniques of the seven affixed interlocking connections comprising of: the five main latitudinal locking connections, six secondary latitudinal locking connections and two longitudinal locking connections to the structural components such as the vertical column 180, horizontal single rim joists 182 or the horizontal double rim joist beam 183 and horizontal support beam 181 forming the main structural supports of the structure and forming a single horizontal segmented plane.

As detailed below the bracket 168f, bracket 142c, bracket 148d and joining plate 170b are particularly advantageous for usage in new construction structures and allowing existing construction practices to be reevaluated on the merit or character of durability to time and especially severe inclement elements forming the sixth new construction techniques and practices incorporating the bracket 168f, bracket 142c, bracket 148d and joining plate 170b.

As described hereinbefore in the delineated assembly is in a more detailed illustration in FIG. 6 where the designated components are explained and illustrated on the design principles on the sixth method of new construction and each of the fabricated embodiments: eighth fabricated embodiment bracket 168f, fourth fabricated embodiment bracket 142c, sixth fabricated embodiment bracket 148d and the fifth fabricated embodiment joining plate 170b.

The bracket 168f is to be arranged in an upside down “L” shape configuration longitudinally to the vertical column 180, the position of the short supporting flanges 132f upwards top face surface 126f is latitudinally positioned to the downwards bottom face surface of the horizontal single rim joists 182 or the horizontal double rim joists 183 and the connecting legs 128f inwards back face surface 140f is longitudinally positioned to the outwards front face surface of the vertical column 180, together define a L-shaped bracket. The connecting leg 128f of bracket 168f is provided with a longitudinal row of through holes the lower through hole 138s and the upper through hole 138t. The bracket 168f connecting leg 128f height is longer then the supporting flanges 132f length.

The corner edge 124f of brackets 168f inwards back face surface 140f intersects the longitudinal outwards front face surface of the vertical column 180 and the upwards top face surface 126f of the short supporting flange 132f intersects the latitudinal bottom face surface of the horizontal single rim joists 182 or the horizontal double rim joists beam 183.

The bracket 142c is to be arranged in an upside down reversed “L” shape configuration longitudinally to the vertical column 180, the position of the long supporting flanges 127c upwards top face surface 141c is latitudinally positioned to the downwards bottom face surface of the horizontal support beam 181 and the connecting leg 128c inwards back face surface 140c is longitudinally positioned to the inwards back face surface of the vertical column 180, together define a L-shaped bracket. The connecting leg 128c of bracket 142c is provided with a longitudinal row of through holes the lower through hole 138cc and the upper through hole 138dc. The bracket 142c connecting leg's 128c height is equal to the supporting flange's 127c length.

The corner edge 124c of bracket 142c coinciding height intersects the inwards back face surface of the vertical column 180 and the upwards top face surface 141c of the long supporting flange 127c intersects the bottom face surface of the horizontal support beam 181.

The coinciding heights of the upwards top facing surface of the horizontal support beam 181 opposing side the downwards bottom facing surface is supported by the upwards facing top surface 141c of the supporting flange 127c and the horizontal single rim joists 182 or the horizontal double rim joists 183 downwards bottom facing surface is supported by the upwards facing top surface 126f of the supporting flange 132f of bracket 168f allowing for an disproportional horizontal planes or two unequal horizontal planes converging on a single horizontal segmented plane.

Once the positioning has been determined on the height of the main structural supports of the structure, the through holes first lower hole and second upper hole in the median of the vertical column 180 forming the main structural support can be drilled and completed to height dimension requirements: the coinciding height intersections of the vertical column forming the main structural support to the bracket 142c flange 127c supporting the downwards bottom facing surface of the horizontal support beam 181 and the height of the horizontal single rim joist 182 or horizontal double joist rim beam 184 downwardly bottom facing surface is level to the upward top facing surface of the horizontal support beam 181 forming the main structural support and the horizontal single rim joist 182 or horizontal double joist rim beam 184 are supported by the bracket 168f supporting flange 132f upwards facing top surface 126f.

The first latitudinal aligned through hole consists of a systematic single phase drilling technique to accomplish the first latitudinal aligned drilling through the vertical column 180. The first phase of the drilling technique consists of the lower through bolt hole 138cc of the connecting leg 128c of bracket 142c being used as template guides to insure positioning and the alignment of the inwards back face surface drilling through the median of the vertical column 180 to the outward front face surface establishes first latitudinal aligned through hole in the vertical column 180.

The second latitudinal aligned through hole consists of a systematic two phase drilling technique to accomplish the second latitudinal aligned drilling through the vertical column 180. The first phase of the drilling technique consists of the lower through bolt hole 138s of the connecting leg 128f of bracket 168f being used as template guides to insure positioning and the alignment of the outward front face surface drilling to the median of the vertical column 180. The second phase of the drilling technique consists of the upper through bolt hole 138dc of the connecting leg 128c of bracket 142c being used as template guides to insure positioning and the alignment of the inwards back face surface drilling through the vertical column 180 coinciding with the first phase of the drilling technique establishes second latitudinal aligned through hole in the vertical column 180.

The third latitudinal aligned through hole consists of a systematic single phase drilling technique to accomplish the third latitudinal aligned drilling to the median core of the vertical column 180. The single phase of the drilling technique consists of the upper through bolt hole 138t of the bracket 168f being used a drilling template guide for drilling through the bracket 168f to the outwards front face surface of the median core of the vertical column 180 establishes third latitudinal aligned through hole into the median core of the vertical column 180.

The first affixed interlocking is latitudinally consisting of a galvanized washer 143 being affixed to a galvanized through bolts' 144 threads. The threads of the galvanized through bolt 144 are passed through the pre drilled first latitudinal through hole in the vertical column 180 through the brackets' 142c connecting leg 128c lower through bolt hole 138cc where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the first latitudinal affixed connection of the first latitudinal through hole in the vertical column 180 through the bracket 142c lower through bolt hole 138cc.

The second affixed interlocking is latitudinally consisting of a galvanized washer 143 being affixed to a galvanized through bolts' 144 threads. The threads of the galvanized through bolt 144 are passed through the brackets' 168f connecting leg 128f lower through bolt hole 138s through the pre drilled second latitudinal through hole in the vertical column 180 through the brackets' 142c connecting leg 128c upper through bolt hole 138dc where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the second latitudinal affixed connection of the bracket 168f lower through bolt hole 138s through the second latitudinal through hole in the vertical column 180 through the bracket 142c upper through bolt hole 138dc.

The third affixed interlocking is latitudinally consisting of a galvanized washer 143 being affixed to a galvanized lag bolt 146 threads. The threads of the galvanized lag bolt 146 are allowed passage through the upper through bolt hole 138t of the bracket 168f through the pre drilled third latitudinal through hole in the vertical column outwards front face surface in the median core where the galvanized lag bolt 146 threads are rigidly embedded. Rigidly embedding the galvanized lag bolt's 146 threads forms the third latitudinal affixed connection of the securing the upper through bolt hole 138t of the bracket 168f to the vertical column 180.

The bracket 168f short supporting flange 132f extends latitudinally outwards of the longitudinal outwards front face surface of the vertical column 180 being respectively offset by height to the bracket 142c long supporting flange 127c extends latitudinally outwards of the longitudinal inwards back face surface of the vertical column 180. A “Z” shape configuration is formed from the converging of the segmental horizontal planes of the bracket 168f short supporting flange 132f being offset by longitudinal height to the bracket 142c long supporting flange 127c allowing for a single horizontal segmented plane to the single longitudinal plane vertically.

Positioned latitudinally atop the upwards top face surface 141c of the long supporting flange 127c of the bracket 142c is the downwards bottom face surface of the horizontal support beam 181 forming a horizontal structural support member.

Bracket 148d is to be arranged in a reversed “L” shape, positioning the connecting leg 128d inwards back face surface 140d longitudinally to the inwards back face surface vertical column 180 and the long flange 127d downwards bottom face surface 141d is positioned to the upwards top face surface of the horizontal support beam 181 forming a main structural support. The position of the long flange 127c upwards top face surface 141c of bracket 142c conforms to a connecting element connecting the upwards top face surface median of the horizontal support beam 181 through to the opposing side the downwards bottom face surface. The bracket 148d long supporting flange 127d connecting elements consist of a row of latitudinal through holes the front through bolt hole 138i and the rear through bolt hole 138j arranged in the median in the long flange 127d through upwards top face surface 141d through to downwards bottom face surface 147d the allowing for an affixed interlocking longitudinally of the upwards top face surface of the horizontal support beam 181 is positioned atop the upwards top face surface 141c of the long supporting flange 127c of bracket 142c.

The connecting leg 128d of bracket 148d is provided with a longitudinal row of through holes the lower through hole 138k and the upper through hole 138l. The connecting leg 128d of bracket 148d is provided with a longitudinal row of through holes the lower through hole 138k and the upper through hole 138l and the long flange 127d is provided with a latitudinal row of through holes the front through hole 138i and the rear through hole 138j. The connecting leg 128d and long flange 127d of bracket 148d have aligned through holes and the connecting leg 128d height is equal to the long flange 127d length.

The corner edge 124d of bracket 148d coinciding height intersects the inwards back face surface of the vertical column 180 forming the main vertical structural support and the bottom face surface of the horizontal support beam 181. The inwards back face surface 140d of the connecting leg 128d of bracket 148d is to be positioned atop the upwards top face surface of the horizontal support beam 181 coinciding with the inwards back face surface of the vertical column 180.

The first longitudinal aligned through hole consists of a systematic two phase drilling technique to accomplish the first longitudinal aligned drilling through the horizontal support beam 181. The first phase of the drilling technique consists of the rear through bolt hole 138g of the brackets 142c long supporting flange 127c as a drilling template guide for drilling through the downwards bottom face surface to the median of the horizontal support beam 181. The second phase of the drilling technique consists of the rear through bolt hole 138j of the brackets 148d long supporting flange 127d being used as template guides to insure positioning and the alignment of the drilling through the upwards top face surface of the horizontal support beam 181 coinciding with the first phase of the drilling technique establishes first longitudinal aligned through hole in the horizontal support beam 181.

The second longitudinal aligned through hole consists of a systematic two phase drilling technique to accomplish the second longitudinal aligned drilling through the horizontal support beam 181. The first phase of the drilling technique consists of the front through bolt hole 138h of the brackets 142c long supporting flange 127c as a drilling template guide for drilling through the downwards bottom face surface to the median of the horizontal support beam 181. The second phase of the drilling technique consists of the front through bolt hole 138i of the brackets 148d long supporting flange 127d being used as template guides to insure positioning and the alignment of the drilling through the upwards top face surface of the horizontal support beam 181 coinciding with the first phase of the drilling technique establishes second longitudinal aligned through hole in the horizontal support beam 181.

The fourth affixed interlocking is longitudinally consisting of a galvanized washer 143 being affixed to a galvanized through bolts' 144 threads. The threads of the galvanized through bolt 144 are passed through the brackets' 142c long supporting flange 127c rear through bolt hole 138g through the pre drilled first longitudinal through hole in the horizontal support beam 181 passing through brackets' 148d long supporting flange 127d rear through bolt hole 138j where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the first longitudinal affixed connection of the bracket 142c rear through bolt hole 138g through the first longitudinal through hole in the horizontal support beam 181 through the bracket 148d rear through bolt hole 138j.

The fifth affixed interlocking is longitudinally consisting of a galvanized washer 143 being affixed to a galvanized through bolts' 144 threads. The threads of the galvanized through bolt 144 are passed through the brackets' 142c long supporting flange 127c front through bolt hole 138h through the pre drilled second longitudinal through hole in the horizontal support beam 181 passing through brackets' 148d long supporting flange 127d front through bolt hole 138i where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the second longitudinal affixed connection of the bracket 142c front through bolt hole 138h through the second longitudinal through hole in the horizontal support beam through 181 bracket 148d front through bolt hole 138i.

Positioned atop the upwards top face surface 126f of the short supporting flange 132f of the bracket 168f latitudinally the downwards bottom face surface of the horizontal single rim joists 182 or the horizontal double rim joists 183 accompanied by the downwards bottom face surface 174c of joining plate 170c having an opposing side the upwards top surface 175c. The joining plate 170c inwards back face surface 172c is to be positioned in front of the outwards front face surface of the horizontal single rim joists 182 or the horizontal double rim joists 183.

The joining plate 170b consists of main latitudinal connecting elements the lower through bolt hole 138eb and an upper through bolt hole 138vfb that are longitudinally aligned in a row along the median of the planner plate 169c.

The fourth latitudinal aligned through hole consists of a systematic two phase drilling technique to accomplish the first latitudinal aligned drilling through the vertical column 180. The first phase of the drilling technique consists of the lower through bolt hole 138eb of the planner plate 169b of the joining plate 170b being used as template guides to insure positioning and the alignment of the outward front face surface drilling through the horizontal single rim joists 182 or the horizontal double rim joists 183 to the median of the vertical column 180. The second phase of the drilling technique consists of the lower through bolt hole 138k of the connecting leg 128d of bracket 148d being used as template guides to insure positioning and the alignment of the drilling through the inwards back face surface drilling through the vertical column 180 coinciding with the first phase of the drilling technique establishes fourth latitudinal aligned through hole 138 through the horizontal single rim joists 182 or the horizontal double rim joists 183 and vertical column 180.

The fifth latitudinal aligned through hole consists of a systematic two phase drilling technique to accomplish the second latitudinal aligned drilling through the vertical column 180. The first phase of the drilling technique consists of the upper through bolt hole 138fb of the planner plate 169b of the joining plate 170b being used as template guides to insure positioning and the alignment of the outward front face surface drilling through the horizontal single rim joists 182 or the horizontal double rim joists 183 to the median of the vertical column 180. The second phase of the drilling technique consists of the upper through bolt hole 138l of the connecting leg 128d of bracket 148d being used as template guides to insure positioning and the alignment of the drilling through the inwards back face surface drilling through the vertical column 180 coinciding with the second phase of the drilling technique establishes fifth latitudinal aligned through hole 138 through the horizontal single rim joists 182 or the horizontal double rim joists 183 and vertical column 180.

The sixth affixed interlocking is latitudinally consisting of a galvanized washer 143 being affixed to a galvanized through bolts' 144 threads. The threads of the galvanized through bolt 144 are passed through the joining plate 170b lower through bolt hole 138eb through the pre drilled fourth latitudinal through hole in the horizontal single rim joists 182 or the horizontal double rim joists 183 and vertical column 180 through the brackets' 148d connecting leg 128d lower through bolt hole 138k where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the fourth latitudinal affixed connection of the joining plate 170b lower through bolt hole 138eb through the fourth latitudinal through holes in the horizontal single rim joists 182 or the horizontal double rim joists 183 and vertical column 180 through the bracket 149d lower through bolt hole 138k.

The seventh affixed interlocking is latitudinally consisting of a galvanized washer 143 being affixed to a galvanized through bolts' 144 threads. The threads of the galvanized through bolt 144 are passed through the joining plate 170b upper through bolt hole 138fb through the pre drilled fifth latitudinal through hole in the horizontal single rim joists 182 or the horizontal double rim joists 183 and vertical column 180 through the brackets' 148d connecting leg 128d upper through bolt hole 138l where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the fifth latitudinal affixed connection of the joining plate 170b upper through bolt hole 138fb through the fifth latitudinal through hole in the horizontal single rim joists 182 or the horizontal double rim joists 183 and vertical column 180 through the bracket 148d upper through bolt hole 138l.

The primordial method of using the bracket 168f, bracket 142c, bracket 148d and joining plate 170b as templates is advantageous to positioning and drilling the through holes in the structural components such as the vertical column 180, horizontal single rim joists 182 or the horizontal double rim joist beam 183, and horizontal support beam 181 forming the main structural supports ensuring that the through holes align and interlocking element such as through bolts 144, lag bolts 146, washers 143, through bolt hex nuts 145 align with bracket 142c, 168f and joining plate 170b through holes allowing for structural integrity in the conjugational union.

The primordial method of bracket 168f lower through bolt hole 138s in the connecting leg 128f being offset from bracket 142c upper through bolt hole 138dc in the connecting leg 128c allows the upwards top facing surface of the short supporting flange 132f of bracket 168f to aligned parallel with the upwards top facing surface of the horizontal support beam 181 forming the main structural supports ensuring that all joist supported by the horizontal support are in aligned with the horizontal single rim joists 182 or the horizontal double rim joist beam 183.

The primordial method of using bracket 168f, bracket 142c, bracket 148d and joining plate 170b in FIGS. 19 and 20 is to illustrates the affixed five latitudinal interlocking connections and the affixed two longitudinal interlocking connections in a structure formed of disproportional horizontal plane using a horizontal support beam 181 as first horizontal plane and horizontal single rim joists 182 or the horizontal double rim joist beam 183 as second horizontal plane intersecting into a single supporting horizontal plane. Thereby, forming the horizontal support beam 181 into an main structural element the horizontal main girder support beam for the floor joist to be support atop the upwards top facing surface.

The three primary main structural support members the horizontal single rim joist 182 or horizontal double rim joist beam 183, the vertical column 180 and the horizontal support beam 181 with the series of brackets: the bracket 168f, bracket 142c, bracket 148d and joining plate 170b are affixed and interlocked forming the main structural supports of the structure and the method of new construction practices, bolting techniques and the embodiments of the invention of bracket 168f, bracket 142, bracket 148d and joining plate 170b in FIG. 6.

FIG. 21 and FIG. 22 depicts the eighth fabricated embodiment bracket 168f, seventh fabricated embodiment is bracket 149e is positioned upside down reversed L-shaped configuration with the welded trapezoid shaped planer plate components and the fifth fabricated embodiment is the joining plate 170b, the installation practices and bolting connecting techniques of the seven affixed interlocking connections comprising of seven main latitudinal locking connections to the structural components such as the vertical column 180, horizontal single rim joists 182 or the horizontal double rim joist beam 183, single horizontal joist 184 or double horizontal joist beam 185 and companion spacer blocks 186 forming the main structural supports of the structure and forming two unequally horizontal planes converging on a single horizontal segmented line plane.

As detailed below the bracket 168f, bracket 149e and joining plate 170b are particularly advantageous for usage in new construction structures and allowing existing construction practices to be reevaluated on the merit or character of durability to time and especially severe inclement elements forming the third new construction techniques and practices incorporating the bracket 168f, bracket 149e and joining plate 170b.

As described hereinbefore in the delineated assembly is in a more detailed illustration in FIG. 7 where the designated components are explained and illustrated on the design principles on the seventh method of new construction and each of the fabricated embodiments: eight fabricated embodiment bracket 168f, seventh fabricated embodiment bracket 149e and the fifth fabricated embodiment the joining plate 170b.

The bracket 168f is to be arranged in an upside down “L” shape configuration longitudinally to the vertical column 180, the position of the short supporting flanges 132f upwards top face surface 126f is latitudinally positioned to the downwards bottom face surface of the horizontal single rim joists 182 or the horizontal double rim joists 183 and the connecting legs 128f inwards back face surface 140f is longitudinally positioned to the outwards front face surface of the vertical column 180, together define a L-shaped bracket. The connecting leg 128f of bracket 168f is provided with a longitudinal row of through holes the lower through hole 138s and the upper through hole 138t. The bracket 168f connecting leg 128f height is longer then the supporting flanges 132f length.

The corner edge 124f of brackets 168f inwards back face surface 140f intersects the longitudinal outwards front face surface of the vertical column 180 and the upwards top face surface 126f of the short supporting flange 132f intersects the latitudinal bottom face surface of the horizontal single rim joists 182 or the horizontal double rim joists beam 183.

The bracket 149e is to be arranged in an upside down reversed “L” shape configuration longitudinally to the vertical column 180, the position of the long supporting flanges 127e upwards top face surface 141b is latitudinally positioned to the downwards bottom face surface of the and horizontal support beam 181 and the connecting leg 128e inwards back face surface 140e is longitudinally positioned to the inwards back face surface of the vertical column 180, together define a L-shaped bracket. The connecting leg 128e of bracket 149e is provided with a longitudinal row of through holes the lower through hole 138m and the upper through hole 138n. The bracket 149e connecting leg's 128e height is equal to the supporting flange's 127e length which are welded to two interconnecting elements or two connecting trapezoid shaped planer plates 157e and 158e forming the channel 200e. As described below in more detail in FIGS. 32 and 33 bracket 149e specifications.

The corner edge 124e of brackets 149e inwards back face surface 140e intersects the longitudinal inwards back face surface of the vertical column 180 and the upwards top face surface 141e of the long supporting flange 127e intersects the latitudinal bottom face surfaces of the single horizontal joist 184 or double horizontal joist beam 185 and companion spacer blocks 186.

The coinciding heights of the upwards top facing surfaces of the single horizontal joist 184 or double horizontal joist beam 185 and companion spacer blocks 186 opposing side the downwards bottom facing surface is supported by the upwards facing top surface 141e of the supporting flange 127e of bracket 149e and the horizontal single rim joists 182 or the horizontal double rim joists 183 downwards bottom facing surface is supported by the upwards facing top surface 126f of the supporting flange 132f of bracket 168f allowing for an disproportional horizontal planes or two unequal horizontal planes converging on a single horizontal segmented plane.

Once the positioning has been determined on the height of the main structural supports of the structure, the through holes first lower hole and second upper hole in the median of the vertical column 180 forming the main structural support can be drilled and completed to height dimension requirements: the coinciding height intersections of the vertical column forming the main structural support to the bracket 149e flange 127e supporting the downwards bottom facing surfaces of the single horizontal joist 184 or double horizontal joist beam 185 and companion spacer blocks 186 and the height of the horizontal single rim joist 182 or horizontal double joist rim beam 184 downwardly bottom facing surface is level to the upward top facing surfaces of the single horizontal joist 184 or double horizontal joist beam 185 and companion spacer blocks 186 forming the main structural support and the horizontal single rim joist 182 or horizontal double joist rim beam 184 are supported by the bracket 168f supporting flange 132f upwards facing top surface 126f.

The first latitudinal aligned through hole consists of a systematic single phase drilling technique to accomplish the first latitudinal aligned drilling through the vertical column 180. The first phase of the drilling technique consists of the lower through bolt hole 138m of the connecting leg 128e of bracket 149e being used as template guides to insure positioning and the alignment of the inwards back face surface drilling through the median of the vertical column 180 to the outward front face surface establishes first latitudinal aligned through hole in the vertical column 180.

The second latitudinal aligned through hole consists of a systematic two phase drilling technique to accomplish the second latitudinal aligned drilling through the vertical column 180. The first phase of the drilling technique consists of the lower through bolt hole 138s of the connecting leg 128f of bracket 168f being used as template guides to insure positioning and the alignment of the outward front face surface drilling to the median of the vertical column 180. The second phase of the drilling technique consists of the upper through bolt hole 138n of the connecting leg 128e of bracket 149e being used as template guides to insure positioning and the alignment of the inwards back face surface drilling through the vertical column 180 coinciding with the second phase of the drilling technique establishes second latitudinal aligned through hole in the vertical column 180.

The third latitudinal aligned through hole consists of a systematic single phase drilling technique to accomplish the third latitudinal aligned drilling to the median core of the vertical column 180. The single phase of the drilling technique consists of the upper through bolt hole 138t of the bracket 168f being used a drilling template guide for drilling through the bracket 168f to the outwards front face surface of the median core of the vertical column 180 establishes third latitudinal aligned through hole into the median core of the vertical column 180.

The first affixed interlocking is latitudinally consisting of a galvanized washer 143 being affixed to a galvanized through bolts' 144 threads. The threads of the galvanized through bolt 144 are passed through the pre drilled first latitudinal through hole in the vertical column 180 through the brackets' 149e connecting leg 128e lower through bolt hole 138m where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the first latitudinal affixed connection of the first latitudinal through hole in the vertical column 180 through the bracket 149e lower through bolt hole 138m.

The second affixed interlocking is latitudinally consisting of a galvanized washer 143 being affixed to a galvanized through bolts' 144 threads. The threads of the galvanized through bolt 144 are passed through the brackets' 168f connecting leg 128f lower through bolt hole 138s through the pre drilled second latitudinal through hole in the vertical column 180 through the brackets' 149e connecting leg 128e upper through bolt hole 138n where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the second latitudinal affixed connection of the bracket 168f lower through bolt hole 138s through the second latitudinal through hole in the vertical column 180 through the bracket 149e upper through bolt hole 138n.

The third affixed interlocking is latitudinally consisting of a galvanized washer 143 being affixed to a galvanized lag bolt 146 threads. The threads of the galvanized lag bolt 146 are allowed passage through the upper through bolt hole 138t of the bracket 168f through the pre drilled third latitudinal through hole in the vertical column outwards front face surface in the median core where the galvanized lag bolt 146 threads are rigidly embedded. Rigidly embedding the galvanized lag bolt's 146 threads forms the third latitudinal affixed connection of the securing the upper through bolt hole 138t of the bracket 168f to the vertical column 180.

The bracket 168f short supporting flange 132f extends latitudinally outwards of the longitudinal outwards front face surface of the vertical column 180 being respectively offset by height to the bracket 149e long supporting flange 127e extends latitudinally outwards of the longitudinal inwards back face surface of the vertical column 180. A “Z” shape configuration is formed from the converging of the segmental horizontal planes of the bracket 168f short supporting flange 132f being offset by longitudinal height to the bracket 149e long supporting flange 127e allowing for a single horizontal segmented plane to the single longitudinal plane vertically.

The bracket 149e connecting leg 128e left outer edge 164ea is welded to the long bases 162ea of the trapezoid configured planner plate 157e inward facing surfaces 151ea and oppositely positioned right outer edge 164eb of the connecting leg 128e is welded long bases 162eb of the trapezoid configured planner plate 158e inward facing surfaces 151 eb. The support flange 127e left outer edge 164ea is welded to the short bases 163ea of the trapezoid configured planner plates 157e inward facing surfaces 151ea and oppositely positioned right outer edge 164eb of the support flange 127e is welded to the short bases 163eb of the trapezoid configured planner plate 158e inward facing surfaces 151eb. The trapezoid configured planner plates 157e and 158e are welded to the connecting leg 128e and the supporting flange 127e form a channel 200e providing a combinational supporting element and connecting element for the single horizontal joist 184 or double horizontal joist beam 185 and companion spacer blocks 186.

The bracket 149e planner plates 157e and 158e are provided with a series of latitudinal through holes through the outwards facing surface 150ea of connecting planner plate 157e forming the rear through hole 138o and the front through hole 138p through to the oppositely positioned inwards facing surface 15 lea and latitudinal through holes through the inwards facing surface 151eb of connecting planner plate 157e forming the rear through hole 138r and the front through hole 138q through to the oppositely positioned the outwards facing surface 150eb.

Positioned latitudinally atop the upwards top face surface 141e of the long supporting flange 127e of the bracket 149e is the downwards bottom face surface of the single horizontal joist 184 or double horizontal joist beam 185 and companion spacer blocks 186 forming a horizontal structural supports member. The bracket 149e is comprised of two identical planner plates planner plate 157e and planner plate 158e shaped in trapezoid configurations. The proportional dimensions of the trapezoid planner plate 157e and planner plate 158e height's are the combined height's of the connecting leg 128e and the single horizontal joist 184 or double horizontal joist beam 185 and companion spacer blocks 186 forming the main structural supports. The proportional dimensions of the trapezoid planner plate 157e and planner plate 158e lengths are the length of the long supporting flange 127e. The proportional dimensions of the trapezoid planner plate 157e and planner plate 158e angled hypotenuse length 156e cutout is equal to the connecting leg 128e outwards facing front surface 131e height to the supporting flange 127e length downwards facing bottom surface 147e, as detail and illustrated in FIGS. 33 and 34.

In the channel 200e of the bracket 149e atop the supporting flange 127e upwards facing top surface 141e latitudinally positioned with the downwards bottom facing surface of the single horizontal joist 184 or double horizontal joist beam 185 and companion spacer blocks 186 forming the main structural supports are positioned awaiting the fourth latitudinal though hole drilling and fifth latitudinal though hole drilling.

The fourth latitudinal aligned through hole consists of a systematic two phase drilling technique to accomplish the fourth latitudinal aligned drilling through the companion spacer blocks 186 and the single horizontal joist 184 or double horizontal joist beam 185. The first phase of the drilling technique consists of the rear through bolt hole 138o of the trapezoid planner plate 157e of bracket 149e being used as template guides to insure positioning and the alignment of the outwards side face surface drilling to the median of the companion spacer blocks 186 and the single horizontal joist 184 or double horizontal joist beam 185. The second phase of the drilling technique consists of the rear through bolt hole 138r of the trapezoid planner plate 158e of bracket 149e of bracket 149e being used as template guides to insure positioning and the alignment of the drilling through the inwards side face surface drilling through the single horizontal joist 184 or double horizontal joist beam 185 and companion spacer blocks 186 coinciding with the first phase of the drilling technique establishes the connection through the trapezoid planner plate 157e through the fourth latitudinal aligned through hole in the companion spacer blocks 186 and the single horizontal joist 184 or double horizontal joist beam 185 through the trapezoid planner plate 158e.

The fifth latitudinal aligned through hole consists of a systematic two phase drilling technique to accomplish the fifth latitudinal aligned drilling through the companion spacer blocks 186 and the single horizontal joist 184 or double horizontal joist beam 185. The first phase of the drilling technique consists of the front through bolt hole 138p of the trapezoid planner plate 157e of bracket 149e being used as template guides to insure positioning and the alignment of the outwards side face surface drilling to the median of the companion spacer blocks 186 and the single horizontal joist 184 or double horizontal joist beam 185. The second phase of the drilling technique consists of the front through bolt hole 138q of the trapezoid planner plate 158e of bracket 149e being used as template guides to insure positioning and the alignment of the drilling through the inwards side face surface drilling through the single horizontal joist 184 or double horizontal joist beam 185 and companion spacer blocks 186 coinciding with the first phase of the drilling technique establishes the connection through the trapezoid planner plate 157e through the fifth latitudinal aligned through hole in the companion spacer blocks 186 and the single horizontal joist 184 or double horizontal joist beam 185 through the trapezoid planner plate 158e.

The fourth main affixed interlocking is latitudinally consisting of a galvanized washer 143 being affixed to a galvanized through bolts' 144 threads. The threads of the galvanized through bolt 144 are passed through the rear through bolt hole 138o of the trapezoid planner plate 157e the pre drilled fourth latitudinal through hole in the companion spacer blocks 186 and the single horizontal joist 184 or double horizontal joist beam 185 through the bracket 149e rear through bolt hole 138r in the trapezoid planner plate 158e where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the fourth main latitudinal affixed connection of the bracket 149e rear through bolt hole 138o in the trapezoid planner plate 157e through the fourth latitudinal through hole in the companion spacer blocks 186 and the single horizontal joist 184 or double horizontal joist beam 185 through the bracket 149e rear through bolt hole 138r in the trapezoid planner plate 158e.

The fifth main affixed interlocking is latitudinally consisting of a galvanized washer 143 being affixed to a galvanized through bolts' 144 threads. The threads of the galvanized through bolt 144 are passed through the brackets' 149e front through bolt hole 138p in the trapezoid planner plate 157e through the pre drilled fifth latitudinal through hole in the companion spacer blocks 186 and the single horizontal joist 184 or double horizontal joist beam 185 through the brackets' 149e front through bolt hole 138q in the trapezoid planner plate 158e where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the fifth main latitudinal affixed connection of the bracket 149e front through bolt hole 138p in the trapezoid planner plate 157e through the fifth latitudinal through hole in the companion spacer blocks 186 and the single horizontal joist 184 or double horizontal joist beam 185 through the bracket 149e front through bolt hole 138q in the trapezoid planner plate 158e.

Positioned atop the upwards top face surface 126f of the short supporting flange 132f of the bracket 168f latitudinally the downwards bottom face surface of the horizontal single rim joists 182 or the horizontal double rim joists 183 accompanied by the downwards bottom face surface 174b of joining plate 170b having an opposing side the upwards top surface 175b.

The joining plate 170b inwards back face surface 172b is to be positioned in front of the outwards front face surface of the horizontal single rim joists 182 or the horizontal double rim joists 183. The joining plate 170b consists of latitudinal connecting elements the lower through bolt hole 138eb and an upper through bolt hole 138fb longitudinally aligned in a row along the median of the lower planner plate 169b. The width specifications of the joining plate 170b outer edges are to be to the longitudinal width specifications of the vertical column 180 forming the main vertical structural support and the height specification of the joining plate 170b planner plate 169b surface is to be longitudinal height of the horizontal single rim joists 182 or the horizontal double rim joists 183 forming the main horizontal structural support member.

The sixth latitudinal aligned through hole consists of a systematic single phase drilling technique to accomplish the sixth latitudinal aligned drilling through the horizontal single rim joists 182 or the horizontal double rim joists 183 and vertical column 180. The single phase of the drilling technique consists of the lower through bolt hole 138eb of the planner plate 169b of joining plate 170b being used as a drilling template guide for drilling through the outwards front face surface of the horizontal single rim joists 182 or the horizontal double rim joists 183 through to the opposing side the inwards back face surface through the outwards front face surface median of the vertical column 180 establishes sixth latitudinal aligned through hole in the horizontal single rim joists 182 or the horizontal double rim joists 183 to the vertical column 180.

The seventh latitudinal aligned through hole consists of a systematic single phase drilling technique to accomplish the seventh latitudinal aligned drilling through the horizontal single rim joists 182 or the horizontal double rim joists 183. The single phase of the drilling technique consists of the upper through bolt hole 138fb of the planner plate 169b of joining plate 170b being used as a drilling template guide for drilling through the outwards front face surface of the horizontal single rim joists 182 or the horizontal double rim joists 183 to the outwards front face surface of the vertical column 180 establishes seventh latitudinal aligned through hole in the horizontal single rim joists 182 or the horizontal double rim joists 183 to the vertical column 180.

The sixth affixed interlocking is latitudinally consisting of a galvanized washer 143 being affixed to a galvanized lag bolt 146 threads. The threads of the galvanized lag bolt 146 are allowed passage through the lower through bolt hole 138eb joining plate 170b through the pre drilled sixth latitudinal through hole in the horizontal single rim joists 182 or horizontal single rim joists beam 183 to the vertical column's 180 outwards front face surface where the galvanized lag bolt 146 threads are rigidly embedded. Rigidly embedding the galvanized lag bolt's 146 threads forms the sixth latitudinal affixed connection of the securing the lower through bolt hole 138eb of the joining plate 170b through the sixth latitudinal through holes horizontal single rim joists 182 or horizontal single rim joists beam 183 to the vertical column 180.

The seventh affixed interlocking is latitudinally consisting of a galvanized washer 143 being affixed to a galvanized lag bolt 146 threads. The threads of the galvanized lag bolt 146 are allowed passage through the upper through bolt hole 138fb joining plate 170b through the pre drilled seventh latitudinal through hole in the horizontal single rim joists 182 or horizontal single rim joists beam 183 to the vertical column's 180 outwards front face surface where the galvanized lag bolt 146 threads are rigidly embedded. Rigidly embedding the galvanized lag bolt's 146 threads forms the seventh latitudinal affixed connection of the securing the upper through bolt hole 138fb of the joining plate 170b through the seventh latitudinal through holes horizontal single rim joists 182 or horizontal single rim joists beam 183 to the vertical column 180.

The primordial method of bracket 168f lower through bolt hole 138s in the connecting leg 124f being offset from bracket 149e upper through bolt hole 138n in the connecting leg 128e allows the upwards top face surface of the short supporting flange 132f of bracket 168f to aligned parallel with the upwards top face surface of the single horizontal joist 184 or double horizontal joist beam 185 and companion spacer blocks 186 forming the main structural supports ensuring that all joist supported by the single horizontal joist 184 or double horizontal joist beam 185 are in alignment with the horizontal single rim joists 182 or the horizontal double rim joist beam 183. Thereby, forming the horizontal double rim joist beam 183 or double horizontal joist beam 185 into an main structural element the horizontal main girder support beam for the floor joist to be support atop the upwards top facing surface.

The three primary main structural support members the horizontal single rim joist 182 or horizontal double rim joist beam 183, the vertical column 180 and the horizontal support beam 181 with the series of brackets: the bracket 168f, bracket 149e, bracket and joining plate 170b are affixed and interlocked forming the main structural supports of the structure and the method of new construction practices, bolting techniques and the embodiments of the invention of bracket 168f, bracket 149e and joining plate 170b in FIG. 7.

FIG. 23 depicts the eighth fabricated embodiment bracket 168f, first fabricated embodiment bracket 130, third fabricated embodiment is joining plate 170a and fifth fabricated embodiment joining plate 170b, the installation practices and bolting connecting techniques of the eight affixed interlocking connections comprising of: the eight main latitudinal locking connections to the structural components such as the vertical column 180, horizontal single rim joists 182 or the horizontal double rim joist beam 183 and single horizontal joist 184 or double horizontal joist beam 185 forming the main structural supports of the structure and forming a several horizontal equal planes.

As detailed below the bracket 168f, bracket 130, joining plate 170a and joining plate 170b are particularly advantageous for usage in new construction structures and allowing existing construction practices to be reevaluated on the merit or character of durability to time and especially severe inclement elements forming the eighth new construction techniques and practices incorporating the bracket 168f, bracket 130, joining plate 170a and joining plate 170b.

As described hereinbefore in the delineated assembly is in a more detailed illustration in FIG. 8 where the designated components are explained and illustrated on the design principles on the eighth method of new construction and each of the fabricated embodiments: eighth fabricated embodiment bracket 168f, first fabricated embodiment bracket 130, third fabricated embodiment is joining plate 170a and the fifth fabricated embodiment joining plate 170b.

The bracket 130 is to be arranged in an upside down “L” shape configuration longitudinally to the outwards front face surface of the vertical column 180, the position of the short supporting flanges 132a upwards top face surface 126a is latitudinally positioned to the downwards bottom face surface of the horizontal single rim joists 182 or the horizontal double rim joists 183 and the connecting legs 128a inwards back face surface 140a is longitudinally positioned to the outwards front face surface of the vertical column 180, together define a L-shaped bracket. The connecting leg 128a of bracket 130 is provided with a longitudinal row of through holes the lower through hole 138a and the upper through hole 138b. The bracket 130 connecting leg 128a height is longer then the supporting flange length.

The corner edge 124a of brackets 130 inwards back face surface 140a intersects the longitudinal outwards front face surface of the vertical column 180 and the upwards top face surface 126a of the short supporting flange 132a intersects the latitudinal bottom face surface of the horizontal single rim joists 182 or the horizontal double rim joists beam 183.

The bracket 168f is to be arranged in an upside down “L” shape configuration longitudinally to the outwards side face surface of the vertical column 180 vertical column 180, the position of the short supporting flanges 132f upwards top face surface 126f is latitudinally positioned to the downwards bottom face surface of the single horizontal joists 184 or the double horizontal joists 185 and the connecting legs 128f inwards back face surface 140f is longitudinally positioned to the outwards front face surface of the vertical column 180, together define a L-shaped bracket. The connecting leg 128f of bracket 168f is provided with a longitudinal row of through holes the lower through hole 138s and the upper through hole 138t. The bracket 168f connecting leg 128f height is longer then the supporting flanges 132f length.

The corner edge 124f of brackets 168f inwards back face surface 140f intersects the longitudinal outwards side face surface of the vertical column 180 and the upwards top face surface 126f of the short supporting flange 132f intersects the latitudinal bottom face surface of the single horizontal joists 184 or the double horizontal joists beam 185.

The coinciding heights of the upwards top facing surface of the single horizontal joists 184 or the double horizontal joists beam 185 opposing side the downwards bottom facing surface is supported by the upwards facing top surface 126f of the supporting flange 132f of bracket 168f and the horizontal single rim joists 182 or the horizontal double rim joists 183 downwards bottom facing surface is supported by the upwards facing top surface 126a of the supporting flange 132a of bracket 130 allowing for an proportional horizontal planes or two equal horizontal planes converging on a several horizontal segmented planes.

Once the positioning has been determined on the height of the main structural supports of the structure, the through holes first lower hole and second upper hole in the median of the vertical column 180 forming the main structural support can be drilled and completed to height dimension requirements: the coinciding height intersections of the vertical column forming the main structural support to the bracket 168f flange 132f supporting the downwards bottom facing surface of the single horizontal joists 184 or the double horizontal joists beam 185 intersects the height level to the downwardly bottom facing surface of the horizontal single rim joist 182 or horizontal double joist rim beam 183 supported by the bracket 130 supporting flange 132a upwards facing top surface 126a.

The first latitudinal aligned through hole consists of a systematic two phase drilling technique to accomplish the first latitudinal aligned drilling through the vertical column 180. The first phase of the drilling technique consists of the lower through bolt hole 138a of the connecting leg 128a of bracket 130 being used as template guides to insure positioning and the alignment of the outward front face surface drilling to the median of the vertical column 180. The second phase of the drilling technique consists of the bracket 130 being place on the opposite inwards back facing surface at the height requirements of the first phase of the outwards front facing surface drilling technique and lower through bolt hole 138a of the connecting leg 128a of bracket 130 being used as template guides to insure positioning and the alignment of the inwards back face surface drilling through the vertical column 180 coinciding with the first phase of the drilling technique establishes first latitudinal aligned through hole in the vertical column 180.

The second latitudinal aligned through hole consists of a systematic two phase drilling technique to accomplish the second latitudinal aligned drilling through the vertical column 180. The first phase of the drilling technique consists of the upper through bolt hole 138b of the connecting leg 128a of bracket 130 being used as template guides to insure positioning and the alignment of the outward front face surface drilling to the median of the vertical column 180. The second phase of the drilling technique consists of the bracket 130 being place on the opposite inwards back facing surface at the height requirements of the first phase of the outwards front facing surface drilling technique and upper through bolt hole 138b of the connecting leg 128a of bracket 130 being used as template guides to insure positioning and the alignment of the inwards back face surface drilling through the vertical column 180 coinciding with the first phase of the drilling technique establishes second latitudinal aligned through hole in the vertical column 180.

The first affixed interlocking is latitudinally consisting of a galvanized washer 143 being affixed to a galvanized through bolts' 144 threads. The threads of the galvanized through bolt 144 are passed through the brackets' 130 connecting leg 128a lower through bolt hole 138a through the pre drilled first latitudinal through hole in the vertical column 180 where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the first latitudinal affixed connection of the bracket 130 lower through bolt hole 138a through the first latitudinal through hole in the vertical column 180.

The second affixed interlocking is latitudinally consisting of a galvanized washer 143 being affixed to a galvanized through bolts' 144 threads. The threads of the galvanized through bolt 144 are passed through the brackets' 130 connecting leg 128a upper through bolt hole 138b through the pre drilled second latitudinal through hole in the vertical column 180 where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the second latitudinal affixed connection of the bracket 130 upper through bolt hole 138b through the second latitudinal through hole in the vertical column 180.

The third latitudinal aligned through hole consists of a systematic two phase drilling technique to accomplish the third latitudinal aligned drilling through the vertical column 180. The first phase of the drilling technique consists of the lower through bolt hole 138s of the connecting leg 128f of bracket 168f being used as template guides to insure positioning and the alignment of the outward side face surface drilling to the median of the vertical column 180. The second phase of the drilling technique consists of the bracket 168s being place on the opposite inwards side facing surface at the height requirements of the first phase of the outwards side facing surface drilling technique and lower through bolt hole 138s of the connecting leg 128f of bracket 168f being used as template guides to insure positioning and the alignment of the inwards side face surface drilling through the vertical column 180 coinciding with the first phase of the drilling technique establishes third latitudinal aligned through hole in the vertical column 180.

The fourth latitudinal aligned through hole consists of a systematic two phase drilling technique to accomplish the second latitudinal aligned drilling through the vertical column 180. The first phase of the drilling technique consists of the upper through bolt hole 138t of the connecting leg 128f of bracket 168f being used as template guides to insure positioning and the alignment of the outward side face surface drilling to the median of the vertical column 180. The second phase of the drilling technique consists of the bracket 168f being place on the opposite inwards side facing surface at the height requirements of the first phase of the outwards side facing surface drilling technique and upper through bolt hole 138t of the connecting leg 128f of bracket 168f being used as template guides to insure positioning and the alignment of the inwards side face surface drilling through the vertical column 180 coinciding with the first phase of the drilling technique establishes fourth latitudinal aligned through hole in the vertical column 180.

The third affixed interlocking is latitudinally consisting of a galvanized washer 143 being affixed to a galvanized through bolts' 144 threads. The threads of the galvanized through bolt 144 are passed through the brackets' 168f connecting leg 128f lower through bolt hole 138s through the pre drilled third latitudinal through hole in the vertical column 180 where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the third latitudinal affixed connection of the bracket 168f lower through bolt hole 138s through the third latitudinal through hole in the vertical column 180.

The fourth affixed interlocking is latitudinally consisting of a galvanized washer 143 being affixed to a galvanized through bolts' 144 threads. The threads of the galvanized through bolt 144 are passed through the brackets' 168f connecting leg 128f upper through bolt hole 138s through the pre drilled fourth latitudinal through hole in the vertical column 180 where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the fourth latitudinal affixed connection of the bracket 130 upper through bolt hole 138b through the fourth latitudinal through hole in the vertical column 180.

The bracket 130 short supporting flange 132a extends latitudinally outwards of the longitudinal outwards front face surface of the vertical column 180 and the bracket 168f short supporting flange 132f extends latitudinally outwards of the longitudinal outwards side face surface of the vertical column 180. A “T” shape configuration is formed by angled corner viewing of the intersection of the horizontal supporting plane of the bracket 130 short supporting flange 132a to the vertical column to the horizontal supporting plane of the bracket 168f short supporting flange 132f allowing for equally latitudinal heights planes to the single longitudinal plane vertically.

Positioned atop the upwards top face surface 126a of the short supporting flange 132a of the bracket 130 latitudinally the downwards bottom face surface of the horizontal single rim joists 182 or the horizontal double rim joists 183 accompanied by the downwards bottom face surface 174b of joining plate 170b having an opposing side the upwards top surface 175b.

The joining plate 170b inwards back face surface 172b is to be positioned in front of the outwards front face surface of the horizontal single rim joists 182 or the horizontal double rim joists 183. The joining plate 170b consists of latitudinal connecting elements the lower through bolt hole 138eb and an upper through bolt hole 138fb longitudinally aligned in a row along the median of the planner plate 169b. The width specifications of the joining plate 170a outer edges are to be to the longitudinal width specifications of the vertical column 180 forming the main vertical structural support and the height specification of the joining plate 170b planner plate 169b surface is to be longitudinal height of the horizontal single rim joists 182 or the horizontal double rim joists 183 forming the main horizontal structural supports.

The fifth latitudinal aligned through hole consists of a systematic single phase drilling technique to accomplish the fifth latitudinal aligned drilling through the horizontal single rim joists 182 or the horizontal double rim joists 183. The single phase of the drilling technique consists of the lower through bolt hole 138eb of the planner plate 169b of joining plate 170b being used as a drilling template guide for drilling through the outwards front face surface of the horizontal single rim joists 182 or the horizontal double rim joists 183 to outwards front face surface of the vertical column 180 establishes fifth latitudinal aligned through hole in the horizontal single rim joists 182 or the horizontal double rim joists 183 to the vertical column 180.

The sixth latitudinal aligned through hole consists of a systematic single phase drilling technique to accomplish the sixth latitudinal aligned drilling through the horizontal single rim joists 182 or the horizontal double rim joists 183. The single phase of the drilling technique consists of the upper through bolt hole 138fb of the planner plate 169b of joining plate 170b being used as a drilling template guide for drilling through the outwards front face surface of the horizontal single rim joists 182 or the horizontal double rim joists 183 to outwards front face surface of the vertical column 180 establishes sixth latitudinal aligned through hole in the horizontal single rim joists 182 or the horizontal double rim joists 183 to the vertical column 180.

The fifth affixed interlocking is latitudinally consisting of a galvanized washer 143 being affixed to a galvanized lag bolt 146 threads. The threads of the galvanized lag bolt 146 are allowed passage through the lower through bolt hole 138eb joining plate 170b through the pre drilled fifth latitudinal through hole in the horizontal single rim joists 182 or horizontal single rim joists beam 183 to the vertical column's 180 outwards front face surface where the galvanized lag bolt 146 threads are rigidly embedded in the vertical column's 180. Rigidly embedding the galvanized lag bolt's 146 threads forms the fifth latitudinal affixed connection of the securing the lower through bolt hole 138eb of the joining plate 170b through the fifth latitudinal through holes in the horizontal single rim joists 182 or horizontal single rim joists beam 183 to the vertical column 180.

The sixth affixed interlocking is latitudinally consisting of a galvanized washer 143 being affixed to a galvanized lag bolt 146 threads. The threads of the galvanized lag bolt 146 are allowed passage through the upper through bolt hole 138fb joining plate 170b through the pre drilled sixth latitudinal through hole in the horizontal single rim joists 182 or horizontal single rim joists beam 183 to the vertical column's 180 outwards front face surface where the galvanized lag bolt 146 threads are rigidly embedded in the vertical column's 180. Rigidly embedding the galvanized lag bolt's 146 threads forms the sixth latitudinal affixed connection of the securing the upper through bolt hole 138fb of the joining plate 170b through the sixth latitudinal through holes in the horizontal single rim joists 182 or horizontal single rim joists beam 183 to the vertical column 180.

Positioned atop the upwards top face surface 126f of the short supporting flange 132f of the bracket 168f latitudinally the downwards bottom face surface of the single horizontal joists 184 or the double horizontal joists beam 185 accompanied by the downwards bottom face surface 174a of joining plate 170a having an opposing side the upwards top surface 175a.

The joining plate 170a inwards back face surface 172a is to be positioned in front of the outwards front face surface of the single horizontal joists 184 or the double horizontal joists 185. The joining plate 170a consists of latitudinal connecting elements the lower through bolt hole 138ea and an upper through bolt hole 138fa longitudinally aligned in a row along the median of the lower planner plate 169a. The width specifications of the joining plate 170a outer edges are to be to the longitudinal width specifications of the vertical column 180 forming the main vertical structural support and the height specification of the joining plate 170a planner plate 169a surface is to be longitudinal height of the single horizontal joists 184 or the double horizontal joists beam 185 forming the main horizontal structural supports.

The seventh latitudinal aligned through hole consists of a systematic single phase drilling technique to accomplish the seventh latitudinal aligned drilling through the single horizontal joist 184 or the double horizontal joists beam 185. The single phase of the drilling technique consists of the lower through bolt hole 138ea of the planner plate 169a of joining plate 170a being used as a drilling template guide for drilling through the outwards front face surface of the single horizontal joist 184 or the double horizontal joists beam 185 to outwards side face surface of the vertical column 180 establishes seventh latitudinal aligned through hole in the single horizontal joist 184 or the double horizontal joists beam 185 to the vertical column 180.

The eighth latitudinal aligned through hole consists of a systematic single phase drilling technique to accomplish the eighth latitudinal aligned drilling through the single horizontal joist 184 or the double horizontal joists beam 185. The single phase of the drilling technique consists of the upper through bolt hole 138fa of the planner plate 169a of joining plate 170a being used as a drilling template guide for drilling through the outwards front face surface of the single horizontal joist 184 or the double horizontal joists beam 185 to outwards side face surface of the vertical column 180 establishes eighth latitudinal aligned through hole in the single horizontal joist 184 or the double horizontal joists beam 185 to the vertical column 180.

The seventh affixed interlocking is latitudinally consisting of a galvanized washer 143 being affixed to a galvanized lag bolt 146 threads. The threads of the galvanized lag bolt 146 are allowed passage through the lower through bolt hole 138ea joining plate 170a through the pre drilled seventh latitudinal through hole in the single horizontal joist 184 or horizontal single rim joists beam 183 to the vertical column's 180 outwards front face surface where the galvanized lag bolt 146 threads are rigidly embedded in the vertical column's 180. Rigidly embedding the galvanized lag bolt's 146 threads forms the seventh latitudinal affixed connection of the securing the lower through bolt hole 138ea of the joining plate 170a through the seventh latitudinal through holes in the single horizontal joist 184 or double horizontal joists beam 185 to the vertical column 180.

The eight affixed interlocking is latitudinally consisting of a galvanized washer 143 being affixed to a galvanized lag bolt 146 threads. The threads of the galvanized lag bolt 146 are allowed passage through the upper through bolt hole 138fa joining plate 170a through the pre drilled eight latitudinal through hole in the single horizontal joist 184 or double horizontal joists beam 185 to the vertical column's 180 outwards front face surface where the galvanized lag bolt 146 threads are rigidly embedded in the vertical column's 180. Rigidly embedding the galvanized lag bolt's 146 threads forms the eight latitudinal affixed connection of the securing the upper through bolt hole 138fa of the joining plate 170a through the eight latitudinal through holes in the single horizontal joist 184 or double horizontal joists beam 185 to the vertical column 180.

The primordial method of bracket 168f lower through bolt hole 138s in the connecting leg 128f connected to the outwards side face surface of the vertical column 180 being offset from bracket 130 lower through bolt hole 138a in the connecting leg 128a connected to the outwards front face surface of the vertical column 180 ensures passage of both lower through bolts connections first latitudinal connection and third latitudinal connection.

The primordial method of bracket 168f upper through bolt hole 138t in the connecting leg 128f connected to the outwards side face surface of the vertical column 180 being offset from bracket 130 upper through bolt hole 138b in the connecting leg 128a connected to the outwards front face surface of the vertical column 180 ensures passage of both upper through bolts connections second latitudinal connection and fourth latitudinal connection.

The primordial method of using bracket 130, bracket 168f, joining plate 170a and joining plate 170b in FIG. 23 is to illustrates the eight affixed interlocking consisting of eight latitudinal locking connections in a structure formed of proportional horizontal plane using single horizontal joist 184 or double horizontal joist beam 185 horizontal as the first horizontal plane and horizontal single rim joists 182 or the horizontal double rim joist beam 183 as second horizontal plane intersecting into a single supporting equally horizontal plane.

The primordial method of bracket 168f short supporting flange 132f being positioned outwards of the outwards side face surface of the vertical column 180 and bracket 130 short supporting flange 132a being positioned outwards of the outwards front face surface of the vertical column 180 allowing the upwardly top face surfaces of both short supporting flanges to be on an equally horizontal plan. Thereby, forming the horizontal double rim joist beam 183 or double horizontal joist beam 185 into a main structural element the horizontal main girder support beam for the floor joist to be support atop the upwards top facing surface.

The five primary main structural support members the horizontal single rim joist 182 or horizontal double rim joist beam 183, the vertical column 180 and the single horizontal joist 184 or double horizontal joist beam 185 with the bracket 168f, bracket 130, joining plate 170a and joining plate 170b are affixed and interlocked forming the main structural supports of the structure and the method of new construction practices, bolting techniques and the embodiments of the invention of bracket 168f, bracket 130, joining plate 170a and joining plate 170b in FIG. 8.

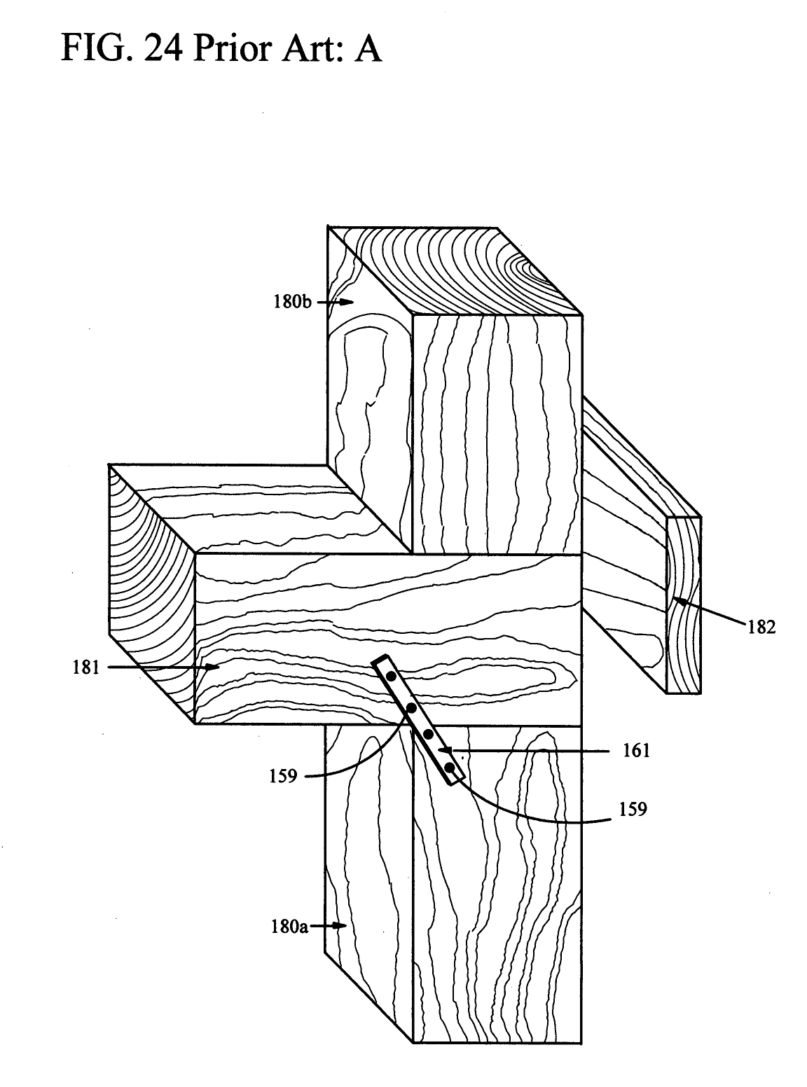

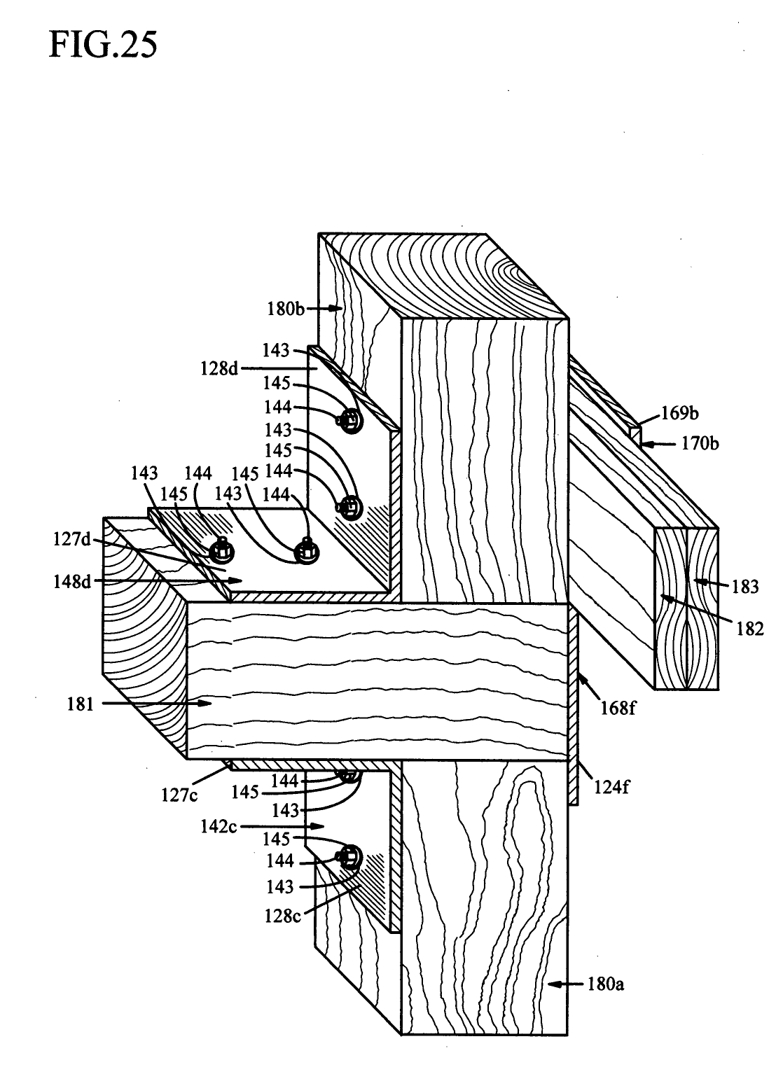

FIG. 24 (Prior Art: A) and FIG. 25 depict the fabricated bracket 168f, bracket 142c, bracket 148d and joining plate 170b installation practices for reinforcing and bolts connecting technique of the five main latitudinal locking connections and two longitudinal locking connections to the structural components such as the vertical column 180a, vertical column 180b, horizontal single rim joists 182 or the horizontal double rim joist beam 183, and horizontal support beam 181 forming the main structural supports of an exist structure as illustrated in FIG. 24 (Prior Art: A).

As detailed below, the fabricated bracket 168f, bracket 142c, bracket 148d and joining plate 170b are particularly advantageous for usage in reinforcing exist structures using the old construction practices and allowing exist construction practices to be reevaluated on the merit or character of durability to time and especially severe inclement elements.

As described hereinbefore the delineated assembly is in a more detailed illustration in FIG. 6, whereby the each of the fabricated embodiments; bracket 168f, bracket 142c, bracket 148d and joining plate 170b designated components are explained and illustrated in detail on the sixth method of new construction disclosed hereinbefore in FIGS. 19 and 20 are applicable for reinforcing exist structures using the old construction practices.

In FIG. 24 (Prior Art: A) are past construction techniques and practices where vertical column 180a was position to the height requirement of the structure supporting the horizontal support beam 181 where a metal strap 161 angled to intersect the outwardly side face surface of the horizontal support beam 181 and the outwardly side face surface of the vertical column 181a forming the main structural support of the structure whereby, nails secure the metal strap 161 and the vertical column 180b forming the main structural support of the structure was positioned on the upwardly top face surface of the horizontal support beam 181 forming the main structural support of the structure. The outwardly side face surface of the horizontal single rim joist was secured with nails to the outwardly side face surface of the vertical column 180b. This method allowed the joist to be positioned on the upwardly top face surface of the horizontal support beam 181 forming the main structural support of the structure. Presently this type construction practice is not used do to shifting of the vertical column 180b forming the main structural support of the structure. At present these structures are still standing and needing reinforcement, in FIG. 25 depiction illustrates the fabricated bracket 168f, bracket 142c, bracket 148d and joining plate 170b reinforcing the structure in FIG. 24 (Prior Art: A). As detailed below in the installation practices for reinforcing and bolts connecting techniques in this section, illustrated in FIG. 6 in the four embodiments of the invention and the sixth method of new construction and referred to in this installation practices for reinforcing exist structures and allowing exist construction practices to be reevaluated on the merit or character of durability to time and especially severe inclement elements as outlined hereinbefore FIGS. 19 and 20.

The bracket 142c is to be arranged in an upside down reversed “L” shape configuration longitudinally to the vertical column 180 upwards top face surface cut off height, the position of the long supporting flanges 127c upwards top face surface 141c is latitudinally positioned under to the downwards bottom face surface of the horizontal support beam 181 supported by the upwards top face surface cut off height of the vertical column 180a and the connecting leg 128c inwards back face surface 140c is longitudinally positioned to the inwards back face surface of the vertical column 180, together define a L-shaped bracket. The connecting leg 128c of bracket 142c is provided with a longitudinal row of through holes the lower through hole 138cc and the upper through hole 138dc. The bracket 142c connecting leg's 128c height is equal to the supporting flange's 127c length.

The corner edge 124c of bracket 142c coinciding height intersects the inwards back face surface of the vertical column 180a upwards top face surface cut off height and the upwards top face surface 141c of the long supporting flange 127c intersects the bottom face surface of the horizontal support beam 181.

Positioned latitudinally atop the upwards top face surface of the vertical column 181a is the downwards bottom face surface of the horizontal support beam 181 forming a horizontal structural support member.

The bracket 168f is to be arranged in an upside down “L” shape configuration longitudinally to the vertical column 180, the position of the short supporting flanges 132f upwards top face surface 126f is latitudinally positioned to the upwards top face surface of the horizontal support beam 181 latitudinal length requirements for structure and the connecting legs 128f inwards back face surface 140f is longitudinally positioned to the outwards front face surface of the horizontal support beam 181 and outwards front face surface of the vertical column 180, together define a L-shaped bracket. The connecting leg 128f of bracket 168f is provided with a longitudinal row of through holes the lower through hole 138s and the upper through hole 138t. The bracket 168f connecting leg 128f height is longer then the supporting flanges 132f length.

The corner edge 124f of bracket 168f coinciding height intersects the outwards front face surface of the horizontal support beam 181 upwards top face surface.

The coinciding heights of the upwards top facing surface of the horizontal support beam 181 opposing side the downwards bottom facing surface is supported by the upwards facing top surface 141c of the supporting flange 127c and the horizontal single rim joists 182 or the horizontal double rim joists 183 downwards bottom facing surface is supported by the upwards facing top surface 126f of the supporting flange 132f of bracket 168f allowing for an disproportional horizontal planes or two unequal horizontal planes converging on a single horizontal segmented plane.

Once the positioning has been determined on the height and length of the main structural supports of the structure, the through holes first lower hole and second upper hole in the median of the first vertical column 180a forming the main structural support can be drilled and completed to height dimension requirements: the coinciding height intersections of the vertical column 180a forming the main structural support to the bracket 142c flange 127c supporting the downwards bottom facing surface of the horizontal support beam 181 and the height of the horizontal single rim joist 182 or horizontal double joist rim beam 184 downwardly bottom facing surface is level to the upward top facing surface of the horizontal support beam 181 forming the main structural support.

The first latitudinal aligned through hole consists of a systematic single phase drilling technique to accomplish the first latitudinal aligned drilling through the vertical column 180. The first phase of the drilling technique consists of the lower through bolt hole 138cc of the connecting leg 128c of bracket 142c being used as template guides to insure positioning and the alignment of the inwards back face surface drilling through the median of the vertical column 180 to the outward front face surface establishes first latitudinal aligned through hole in the vertical column 180.

The second latitudinal aligned through hole consists of a systematic two phase drilling technique to accomplish the second latitudinal aligned drilling through the vertical column 180. The first phase of the drilling technique consists of the lower through bolt hole 138s of the connecting leg 128f of bracket 168f being used as template guides to insure positioning and the alignment of the outward front face surface drilling to the median of the vertical column 180. The second phase of the drilling technique consists of the upper through bolt hole 138dc of the connecting leg 128c of bracket 142c being used as template guides to insure positioning under the horizontal support beam 181 and the alignment of the inwards back face surface drilling through the vertical column 180 coinciding with the first phase of the drilling technique establishes second latitudinal aligned through hole in the vertical column 180.

The third latitudinal aligned through hole consists of a systematic single phase drilling technique to accomplish the third latitudinal aligned drilling to the median core of the horizontal support beam 181. The single phase of the drilling technique consists of the upper through bolt hole 138t of the bracket 168f being used a drilling template guide for drilling through the bracket 168f to the outwards front face surface of the median core of the horizontal support beam 181 establishes third latitudinal aligned through hole into the median core of the horizontal support beam 181.

The first affixed interlocking is latitudinally consisting of a galvanized washer 143 being affixed to a galvanized through bolts' 144 threads. The threads of the galvanized through bolt 144 are passed through the pre drilled first latitudinal through hole in the vertical column 180 through the brackets' 142c connecting leg 128c lower through bolt hole 138cc where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the first latitudinal affixed connection of the first latitudinal through hole in the vertical column 180 through the bracket 142c lower through bolt hole 138cc.

The second affixed interlocking is latitudinally consisting of a galvanized washer 143 being affixed to a galvanized through bolts' 144 threads. The threads of the galvanized through bolt 144 are passed through the brackets' 168f connecting leg 128f lower through bolt hole 138s through the pre drilled second latitudinal through hole in the vertical column 180 through the brackets' 142c connecting leg 128c upper through bolt hole 138dc where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the second latitudinal affixed connection of the bracket 168f lower through bolt hole 138s through the second latitudinal through hole in the vertical column 180 through the bracket 142c upper through bolt hole 138dc.

The third affixed interlocking is latitudinally consisting of a galvanized washer 143 being affixed to a galvanized lag bolt 146 threads. The threads of the galvanized lag bolt 146 are allowed passage through the upper through bolt hole 138t of the bracket 168f through the pre drilled third latitudinal through hole in the horizontal support beam 181 outwards front face surface in the median core where the galvanized lag bolt 146 threads are rigidly embedded. Rigidly embedding the galvanized lag bolt's 146 threads forms the third latitudinal affixed connection of the securing the upper through bolt hole 138t of the bracket 168f to the horizontal support beam 181.

The bracket 168f short supporting flange 132f extends latitudinally outwards of the longitudinal outwards front face surface of the horizontal support beam 181 being respectively offset by height to the bracket 142c long supporting flange 127c extends latitudinally outwards of the longitudinal inwards back face surfaces of the horizontal support beam 181 and vertical column 180a outward front face surfaces. A “Z” shape configuration is formed from the converging of the segmental horizontal planes of the bracket 168f short supporting flange 132f being offset by longitudinal height to the bracket 142c long supporting flange 127c allowing for a single horizontal segmented plane to the single longitudinal plane vertically herein below.

Positioned latitudinally atop the upwards top face surface 141c of the long supporting flange 127c of the bracket 142c is the downwards bottom face surface of the horizontal support beam 181 forming a horizontal structural support member.

Bracket 148d is to be arranged in a reversed “L” shape, positioning the connecting leg 128d inwards back face surface 140d longitudinally to the inwards back face surface vertical column 180b and the long flange 127d downwards bottom face surface 141d is positioned to the upwards top face surface of the horizontal support beam 181 forming a main structural support. The position of the long flange 127d upwards top face surface 141c of bracket 142c conforms to a connecting element connecting the upwards top face surface median of the horizontal support beam 181 through to the opposing side the downwards bottom face surface.

The bracket 148d long supporting flange 127d connecting elements consist of a row of latitudinal through holes the front through bolt hole 138i and the rear through bolt hole 138j arranged in the median in the long flange 127d through upwards top face surface 141d through to downwards bottom face surface 147d the allowing for an affixed interlocking longitudinally of the upwards top face surface of the horizontal support beam 181 is positioned atop the upwards top face surface 141c of the long supporting flange 127c of bracket 142c. The connecting leg 128d of bracket 148d is provided with a longitudinal row of through holes the lower through hole 138k and the upper through hole 138l. The connecting leg 128d of bracket 148d is provided with a longitudinal row of through holes the lower through hole 138k and the upper through hole 138l and the long flange 127d is provided with a latitudinal row of through holes the front through hole 138i and the rear through hole 138j. The connecting leg 128d and long flange 127d of bracket 148d have aligned through holes and the connecting leg 128d height is equal to the long flange 127d length.

The corner edge 124d of bracket 148d coinciding height intersects the inwards back face surface of the vertical column 180b forming the main vertical structural support and the bottom face surface of the horizontal support beam 181. Positioning a cut off scrap piece of vertical column template guide atop the upwards top surface and aligning with the outwards front face surface of the horizontal beam 181 will assist in the determining the position of the corner edge 124d of bracket 148d to the horizontal support beam 181.

The first longitudinal aligned through hole consists of a systematic two phase drilling technique to accomplish the first longitudinal aligned drilling through the horizontal support beam 181. The first phase of the drilling technique consists of the rear through bolt hole 138g of the brackets 142c long supporting flange 127c as a drilling template guide for drilling through the downwards bottom face surface to the median of the horizontal support beam 181. The second phase of the drilling technique consists of the rear through bolt hole 138j of the brackets 148d long supporting flange 127d being used as template guides to insure positioning and the alignment of the drilling through the upwards top face surface of the horizontal support beam 181 coinciding with the first phase of the drilling technique establishes first longitudinal aligned through hole in the horizontal support beam 181.

The second longitudinal aligned through hole consists of a systematic two phase drilling technique to accomplish the second longitudinal aligned drilling through the horizontal support beam 181. The first phase of the drilling technique consists of the front through bolt hole 138h of the brackets 142c long supporting flange 127c as a drilling template guide for drilling through the downwards bottom face surface to the median of the horizontal support beam 181. The second phase of the drilling technique consists of the front through bolt hole 138i of the brackets 148d long supporting flange 127d being used as template guides to insure positioning and the alignment of the drilling through the upwards top face surface of the horizontal support beam 181 coinciding with the first phase of the drilling technique establishes second longitudinal aligned through hole in the horizontal support beam 181.

The fourth affixed interlocking is longitudinally consisting of a galvanized washer 143 being affixed to a galvanized through bolts' 144 threads. The threads of the galvanized through bolt 144 are passed through the brackets' 142c long supporting flange 127c rear through bolt hole 138g through the pre drilled first longitudinal through hole in the horizontal support beam 181 passing through brackets' 148d long supporting flange 127d rear through bolt hole 138j where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the first longitudinal affixed connection of the bracket 142c rear through bolt hole 138g through the first longitudinal through hole in the horizontal support beam 181 through the bracket 148d rear through bolt hole 138j.

The fifth affixed interlocking is longitudinally consisting of a galvanized washer 143 being affixed to a galvanized through bolts' 144 threads. The threads of the galvanized through bolt 144 are passed through the brackets' 142c long supporting flange 127c front through bolt hole 138h through the pre drilled second longitudinal through hole in the horizontal support beam 181 passing through brackets' 148d long supporting flange 127d front through bolt hole 138i where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the second longitudinal affixed connection of the bracket 142c front through bolt hole 138h through the second longitudinal through hole in the horizontal support beam through 181 bracket 148d front through bolt hole 138i.

Once brackets' 142c long supporting flange 127c has been secured to the upwards top face surface of the horizontal support beam 181 the vertical column 181b downwards bottom face surface is positioned atop the upwards top face surface of the horizontal support beam 181 and coinciding with the outwards front face surface of the horizontal support beam 181 is the outwards front face surface of the vertical column 181b.

Positioned atop the upwards top face surface 126f of the short supporting flange 132f of the bracket 168f latitudinally the downwards bottom face surface of the horizontal single rim joists 182 or the horizontal double rim joists 183 accompanied by the downwards bottom face surface 174b of joining plate 170b having an opposing side the upwards top surface 175b.

The joining plate 170b inwards back face surface 172b is to be positioned in front of the outwards front face surface of the horizontal single rim joists 182 or the horizontal double rim joists 183. The joining plate 170b consists of latitudinal connecting elements the lower through bolt hole 138eb and an upper through bolt hole 138fb longitudinally aligned in a row along the median of the planner plate 169b. The width specifications of the joining plate 170b outer edges are to be to the longitudinal width specifications of the vertical column 180b forming the second main vertical structural support and the height specification of the joining plate 170b planner plate 169b surface is to be longitudinal height of the horizontal single rim joists 182 or the horizontal double rim joists 183 forming the main horizontal structural supports.

The fourth latitudinal aligned through hole consists of a systematic two phase drilling technique to accomplish the first latitudinal aligned drilling through the vertical column 180b. The first phase of the drilling technique consists of the lower through bolt hole 138eb of the planner plate 169b of the joining plate 170b being used as template guides to insure positioning and the alignment of the outward front face surface drilling through the horizontal single rim joists 182 or the horizontal double rim joists 183 to the median of the vertical column 180b. The second phase of the drilling technique consists of the lower through bolt hole 138k of the connecting leg 128d of bracket 148d being used as template guides to insure positioning and the alignment of the drilling through the inwards back face surface drilling through the vertical column 180b coinciding with the first phase of the drilling technique establishes fourth latitudinal aligned through hole 138 through the horizontal single rim joists 182 or the horizontal double rim joists 183 and vertical column 180b.

The fifth latitudinal aligned through hole consists of a systematic two phase drilling technique to accomplish the second latitudinal aligned drilling through the vertical column 180b. The first phase of the drilling technique consists of the upper through bolt hole 138fb of the planner plate 169b of the joining plate 170b being used as template guides to insure positioning and the alignment of the outward front face surface drilling through the horizontal single rim joists 182 or the horizontal double rim joists 183 to the median of the vertical column 180b. The second phase of the drilling technique consists of the upper through bolt hole 138l of the connecting leg 128d of bracket 148d being used as template guides to insure positioning and the alignment of the drilling through the inwards back face surface drilling through the vertical column 180b coinciding with the second phase of the drilling technique establishes fifth latitudinal aligned through hole 138 through the horizontal single rim joists 182 or the horizontal double rim joists 183 and vertical column 180b.

The sixth affixed interlocking is latitudinally consisting of a galvanized washer 143 being affixed to a galvanized through bolts' 144 threads. The threads of the galvanized through bolt 144 are passed through the joining plate 170b lower through bolt hole 138eb through the pre drilled fourth latitudinal through hole in the horizontal single rim joists 182 or the horizontal double rim joists 183 and vertical column 180b through the brackets' 148d connecting leg 128d lower through bolt hole 138k where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the fourth latitudinal affixed connection of the joining plate 170b lower through bolt hole 138eb through the fourth latitudinal through holes in the horizontal single rim joists 182 or the horizontal double rim joists 183 and vertical column 180b through the bracket 149d lower through bolt hole 138k.

The seventh affixed interlocking is latitudinally consisting of a galvanized washer 143 being affixed to a galvanized through bolts' 144 threads. The threads of the galvanized through bolt 144 are passed through the joining plate 170b upper through bolt hole 138fb through the pre drilled fifth latitudinal through hole in the horizontal single rim joists 182 or the horizontal double rim joists 183 and vertical column 180b through the brackets' 148d connecting leg 128d upper through bolt hole 138l where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the fifth latitudinal affixed connection of the joining plate 170 upper through bolt hole 138fb through the fifth latitudinal through hole in the horizontal single rim joists 182 or the horizontal double rim joists 183 and vertical column 180b through the bracket 148d upper through bolt hole 138l.

The primordial method of using the bracket 168f, bracket 142c, bracket 148d and joining plate 170b as templates is advantageous to positioning and drilling the through holes in the structural components such as the vertical column 180a, vertical column 180b, horizontal single rim joists 182 or the horizontal double rim joist beam 183, and horizontal support beam 181 forming the main structural supports ensuring that the through holes align and interlocking element such as through bolts 144, lag bolts 146, washers 143, through bolt hex nuts 145 align with bracket 142c, 168f and joining plate 170b through holes allowing for structural integrity in the conjugational union.

The primordial method of bracket 168f lower through bolt hole 138s in the connecting leg 128f being offset from bracket 142c upper through bolt hole 138dc in the connecting leg 128c allows the upwards top facing surface of the short supporting flange 132f of bracket 168f to aligned parallel with the upwards top facing surface of the horizontal support beam 181 forming the main structural supports ensuring that all joist supported by the horizontal support are in aligned with the horizontal single rim joists 182 or the horizontal double rim joist beam 183.

The primordial method of using bracket 168f, bracket 142c, bracket 148d and joining plate 170b in FIGS. 19 and 20 is to illustrates the affixed five latitudinal interlocking connections and the affixed two longitudinal interlocking connections in a structure formed of stacking method and the disproportional horizontal planes using a horizontal support beam 181 as first horizontal plane and horizontal single rim joists 182 or the horizontal double rim joist beam 183 as second horizontal plane intersecting into a single supporting horizontal plane. Thereby, forming the horizontal support beam 181 into an main structural element the horizontal main girder support beam for the floor joist and vertical column 180b to be support atop the upwards top facing surface.

The four primary main structural support members the horizontal single rim joist 182 or horizontal double rim joist beam 183, the vertical column 180a, vertical column 180b and the horizontal support beam 181 with the bracket 168f, bracket 142c, bracket 148d and joining plate 170b are affixed and interlocked forming the main structural supports of the structure and the method of new construction practices, bolting techniques and the embodiments of the invention of bracket 168f, bracket 142, bracket 148d and joining plate 170b in FIG. 6.

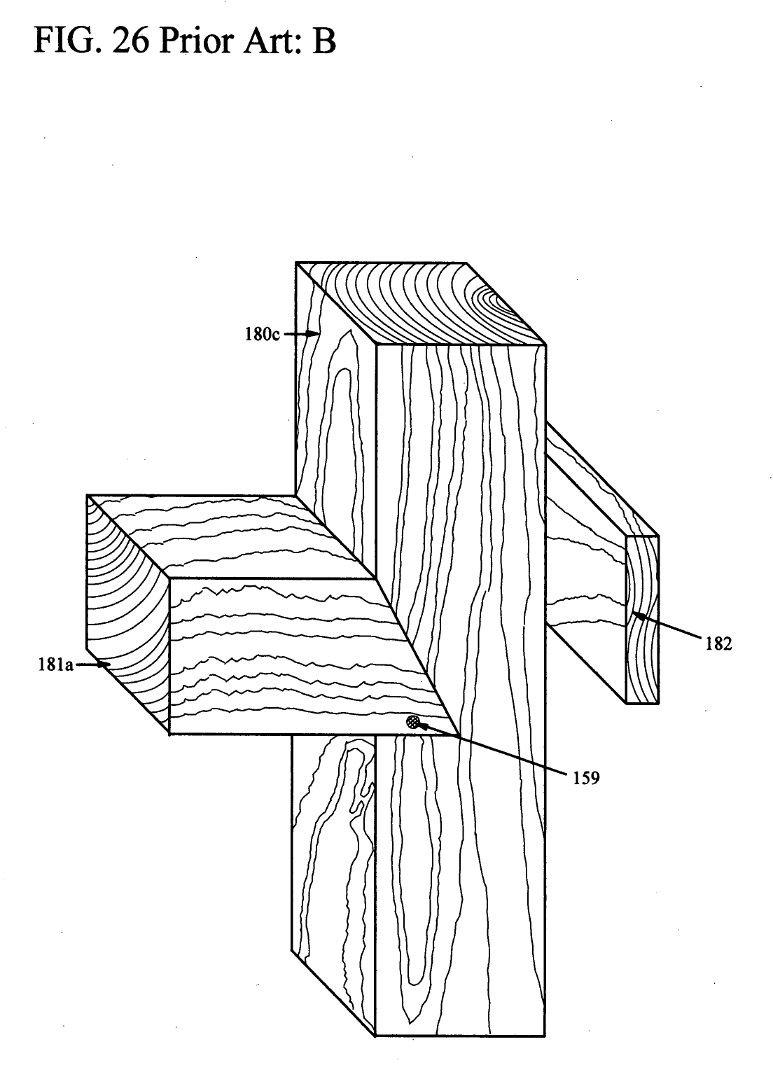

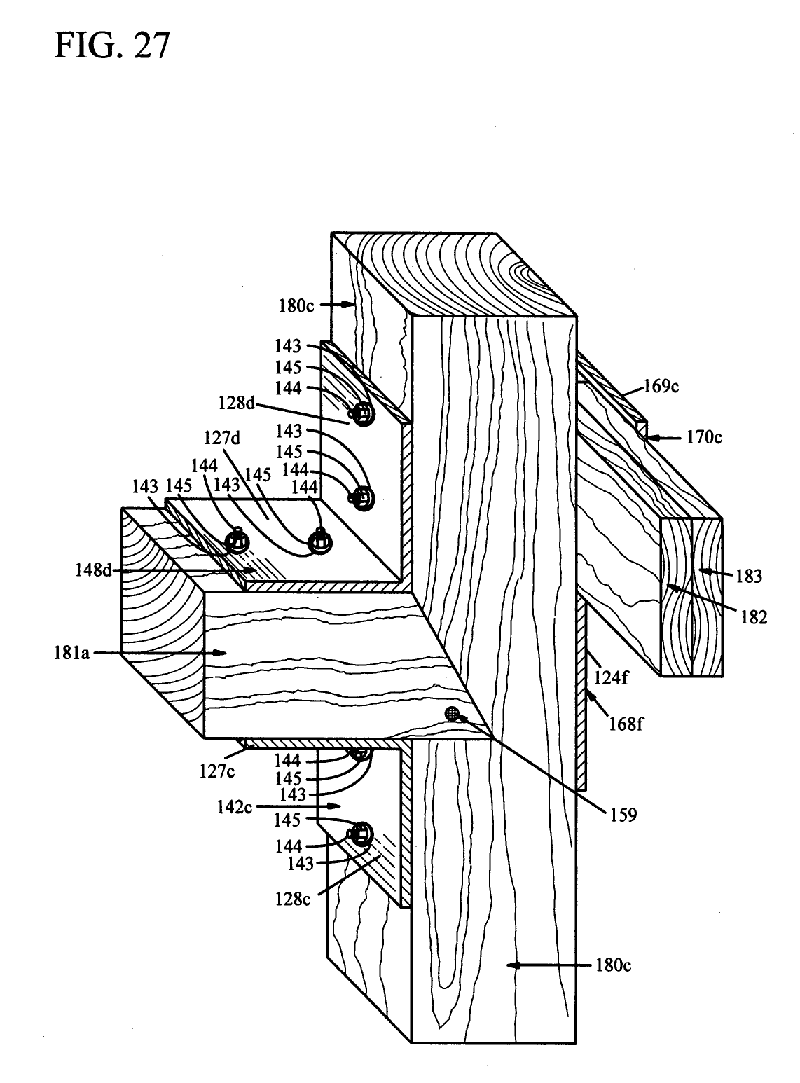

FIG. 26 (Prior Art: B) and FIG. 27 depict the fabricated bracket 168f, bracket 142c, bracket 148d and joining plate 170c installation practices for reinforcing and bolts connecting techniques of the five main latitudinal locking connections, six secondary latitudinal locking connections and two longitudinal locking connections to the structural components such as the vertical column 180c, horizontal single rim joists 182 or the horizontal double rim joist beam 183, and horizontal support beam 181a forming the main structural supports of an existing structures that are notched. As detailed below, the fabricated bracket 168f, bracket 142c, bracket 148d and joining plate 170c are particularly advantageous for usage in reinforcing exist notched structures and allowing existing construction practices to be reevaluated on the merit or character of durability to time and especially severe inclement elements. Whereby each of the fabricated embodiments bracket 168f, bracket 142c, bracket 148d and joining plate 170c designated components are explained in detail on the applicable for reinforcing exist structures using the old construction practices.

In FIG. 26 (Prior Art: B) past construction techniques and practices where the inwardly back face surface of the vertical column 180c were notched with a two and three quarters inwardly cut by five and one haft height and forty five-degree angular stage-notched cutouts at the height of the downwardly face surface of the horizontal support beam 181a to the opposing side the upwards face surface providing a shelf for the supporting the horizontal support beam 181a beveled two and three quarter from the outwardly end face surface to the upwardly top face surface allowing for an angled incline plane to the horizontal support beam 181a outwardly end face surface used to support the horizontal support beam 181a to the angular stage shelf notch of the vertical column 180c. Presently this type construction practice is not used do to weakening of the angled incline plane of the horizontal support beam 181a and vertical column 180c forming the main structural support of the structure. At present these structures are still standing and needing reinforcement, in FIG. 27 depiction illustrates of the fabricated bracket 168f, bracket 142c, bracket 148d and joining plate 170c reinforcing the structure in FIG. 26 (Prior Art: B). The installation practices for reinforcing existing structures and allowing existing construction practices to be reevaluated on the merit or character of durability to time and especially severe inclement elements.

The bracket 168f is to be arranged in an upside down “L” shape configuration longitudinally to the vertical column 180, the position of the short supporting flanges 132f upwards top face surface 126f is latitudinally positioned to the downwards bottom face surface of the horizontal single rim joists 182 or the horizontal double rim joists 183 and the connecting legs 128f inwards back face surface 140f is longitudinally positioned to the outwards front face surface of the vertical column 180, together define a L-shaped bracket. The connecting leg 128f of bracket 168f is provided with a longitudinal row of through holes the lower through hole 138s and the upper through hole 138t. The bracket 168f connecting leg 128f height is longer then the supporting flanges 132f length.

The corner edge 124f of brackets 168f inwards back face surface 140f intersects the longitudinal outwards front face surface of the vertical column 180 and the upwards top face surface 126f of the short supporting flange 132f intersects the latitudinal bottom face surface of the horizontal single rim joists 182 or the horizontal double rim joists beam 183.

The bracket 142c is to be arranged in an upside down reversed “L” shape configuration longitudinally to the vertical column 180, the position of the long supporting flanges 127c upwards top face surface 141c is latitudinally positioned to the downwards bottom face surface of the horizontal support beam 181 and the connecting leg 128c inwards back face surface 140c is longitudinally positioned to the inwards back face surface of the vertical column 180, together define a L-shaped bracket. The connecting leg 128c of bracket 142c is provided with a longitudinal row of through holes the lower through hole 138cc and the upper through hole 138dc. The bracket 142c connecting leg's 128c height is equal to the supporting flange's 127c length.

The corner edge 124c of bracket 142c coinciding height intersects the inwards back face surface of the vertical column 180 and the upwards top face surface 141c of the long supporting flange 127c intersects the bottom face surface of the horizontal support beam 181.

The coinciding heights of the upwards top facing surface of the horizontal support beam 181 opposing side the downwards bottom facing surface is supported by the upwards facing top surface 141c of the supporting flange 127c and the horizontal single rim joists 182 or the horizontal double rim joists 183 downwards bottom facing surface is supported by the upwards facing top surface 126f of the supporting flange 132f of bracket 168f allowing for an disproportional horizontal planes or two unequal horizontal planes converging on a single horizontal segmented plane.

Once the positioning has been determined on the height of the bracket 168f and bracket 142c to the main structural supports of the structure, the through holes first lower hole and second upper hole in the median of the vertical column 180 forming the main structural support can be drilled and completed to height dimension requirements: the coinciding height intersections of the vertical column forming the main structural support to the bracket 142c flange 127c supporting the downwards bottom facing surface of the horizontal support beam 181 and the height of the horizontal single rim joist 182 or horizontal double joist rim beam 184 downwardly bottom facing surface is level to the upward top facing surface of the horizontal support beam 181 forming the main structural support and the horizontal single rim joist 182 or horizontal double joist rim beam 184 are supported by the bracket 168f supporting flange 132f upwards facing top surface 126f.

The first latitudinal aligned through hole consists of a systematic single phase drilling technique to accomplish the first latitudinal aligned drilling through the vertical column 180c. The first phase of the drilling technique consists of the lower through bolt hole 138cc of the connecting leg 128c of bracket 142c being used as template guides to insure positioning and the alignment of the inwards back face surface drilling through the median of the vertical column 180c to the outward front face surface establishes first latitudinal aligned through hole in the vertical column 180c.

The second latitudinal aligned through hole consists of a systematic two phase drilling technique to accomplish the second latitudinal aligned drilling through the vertical column 180c. The first phase of the drilling technique consists of the lower through bolt hole 138s of the connecting leg 128f of bracket 168f being used as template guides to insure positioning and the alignment of the outward front face surface drilling to the median of the vertical column 180c. The second phase of the drilling technique consists of the upper through bolt hole 138dc of the connecting leg 128c of bracket 142c being used as template guides to insure positioning and the alignment of the inwards back face surface drilling through the vertical column 180c coinciding with the first phase of the drilling technique establishes second latitudinal aligned through hole in the vertical column 180c.

The third latitudinal aligned through hole consists of a systematic single phase drilling technique to accomplish the third latitudinal aligned drilling to the median core of the vertical column 180c. The single phase of the drilling technique consists of the upper through bolt hole 138t of the bracket 168f being used a drilling template guide for drilling through the bracket 168f to the outwards front face surface of the median core of the vertical column 180c establishes third latitudinal aligned through hole into the median core of the vertical column 180c.

The first affixed interlocking is latitudinally consisting of a galvanized washer 143 being affixed to a galvanized through bolts' 144 threads. The threads of the galvanized through bolt 144 are passed through the pre drilled first latitudinal through hole in the vertical column 180c through the brackets' 142c connecting leg 128c lower through bolt hole 138cc where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the first latitudinal affixed connection of the first latitudinal through hole in the vertical column 180c through the bracket 142c lower through bolt hole 138cc.

The second affixed interlocking is latitudinally consisting of a galvanized washer 143 being affixed to a galvanized through bolts' 144 threads. The threads of the galvanized through bolt 144 are passed through the brackets' 168f connecting leg 128f lower through bolt hole 138s through the pre drilled second latitudinal through hole in the vertical column 180c through the brackets' 142c connecting leg 128c upper through bolt hole 138dc where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the second latitudinal affixed connection of the bracket 168f lower through bolt hole 138s through the second latitudinal through hole in the vertical column 180c through the bracket 142c upper through bolt hole 138dc.

The third affixed interlocking is latitudinally consisting of a galvanized washer 143 being affixed to a galvanized lag bolt 146 threads. The threads of the galvanized lag bolt 146 are allowed passage through the upper through bolt hole 138t of the bracket 168f through the pre drilled third latitudinal through hole in the vertical column outwards front face surface in the median core where the galvanized lag bolt 146 threads are rigidly embedded. Rigidly embedding the galvanized lag bolt's 146 threads forms the third latitudinal affixed connection of the securing the upper through bolt hole 138t of the bracket 168f to the vertical column 180c.

The bracket 168f short supporting flange 132f extends latitudinally outwards of the longitudinal outwards front face surface of the vertical column 180c being respectively offset by height to the bracket 142c long supporting flange 127c extends latitudinally outwards of the longitudinal inwards back face surface of the vertical column 180c. A “Z” shape configuration is formed from the converging of the segmental horizontal planes of the bracket 168f short supporting flange 132f being offset by longitudinal height to the bracket 142c long supporting flange 127c allowing for a single horizontal segmented plane to the single longitudinal plane vertically.

The latitudinally atop the upwards top face surface 141c of the long supporting flange 127c of the bracket 142c is positioned to the downwards bottom face surface of the horizontal support beam 181a forming a horizontal structural support member.

Bracket 148d is to be arranged in a reversed “L” shape, positioning the connecting leg 128d inwards back face surface 140d longitudinally to the inwards back face surface vertical column 180c and the long flange 127d downwards bottom face surface 141d is positioned to the upwards top face surface of the horizontal support beam 181a forming a main structural support. The position of the long flange 127d upwards top face surface 141c of bracket 142c conforms to a connecting element connecting the upwards top face surface median of the horizontal support beam 181a through to the opposing side the downwards bottom face surface.

The bracket 148d long supporting flange 127d connecting elements consist of a row of latitudinal through holes the front through bolt hole 138i and the rear through bolt hole 138j arranged in the median in the long flange 127d through upwards top face surface 141d through to downwards bottom face surface 147d the allowing for an affixed interlocking longitudinally of the upwards top face surface of the horizontal support beam 181a. The connecting leg 128d of bracket 148d is provided with a longitudinal row of through holes the lower through hole 138k and the upper through hole 138l. The connecting leg 128d of bracket 148d is provided with a longitudinal row of through holes the lower through hole 138k and the upper through hole 138l and the long flange 127d is provided with a latitudinal row of through holes the front through hole 138i and the rear through hole 138j. The connecting leg 128d and long flange 127d of bracket 148d have aligned through holes and the connecting leg 128d height is equal to the long flange 127d length.

The corner edge 124d of bracket 148d coinciding height intersects the inwards back face surface of the vertical column 180c forming the main vertical structural support and the bottom face surface of the horizontal support beam 181a. The inwards back face surface 140d of the connecting leg 128d of bracket 148d is to be positioned atop the upwards top face surface of the horizontal support beam 181a coinciding with the inwards back face surface of the vertical column 180c.

The first longitudinal aligned through hole consists of a systematic two phase drilling technique to accomplish the first longitudinal aligned drilling through the horizontal support beam 181a. The first phase of the drilling technique consists of the rear through bolt hole 138g of the brackets 142c long supporting flange 127c as a drilling template guide for drilling through the downwards bottom face surface to the median of the horizontal support beam 181a. The second phase of the drilling technique consists of the rear through bolt hole 138j of the brackets 148d long supporting flange 127d being used as template guides to insure positioning and the alignment of the drilling through the upwards top face surface of the horizontal support beam 181a coinciding with the first phase of the drilling technique establishes first longitudinal aligned through hole in the horizontal support beam 181a.

The second longitudinal aligned through hole consists of a systematic two phase drilling technique to accomplish the second longitudinal aligned drilling through the horizontal support beam 181a. The first phase of the drilling technique consists of the front through bolt hole 138h of the brackets 142c long supporting flange 127c as a drilling template guide for drilling through the downwards bottom face surface to the median of the horizontal support beam 181a. The second phase of the drilling technique consists of the front through bolt hole 138i of the brackets 148d long supporting flange 127d being used as template guides to insure positioning and the alignment of the drilling through the upwards top face surface of the horizontal support beam 181a coinciding with the first phase of the drilling technique establishes second longitudinal aligned through hole in the horizontal support beam 181a.

The fourth affixed interlocking is longitudinally consisting of a galvanized washer 143 being affixed to a galvanized through bolts' 144 threads. The threads of the galvanized through bolt 144 are passed through the brackets' 142c long supporting flange 127c rear through bolt hole 138g through the pre drilled first longitudinal through hole in the horizontal support beam 181a passing through brackets' 148d long supporting flange 127d rear through bolt hole 138j where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the first longitudinal affixed connection of the bracket 142c rear through bolt hole 138g through the first longitudinal through hole in the horizontal support beam 181a through the bracket 148d rear through bolt hole 138j.

The fifth affixed interlocking is longitudinally consisting of a galvanized washer 143 being affixed to a galvanized through bolts' 144 threads. The threads of the galvanized through bolt 144 are passed through the brackets' 142c long supporting flange 127c front through bolt hole 138h through the pre drilled second longitudinal through hole in the horizontal support beam 181a passing through brackets' 148d long supporting flange 127d front through bolt hole 138i where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the second longitudinal affixed connection of the bracket 142c front through bolt hole 138h through the second longitudinal through hole in the horizontal support beam through 181a bracket 148d front through bolt hole 138i.

The atop the upwards top face surface 126f of the short supporting flange 132f of the bracket 168f latitudinally to the downwards bottom face surface of the horizontal single rim joists 182 or the horizontal double rim joists 183 accompanied by the downwards bottom face surface 174c of joining plate 170c having an opposing side the upwards top surface 175c. The joining plate 170c inwards back face surface 172c is to be positioned in front of the outwards front face surface of the horizontal single rim joists 182 or the horizontal double rim joists 183.

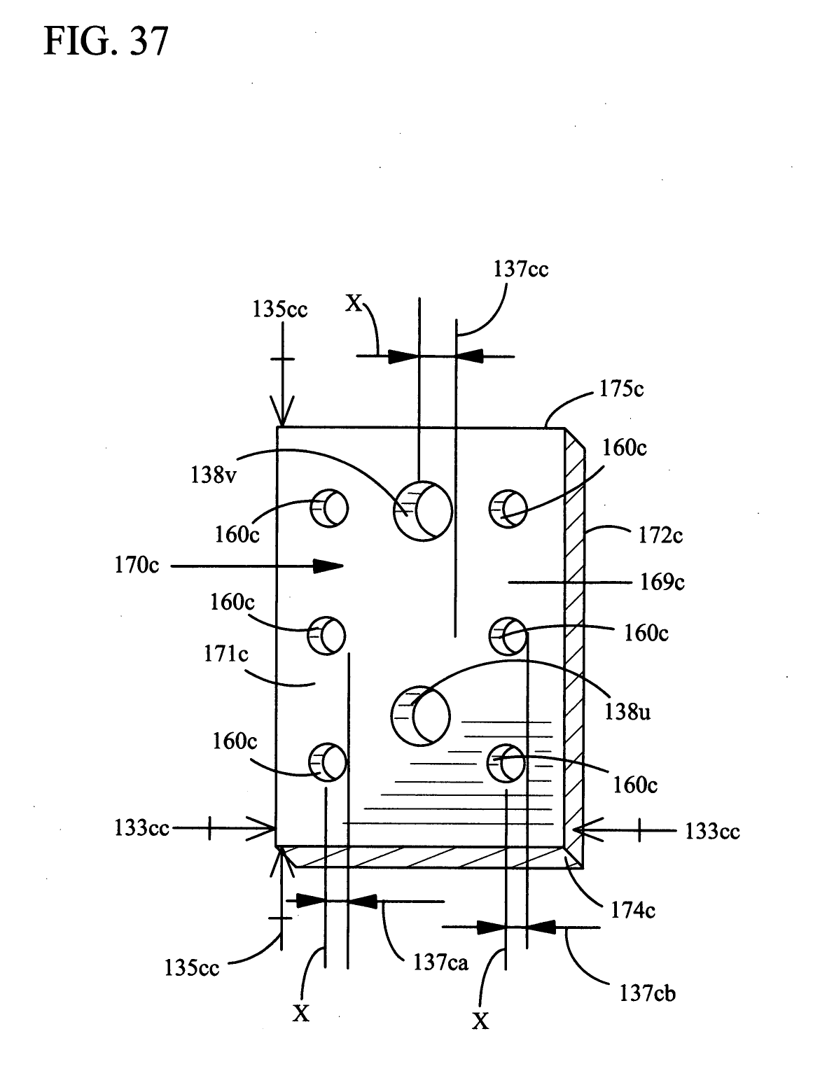

The joining plate 170c consists of latitudinal connecting elements the lower through bolt hole 138u and an upper through bolt hole 138v longitudinally aligned in a row along the median of the planner plate 169c. The width specifications of the joining plate 170c outer edges are to be to the longitudinal width specifications of the vertical column 180c forming the main vertical structural support and the height specification of the joining plate 170c planner plate 169c surface is to be longitudinal height of the horizontal single rim joists 182 or the horizontal double rim joists 183 forming the main horizontal structural supports. The joining plate 170c has series of two rolls of longitudinally aligning smaller diameter through holes 160c offsetting of the median of the planner plate 169c and the outer edges 133c through the outwards facing front surface 171c through the front of the plate 171c through to the inwards facing back surface 172c allowing for nails 159 to be secure one horizontal single rim joist 182 conjoined to another horizontal single rim joist 182 in a union or one horizontal double rim joist 183 conjoined to another horizontal double rim joist 183 ends conjoin together to form a continues horizontal double rim joist 183 in a conjoined union and before the drilling for the sixth and seventh connection through holes. Refer to detailed illustration and specifications in FIG. 37 on the joining plate 170c.

The establishing of the six secondary latitudinal locking connections consist of the hammering six nails through the joining plate 170c six through holes 160c through the outwards facing front surface 171c through the front of the plate 171c through to the inwards facing back surface 172c allowing for nails 159 to be secure the two horizontal single rim joist 183 outwards front face surfaces through to the inward back face surfaces through the outwards front face surface the horizontal double rim joist 182 through to the inward back face surfaces through the outwards front face surface of the vertical column 180c. Where the establishing of the six secondary latitudinal locking connections nailed through the horizontal single rim joists 182 or the horizontal double rim joists 183 to the vertical column 180c.

The fourth latitudinal aligned through hole consists of a systematic two phase drilling technique to accomplish the first latitudinal aligned drilling through the vertical column 180c. The first phase of the drilling technique consists of the lower through bolt hole 138u of the planner plate 169c of the joining plate 170c being used as template guides to insure positioning and the alignment of the outward front face surface drilling through the horizontal single rim joists 182 or the horizontal double rim joists 183 to the median of the vertical column 180c. The second phase of the drilling technique consists of the lower through bolt hole 138k of the connecting leg 128d of bracket 148d being used as template guides to insure positioning and the alignment of the drilling through the inwards back face surface drilling through the vertical column 180c coinciding with the first phase of the drilling technique establishes fourth latitudinal aligned through hole 138 through the horizontal single rim joists 182 or the horizontal double rim joists 183 and vertical column 180c.

The fifth latitudinal aligned through hole consists of a systematic two phase drilling technique to accomplish the second latitudinal aligned drilling through the vertical column 180c. The first phase of the drilling technique consists of the upper through bolt hole 138v of the planner plate 169c of the joining plate 170c being used as template guides to insure positioning and the alignment of the outward front face surface drilling through the horizontal single rim joists 182 or the horizontal double rim joists 183 to the median of the vertical column 180c. The second phase of the drilling technique consists of the upper through bolt hole 138l of the connecting leg 128d of bracket 148d being used as template guides to insure positioning and the alignment of the drilling through the inwards back face surface drilling through the vertical column 180c coinciding with the second phase of the drilling technique establishes fifth latitudinal aligned through hole 138 through the horizontal single rim joists 182 or the horizontal double rim joists 183 and vertical column 180c.

The sixth affixed interlocking is latitudinally consisting of a galvanized washer 143 being affixed to a galvanized through bolts' 144 threads. The threads of the galvanized through bolt 144 are passed through the joining plate 170c lower through bolt hole 138u through the pre drilled fourth latitudinal through hole in the horizontal single rim joists 182 or the horizontal double rim joists 183 and vertical column 180c through the brackets' 148d connecting leg 128d lower through bolt hole 138k where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the fourth latitudinal affixed connection of the joining plate 170c lower through bolt hole 138u through the fourth latitudinal through holes in the horizontal single rim joists 182 or the horizontal double rim joists 183 and vertical column 180c through the bracket 149d lower through bolt hole 138k.

The seventh affixed interlocking is latitudinally consisting of a galvanized washer 143 being affixed to a galvanized through bolts' 144 threads. The threads of the galvanized through bolt 144 are passed through the joining plate 170c upper through bolt hole 138v through the pre drilled fifth latitudinal through hole in the horizontal single rim joists 182 or the horizontal double rim joists 183 and vertical column 180c through the brackets' 148d connecting leg 128d upper through bolt hole 138l where the galvanized through bolts' 144 threads are exposed. The exposing of the galvanized through bolts' 144 threads allows for a galvanized washer 143 to be affixed to a galvanized through bolts' 144 threads with a galvanized through bolt hex nut 145. The galvanized through bolt hex nut 145 is rigidly affixed to the galvanized through bolts' 144 threads and forming the fifth latitudinal affixed connection of the joining plate 170 upper through bolt hole 138v through the fifth latitudinal through hole in the horizontal single rim joists 182 or the horizontal double rim joists 183 and vertical column 180 cc through the bracket 148d upper through bolt hole 138l.

The primordial method of using the bracket 168f, bracket 142c, bracket 148d and joining plate 170c as templates is advantageous to positioning and drilling the through holes in the structural components such as the vertical column 180c, horizontal single rim joists 182 or the horizontal double rim joist beam 183, and horizontal support beam 181a forming the main structural supports ensuring that the through holes align and interlocking element such as through bolts 144, lag bolts 146, washers 143, through bolt hex nuts 145 align with bracket 142c, 168f and joining plate 170c through holes allowing for structural integrity in the conjugational union.

The primordial method of bracket 168f lower through bolt hole 138s in the connecting leg 124f being offset from bracket 142c upper through bolt hole 138d in the connecting leg 128c allows the upwardly top face surface of the short supporting flange 132f of bracket 168f to aligned parallel with the upwardly top face surface of the horizontal support beam 181a forming the main structural supports ensuring that all joist supported by the horizontal support are in aligned with the horizontal single rim joists 182 or the horizontal double rim joist beam 183.

The primordial method of joining plate 170c two aligned rows of smaller diameter through holes is to secure the union of the joining of the two structural members such as horizontal single rim joists 182 or the horizontal double rim joist beam 183.

The three primary main structural support members the horizontal single rim joist 182 or horizontal double rim joist beam 183, the vertical column 180c and the horizontal support beam 181a with the series of brackets: the bracket 168f, bracket 142c, bracket 148d and joining plate 170c are affixed and interlocked forming the main structural supports of the structure and the construction practices, bolting techniques and the embodiments of the invention of bracket 168f, bracket 142, bracket 148d and joining plate 170c.

In FIG. 28 the first fabricated embodiment bracket 130 is comprised of a supporting element or the short flange 132a that is composed of a flat planar plate having a width 134a and flat planar plate length 136a. The short flange 132a is composed of a downwards bottom face surface 125a opposing side the upwardly top surface face 126a for the supporting of the horizontal single rim joist 182, horizontal double rim joist 183 and series joining plate 170, the connecting element or connecting leg 128a that is composed of a flat planar plate having width 133a and height 135a. The connecting leg 128a is composed of an outwardly front surface face 131a and an opposing side the inwardly back face surface 140a.

The connecting leg 128a is provided with a series of through holes through the outwardly front face surface 131a forming the lower through bolt hole 138a and the upper through bolt hole 138b through to the opposing side the inwardly back face surface 140a. The outwardly front face 131a of the connecting leg 128a lower through bolt hole 138a and the upper through bolt hole 138b to the opposing side the inwardly back face surface 140a is adapted to receive bolts for connecting to the outwardly facing surface of a vertical column 180.

The connecting leg 128a width 133a is equal to the short supporting flange 132a width 134a and equal to the width dimensions of the structural members forming the structure.

The positioning and alignment of the through holes in the connecting leg 128a are linearly arranged longitudinally in the median of the connecting leg 128a by the width 133a outer boundaries and respect to the median dimensions longitudinal line 137a of the lumber or composite lumber used as a vertical column connecting elements being offset upwards with respect to the other through hole along the same roll by a distance X along the longitudinal dimensions line 137a. This offset of the upwards through hole helps to provide an aligned connection through the vertical column and reinforces the embodiments of the invention allowing for passage of fasteners through the alignment of the through holes that are centered on the width outer boundaries.

As can be seen with reference to FIGS. 1, 2, 3, 4, 9, 10, 11, 12, 13, 14, 15, 16 and 23, and referred to as the first fabricated embodiment referring to bracket 130 is to be arranged in an upside down “L” shape longitudinally, positioning the short supporting flange 132a upwardly top face surface 126a latitudinally positioned to the downwards bottom face surface of the horizontal single rim joists 182 or the horizontal double rim joists 183 and the connecting leg 128a inwardly back face surface 140a longitudinally positioned to the outwardly front face surface vertical column's 180, together define an L-shaped bracket. The L-shaped bracket is provided with an outer corner edge 124a which is adapted to fit in the interior corner formed between the column outwardly front face surface and the horizontal double rim joist beam 183 inwardly facing back surface. In this way, the upwardly top face surface 126a of the short supporting flange 132a is in abutting relation with the inwardly back face surface 140a of the connecting leg 128a positioned indirect abutting relation to the outwardly facing front surface of the vertical column 180 and the inner corner 123a is in direct abutting relation to the downwards bottom facing surface 125a of the flange 132a and the outwardly front facing surface 131a of the connecting leg 128a.

The bracket 130 embodiment derived from all six proviso features, the manufacturing process of the bracket 130 invention's embodiment is derived from the American Iron and Steel Institute Specifications, the rust preventive coating of the bracket 130, the components' fasteners and connection hardware used in assembly of the structural main support structure using the bracket 130, the component's structural wooden lumber members and/or composite and/or plastic lumber members' width dimensions are the width 133a dimensions of the connecting leg 128a of bracket 130. The first fabricated embodiment bracket 130 proviso specifications for this bracing invention's embodiment herein and hereafter part of the inventions embodiments as reference to the opening six proviso specifications.

In FIG. 29 the second fabricated embodiment bracket 139 is comprised of a supporting element or the long flange 127b that is composed of a flat planar plate a having width 134b and length 136b and an downwards bottom face surface 147b opposing side the upwardly top surface face 141b for the supporting of the horizontal support beam 181 and the connecting element or connecting leg 128b that is composed of flat planar plate a having width 133b and height 135b and an outwardly front surface face 131b opposing side the inwardly back face surface 140b.

The connecting leg 128b is provided with a series of through holes through the outwardly front face surface 131b forming the lower through bolt hole 138c and the upper through bolt hole 138d through to the opposing side the inwardly back face surface 140b. The outwardly front face 131b of the connecting leg 128b lower through bolt hole 138c and the upper through bolt hole 138d to the opposing side the inwardly back face surface 140b are adapted to receive bolts for connecting to the outwardly facing surface of the column 180.

The positioning and alignment of the through holes in the connecting leg 128b are linearly arranged longitudinally in the median of the connecting leg 128b by the width 133b outer boundaries and respect to the median dimensions longitudinal line 137b of the lumber or composite lumber used as a vertical column connecting elements being offset upwards with respect to the other through hole along the same roll by a distance X along the longitudinal dimensions line 137b. This offset of the upwards through hole helps to provide a aligned connection through the vertical column and reinforces the embodiments of the invention allowing for passage of fasteners through the alignment of the through holes that are centered on the width outer boundaries.

The connecting leg 128b height is equal to the connecting flange 127b length, the connecting leg 128b width 133b is equal to the connecting flange 127b width 134b and equal to the width dimensions of the structural members forming the structure.

As can be seen with reference to FIGS. 1, 9 and 10, and referred to as the second fabricated embodiment referring to the bracket 139 is to be arranged in an upside down reversed “L” shape longitudinally, positioning the long supporting flange 127b upwardly top face surface 141b latitudinally positioned to the downwardly bottom face surface of the horizontal support beam 181 and the connecting leg 128b inwardly back face surface 140b longitudinally positioned to the outwardly front face surface vertical column's 180, together define an L-shaped bracket. The L-shaped bracket is provided with an outer corner edge 124b which is adapted to fit in the interior corner formed between the vertical column 180 inwardly facing back surface and the horizontal support beam downwardly bottom face surface. In this way, the upwardly top face surface 141b of the supporting flange 127b is in abutting relation with the inwardly facing leg surface 140b of the connecting leg 128b positioned in direct abutting relation to the column inwardly facing back surface and the inner corner 123b is in direct abutting relation to the downwardly bottom face surface 125b of the support beam supporting flange 132b and the outwardly front face surface 131b of the connecting leg 128b.

The six several proviso features derive the embodiment of the bracket 139, the manufacturing process of the bracket 139 invention's embodiment, the rust preventive coating of the bracket 139, the components' fasteners and connection hardware used in assembly of the structural main support structure using the bracket 139, the component's structural wooden lumber members and/or composite and/or plastic lumber members width dimensions are the width 133b dimensions of the connecting leg 128b of bracket 139. The fourth fabricated embodiment bracket 139 proviso specifications for this bracing invention's embodiment herein and hereafter part of the inventions embodiments as reference the opening six proviso specifications.

In FIG. 30 the fourth fabricated embodiment bracket 142c is comprised of a supporting element or the long flange 127c that is composed of flat planar plate a having width 134c and length 136c and an downwards bottom face surface 147c opposing side the upwards top surface face 141c for the supporting of the horizontal support beam 181 and the connecting element or connecting leg 128c that is composed of flat planar plate a having width 133c and height 135c and an outwards front surface face 131c opposing side the inwards back face surface 140c.

The connecting leg 128c is provided with a series of through holes through the outwards front face surface 131c forming the lower through bolt hole 138a and the upper through bolt hole 138b through to the opposing side the inwards back face surface 140c. The outwards front face 131c of the connecting leg 138c lower through bolt hole 138c and the upper through bolt hole 138d to the opposing side the inwards back face surface 140c are adapted to receive bolts for connecting to the outwards facing surface of the column 180.

The positioning and alignment of the through holes in the connecting leg 128c are linearly arranged longitudinally in the median of the connecting leg 128c by the width 133c outer boundaries and respect to the median dimensions longitudinal line 137c of the lumber or composite lumber used as a vertical column connecting elements being offset upwards with respect to the other through hole along the same roll by a distance X along the longitudinal dimensions line 137c. This offset of the upwards through hole helps to provide a aligned connection through the vertical column and reinforces the embodiments of the invention allowing for passage of fasteners through the alignment of the through holes that are centered on the width outer boundaries.

The connecting flange 127c is provided with a series of through holes through the upwards top face surface 141c forming the front through bolt hole 138h and the rear through bolt hole 138g through to the opposing side the downwards bottom face surface 147c. The upwards top face 141c of the connecting flange 127c front through bolt hole 138g and the rear through bolt hole 138h to the opposing side the downwards bottom face surface 147c are adapted to receive bolts for connecting to the downwards facing surface of the horizontal support beam 181 through to the upwards top face surface.

The positioning and alignment of the through holes in the connecting flange 127c are linearly arranged latitudinally in the median of the connecting flange 127c by the width 134c outer boundaries and respect to the median dimensions longitudinal line 137c of the lumber or composite lumber used as a vertical column connecting elements being offset upwards with respect to the other through hole along the same roll by a distance X along the latitudinal dimensions line 137cc. This offset of the upwards through hole helps to provide a aligned connection through the horizontal support beam 181 and reinforces the embodiments of the invention allowing for passage of fasteners through the alignment of the through holes that are centered on the width outer boundaries.

The connecting leg 128c height is equal to the connecting flange 127c length and the longitudinal through holes lower through bolt hole 138c and the upper through bolt hole 138d are linearly aligned linearly with the latitudinal through holes front through bolt hole 138g and the rear through bolt hole 138h. The connecting leg 128c width 133c is equal to the connecting flange 127c width 134c.

As can be seen with reference to FIGS. 2, 3, 5, 6, 11, 12, 13, 14, 17, 18, 19, 20, 25 and 27, and referred to as the fourth fabricated embodiment referring to the bracket 142c is to be arranged in an upside down reversed “L” shape longitudinally, positioning the long supporting flange 127c upwards top face surface 141c latitudinally positioned to the downwards bottom face surface of the horizontal support beam 181 and the connecting leg 128c inwards back face surface 140c longitudinally positioned to the outwards front face surface vertical column's 180, together define an L-shaped bracket. The L-shaped bracket is provided with an outer corner edge 124c which is adapted to fit in the interior corner formed between the vertical column 180 inwards facing back surface and the horizontal support beam downwards bottom face surface. In this way, the upwards top face surface 141c of the supporting flange 127c is in abutting relation with the inwards facing leg surface 140c of the connecting leg 128c positioned in direct abutting relation to the column inwards facing back surface and the inner corner 123c is in direct abutting relation to the downwards bottom face surface 125c of the support beam supporting flange 132c and the outwards front face surface 131c of the connecting leg 128c.

The six proviso features derives the embodiment of the bracket 142c, the manufacturing process of the bracket 142c invention's embodiment, the rust preventive coating of the bracket 142c, the components' fasteners and connection hardware used in assembly of the structural main support structure using the bracket 142c, the component's structural wooden lumber members and/or composite and/or plastic lumber members width dimensions are the width 133c dimensions of the connecting leg of the bracket 142c. The fourth fabricated embodiment bracket 142c proviso specifications for this bracing invention's embodiment herein and hereafter part of the inventions embodiments as reference the opening six proviso specifications.

In FIG. 31 the sixth fabricated embodiment bracket 148d is comprised of a securing element or the long flange 127b that is composed of flat planar plate a having width 134d and length 136d and an upwards top face surface 147d opposing side the downwards bottom surface face 141d for the securing of the horizontal support beam 181 and the connecting element or connecting leg 128d that is composed of flat planar plate a having width 133d and height 135d and an outwards front surface face 131d opposing side the inwards back face surface 140d.

The connecting leg 128d is provided with a series of through holes through the outwards front face surface 131d forming the lower through bolt hole 138k and the upper through bolt hole 138l through to the opposing side the inwards back face surface 140d.

The positioning and alignment of the through holes in the connecting leg 128d are linearly arranged longitudinally in the median of the connecting leg 128d by the width 133d outer boundaries and respect to the median dimensions longitudinal line 137d of the lumber or composite lumber used as a vertical column 180 connecting elements being offset upwards with respect to the other through hole along the same roll by a distance X along the longitudinal dimensions line 137d. This offset of the upwards through hole helps to provide a aligned connection through the vertical column 180 and reinforces the embodiments of the invention allowing for passage of fasteners through the alignment of the through holes that are centered on the width outer boundaries.

The connecting flange 127d is provided with a series of through holes through the downwards bottom face surface 141d forming the front through bolt hole 138i and the rear through bolt hole 138j through to the opposing side the upwards top face surface 147d. The downwards bottom face 141d of the connecting flange 127d front through bolt hole 138i and the rear through bolt hole 138j to the opposing side the downwards bottom face surface 141d are adapted to receive bolts for connecting the upwards facing surface of the horizontal support beam 181 to the downwards bottom face surface 141d through to upwards top face surface 147d of the connecting flange 127d.

The positioning and alignment of the through holes in the connecting flange 127d are linearly arranged latitudinally in the median of the connecting flange 127d by the width 134d outer boundaries and respect to the median dimensions longitudinal line 137d of the lumber or composite lumber used as a vertical column connecting elements being offset upwards with respect to the other through hole along the same roll by a distance X along the latitudinal dimensions line 137d. This offset of the upwards through hole helps to provide a aligned connection through the median of the horizontal support beam 181 and reinforces the embodiments of the invention allowing for passage of fasteners through the alignment of the through holes that are centered on the width outer boundaries.

The connecting leg 128d height is equal to the connecting flange 127d length and the longitudinal through holes lower through bolt hole 138k and the upper through bolt hole 138l are linearly aligned linearly with the latitudinal through holes front through bolt hole 138i and the rear through bolt hole 138j. The connecting leg 128d width 133d is equal to the connecting flange 127d width 134d.

As can be seen with reference to FIGS. 2, 3, 5, 6, 11, 12, 13, 14, 17, 18, 19, 20, 25 and 27, and referred to as the fourth fabricated embodiment referring to the bracket 148d is to be arranged in an reversed “L” shape longitudinally, positioning the long securing flange 127d downwards bottom face surface 141d latitudinally positioned to the upwards top face surface of the horizontal support beam 181 and the connecting leg 128d inwards back face surface 140d longitudinally positioned to the inwards back face surface vertical column's 180, together define an L-shaped bracket. The L-shaped bracket is provided with an outer corner edge 124d which is adapted to fit in the interior corner formed between the vertical column 180 inwards facing back surface and the horizontal support beam upwards top face surface. In this way, the upwards top face surface 147d of the supporting flange 127d is in abutting relation with the inwards facing leg surface 131b of the connecting leg 128d form the inner corner 123d is in direct abutting relation to the upwards top face surface 147d of the supporting flange 132d and the outwards front face surface 131d of the connecting leg 128d.

The six several proviso features derives the embodiment of the bracket 148d, the manufacturing process of the bracket 148d invention's embodiment, the rust preventive coating of the bracket 148d, the components' fasteners and connection hardware used in assembly of the structural main support structure using the bracket 148d, the component's structural wooden lumber members and/or composite and/or plastic lumber members width dimensions are the width 133d dimensions of the connecting leg of the bracket 148d. The sixth fabricated embodiment bracket 148d proviso specifications for this bracing invention's embodiment herein and hereafter part of the inventions embodiments as reference the opening six proviso specifications.

In FIGS. 32 and 33 the seventh fabricated embodiment bracket 149e is comprised of a supporting element or the long flange 127e that is composed of flat planar plate a having width 134e and length 136e and an downwardly bottom face surface 147e opposing side the upwardly top surface face 141e for the supporting of the horizontal support joist beams 184 and 185 and the companion space blocking 186. The bracket 149e connecting element or connecting leg 128e that is composed of flat planar plate a having width 133e and height 135e and an outwardly front surface face 131e opposing side the inwardly back face surface 140e that is adapted to face and be latitudinal affixed to the vertical column 180 outwardly front face surface. Bracket 149e is comprised of a connecting element or connecting leg 128e, a horizontal supporting element or flange 127e and two interconnecting elements or two connecting trapezoid shaped planer plates 157e and 158e.

The connecting leg 128e is provided with a series of through holes through the outwardly front face surface 131e forming the lower through bolt hole 138m and the upper through bolt hole 138n through to the opposing side the inwardly back face surface 140e. The outwardly front face 131e of the connecting leg 128e lower through bolt hole 138m and the upper through bolt hole 138n to the opposing side the inwardly back face surface 140e are adapted to receive bolts for connecting to the outwardly facing surface of the column.

The horizontal supporting flange 127e of bracket 149e is also comprised of a generally planar plate having an upwards facing top surface 141e and an oppositely positioned downwards facing bottom surface 147e.

The positioning and alignment of the through holes in the connecting leg 128e are linearly arranged longitudinally in the median of the connecting leg 128e by the width 133ee outer boundaries and respect to the median dimensions longitudinal line 137e of the lumber or composite lumber used as a vertical column connecting elements being offset upwards with respect to the other through hole along the same roll by a distance X along the longitudinal dimensions line 137e. This offset of the upwards through hole helps to provide a aligned connection through the vertical column and reinforces the embodiments of the invention allowing for passage of fasteners through the alignment of the through holes that are centered on the width outer boundaries.

The connecting leg 128e height is equal to the connecting flange 127e length and the connecting leg 128e width 133ee is equal to the connecting flange 127e width 134ee.

As can be seen with reference to FIGS. 4, 7, 15, 16, 21 and 22, and referred to as the seventh fabricated embodiment referring to the bracket 149e is to be arranged in an upside down reversed “L” shape longitudinally, positioning the long supporting flange 127e upwardly top face surface 141e latitudinally positioned to the downwardly bottom face surface of the horizontal support joist beams 184 and 185 and the companion space blocking 186, the connecting leg 128b inwardly back face surface 140e longitudinally positioned to the outwardly front face surface vertical column's 180, together define an L-shaped bracket. The L-shaped bracket is provided with an outer corner edge 124e which is adapted to fit in the interior corner formed between the vertical column 180 inwardly facing back surface and the horizontal support joist beams 184 and 185 and the companion space blocking downwardly bottom face surface. In this way, the upwardly top face surface 141e of the supporting flange 127e is in abutting relation with the inwardly facing leg surface 140e of the connecting leg 128e positioned in direct abutting relation to the column 180 inwardly facing back surface and the inner corner 123e is in direct abutting relation to the downwardly bottom face surface 147e of the support joist beam supporting flange 127e and the outwardly front face surface 131e of the connecting leg 128e and the outer corner 124e.

The vertical connecting leg 128e left outer edge 164ea is welded 201ea to the long bases 162ea of the trapezoid shaped planer plate 157e inward facing surface 151ea and oppositely positioned right outer edge 164eb of the connecting leg 128e is welded 201eb long bases 162eb of the trapezoid shaped planer plate 158e inward facing surfaces 151eb. The horizontal support flange 127e left outer edge 164ea is welded 202 ea to the short bases 163ea of the trapezoid shaped planer plates 157e inward facing surface 15 lea and oppositely positioned right outer edge 164eb of the support flange 127e is welded 202eb to the short bases 163eb of the trapezoid shaped planer plate 158e inward facing surface 151eb. The two trapezoid shaped planer plates 157e and 158e are welded by means of 201ea, 201eb, 202ea and 202eb to the vertical connecting leg 128e width 134ee and the horizontal joist supporting flange 127e width 134ee form a supported channelized connecting element 200e supported by the flange 127e upwards facing top surface 141e and channeled by the trapezoid shaped planer plate 157e and trapezoid shaped planer plate 158e.

The outwards facing surface 150ea and the oppositely positioned inwards facing surface 151ea of the trapezoid shaped planer plate 157e is provided with a series of through holes the front through hole 138p and the rear through hole 138o and the outwards facing surface 150eb and the oppositely positioned inwards facing surface 151 eb of the connecting trapezoid planer plate 158e provided with a series of through holes the front through hole 138q and the rear through hole 138r are linearly arranged latitudinally in the median of the channel which is determined by the depth of the channel or width of the component's wooden lumber members and/or composite and/or plastic lumber members being used as horizontal support joist beams 184 and 185 and the companion space blocking 186. The series of through holes the front through hole 138p and the rear through hole 138o being offset latitudinally with respect to the other through hole along the same roll by a distance X along the latitudinal dimensions line 137ea. This offset of the latitudinally through hole helps to provide a aligned connection through the inwards facing surface 151eb and the oppositely positioned outwards facing surface 150eb of the trapezoid shaped planer plate 158e provided with a series of through holes the front through hole 138q and the rear through hole 138r being offset latitudinally with respect to the other through hole along the same roll by a distance X along the latitudinal dimensions line 137eb and reinforces the embodiments of the invention allowing for passage of fasteners through the alignment of the through holes that are centered on depth of the channel.

The six proviso features derives the embodiment of the bracket 149e, the manufacturing process of the bracket 149e invention's embodiment, the rust preventive coating of the bracket 149e, the components' fasteners and connection hardware used in assembly of the structural main support structure using the bracket 149e, the component's structural wooden lumber members and/or composite and/or plastic lumber members width dimensions are the width 133b dimensions of the connecting leg of the bracket 149e. The seventh fabricated embodiment bracket 149e proviso specifications for this bracing invention's embodiment herein and hereafter part of the inventions embodiments as reference the opening six proviso specifications.

In FIG. 34 the eight fabricated embodiment bracket 168f is comprised of a supporting element or the short flange 132f that is composed of flat planar plate a having width 134f and flat planar plate length 136f. The short flange 132f is composed of an downwardly bottom face surface 125f opposing side the upwardly top surface face 126f for the supporting of the horizontal single rim joist 182, horizontal double rim joist 183 and joining plates series 170, the connecting element or long connecting leg 128f that is composed of flat planar plate a having width 133f and height 135f. The long connecting leg 128f is composed of an outwardly front surface face 131f and an opposing side the inwardly back face surface 140f that is adapted to face and be latitudinal affixed to the vertical column 180 outwardly front face surface.

The long connecting leg 128f is provided with a series of through holes through the outwardly front face surface 131f forming the lower through bolt hole 138s and the upper through bolt hole 138t through to the opposing side the inwardly back face surface 140f. The outwardly front face 131f of the long connecting leg 128f lower through bolt hole 138s and the upper through bolt hole 138t to the opposing side the inwardly back face surface 140f are adapted to receive bolts for connecting to the outwardly facing surface of a vertical column 180.

The long connecting leg 128f width 133f is equal to the short supporting flange 132f width 134f.

The positioning and alignment of the through holes in the long connecting leg 128f are linearly arranged longitudinally in the median of the long connecting leg 128f by the width 133f outer boundaries and respect to the median dimensions longitudinal line 137f of the lumber or composite lumber used as a vertical column connecting elements being offset upwards with respect to the other through hole along the same roll by a distance X along the longitudinal dimensions line 137f. This offset of the upwards through hole helps to provide a aligned connection through the vertical column and reinforces the embodiments of the invention allowing for passage of fasteners through the alignment of the through holes that are centered on the width outer boundaries.

As can be seen with reference to FIGS. 5, 6, 7, 8, 17, 18, 19, 20, 21, 22, 23, 25, and 27, whereby referred to as the eight fabricated embodiment referring to bracket 168f is to be arranged in an upside down “L” shape longitudinally, positioning the short supporting flange 132f upwardly top face surface 126f latitudinally positioned to the downwardly bottom face surface of the horizontal single rim joists 182 or the horizontal double rim joists 183 and the long connecting leg 128f inwardly back face surface 140f longitudinally positioned to the outwardly front face surface vertical column's 180, together define an L-shaped bracket. The L-shaped bracket is provided with an outer corner edge 124f which is adapted to fit in the interior corner formed between the column outwardly front face surface and the horizontal double rim joist beam 183 inwardly facing back surface. In this way, the upwardly top face surface 126f of the short supporting flange 132f is in abutting relation with the inwardly back face surface 140f of the long connecting leg 128f positioned indirect abutting relation to the outwardly facing front surface of the vertical column 180 and the inner corner 123f is in direct abutting relation to the downwardly bottom facing surface 125f of the flange 132f and the outwardly front facing surface 131f of the long connecting leg 128f.

The six several proviso features derives the embodiment of the bracket 168f, the manufacturing process of the bracket 168f invention's embodiment, the rust preventive coating of the bracket 168f, the components' fasteners and connection hardware used in assembly of the structural main support structure using the bracket 168f, the component's structural wooden lumber members and/or composite and/or plastic lumber members width dimensions are the width 133f of the connecting leg of bracket 168f. The eight fabricated embodiment bracket 168f proviso specification for this bracing invention's embodiment herein and hereafter part of the inventions embodiments as reference the opening six proviso specifications.

In FIG. 35 the third fabricated embodiment joining plate 170a is comprised of a flat planar plate a having width 133aa and flat planar plate height 135aa. The joining plate is composed of an outwardly front surface face 171a and an opposing side the inwardly back face surface 172a that is adapted to face and be latitudinal affixed to the outwardly front face surface of the horizontal single rim joist 182, horizontal double rim joist 183 and vertical column 180. The downwards bottom face surface 174a of joining plate 170a and the upwards top surface 175a is to the width specification of the horizontal single rim joists 182 or the horizontal double rim joists 183 outer edges forming the main structural supports.

The joining plate 170a is provided with a series of through holes through the outwardly front face surface 171a forming the lower through bolt hole 138ea and the upper through bolt hole 138fa through to the opposing side the inwardly back face surface 172a. The outwardly front face 171a of the joining plate 170a lower through bolt hole 138ea and the upper through bolt hole 138fa to the opposing side the inwardly back face surface 172a are adapted to receive bolts for connecting to the outwardly facing surface of horizontal single rim joist 182, horizontal double rim joist 183 and a vertical column 180.

The positioning and alignment of the through holes in the joining plate 170a are linearly arranged longitudinally in the median of the joining plate 170a by the width 133aa outer boundaries and respect to the median dimensions longitudinal line 137aa of the lumber or composite lumber used as a vertical column connecting elements being offset upwards with respect to the other through hole along the same roll by a distance X along the longitudinal dimensions line 137aa. This offset of the upwards through hole helps to provide a aligned connection through the vertical column and reinforces the embodiments of the invention allowing for passage of fasteners through the alignment of the through holes that are centered on the width outer boundaries.

As can be seen with reference to FIGS. 1, 2, 3, 8, 9, 10, 11, 12, 13, 14 and 23, where the joining plate 170a is referred to as the third fabricated embodiment referring to joining plate 170a is to be arranged longitudinally and positioned atop a the flange of an fabricated embodiment bracket series with short supporting flange 132 series disclosed hereinbefore. The joining plate 170a is positioned to the outwardly facing surface of horizontal single rim joist 182, horizontal double rim joist 183 whereby the joining plate 170b is affixed.

The several proviso features derives the embodiment of the joining plate 170a, the manufacturing process of the joining plate 170a invention's embodiment, the rust preventive coating of the joining plate 170a, the components' fasteners and connection hardware used in assembly of the structural main support structure using the joining plate 170a, the component's structural wooden lumber members and/or composite and/or plastic lumber members dimensions that joining plate 170a dimensions are to conform to, materials requirements for the joining plate 170a. The third fabricated embodiment joining plate 170a proviso specification for this bracing invention's embodiment herein and hereafter part of the inventions embodiments as reference the opening six proviso specifications.

In FIG. 36 the fifth fabricated embodiment joining plate 170b is comprised of a flat planar plate 169b a having width 133bb and flat planar plate height 135bb. The joining plate is composed of an outwardly front surface face 171b and an opposing side the inwardly back face surface 172b that is adapted to face and be latitudinal affixed to the outwardly front face surface of the horizontal single rim joist 182, horizontal double rim joist 183 and vertical column 180. The downwards bottom face surface 174b of joining plate 170b and the upwards top surface 175b is to the width specification of the horizontal single rim joists 182 or the horizontal double rim joists 183 outer edges forming the main structural supports.

The joining plate 170b is provided with a series of through holes through the outwardly front face surface 171b forming the lower through bolt hole 138eb and the upper through bolt hole 138fb through to the opposing side the inwardly back face surface 172b. The outwardly front face 171b of the joining plate 170b lower through bolt hole 138eb and the upper through bolt hole 138fb to the opposing side the inwardly back face surface 172b are adapted to receive bolts for connecting to the outwardly facing surface of horizontal single rim joist 182, horizontal double rim joist 183 through the vertical columns 180 inwardly facing surface through the inwards back face surface 140d of the brackets 148d lower through bolt hole 138k and the upper through bolt hole 138l through to the opposing side the inwards front face surface 131d.

The positioning and alignment of the through holes in the joining plate 170b are linearly arranged longitudinally in the median of the joining plate 170b by the width 133bb outer boundaries and respect to the median dimensions longitudinal line 137b of the lumber or composite lumber used as a vertical column connecting elements being offset upwards with respect to the other through hole along the same roll by a distance X along the longitudinal dimensions line 137b. This offset of the upwards through hole helps to provide a aligned connection through the vertical column and reinforces the embodiments of the invention allowing for passage of fasteners through the alignment of the through holes that are centered on the width outer boundaries.

As can be seen with reference to FIGS. 5, 6, 7, 8, 17, 18, 19, 20, 21, 22, 23 and 25 where the joining plate 170b is referred to as the fifth fabricated embodiment referring to joining plate 170b is to be arranged longitudinally and positioned atop a the flange of an fabricated embodiment bracket series with short supporting flange 132 series disclosed hereinbefore. The joining plate 170b is positioned to the outwardly facing surface of horizontal single rim joist 182, horizontal double rim joist 183 whereby the joining plate 170b is affixed.

The six proviso features derives the embodiment the joining plate 170b, the manufacturing process of the joining plate 170b invention's embodiment, the rust preventive coating of the joining plate 170b, the components' fasteners and connection hardware used in assembly of the structural main support structure using the joining plate 170b, the component's structural wooden lumber members and/or composite and/or plastic lumber members dimensions that joining plate 170b dimensions are to conform to, materials requirements for the joining plate 170b. The fifth fabricated embodiment joining plate 170b six proviso specification for this bracing invention's embodiment herein and hereafter part of the inventions embodiments as reference the opening six proviso specifications.

In FIG. 37 the ninth fabricated embodiment joining plate 170c is comprised of a flat planar plate 169c a having width 133cc and flat planar plate height 135cc. The joining plate is composed of an outwardly front surface face 171c and an opposing side the inwardly back face surface 172c that is adapted to face and be latitudinal affixed to the outwardly front face surface of the horizontal single rim joist 182, horizontal double rim joist 183 and vertical column 180. The downwards bottom face surface 174c of joining plate 170c and the upwards top surface 175c is to the width specification of the horizontal single rim joists 182 or the horizontal double rim joists 183 outer edges forming the main structural supports.

The joining plate 170c is provided with a series of main latitudinal connecting elements centered on the median through the outwardly front face surface 171c forming the lower through bolt hole 138u and the upper through bolt hole 138v through to the opposing side the inwardly back face surface 172c. The joining plate 170c secondary latitudinal connecting elements consisting of two rolls of longitudinally aligning smaller diameter through holes 160 offsetting of the median of the planner plate 169c and the outer edges 133cc through the outwards facing front surface 171c through the front of the plate 171c through to the inwards facing back surface 172c allowing for nails 159 to be secure one horizontal single rim joist 182 conjoined to another horizontal single rim joist 182 in a union or one horizontal double rim joist 183 conjoined to another horizontal double rim joist 183 ends conjoin together to form a continues horizontal double rim joist 183 in a conjoined union. The outwardly front face 171c of the joining plate 170c lower through bolt hole 138u and the upper through bolt hole 138v to the opposing side the inwardly back face surface 172c are adapted to receive bolts for connecting to the outwardly facing surface of horizontal single rim joist 182, horizontal double rim joist 183, through the vertical columns 180 inwardly facing surface through the inwards back face surface 140d of the brackets 148d lower through bolt hole 138k and the upper through bolt hole 138l through to the opposing side the inwards front face surface 131d.

The positioning and alignment of the single row of main latitudinal connecting elements through holes in the joining plate 170c are linearly arranged longitudinally in the median of the planner plates 169c by the width 133cc outer boundaries and respect to the median dimensions longitudinal line 137 cc of the lumber or composite lumber used as a vertical column connecting elements being offset upwards with respect to the other through hole along the same roll by a distance X along the longitudinal dimensions line 137cc. This offset of the upwards through hole helps to provide a aligned connection through the vertical column and reinforces the embodiments of the invention allowing for passage of fasteners through the alignment of the through holes that are centered on the vertical column 180 width outer boundaries.

The positioning and alignment of the secondary latitudinal nail through holes 160 in the joining plate 170c are linearly arranged longitudinally between the median of the planner plate 169c and width 133cc outer boundaries and respect to being offsetting the median and width 133cc outer boundaries dimensions longitudinal lines 137ca and 135cb being offset upwards with respect to the other through holes along the same roll by a distance X along the longitudinal dimensions lines 137ca and 137cb. These offsettings of the median and width 133cc outer boundaries dimensions longitudinally allowing for nails 159 to be secure one horizontal single rim joist 182 conjoined to another horizontal single rim joist 182 in a union or one horizontal double rim joist 183 conjoined to another horizontal double rim joist 183 ends conjoin together to form a continues horizontal double rim joist 183 in a conjoined union.

As can be seen with reference to FIG. 27 where the joining plate 170c is referred to as the ninth fabricated embodiment referring to joining plate 170c is to be arranged longitudinally and positioned atop a the flange of an fabricated embodiment bracket series with short supporting flange 132 series disclosed hereinbefore. The joining plate 170c inwardly back face surface 172c is positioned to the outwardly facing surface of horizontal single rim joist 182, horizontal double rim joist 183 whereby the joining plate 170c is affixed.

The six proviso features derive the embodiment of the joining plate 170c, the manufacturing process of the joining plate 170c invention's embodiment, the rust preventive coating of the joining plate 170c, the components' fasteners and connection hardware used in assembly of the structural main support structure using the joining plate 170c, the component's structural wooden lumber members and/or composite and/or plastic lumber members dimensions that joining plate 170c dimensions are to conform to, materials requirements for the joining plate 170c. The ninth fabricated embodiment joining plate 170c six proviso specification for this bracing invention's embodiment herein and hereafter part of the inventions embodiments as reference the opening six proviso specifications.

In FIG. 38 the tenth fabricated embodiment joining plate 170d is comprised of a flat planar plate 169d a having width 133cc and flat planar plate height 135dd. The joining plate is composed of an outwardly front surface face 171d and an opposing side the inwardly back face surface 172d that is adapted to face and be latitudinal affixed to the outwardly front face surface of the horizontal single rim joist 182, horizontal double rim joist 183 and vertical column 180. The downwards bottom face surface 174d of joining plate 170d and the upwards top surface 175d is to the width specification of the horizontal single rim joists 182 or the horizontal double rim joists 183 outer edges forming the main structural supports.

The joining plate 170d is provided with a series of main latitudinal connecting elements centered on the median through the outwardly front face surface 171d forming the lower through bolt hole 138ed and the upper through bolt hole 138fd through to the opposing side the inwardly back face surface 172d. The joining plate 170d secondary latitudinal connecting elements consisting of two rolls of longitudinally aligning smaller diameter through holes 160 offsetting of the median of the planner plate 169d and the outer edges 133dd through the outwards facing front surface 171d through the front of the plate 171d through to the inwards facing back surface 172d allowing for nails 159 to be secure one horizontal single rim joist 182 conjoined to another horizontal single rim joist 182 in a union or one horizontal double rim joist 183 conjoined to another horizontal double rim joist 183 ends conjoin together to form a continues horizontal double rim joist 183 in a conjoined union. The outwardly front face 171d of the joining plate 170d lower through bolt hole 138ed and the upper through bolt hole 138fd to the opposing side the inwardly back face surface 172d are adapted to receive bolts for connecting to the outwardly facing surface of horizontal single rim joist 182, horizontal double rim joist 183, vertical column 180.

The positioning and alignment of the single row of main latitudinal connecting elements through holes in the joining plate 170d are linearly arranged longitudinally in the median of the planner plates 169d by the width 133dd outer boundaries and respect to the median dimensions longitudinal line 137de of the lumber or composite lumber used as a vertical column connecting elements being offset upwards with respect to the other through hole along the same roll by a distance X along the longitudinal dimensions line 137de. This offset of the upwards through hole helps to provide a aligned connection through the vertical column and reinforces the embodiments of the invention allowing for passage of fasteners through the alignment of the through holes that are centered on the vertical column 180 width outer boundaries.

The positioning and alignment of the secondary latitudinal nail through holes 160 in the joining plate 170d are linearly arranged longitudinally between the median of the planner plate 169d and width 133dd outer boundaries and respect to being offsetting the median and width 133dd outer boundaries dimensions longitudinal lines 137da and 137db being offset upwards with respect to the other through holes along the same roll by a distance X along the longitudinal dimensions lines 137da and 137db. These off-settings of the median and width 133dd outer boundaries perimeter dimensions longitudinally allowing for nails 159 to be secure one horizontal single rim joist 182 conjoined to another horizontal single rim joist 182 in a union or one horizontal double rim joist 183 conjoined to another horizontal double rim joist 183 ends conjoin together to form a continues horizontal double rim joist 183 in a conjoined union.

As can be seen with reference to FIGS. 4, 15 and 16 where the joining plate 170d is referred to as the tenth fabricated embodiment referring to joining plate 170d is to be arranged longitudinally and positioned atop a the flange of an fabricated embodiment bracket series with short supporting flange 132 series disclosed hereinbefore. The joining plate 170d inwardly back face surface 172d is positioned to the outwardly facing surface of horizontal single rim joist 182, horizontal double rim joist 183 whereby the joining plate 170d is affixed.

The six proviso features derive the embodiment of the joining plate 170d, the manufacturing process of the joining plate 170d invention's embodiment, the rust preventive coating of the joining plate 170d, the components' fasteners and connection hardware used in assembly of the structural main support structure using the joining plate 170d, the component's structural wooden lumber members and/or composite and/or plastic lumber members dimensions that joining plate 170d dimensions are to conform to, materials requirements for the joining plate 170d. The tenth fabricated embodiment joining plate 170d six proviso specification for this bracing invention's embodiment herein and hereafter part of the inventions embodiments as reference the opening six proviso specifications.

The present invention provides a series of brackets and joining plate connecting elements for effecting a bolted connection between treated wooden lumber members and/or composite lumber and/or plastic lumber members plurality vertical post or column members and a plurality horizontal supports beam, single horizontal joist, double horizontal joist, horizontal single rim joist and horizontal double rim joist beams in a structural framing. As described above in more detail, the affixed interlocking connections latitudinally and longitudinally practices, technique in positioning, designs and bolting patterns work in conjunction to the present invention is particularly advantageous for use in repairing foundation columns that are lacking structural integrity or if the structure is not in compliance with municipal building codes findings that plurality notched vertical columns in porch and decks lack structural integrity in most of the existing structures constructed of wooden and composite members.

The brackets also has application in the context of existing structures which, other, although not damaged, may nevertheless require reinforcement to further the structural integrity. Further, the inventions brackets embodiments and applications of installation to new frame constructions to provide a rigid non-moment frame structure in conjunction with the connection application. In addition, the brackets invention components can be used individual components on structures lacking structural integrity in harsh weathered regions needing hurricane tie downs.

What is claimed is:

1. The first method of new construction practices between a beam, horizontal
rim joist members and a column comprised of lumber members forming the main structural supports utilizing a series of two equal in heights structural steel forged angled L shaped brackets with unequal lengths and a steel joining plate to allow for affixed connections between said main structural supports in a structure forming equal horizontal planes, comprising of:
providing the first angled L shaped bracket having a column connecting element the connecting leg and a horizontal rim joist members supporting element the short supporting flange, the said column connecting element the connecting leg having longitudinal aligned through holes positioned latitudinally through the said outer surface median through to the opposing side the inner surface, said horizontal rim joist members supporting element the short flange having an upward surface with an opposing surface the downwards surface;
providing the second angled L shaped bracket having a column connecting element the connecting leg and a beam supporting element the supporting flange, the said columns connecting element the connecting leg having longitudinal aligned through holes positioned latitudinally through the outer surface median through to the opposing side the inner surface, the said beam supporting element the supporting flange having an upward surface with an opposing side the downwards surface;
positioning the said first angled L shaped bracket in a upside down L shape configuration that the outer surface of the connecting leg is facing the inwards towards the columns front surface extending the short flange upwards surface to the horizontal rim joist members bottom surface;
positioning the said second angled L shaped bracket in a reversed upside down L shape configuration so that the outer surface of the connecting leg is facing the inwards the columns back surface extending the supporting flange upwards surface to the beams bottom surface;
forming a least one first through bolt hole in the said columns front surface of the lumber members forming a vertical main structural support;
forming a least one first through bolt hole in the said columns back surface of the lumber members forming a vertical main structural support;
connecting said first angled L shaped bracket column connecting element leg to the said front surface of the column to the opposing side the back surface to the said second angled L shaped bracket column connecting leg by provided said through holes in the said first angled L shaped bracket column connecting leg through the said column through extending through the said second angled L shaped bracket column connecting leg for bolted affixed connections;
providing the joining plate having a horizontal rim joist members connecting element the planner surface provided with a horizontal rim joist members connecting element having longitudinal aligned through holes positioned latitudinally through the outer surface median through to opposing side the inner surface;
positioning the said joining plate so the inner surface of the planner surface is facing the inwards the horizontal rim joist members front surface supported by the first angled L shaped bracket supporting element the short supporting flange;
forming a least one first lag bolt through hole in said front surface of the horizontal rim joist members to the opposing side the back surface extending through the said front surface of the column to the opposing side the back surface through the front surface of the said beam; and
connecting the said joining plate to the said front surface of the horizontal rim joist members through to the opposing side the back surface extending through the said front surface of the column to the opposing back surface to the front surface of the said beam by the provided said through holes in the said joining plate through the said horizontal rim joist members extending through the said column to the beams through holes for lag bolted affixed connections

2. Method according to claim 1, wherein said first angled L shaped bracket
includes an outer edge corner, said first angled L shaped bracket connecting leg inner surface being positioned so that the said inner surface abuts the said front surface of the column the said short supporting flange upwards surface abuts the said horizontal rim joist members bottom surface.

3. Method according to claim 1, wherein said second angled L shaped bracket
includes an outer edge corner, said second angled L shaped bracket connecting leg inner surface being positioned so that the said inner surface abuts the said back surface of the column the said supporting flange upwards surface abuts the said beams bottom surface.

4. Method according to claim 1, wherein said two equal in heights structural
angled L shaped brackets have said bolted affixed connections through the holes in the said first angled L shaped bracket connecting leg through said column though said second angled L shaped bracket connecting leg derives said short supporting flange of said first angled L shaped bracket aligns latitudinally with said supporting flange of second angled L shaped bracket allowing for equal horizontal planes of alignment of the said beam and said horizontal rim joist members.

5. Method according to claim 1, wherein said lag bolted affixed connections
through the holes in the said joining plate said horizontal rim joist members extending through the said column surfaces to the front surface of the said beam derives said joining plate the primary connecting element for the said first method of new construction practices between said horizontal rim joist members said column and said beam.

6. The second method of new construction practices between a beam,
horizontal rim joist members and a column comprised of lumber members forming the main structural supports utilizing a series of two equal in heights structural steel forged angled L shaped brackets with unequal lengths and a steel joining plate to allow for affixed connections between said main structural supports in a structure forming equal horizontal planes, comprising of:
providing the first angled L shaped bracket having a column connecting element the connecting leg and a horizontal rim joist members supporting element the short supporting flange, the said column connecting element the connecting leg having longitudinal aligned through holes positioned latitudinally through the said outer surface median through to the opposing side the inner surface, said horizontal rim joist members supporting element the short flange having an upward surface with an opposing surface the downwards surface;
providing the second angled L shaped bracket having a column connecting element the connecting leg and a beam connecting element the connecting flange, the said columns connecting element the connecting leg having longitudinal aligned through holes positioned latitudinally through the outer surface median through to the opposing side the inner surface, the said beam supporting element the supporting flange having latitudinal aligned through the downwards surface median through to the opposing side the upwards surface;
positioning the said first angled L shaped bracket in a upside down L shape configuration that the outer surface of the connecting leg is facing the inwards towards the columns front surface extending the short flange upwards surface to the horizontal rim joist members bottom surface;
positioning the said second angled L shaped bracket in a reversed upside down L shape configuration so that the outer surface of the connecting leg is facing the inwards the columns back surface extending the supporting flange upwards surface to the beams bottom surface;
forming a least one first through bolt hole in the said columns front surface of the lumber members forming a vertical main structural support;
forming a least one first through bolt hole in the said columns back surface of the lumber members forming a vertical main structural support;
connecting said first angled L shaped bracket column connecting element leg to the said front surface of the column to the opposing side the back surface to the said second angled L shaped bracket column connecting leg by provided said through holes in the said first angled L shaped bracket column connecting leg through the said column through extending through the said second angled L shaped bracket column connecting leg for bolted affixed connections;
forming a least one first through bolt hole in the said beams bottom surface of the lumber members forming a horizontal main structural support;
connecting said second angled L shaped bracket beam connecting element the connecting flange to the said bottom surface of the said beam to the opposing side the top surface by provided said through holes in the said second angled L shaped bracket connecting flange through the said beam for bolted affixed connections;
providing the joining plate having a horizontal rim joist members connecting element the planner surface provided with a horizontal rim joist members connecting element having longitudinal aligned through holes positioned latitudinally through the outer surface median through to opposing side the inner surface;
positioning the said joining plate so the inner surface of the planner surface is facing the inwards the horizontal rim joist members front surface supported by the first angled L shaped bracket supporting element the short supporting flange;
forming a least one first lag bolt through hole in said front surface of the horizontal rim joist members to the opposing side the back surface extending through the said front surface of the said columns median;
connecting the said joining plate to the said front surface of the horizontal rim joist members through to the opposing side the back surface extending through the said front surface of the said columns median by the provided said through holes in the said joining plate through the said horizontal rim joist members extending through the said median of the columns median through holes for lag bolted affixed connections.

7. Method according to claim 6, wherein said second angled L shaped bracket
includes an outer edge corner, said second angled L shaped bracket connecting leg inner surface being positioned so that the said inner surface abuts the said back surface of the column the said connecting flange upwards surface abuts the said beams bottom surface.

8. Method according to claim 6, wherein said bolted affixed connections by
through the holes in the said first angled L shaped bracket connecting leg through said column though said second angled L shaped bracket connecting leg and the said second angled L shaped bracket connecting flange through said beam derives said second angled L shaped bracket the primary said beam to said column connecting element for the second method of new construction practices.

9. Method according to claim 6, wherein said lag bolted affixed connections
through the holes in the said joining plate said horizontal rim joist members extending through the said median of said column derives said joining plate the primary said horizontal rim joist members and said column connecting element for the second method of new construction practices.

10. The third method of new construction practices between a beam,
horizontal rim joist members and a column comprised of lumber members forming the main structural supports utilizing a series of three equal in heights structural steel forged angled L shaped brackets and a steel joining plate to allow for affixed connections between said main structural supports in a structure forming equal horizontal planes, comprising of:
providing the first angled L shaped bracket having a column connecting element the connecting leg and a horizontal rim joist members supporting element the short supporting flange, the said column connecting element the connecting leg having longitudinal aligned through holes positioned latitudinally through the said outer surface median through to the opposing side the inner surface, said horizontal rim joist members supporting element the short flange having an upward surface with an opposing surface the downwards surface;
providing the second angled L shaped bracket having a column connecting element the connecting leg and a beam connecting element the connecting flange, the said columns connecting element the connecting leg having longitudinal aligned through holes positioned latitudinally through the outer surface median through to the opposing side the inner surface, the said beam supporting element the connecting flange having latitudinal aligned through the downwards surface median through to the opposing side the upwards surface;
positioning the said first angled L shaped bracket in a upside down L shape configuration that the outer surface of the connecting leg is facing the inwards towards the columns front surface extending the short flange upwards surface to the horizontal rim joist members bottom surface;
positioning the said second angled L shaped bracket in a reversed upside down L shape configuration so that the outer surface of the connecting leg is facing the inwards the columns back surface extending the supporting flange upwards surface to the beams bottom surface;
forming a least one first through bolt hole in the said columns front surface of the lumber members forming a vertical main structural support;
forming a least one first through bolt hole in the said columns back surface of the lumber members forming a vertical main structural support;
connecting said first angled L shaped bracket column connecting element leg to the said front surface of the column to the opposing side the back surface to the said second angled L shaped bracket column connecting leg by provided said through holes in the said first angled L shaped bracket column connecting leg through the said column through extending through the said second angled L shaped bracket column connecting leg for bolted affixed connections;
providing the third angled L shaped bracket having a column connecting element the connecting leg and a beam connecting element the connecting flange, the said columns connecting element the connecting leg having longitudinal aligned through holes positioned latitudinally through the outer surface median through to the opposing side the inner surface, the said beam connecting element the connecting flange having latitudinal aligned through the surface upwards median through to the opposing side the downwards surface;
positioning the said third angled L shaped bracket in a reversed L shape configuration so that the outer surface of the connecting leg is facing the inwards the columns back surface extending the supporting flange downwards surface to the beams top surface;
forming a least one first through bolt hole in the said beams bottom surface of the lumber members forming a horizontal main structural support;
forming a least one first through bolt hole in the said beams top surface of the lumber members forming a horizontal main structural support;
connecting said second angled L shaped bracket beam connecting element the connecting flange to the said bottom surface of the said beam to the opposing side the top surface to said third angled L shaped bracket beam connecting element the connecting flange by provided said through holes in the said second angled L shaped bracket connecting flange through the said beam through the third angled L shaped bracket connecting flange for bolted affixed connections;
forming a least two first through bolt hole in the said columns back surface of the lumber members forming a vertical main structural support;
connecting said third angled L shaped bracket connecting leg to the said back front surface of the column by provided said through holes in the said third angled L shaped bracket through the said back surface of the column to the opposing side the surface for bolted affixed connections;
providing the joining plate having a horizontal rim joist members connecting element the planner surface provided with a horizontal rim joist members connecting element having longitudinal aligned through holes positioned latitudinally through the outer surface median through to opposing side the inner surface;
positioning the said joining plate so the inner surface of the planner surface is facing the inwards the horizontal rim joist members front surface supported by the first angled L shaped bracket supporting element the short supporting flange;
forming a least one first lag bolt through hole in said front surface of the horizontal rim joist members to the opposing side the back surface extending through the said front surface of the said columns median;
connecting the said joining plate to the said front surface of the horizontal rim joist members through to the opposing side the back surface extending through the said front surface of the said columns median by the provided said through holes in the said joining plate through the said horizontal rim joist members extending through the said median of the columns median through holes for lag bolted affixed connections.

11. Method according to claim 10, wherein said third angled L shaped
bracket includes an outer edge corner, said third angled L shaped bracket connecting leg inner surface being positioned so that the said inner surface abuts the said back surface of the column the said connecting flange downwards surface abuts the said beams top surface.

12. The fourth method of new construction practices between a horizontal joist
members, horizontal rim joist members and a column comprised of lumber members forming the main structural supports utilizing a series of two equal in heights structural steel forged angled L shaped brackets with unequal lengths and a steel joining plate to allow for affixed connections between said main structural supports in a structure forming equal horizontal planes, comprising of:
providing the first angled L shaped bracket having a column connecting element the connecting leg and a horizontal rim joist members supporting element the short supporting flange, the said column connecting element the connecting leg having longitudinal aligned through holes positioned latitudinally through the said outer surface median through to the opposing side the inner surface, said horizontal rim joist members supporting element the short flange having an upward surface with an opposing surface the downwards surface;
providing the second angled L shaped bracket having a column connecting element the connecting leg with outer edges are affixed with trapezoid plates and the horizontal joist members supporting flange with outer edges are affixed with the same said trapezoid plates, the said columns connecting element the connecting leg having longitudinal aligned through holes positioned latitudinally through the outer surface median through to the opposing side the inner surface, the said horizontal joist members supporting flange having a downwards surface with an opposing side the upwards surface, the said trapezoid plates extending past the height of the said connecting leg to the height dimension of the said horizontal joist members extending the length of the said supporting flange, each said trapezoid plate affixed to the said outer edges of the said supporting flange form a channel, said trapezoid plates having a connecting element the latitudinal aligned through holes positioned with the median of the said channel latitudinally through the outer surface of the trapezoid plates to the opposing side the inner surface;
positioning the said first angled L shaped bracket in a upside down L shape configuration that the outer surface of the connecting leg is facing the inwards towards the columns front surface extending the short flange upwards surface to the horizontal rim joist members bottom surface;
positioning the said second angled L shaped bracket in a reversed upside down L shape configuration so that the outer surface of the connecting leg is facing the inwards the columns back surface extending the supporting flange upwards surface to the horizontal joist members bottom surface;
forming a least one first through bolt hole in the said columns front surface of the lumber members forming a vertical main structural support;
forming a least one first through bolt hole in the said columns back surface of the lumber members forming a vertical main structural support;
connecting said first angled L shaped bracket column connecting element leg to the said front surface of the column to the opposing side the back surface to the said second angled L shaped bracket column connecting leg by provided said through holes in the said first angled L shaped bracket column connecting leg through the said column through extending through the said second angled L shaped bracket column connecting leg for bolted affixed connections;
forming a least one first through bolt hole in the said horizontal joist members side surface of the lumber members forming a horizontal structural support;
connecting said second angled L shaped bracket horizontal joist members connecting elements the said outer surface of the first trapezoid plate through the opposing side inner surface through the said horizontal joist members through the said inner surface of the second trapezoid plate through the opposing side outer surface by provided said through holes in the said second angled L shaped brackets said first trapezoid plate through the said horizontal joist members through the said second trapezoid plate for bolted affixed connections;
providing the joining plate having various horizontal rim joist members connecting element in the planner surface provided with primary lag bolt through hole having longitudinal aligned through holes positioned latitudinally through the outer surface median through to opposing side the inner surface, the secondary plurality of nail through holes longitudinal aligned through holes positioned latitudinally through the outer surface off setting the median of the said planner surface;
positioning the said joining plate so the inner surface of the planner surface is facing the inwards the horizontal rim joist members front surface supported by the first angled L shaped bracket supporting element the short supporting flange;
connecting said joining plate secondary horizontal rim joist members connecting element in the planner surface to the said horizontal rim joist members extending to the said column by the provided nailing through the said nail through holes in the planner surface through the said horizontal rim joist members extending to the said column for nailed affixed connections;
forming a least one first lag bolt through hole in said front surface of the horizontal rim joist members to the opposing side the back surface extending through the said front surface of the said columns median;
connecting the said joining plate to the said front surface of the horizontal rim joist members through to the opposing side the back surface extending through the said front surface of the said columns median by the provided said through holes in the said joining plate through the said horizontal rim joist members extending through the said median of the columns median through holes for lag bolted affixed connections.

13. Method according to claim 12, including the positioning of a spacer
blocking between the said horizontal joist members and the said trapezoid plate to increase stability and decrease movement between said horizontal joist members said bolted affixed connection to the said channel formed of said trapezoid plates on the said outer edges of the said supporting flange, said spacer blocking includes latitudinal aligned through holes latitudinal aligned with the through holes in the said trapezoid plates and said horizontal joist members.

14. Method according to claim 12, wherein said joining plate secondary horizontal rim joist members connecting element in the planner surface said nail through holes are a joining element were two horizontal rim joist members butt ends converge together along the span of the said two horizontal rim joist members.

15. The fifth method of new construction practices between a beam,
horizontal rim joist members and a column comprised of lumber members forming the main structural supports utilizing a series of two unequal in heights structural steel forged angled L shaped brackets with unequal lengths and a steel joining plate to allow for affixed connections between said main structural supports in a structure forming unequal horizontal planes converging on a single horizontal segmented plane, comprising of:
providing the first angled L shaped bracket having a column connecting element the connecting leg and a beam connecting element the connecting flange, the said columns connecting element the connecting leg having longitudinal aligned through holes positioned latitudinally through the outer surface median through to the opposing side the inner surface, the said beam supporting element the supporting flange having latitudinal aligned through the downwards surface median through to the opposing side the upwards surface;
providing the second angled L shaped bracket having a column connecting element the long connecting leg and a horizontal rim joist members supporting element the short supporting flange, the said column connecting element the long connecting leg having longitudinal aligned through holes positioned latitudinally through the said outer surface median through to the opposing side the inner surface, said horizontal rim joist members supporting element the short flange having an downwards surface with an opposing surface upward surface;
positioning the said first angled L shaped bracket in a reversed upside down L shape configuration so that the outer surface of the connecting leg is facing the inwards the columns back surface extending the supporting flange upwards surface to the bottom surface of the beam having an opposing side the top surface;
positioning the said second angled L shaped bracket in a upside down L shape configuration that the outer surface of the connecting leg is facing the inwards towards the columns front surface extending the short flange upwards surface to the horizontal rim joist members bottom surface; the said upward surface latitudinally aligns with the top surface of the said beam;
forming one first through bolt hole in the said columns back surface of the lumber members forming a vertical main structural support;
connecting said first angled L shaped bracket column connecting element leg to the said back surface of the column to the opposing side the front surface by provided said first through hole in the said front surface of the column to the opposing side the back surface through the said first angled L shaped bracket column connecting element leg for bolted affixed connections;
forming one first through bolt hole in the said columns front surface of the lumber members forming a vertical main structural support;
connecting said second angled L shaped bracket long connecting leg to the said front surface of the column to the opposing side the back surface through the said first angled L shaped bracket connecting leg by provided said second through hole in the said front surface of the column to the opposing side back surface through the said first angled L shaped bracket connecting leg for bolted affixed connections;
forming one first lag through hole in the median of the said columns front surface lumber members forming a vertical main structural support;
connecting said second angled L shaped bracket column connecting element leg to the median of the said column by provided said through holes in the said second angled L shaped bracket long connecting leg through the median of the said columns for lag bolted affixed connections;
providing the joining plate having a horizontal rim joist members connecting element the planner surface provided with a horizontal rim joist members connecting element having longitudinal aligned through holes positioned latitudinally through the outer surface median through to opposing side the inner surface;
positioning the said joining plate so the inner surface of the planner surface is facing the inwards the horizontal rim joist members front surface supported by the second angled L shaped bracket supporting element the short supporting flange;
forming a least one first through bolt hole in said front surface of the horizontal rim joist members to the opposing side the back surface extending through the said front surface of the said columns to the opposing side the back surface;
connecting the said joining plate to the said front surface of the horizontal rim joist members through to the opposing side the back surface extending through the said front surface of the said columns to the opposing side the back surface by the provided said through bolt holes in the said joining plate through the said horizontal rim joist members extending through the said front surface of the said columns to the opposing side the back surface for bolted affixed connections;

16. Method according to claim 15, wherein said second angled L shaped
bracket includes an outer edge corner, said first angled L shaped bracket long connecting leg inner surface being positioned so that the said inner surface abuts the said front surface of the column the said short supporting flange upwards surface abuts the said horizontal rim joist members bottom surface.

17. Method according to claim 15, wherein said second angled L shaped
bracket supporting element flange upwards surface would be in latitudinal alignment with the said beams top surface, said second angled L shaped bracket lower through bolt hole in the said long connecting leg would offset the said first angled L shaped bracket connecting element upper through bolt hole in the said connecting leg forming unequal horizontal planes of the said beam top surface with the said horizontal rim joist members bottom surface converging on the single segmented horizontal plane the said top surface aligning with the said bottom surface.

18. The sixth method of new construction practices between a beam,
horizontal rim joist members and a column comprised of lumber members forming the main structural supports utilizing a series of one unequal in height structural steel forged angled L shaped brackets with unequal length, two equal in heights structural steel forged angled L shaped brackets with equal lengths and a steel joining plate to allow for affixed connections between said main structural supports in a structure forming unequal horizontal planes converging on a single horizontal segmented plane, comprising of:
providing the first angled L shaped bracket having a column connecting element the connecting leg and a beam connecting element the connecting flange, the said columns connecting element the connecting leg having longitudinal aligned through holes positioned latitudinally through the outer surface median through to the opposing side the inner surface, the said beam supporting element the supporting flange having latitudinal aligned through the downwards surface median through to the opposing side the upwards surface;
providing the second angled L shaped bracket having a column connecting element the long connecting leg and a horizontal rim joist members supporting element the short supporting flange, the said column connecting element the long connecting leg having longitudinal aligned through holes positioned latitudinally through the said outer surface median through to the opposing side the inner surface, said horizontal rim joist members supporting element the short flange having an downwards surface with an opposing surface upward surface;
positioning the said first angled L shaped bracket in a reversed upside down L shape configuration so that the outer surface of the connecting leg is facing the inwards the columns back surface extending the supporting flange upwards surface to the bottom surface of the beam having an opposing side the top surface;
positioning the said second angled L shaped bracket in a upside down L shape configuration that the outer surface of the connecting leg is facing the inwards towards the columns front surface extending the short flange upwards surface to the horizontal rim joist members bottom surface, the said upward surface latitudinally aligns with the top surface of the said beam;
forming one first through bolt hole in the said columns back surface of the lumber members forming a vertical main structural support;
connecting said first angled L shaped bracket column connecting element leg to the said back surface of the column to the opposing side the front surface by provided said first through hole in the said front surface of the column to the opposing side the back surface through the said first angled L shaped bracket column connecting element leg for bolted affixed connections;
forming one first through bolt hole in the said columns front surface of the lumber members forming a vertical main structural support;
connecting said second angled L shaped bracket long connecting leg to the said front surface of the column to the opposing side the back surface through the said first angled L shaped bracket connecting leg by provided said second through hole in the said front surface of the column to the opposing side back surface through the said first angled L shaped bracket connecting leg for bolted affixed connections;
forming one first lag through hole in the median of the said columns front surface lumber members forming a vertical main structural support;
connecting said second angled L shaped bracket column connecting element leg to the median of the said column by provided said through holes in the said second angled L shaped bracket long connecting leg through the median of the said columns for lag bolted affixed connections;
providing the third angled L shaped bracket having a column connecting element the connecting leg and a beam connecting element the connecting flange, the said columns connecting element the connecting leg having longitudinal aligned through holes positioned latitudinally through the outer surface median through to the opposing side the inner surface, the said beam connecting element the connecting flange having latitudinal aligned through the surface upwards median through to the opposing side the downwards surface;
positioning the said third angled L shaped bracket in a reversed L shape configuration so that the outer surface of the connecting leg is facing the inwards the columns back surface extending the supporting flange downwards surface to the beams top surface;
forming a least one first through bolt hole in the said beams bottom surface of the lumber members forming a horizontal main structural support;
forming a least one first through bolt hole in the said beams top surface of the lumber members forming a horizontal main structural support;
connecting said first angled L shaped bracket beam connecting element the connecting flange to the said bottom surface of the said beam to the opposing side the top surface to said third angled L shaped bracket beam connecting element the connecting flange by provided said through holes in the said first angled L shaped bracket connecting flange through the said beam through the third angled L shaped bracket connecting flange for bolted affixed connections;
providing the joining plate having a horizontal rim joist members connecting element the planner surface provided with a horizontal rim joist members connecting element having longitudinal aligned through holes positioned latitudinally through the outer surface median through to opposing side the inner surface;
positioning the said joining plate so the inner surface of the planner surface is facing the inwards the horizontal rim joist members front surface supported by the second angled L shaped bracket supporting element the short supporting flange;
forming a least one first through bolt hole in said front surface of the horizontal rim joist members to the opposing side the back surface extending through the said front surface of the said columns to the opposing side the back surface;
forming a least one first through bolt hole in the said columns back surface of the lumber members forming a vertical main structural support;
connecting the said joining plate to the said front surface of the horizontal rim joist members through to the opposing side the back surface extending through the said front surface of the said columns to the opposing side the back surface to the said third angled L shaped bracket connecting leg by the provided said through holes in the said joining plate through the said horizontal rim joist members extending through said columns surface through said third angled L shaped bracket connecting leg for bolted affixed connections.

19. Method according to claim 18, wherein said bolted affixed connections of the said joining plate planner surface to the said horizontal rim joist members to the said columns extending to the said third angled L shaped bracket connecting leg derives the alignment of the through holes in the said joining plate and said third angled L shaped bracket connecting leg for said bolted affixed connections.

20. The seventh method of new construction practices between a horizontal
joist members, horizontal rim joist members and a column comprised of lumber members forming the main structural supports utilizing a series of one unequal in height structural steel forged angled L shaped brackets with unequal length, one equal in height structural steel forged angled L shaped brackets with equal length and a steel joining plate to allow for affixed connections between said main structural supports in a structure forming unequal horizontal planes converging on a single horizontal segmented plane, comprising of:
providing the first angled L shaped bracket having a column connecting element the connecting leg with outer edges are affixed with trapezoid plates and the horizontal joist members supporting flange with outer edges are affixed with the same said trapezoid plates, the said columns connecting element the connecting leg having longitudinal aligned through holes positioned latitudinally through the outer surface median through to the opposing side the inner surface, the said horizontal joist members supporting flange having a downwards surface with an opposing side the upwards surface, the said trapezoid plates extending past the height of the said connecting leg to the height dimension of the said horizontal joist members extending the length of the said supporting flange, each said trapezoid plate affixed to the said outer edges of the said supporting flange form a channel, said trapezoid plates having a connecting element the latitudinal aligned through holes positioned with the median of the said channel latitudinally through the outer surface of the trapezoid plates to the opposing side the inner surface;
providing the second angled L shaped bracket having a column connecting element the long connecting leg and a horizontal rim joist members supporting element the short supporting flange, the said column connecting element the long connecting leg having longitudinal aligned through holes positioned latitudinally through the said outer surface median through to the opposing side the inner surface, said horizontal rim joist members supporting element the short flange having an downwards surface with an opposing surface upward surface;
positioning the said first angled L shaped bracket in a reversed upside down L shape configuration so that the outer surface of the connecting leg is facing the inwards the columns back surface extending the supporting flange upwards surface to the horizontal joist members bottom surface;
positioning the said second angled L shaped bracket in a upside down L shape configuration that the outer surface of the connecting leg is facing the inwards towards the columns front surface extending the short flange upwards surface to the horizontal rim joist members bottom surface; the said upward surface latitudinally aligns with the top surface of the said beam, the said upward surface latitudinally aligns with the top surface of the said beam;
forming one first through bolt hole in the said columns back surface of the lumber members forming a vertical main structural support;
connecting said first angled L shaped bracket column connecting element leg to the said back surface of the column to the opposing side the front surface by provided said first through hole in the said front surface of the column to the opposing side the back surface through the said first angled L shaped bracket column connecting element leg for bolted affixed connections;
forming one first through bolt hole in the said columns front surface of the lumber members forming a vertical main structural support;
connecting said second angled L shaped bracket long connecting leg to the said front surface of the column to the opposing side the back surface through the said first angled L shaped bracket connecting leg by provided said second through hole in the said front surface of the column to the opposing side back surface through the said first angled L shaped bracket connecting leg for bolted affixed connections;
forming one first lag through hole in the median of the said columns front surface lumber members forming a vertical main structural support;
connecting said second angled L shaped bracket column connecting element leg to the median of the said column by provided said through holes in the said second angled L shaped bracket long connecting leg through the median of the said columns for lag bolted affixed connections;
forming a least one first through bolt hole in the said horizontal joist members side surface of the lumber members forming a horizontal structural support;
connecting said first angled L shaped bracket horizontal joist members connecting elements the said outer surface of the first trapezoid plate through the opposing side inner surface through the said horizontal joist members through the said inner surface of the second trapezoid plate through the opposing side outer surface by provided said through holes in the said first angled L shaped brackets said first trapezoid plate through the said horizontal joist members through the said second trapezoid plate for bolted affixed connections;
providing the joining plate having a horizontal rim joist members connecting element the planner surface provided with a horizontal rim joist members connecting element having longitudinal aligned through holes positioned latitudinally through the outer surface median through to opposing side the inner surface;
positioning the said joining plate so the inner surface of the planner surface is facing the inwards the horizontal rim joist members front surface supported by the first angled L shaped bracket supporting element the short supporting flange;
forming a least one first lag bolt through hole in said front surface of the horizontal rim joist members to the opposing side the back surface extending through the said front surface of the said columns median;
connecting the said joining plate to the said front surface of the horizontal rim joist members through to the opposing side the back surface extending through the said front surface of the said columns median by the provided said through holes in the said joining plate through the said horizontal rim joist members extending through the said median of the columns median through holes for lag bolted affixed connections.

21. Method according to claim 20, wherein said second angled L shaped
bracket supporting element flange upwards surface would be in latitudinal alignment with the said beams top surface, said second angled L shaped bracket lower through bolt hole in the said long connecting leg would offset the said first angled L shaped bracket connecting element upper through bolt hole in the said connecting leg forming unequal horizontal planes of the said horizontal joist members top surface with the said horizontal rim joist members bottom surface converging on the single segmented horizontal plane the said top surface aligning with the said bottom surface.

22. Method according to claim 21, including the positioning of a spacer
blocking between the said horizontal joist members and the said trapezoid plate to increase stability and decrease movement between said horizontal joist members said bolted affixed connection to the said channel formed of said trapezoid plates on the said outer edges of the said supporting flange, said spacer blocking includes latitudinal aligned through holes latitudinal aligned with the through holes in the said trapezoid plates and said horizontal joist members.

23. The eight method of new construction practices between a, horizontal
rim joist members, horizontal joist members and a column comprised of lumber members forming the main structural supports utilizing a series of two unequal in heights structural steel forged angled L shaped brackets with equal lengths and two steel joining plate with unequal aligned through holes to allow for affixed connections between said main structural supports in a structure forming equal horizontal planes, comprising of:
providing the first angled L shaped bracket having a column connecting element the connecting leg and a horizontal rim joist members supporting element the short supporting flange, the said column connecting element the connecting leg having longitudinal aligned through holes positioned latitudinally through the said outer surface median through to the opposing side the inner surface, said horizontal rim joist members supporting element the short flange having an upward surface with an opposing surface the downwards surface;
providing the second angled L shaped bracket having a column connecting element the long connecting leg and a horizontal rim joist members supporting element the short supporting flange, the said column connecting element the long connecting leg having longitudinal aligned through holes positioned latitudinally through the said outer surface median through to the opposing side the inner surface, said horizontal rim joist members supporting element the short flange having an downwards surface with an opposing surface upward surface;
positioning the said first angled L shaped bracket in a upside down L shape configuration that the outer surface of the connecting leg is facing the inwards towards the columns front surface extending the short flange upwards surface to the horizontal rim joist members bottom surface;
positioning the said second angled L shaped bracket in a upside down L shape configuration that the outer surface of the long connecting leg is facing the inwards towards the columns outwards side surface extending the short flange upwards surface to the horizontal joist members bottom surface;
forming a least two first through bolt hole in the said columns front surface of the lumber members forming a vertical main structural support;
connecting said first angled L shaped bracket column connecting element leg to the said front surface of the column to the opposing side the back surface by provided said through holes in the said first angled L shaped bracket column connecting leg through the said column for bolted affixed connections;
forming a least two first through bolt hole in the said columns outwards side surface of the lumber members forming a vertical main structural support;
connecting said second angled L shaped bracket column connecting element leg to the said outwards side surface of the column to the opposing side the inwards side surface by provided said through holes in the said first angled L shaped bracket column long connecting leg through the said column for bolted affixed connections;
providing the first joining plate having a horizontal rim joist members connecting element the planner surface provided with a horizontal rim joist members connecting element having longitudinal aligned through holes positioned latitudinally through the outer surface median through to opposing side the inner surface;
positioning the said first joining plate so the inner surface of the planner surface is facing the inwards the said horizontal rim joist members front surface supported by the second angled L shaped bracket supporting element the short supporting flange;
forming a least two first through bolt hole in said front surface of the said horizontal rim joist members to the opposing side the back surface extending through the said front surface of the said columns to the opposing side the back surface;
connecting the said first joining plate to the said front surface of the horizontal rim joist members through to the opposing side the back surface provided said through holes in the said first joining plate through the said horizontal rim joist members extending through said columns surface for bolted affixed connections;
providing the second joining plate having a horizontal rim joist members connecting element the planner surface provided with a horizontal joist members connecting element having longitudinal aligned through holes positioned latitudinally through the outer surface median through to opposing side the inner surface;
positioning the said second joining plate so the inner surface of the planner surface is facing the inwards the said horizontal joist members front surface supported by the second angled L shaped bracket supporting element the short supporting flange;
forming a least two first through bolt hole in said front surface of the horizontal joist members to the opposing side the back surface extending through the said outwards side surface of the said columns to the opposing inwards side surface; and
connecting the said second joining plate to the said front surface of the horizontal joist members through to the opposing side the back surface provided by said through holes in the said first joining plate through the said horizontal joist members extending through said columns side surfaces for bolted affixed connections;

24. Method according to claim 23, wherein said two unequal in heights of
structural angled L shaped brackets have said bolted affixed connections through the holes in the said first angled L shaped bracket connecting leg through said column front surface, the said second angled L shaped bracket long connecting leg through said column outwards side surface derives said short flange of the said first angled L shaped bracket connecting leg height alignment with the said short flange of the said second angled L shaped bracket long connecting leg height alignment supporting the said two unequal in heights of structural angled L shaped brackets forming equal horizontal planes height to the said column.

25. Method according to claim 24, wherein said two unequal in heights of
structural angled L shaped brackets have said bolted affixed connections through the holes in the said first angled L shaped bracket connecting leg through said column front surface, the said second angled L shaped bracket long connecting leg through said column outwards side surface derives the off setting of the latitudinal through holes along the longitudinal median of the said first angled L shaped bracket connecting leg through holes with the said second angled L shaped bracket long connecting leg through holes alignment supporting the said two unequal in heights of structural angled L shaped brackets forming equal horizontal planes of height to the said column front surface to the said outwards side surface.

26. The First method of reinforcing existing stacked structures with past
construction practices between a beam, horizontal rim joist members and two column comprised of lumber members forming the main structural supports utilizing a series of one unequal in height structural steel forged angled L shaped brackets with unequal length, two equal in heights structural steel forged angled L shaped brackets with equal lengths and a steel joining plate to allow for affixed connections between said main structural supports in a structure forming unequal horizontal planes converging on a single horizontal segmented plane, comprising of:
providing the first angled L shaped bracket having a column connecting element the connecting leg and a beam connecting element the connecting flange, the said columns connecting element the connecting leg having longitudinal aligned through holes positioned latitudinally through the outer surface median through to the opposing side the inner surface, the said beam supporting element the supporting flange having latitudinal aligned through the downwards surface median through to the opposing side the upwards surface;
providing the second angled L shaped bracket having a column connecting element the long connecting leg and a horizontal rim joist members supporting element the short supporting flange, the said column connecting element the long connecting leg having longitudinal aligned through holes positioned latitudinally through the said outer surface median through to the opposing side the inner surface, said horizontal rim joist members supporting element the short flange having an downwards surface with an opposing surface upward surface;
positioning the said first angled L shaped bracket in a reversed upside down L shape configuration so that the outer surface of the connecting leg is facing the inwards the first columns back surface extending the supporting flange upwards surface to the bottom surface of the beam having an opposing side the top surface;
positioning the said second angled L shaped bracket in a upside down L shape configuration that the outer surface of the connecting leg is facing the inwards towards the same said first columns front surface extending the short flange upwards surface to the horizontal rim joist members bottom surface, the said upward surface latitudinally aligns with the top surface of the said beam;
forming one first through bolt hole in the said first columns back surface of the lumber members forming a vertical main structural support;
connecting said first angled L shaped bracket column connecting element leg to the said back surface of the first column to the opposing side the front surface by provided said first through hole in the said front surface of the first column to the opposing side the back surface through the said first angled L shaped bracket column connecting element leg for bolted affixed connections;
forming one first through bolt hole in the said first columns front surface of the lumber members forming a vertical main structural support;
connecting said second angled L shaped bracket long connecting leg to the said front surface of the first column to the opposing side the back surface through the said first angled L shaped bracket connecting leg by provided said second through hole in the said front surface of the first column to the opposing side back surface through the said first angled L shaped bracket connecting leg for bolted affixed connections;
forming one first lag through hole in the median of the said beam front surface lumber members forming a horizontal main structural support;
connecting said second angled L shaped bracket column connecting element leg to the said median of the beams front surface by provided said through holes in the said second angled L shaped bracket long connecting leg through the said median of the beams front surface for lag bolted affixed connections;
providing the third angled L shaped bracket having a column connecting element the connecting leg and a beam connecting element the connecting flange, the said columns connecting element the connecting leg having longitudinal aligned through holes positioned latitudinally through the outer surface median through to the opposing side the inner surface, the said beam connecting element the connecting flange having latitudinal aligned through the surface upwards median through to the opposing side the downwards surface;
positioning the said third angled L shaped bracket in a reversed L shape configuration so that the outer surface of the connecting leg is facing the inwards the second columns back surface extending the supporting flange downwards surface to the said beams top surface;
forming a least one first through bolt hole in the said beams bottom surface of the lumber members forming a horizontal main structural support;
forming a least one first through bolt hole in the said beams top surface of the lumber members forming a horizontal main structural support;
connecting said first angled L shaped bracket beam connecting element the connecting flange to the said bottom surface of the said beam to the opposing side the top surface to said third angled L shaped bracket beam connecting element the connecting flange by provided said through holes in the said first angled L shaped bracket connecting flange through the said beam through the third angled L shaped bracket connecting flange for bolted affixed connections;
providing the joining plate having a horizontal rim joist members connecting element the planner surface provided with a horizontal rim joist members connecting element having longitudinal aligned through holes positioned latitudinally through the outer surface median through to opposing side the inner surface;
positioning the said joining plate so the inner surface of the planner surface is facing the inwards the horizontal rim joist members front surface supported by the second angled L shaped bracket supporting element the short supporting flange;
forming a least one first through bolt hole in said front surface of the horizontal rim joist members to the opposing side the back surface extending through the said front surface of the second columns to the opposing side the back surface;
forming a least one first through bolt hole in the said second columns back surface of the lumber members forming a vertical main structural support;
connecting the said joining plate to the said front surface of the horizontal rim joist members through to the opposing side the back surface extending through the said front surface of the said second columns to the opposing side the back surface to the said third angled L shaped bracket connecting leg by the provided said through holes in the said joining plate through the said horizontal rim joist members extending through said second columns surface through said third angled L shaped bracket connecting leg for bolted affixed connections.

27. Method according to claim 26, wherein said second angled L shaped
bracket supporting element flange upwards surface would be in latitudinal alignment with the said beams top surface, said second angled L shaped bracket lower through bolt hole in the said long connecting leg would offset the said first angled L shaped bracket connecting element upper through bolt hole in the said connecting leg forming unequal horizontal planes of the said beam top surface with the said horizontal rim joist members bottom surface converging on the single segmented horizontal plane the said top surface aligning with the said bottom surface.

28. Method according to claim 26, wherein said bolted affixed connections of the said joining plate planner surface to the said horizontal rim joist members to the said second columns extending to the said third angled L shaped bracket connecting leg derives the alignment of the through holes in the said joining plate and said third angled L shaped bracket connecting leg for said bolted affixed connections between said second column to the said beam by means of the said joining plate to the third angled L shaped brackets said connecting leg with the said connecting flange.

29. The second method of reinforcing existing notched structures with past
construction practices between a beam, horizontal rim joist members and notched column comprised of lumber members forming the main structural supports utilizing a series of one unequal in height structural steel forged angled L shaped brackets with unequal length, two equal in heights structural steel forged angled L shaped brackets with equal lengths and a steel joining plate to allow for affixed connections between said main structural supports in a structure forming unequal horizontal planes converging on a single horizontal segmented plane, comprising of:
providing the first angled L shaped bracket having a column connecting element the connecting leg and a beam connecting element the connecting flange, the said columns connecting element the connecting leg having longitudinal aligned through holes positioned latitudinally through the outer surface median through to the opposing side the inner surface, the said beam supporting element the supporting flange having latitudinal aligned through the downwards surface median through to the opposing side the upwards surface;
providing the second angled L shaped bracket having a column connecting element the long connecting leg and a horizontal rim joist members supporting element the short supporting flange, the said column connecting element the long connecting leg having longitudinal aligned through holes positioned latitudinally through the said outer surface median through to the opposing side the inner surface, said horizontal rim joist members supporting element the short flange having an downwards surface with an opposing surface upward surface;
positioning the said first angled L shaped bracket in a reversed upside down L shape configuration so that the outer surface of the connecting leg is facing the inwards the notched columns back surface extending the supporting flange upwards surface to the bottom surface of the beam having an opposing side the top surface;
positioning the said second angled L shaped bracket in a upside down L shape configuration that the outer surface of the connecting leg is facing the inwards towards the same said notched columns front surface extending the short flange upwards surface to the horizontal rim joist members bottom surface, the said upward surface latitudinally aligns with the top surface of the said beam;
forming one first through bolt hole in the said notched columns back surface of the lumber members forming a vertical main structural support;
connecting said first angled L shaped bracket column connecting element leg to the said back surface of the first column to the opposing side the front surface by provided said first through hole in the said front surface of the notched column to the opposing side the back surface through the said first angled L shaped bracket column connecting element leg for bolted affixed connections;
forming one first through bolt hole in the said notched columns front surface of the lumber members forming a vertical main structural support;
connecting said second angled L shaped bracket long connecting leg to the said front surface of the notched column to the opposing side the back surface through the said first angled L shaped bracket connecting leg by provided said second through hole in the said front surface of the notched column to the opposing side back surface through the said first angled L shaped bracket connecting leg for bolted affixed connections;
forming one first lag through hole in the median of the said notched column front surface lumber members forming a horizontal main structural support;
connecting said second angled L shaped bracket column connecting element leg to the said median of the notched columns front surface by provided said through holes in the said second angled L shaped bracket long connecting leg through the said median of the notched columns front surface for lag bolted affixed connections;
providing the third angled L shaped bracket having a column connecting element the connecting leg and a beam connecting element the connecting flange, the said columns connecting element the connecting leg having longitudinal aligned through holes positioned latitudinally through the outer surface median through to the opposing side the inner surface, the said beam connecting element the connecting flange having latitudinal aligned through the surface upwards median through to the opposing side the downwards surface;
positioning the said third angled L shaped bracket in a reversed L shape configuration so that the outer surface of the connecting leg is facing the inwards the notched columns back surface extending the supporting flange downwards surface to the said beams top surface;
forming a least one first through bolt hole in the said beams bottom surface of the lumber members forming a horizontal main structural support;
forming a least one first through bolt hole in the said beams top surface of the lumber members forming a horizontal main structural support;
connecting said first angled L shaped bracket beam connecting element the connecting flange to the said bottom surface of the said beam to the opposing side the top surface to said third angled L shaped bracket beam connecting element the connecting flange by provided said through holes in the said first angled L shaped bracket connecting flange through the said beam through the third angled L shaped bracket connecting flange for bolted affixed connections;
providing the joining plate having a horizontal rim joist members connecting element the planner surface provided with a horizontal rim joist members connecting element having longitudinal aligned through holes positioned latitudinally through the outer surface median through to opposing side the inner surface;
positioning the said joining plate so the inner surface of the planner surface is facing the inwards the horizontal rim joist members front surface supported by the second angled L shaped bracket supporting element the short supporting flange;
forming a least one first through bolt hole in said front surface of the horizontal rim joist members to the opposing side the back surface extending through the said front surface of the notched column to the opposing side the back surface;
forming a least one first through bolt hole in the said notched columns back surface of the lumber members forming a vertical main structural support;
connecting the said joining plate to the said front surface of the horizontal rim joist members through to the opposing side the back surface extending through the said front surface of the said notched column to the opposing side the back surface to the said third angled L shaped bracket connecting leg by the provided said through holes in the said joining plate through the said horizontal rim joist members extending through said notched columns surfaces through said third angled L shaped bracket connecting leg for bolted affixed connections.

30. Method according to claim 29, wherein said second angled L shaped
bracket supporting element flange upwards surface would be in latitudinal alignment with the said beams top surface, said second angled L shaped bracket lower through bolt hole in the said long connecting leg would offset the said first angled L shaped bracket connecting element upper through bolt hole in the said connecting leg forming unequal horizontal planes of the said beam top surface with the said horizontal rim joist members bottom surface converging on the single segmented horizontal plane the said top surface aligning with the said bottom surface.
